(19) United States
(12) Patent Application Publication
(10) Pub. No.: US 2024/0069500 A1
(43) Pub. Date: Feb. 29, 2024

(54) AI intelligent things

(71) Applicants: Bright Roger Sung, New York, NY (US); Jesse O Sung, New York, NY (US)

(72) Inventors: Bright Roger Sung, New York, NY (US); Jesse O Sung, New York, NY (US)

(21) Appl. No.: 17/656,606

(22) Filed: May 13, 2022

(51) Int. Cl. G05B 13/02; E03D 9/00

(52) U.S. Cl. CPC G05B 13/027; E03D 9/00

(57) ABSTRACT

The invention consists(including and not limited to) of the three interrelate and independent themes;
I, the “AI Toilet” systems to changing Human stool excretions. Making its become a pleasures, to reducing anal diseases by more than 80%, Hemorrhoids will disappear from humanity. Used intelligent robots, smart sensors community, ect.
II, Family data center. To protect the privacys, its changing internet ecology, made decentralization, Establishment every center of the each user family(web3.0+). It own triple protections;
A, passware and three security questions, No transfor and saves into the home storage.
B, disconnected communication between double barkups.
C, Blockchain AI.
III, all personal with home devices to IoT. any time any where access, View, Deal.

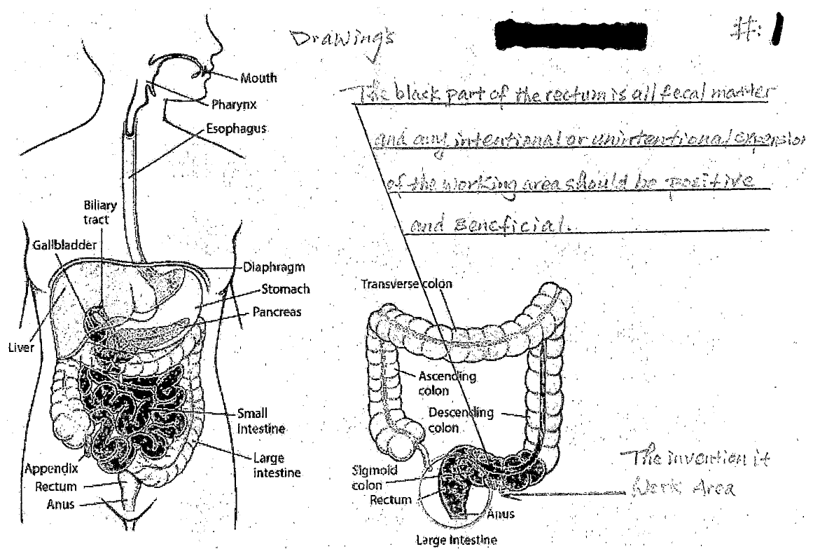

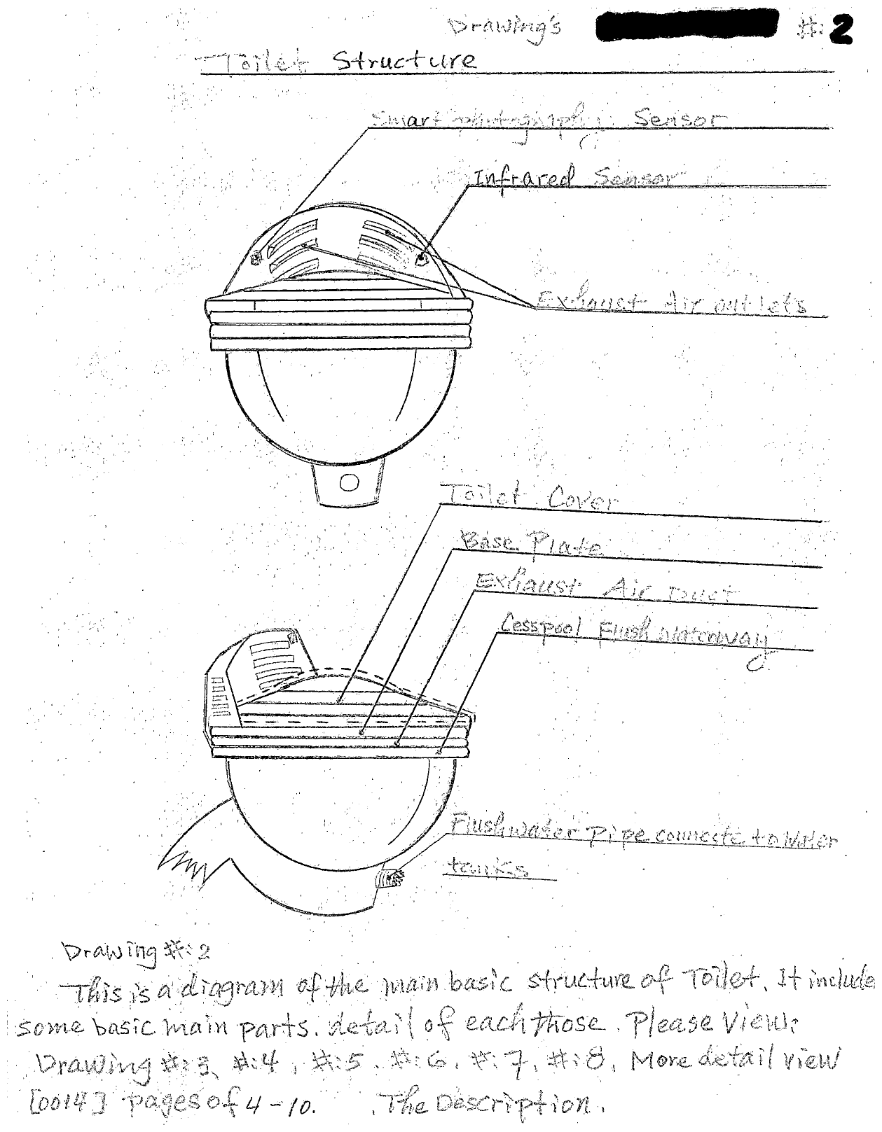

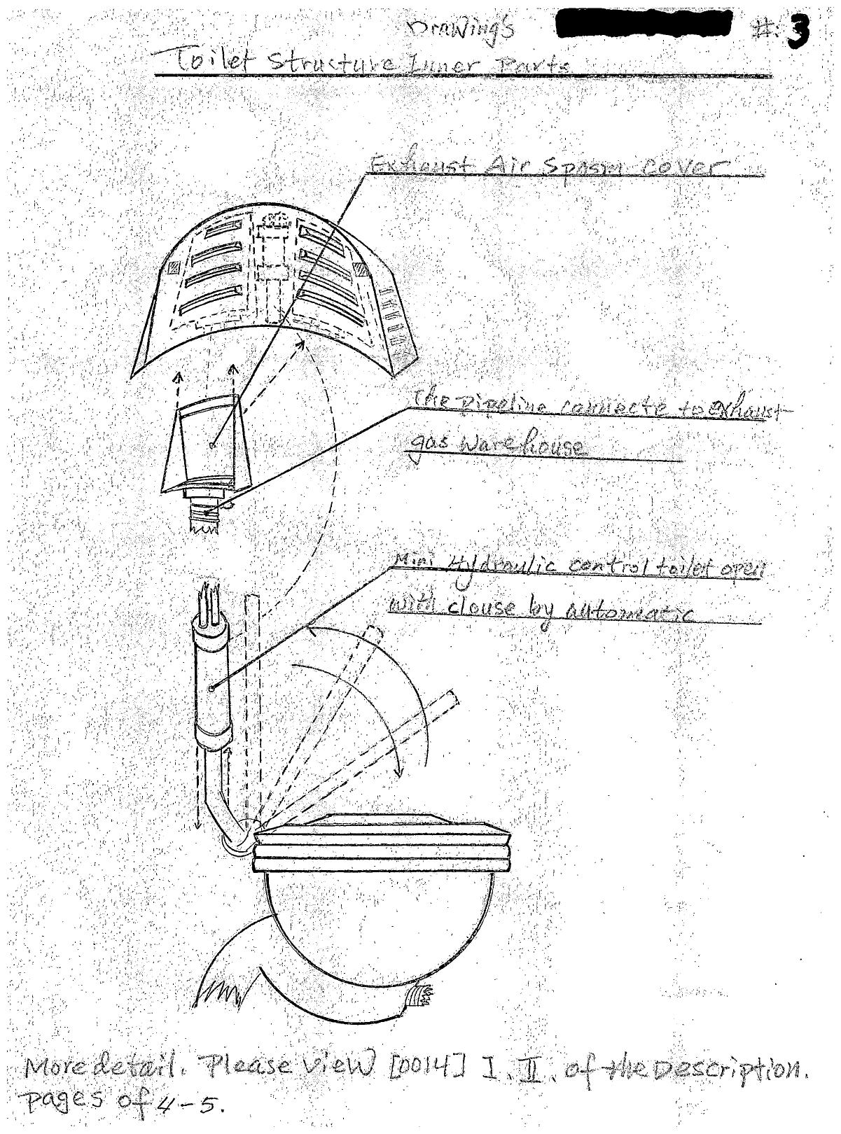

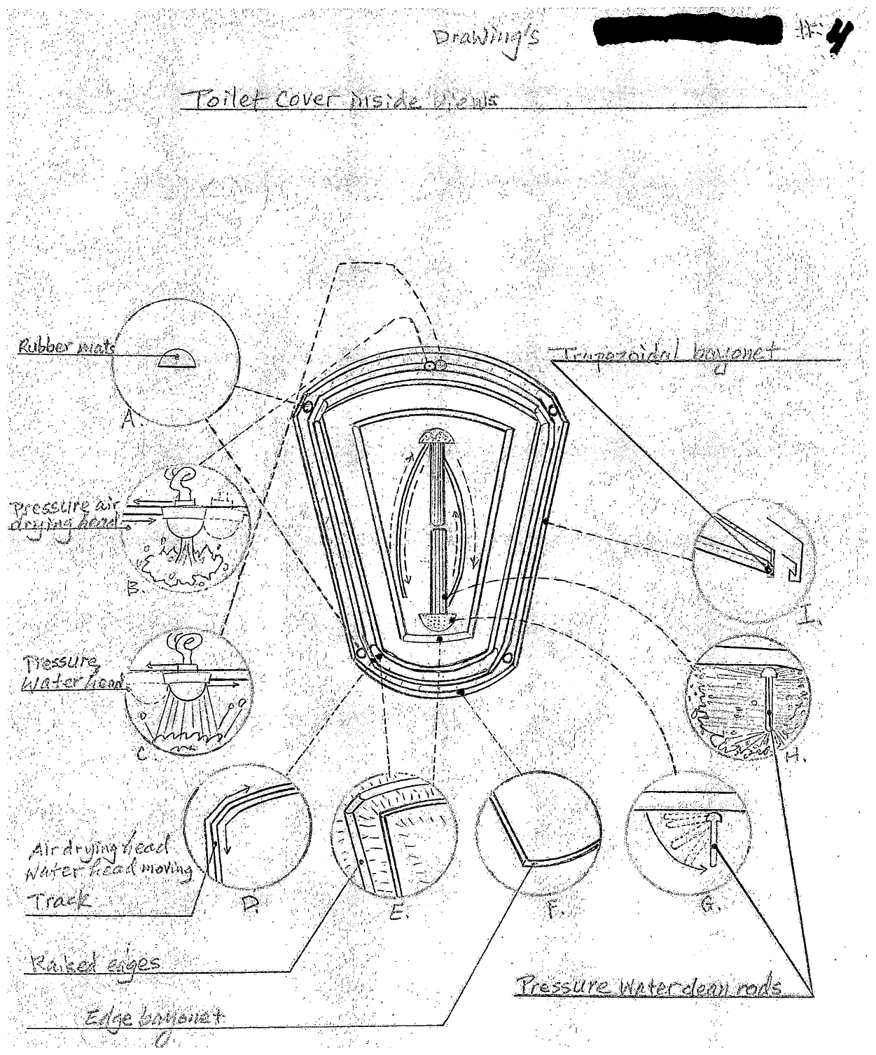

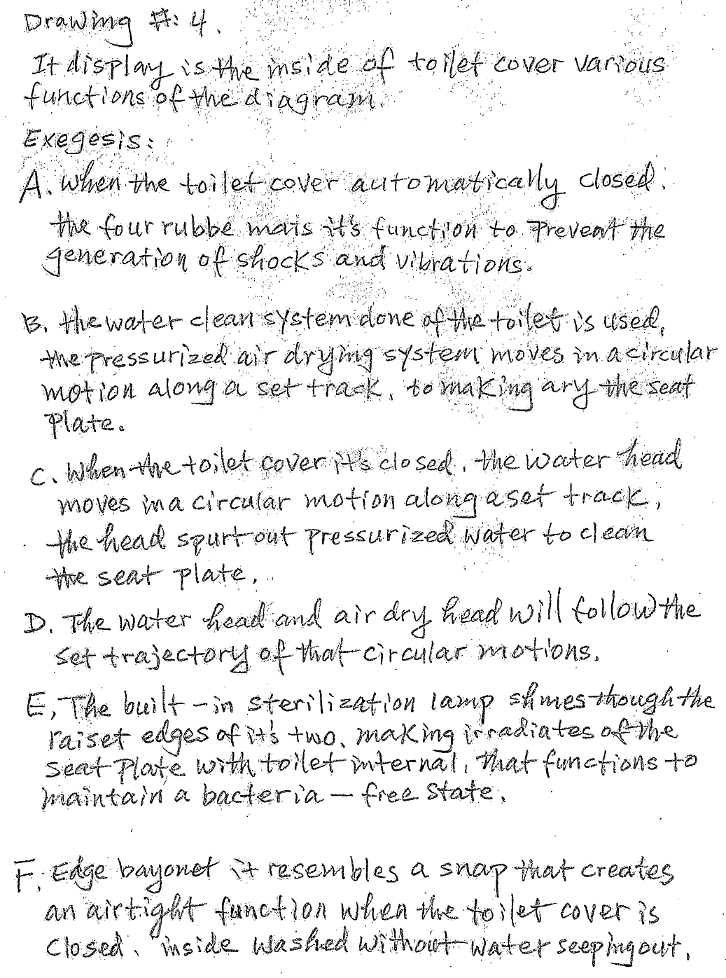

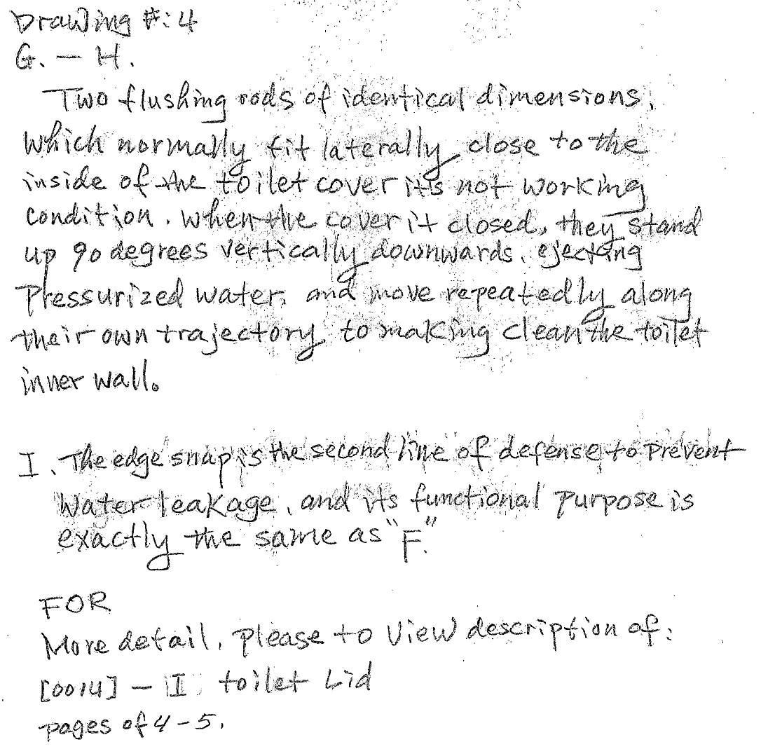

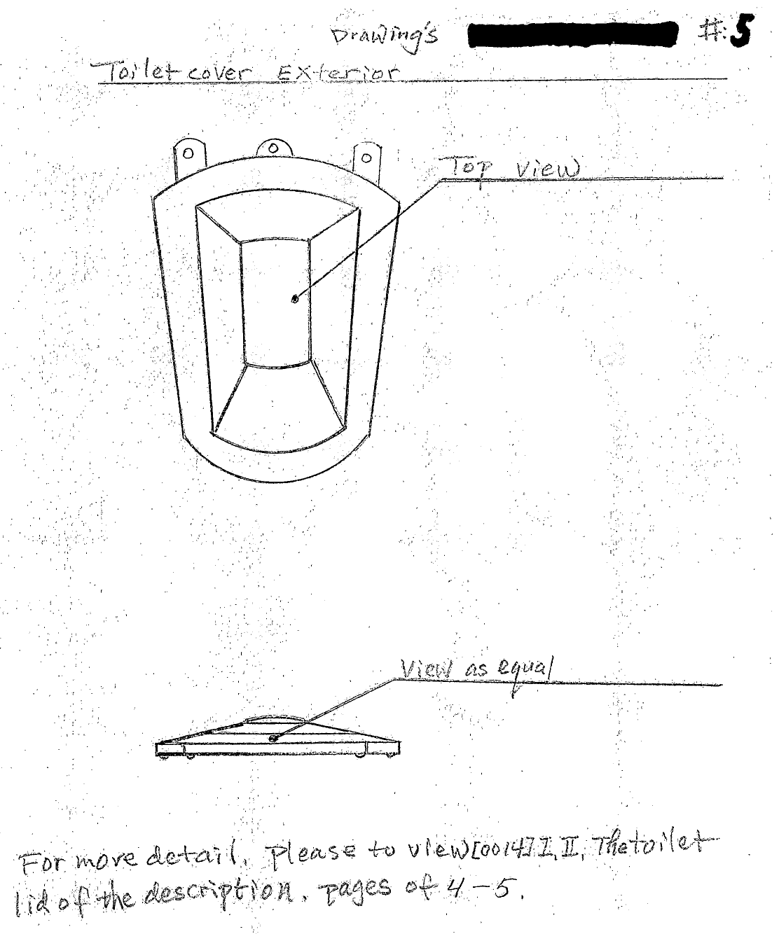

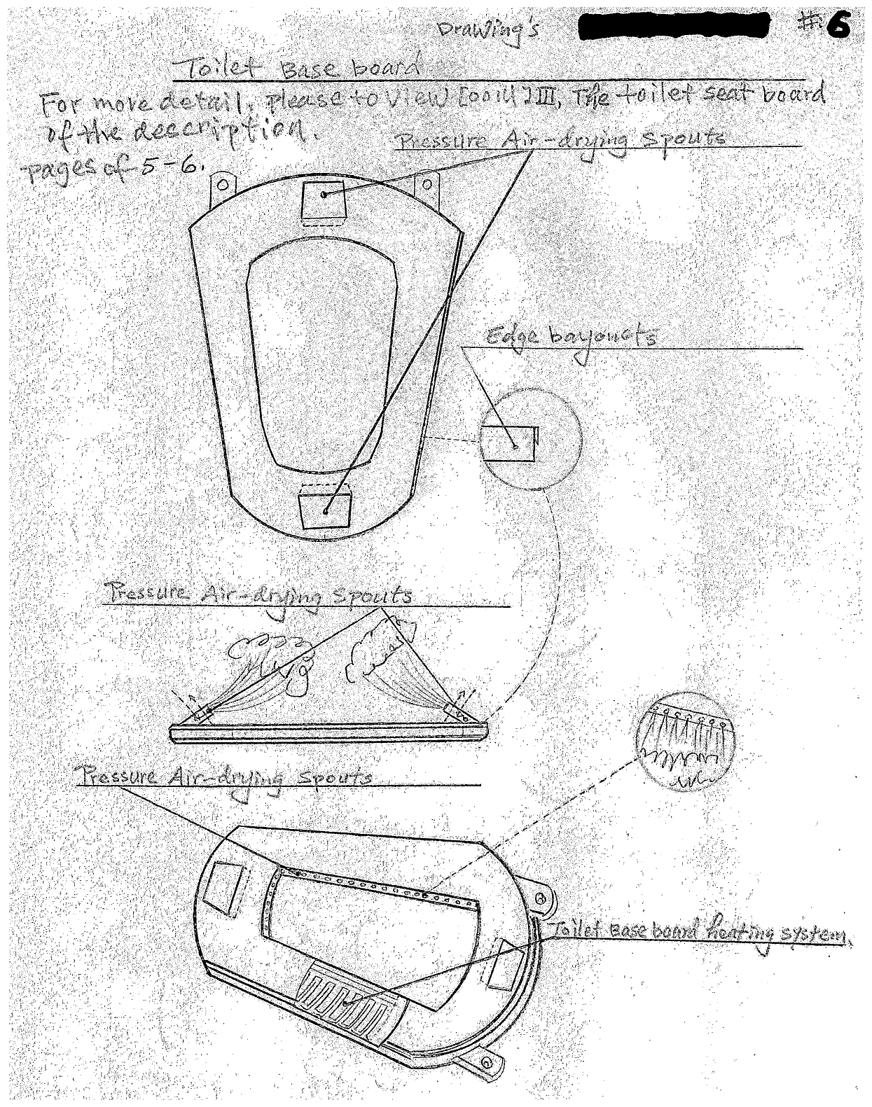

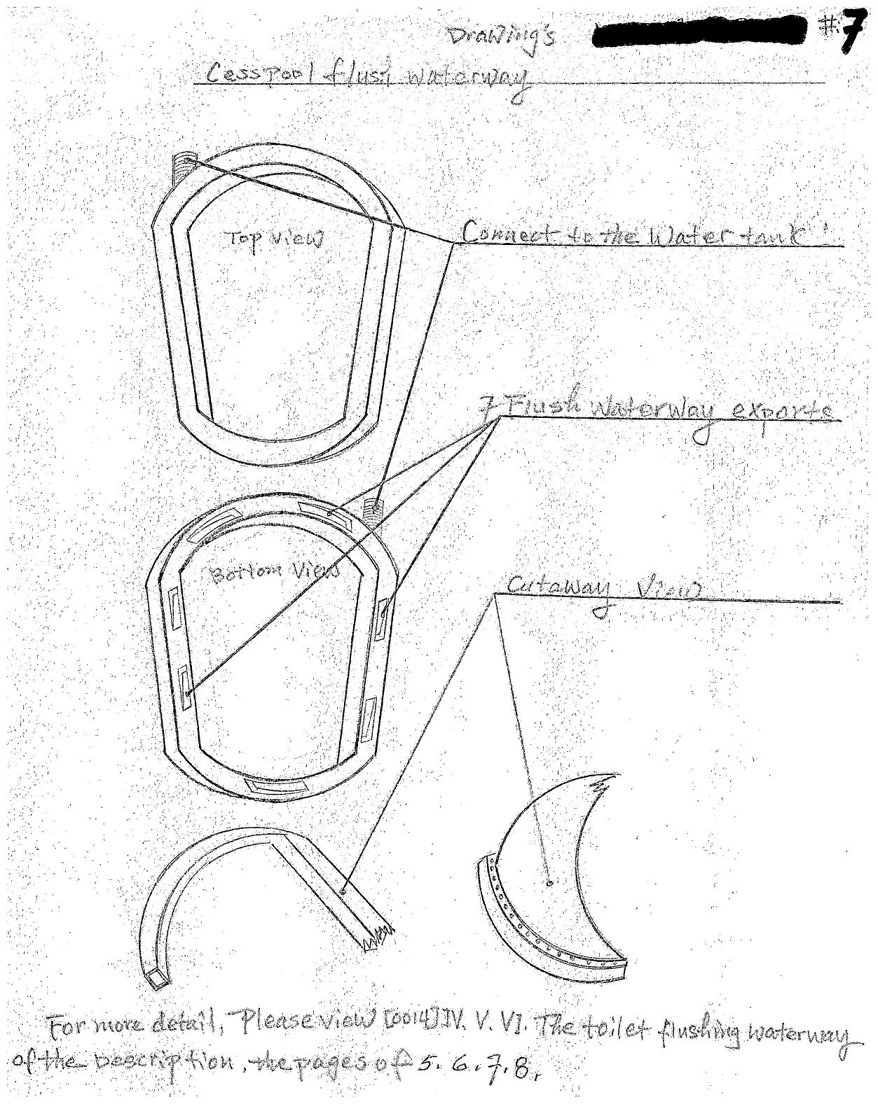

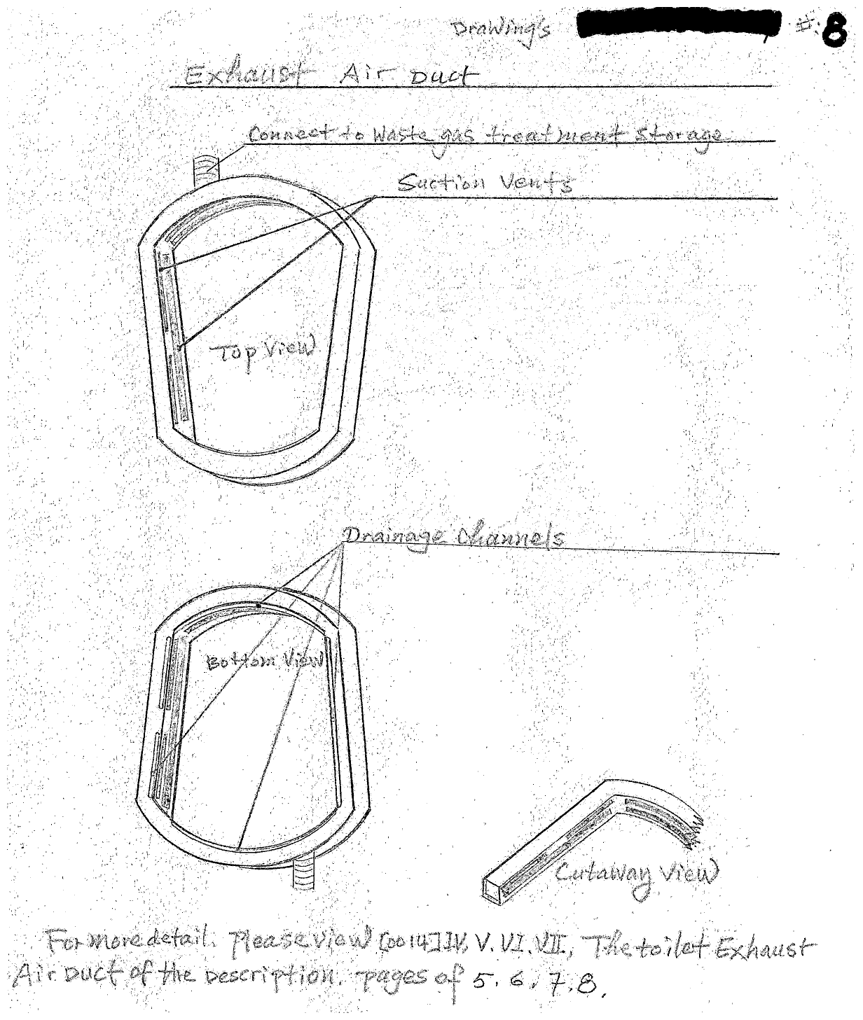

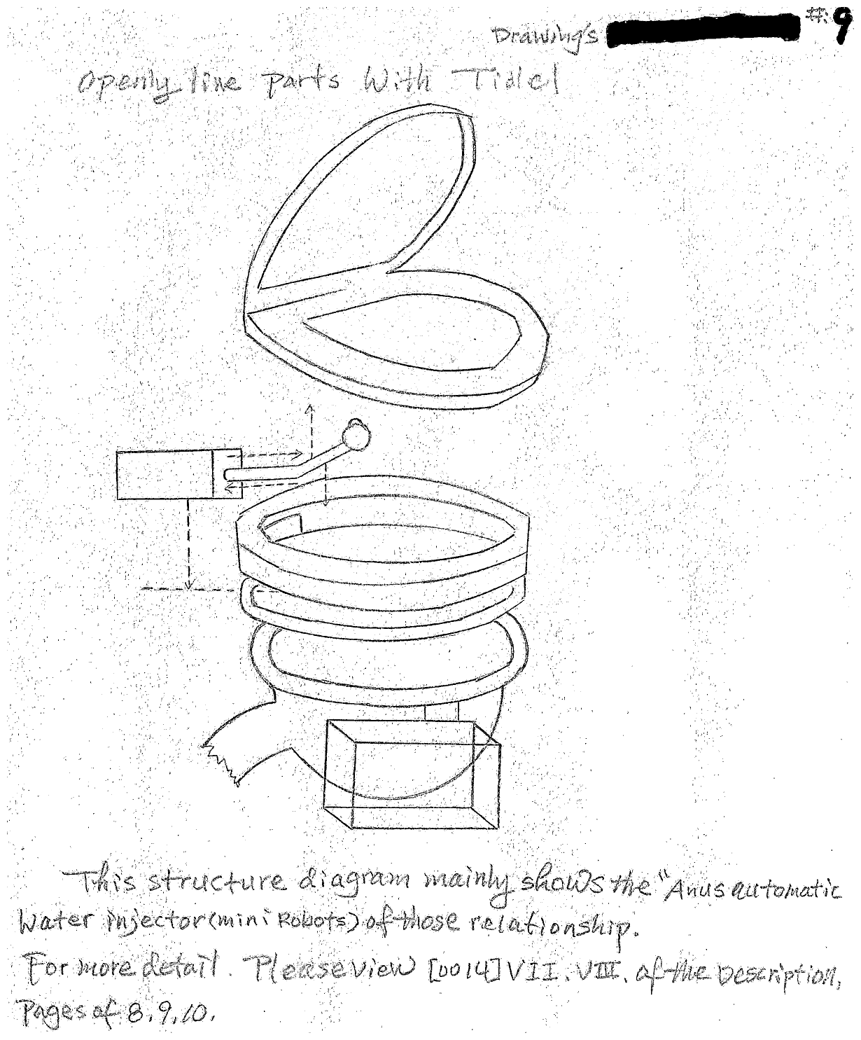

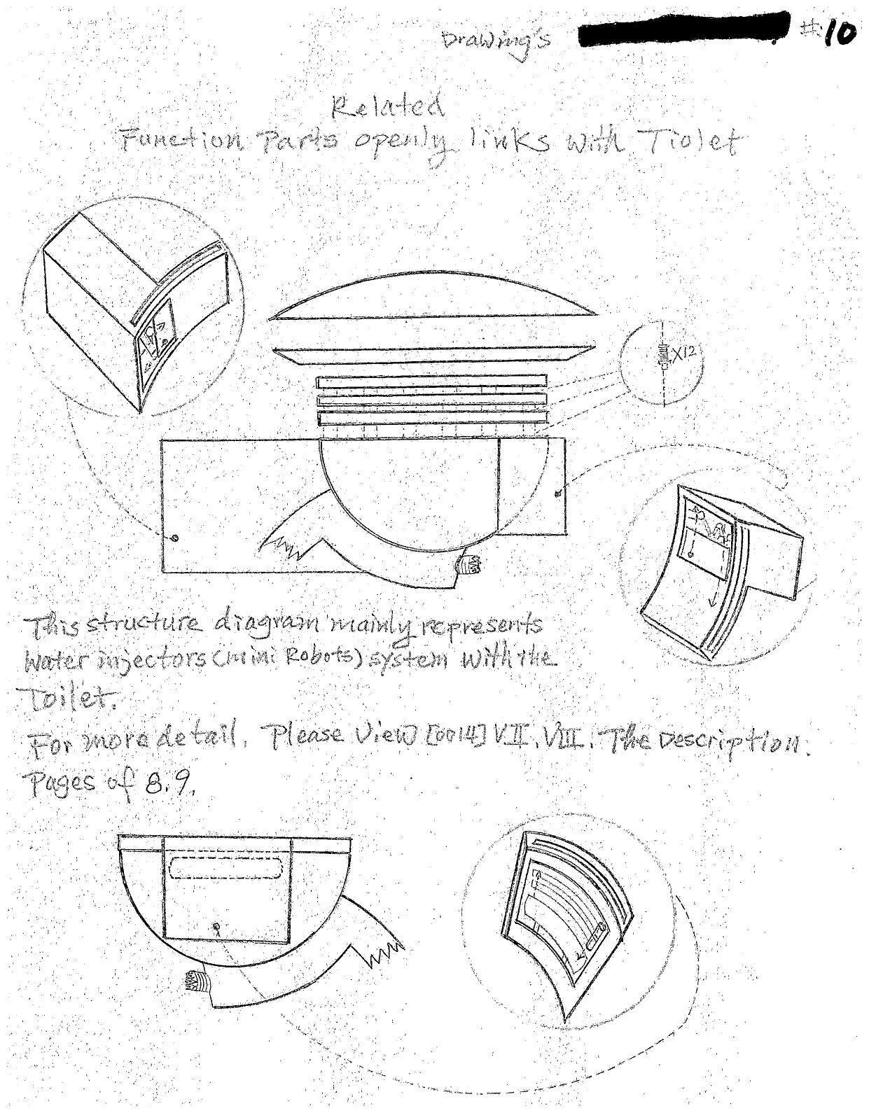

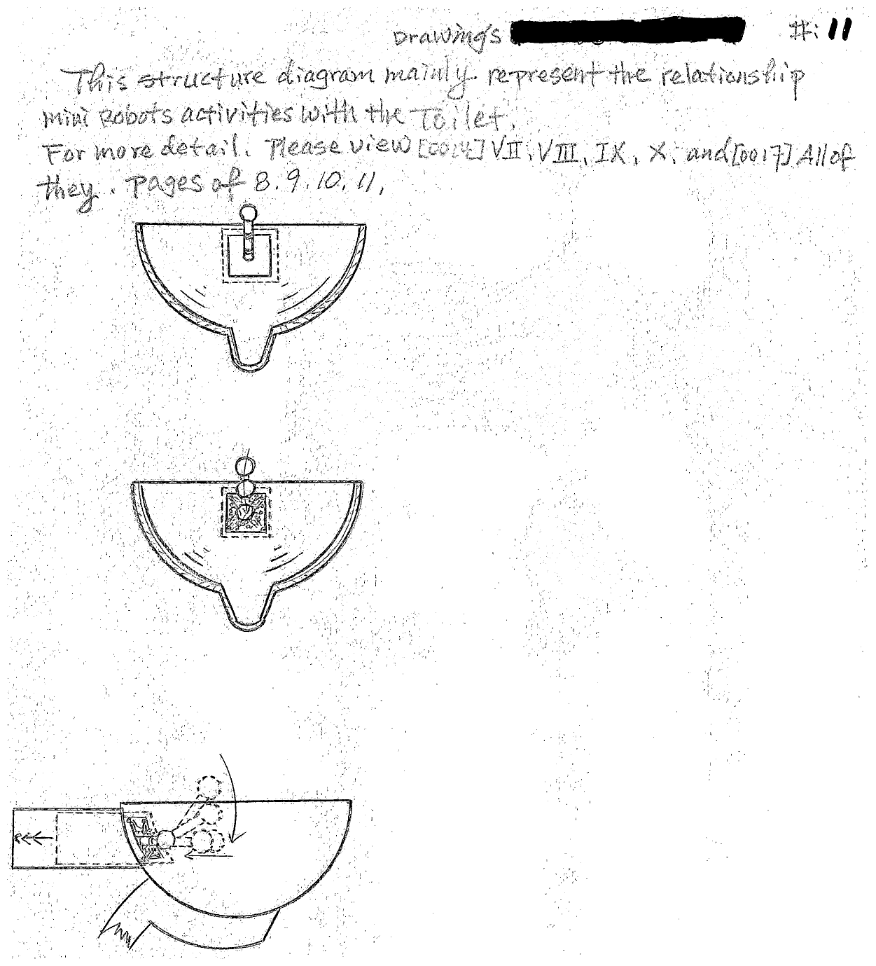

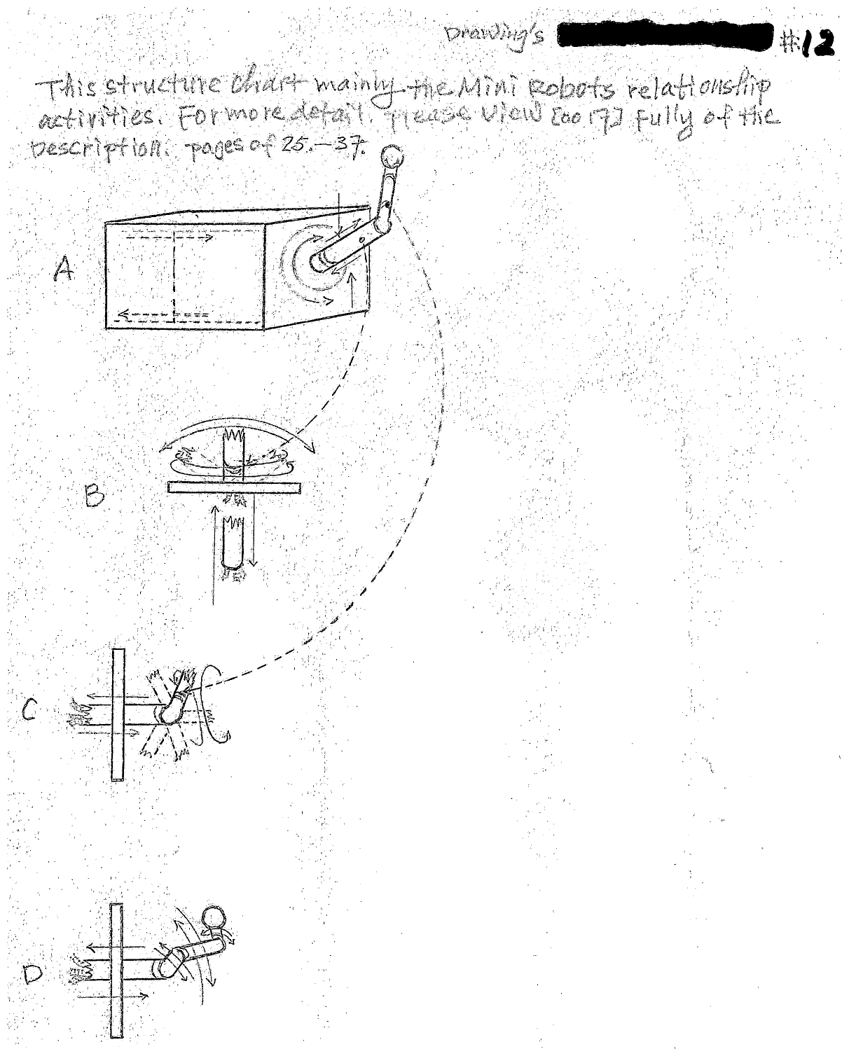

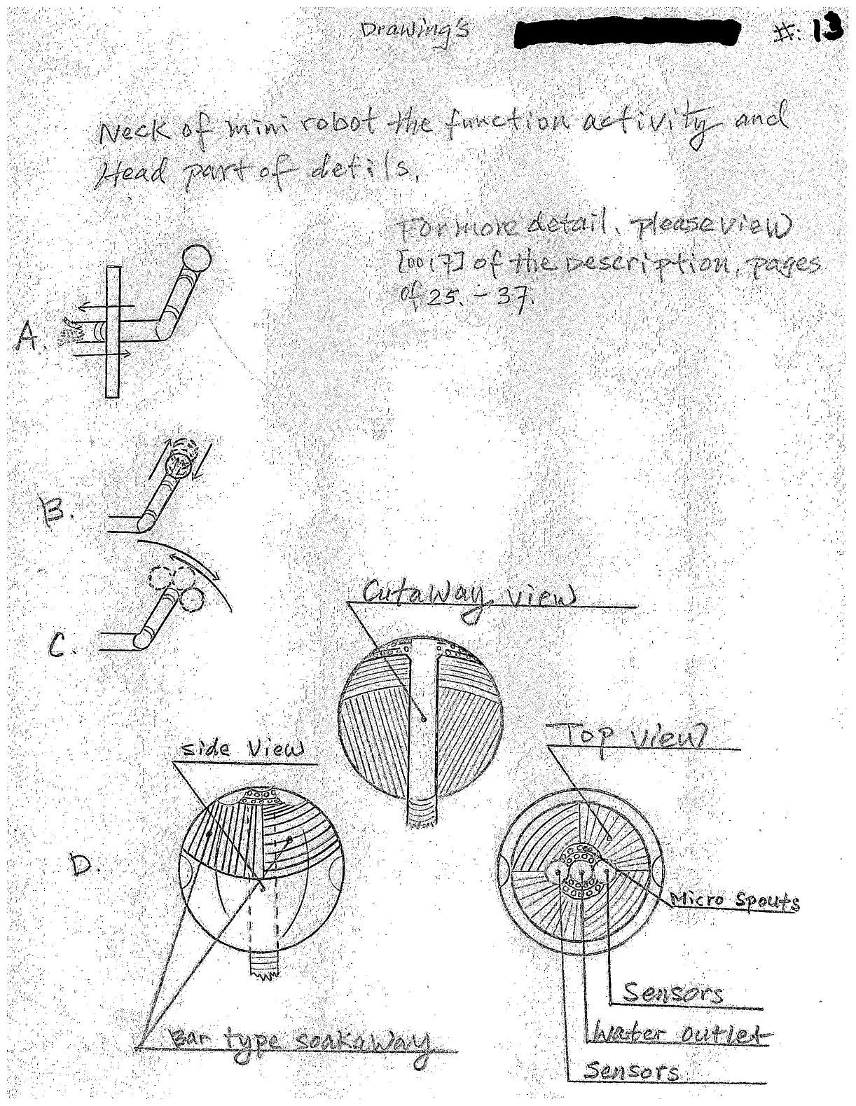

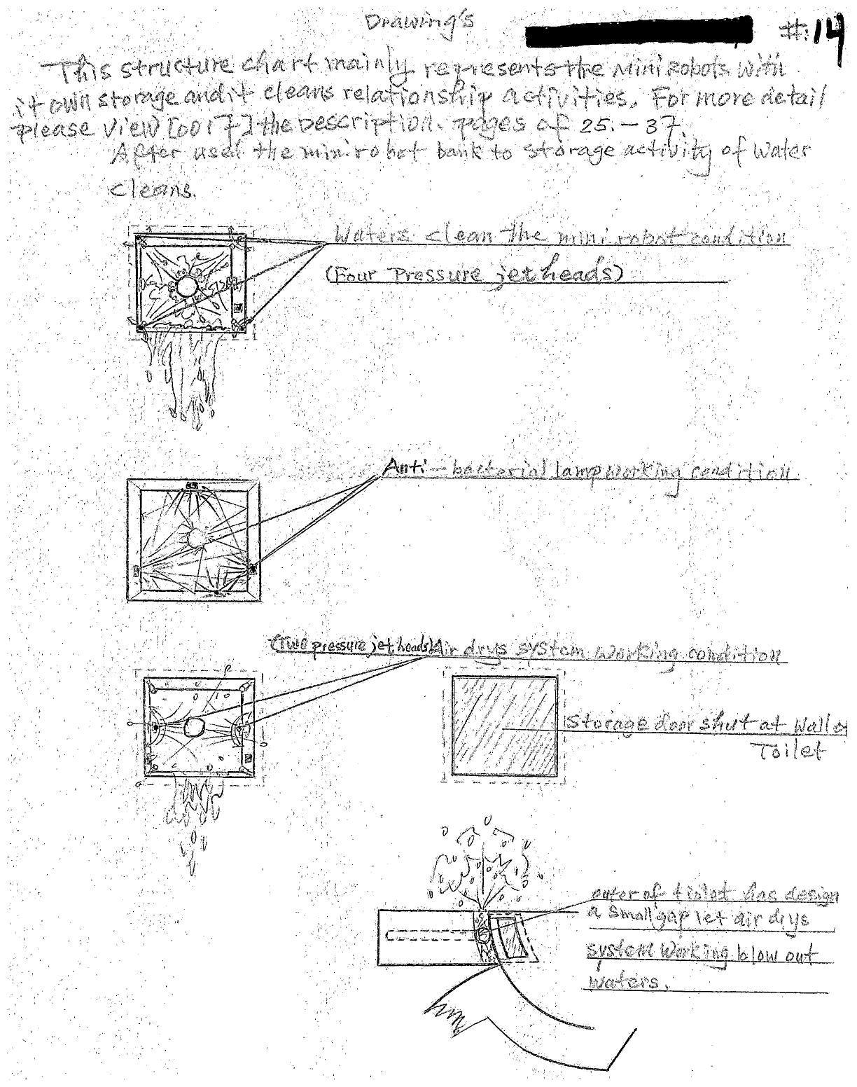

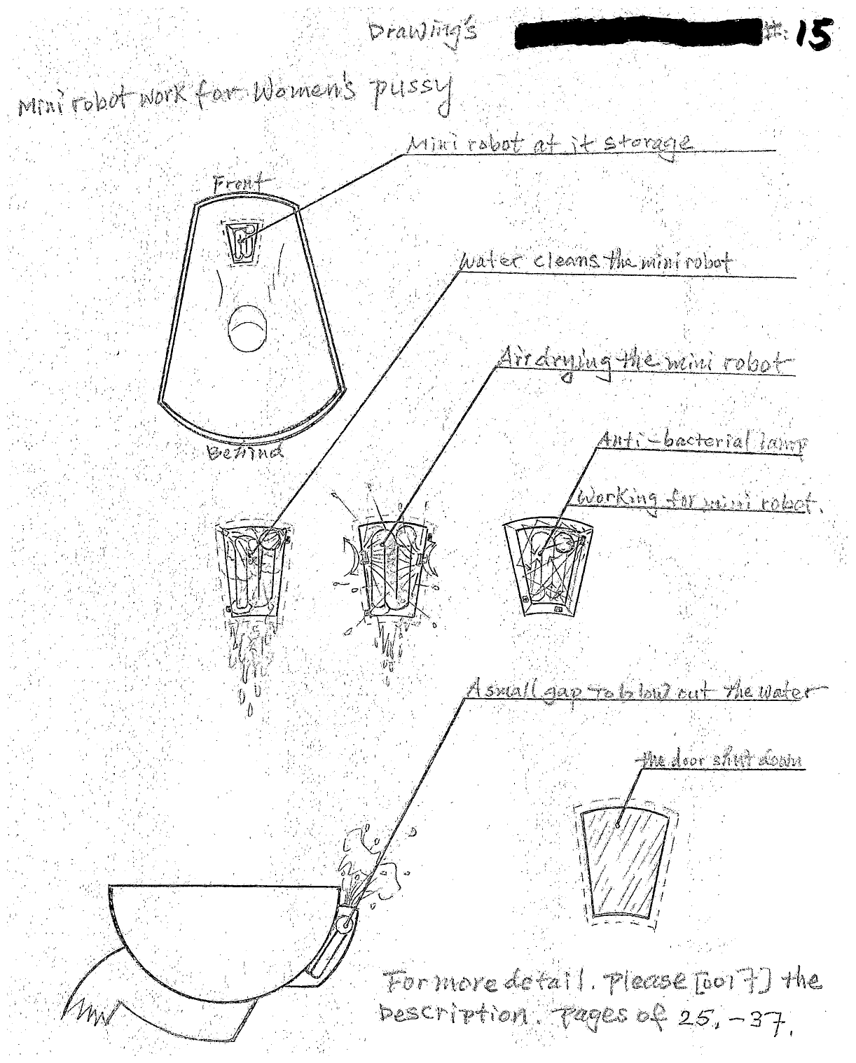

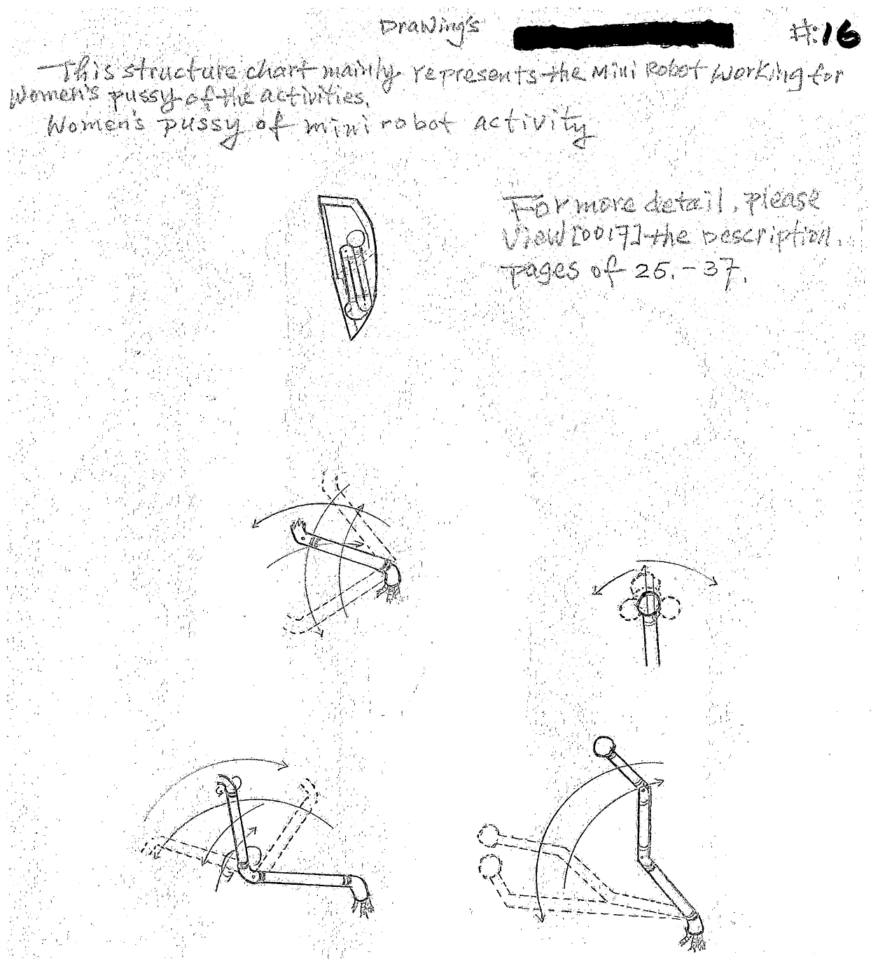

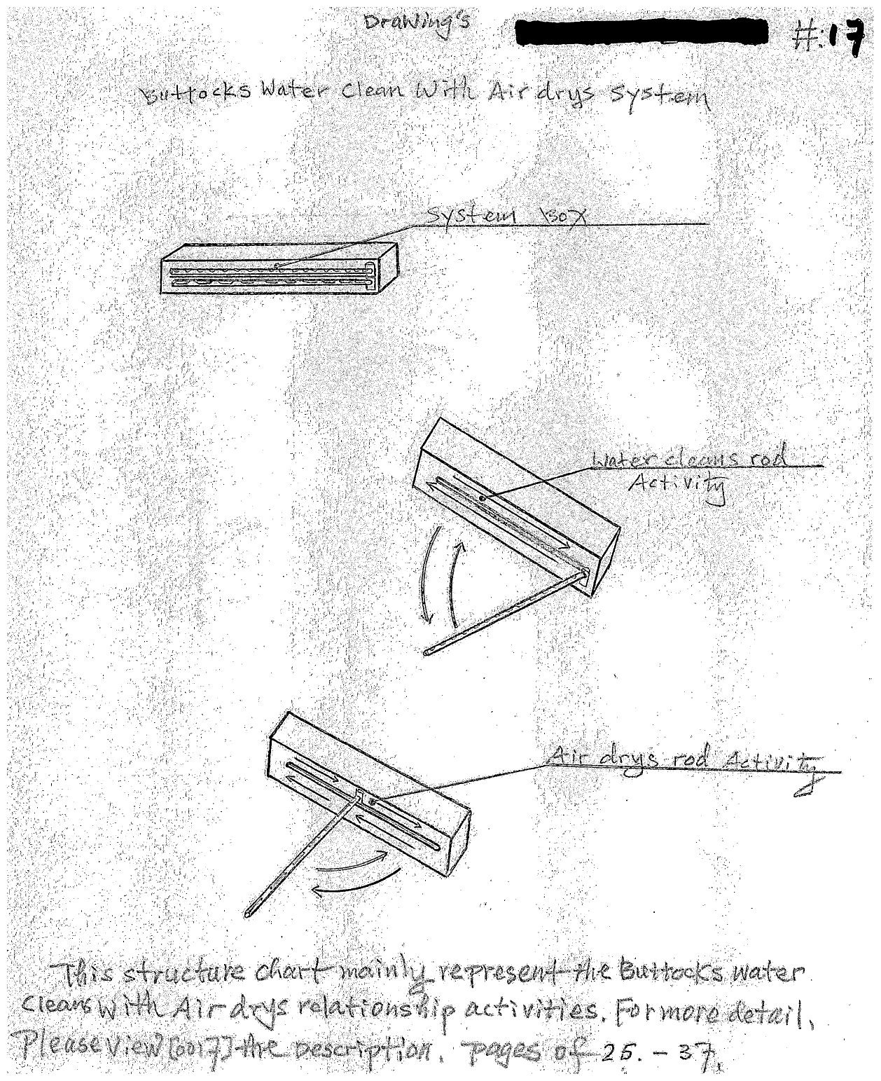

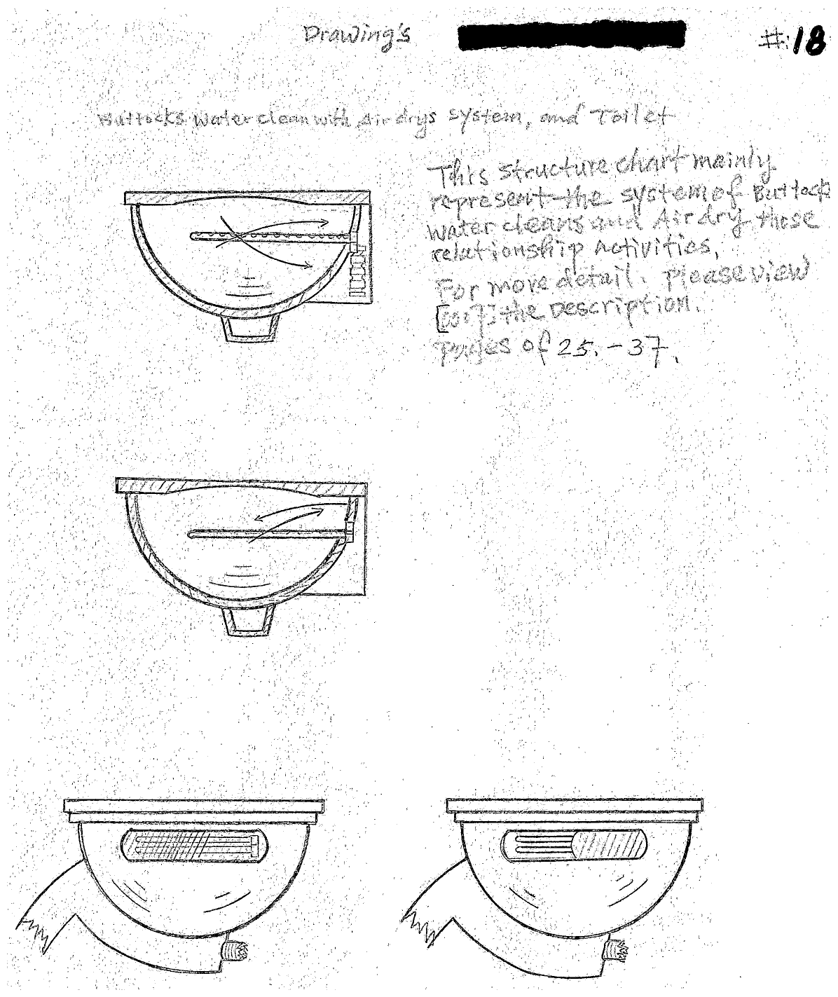

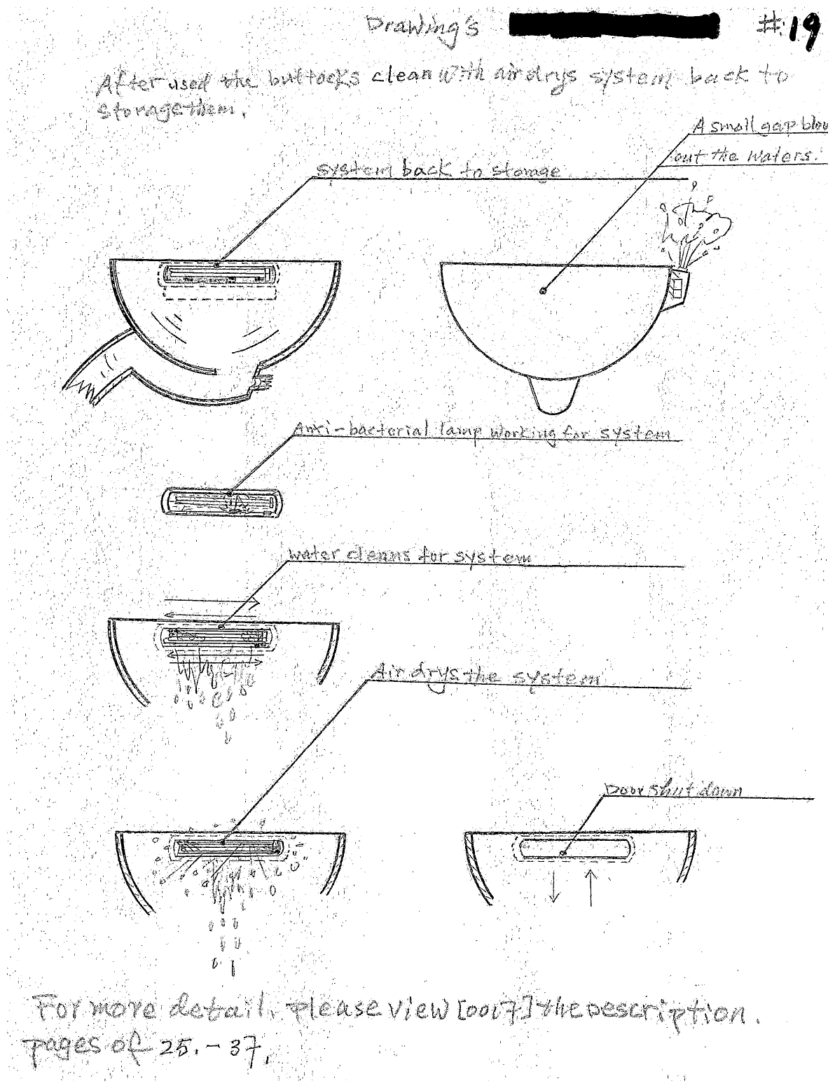

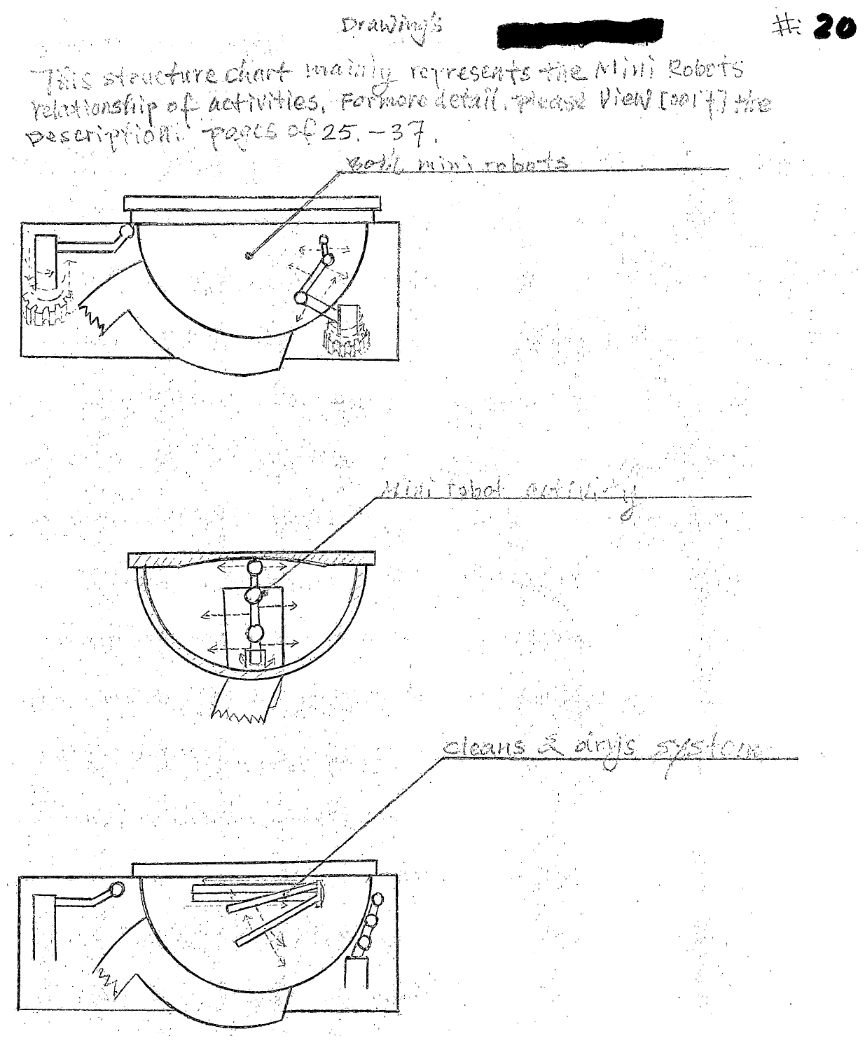

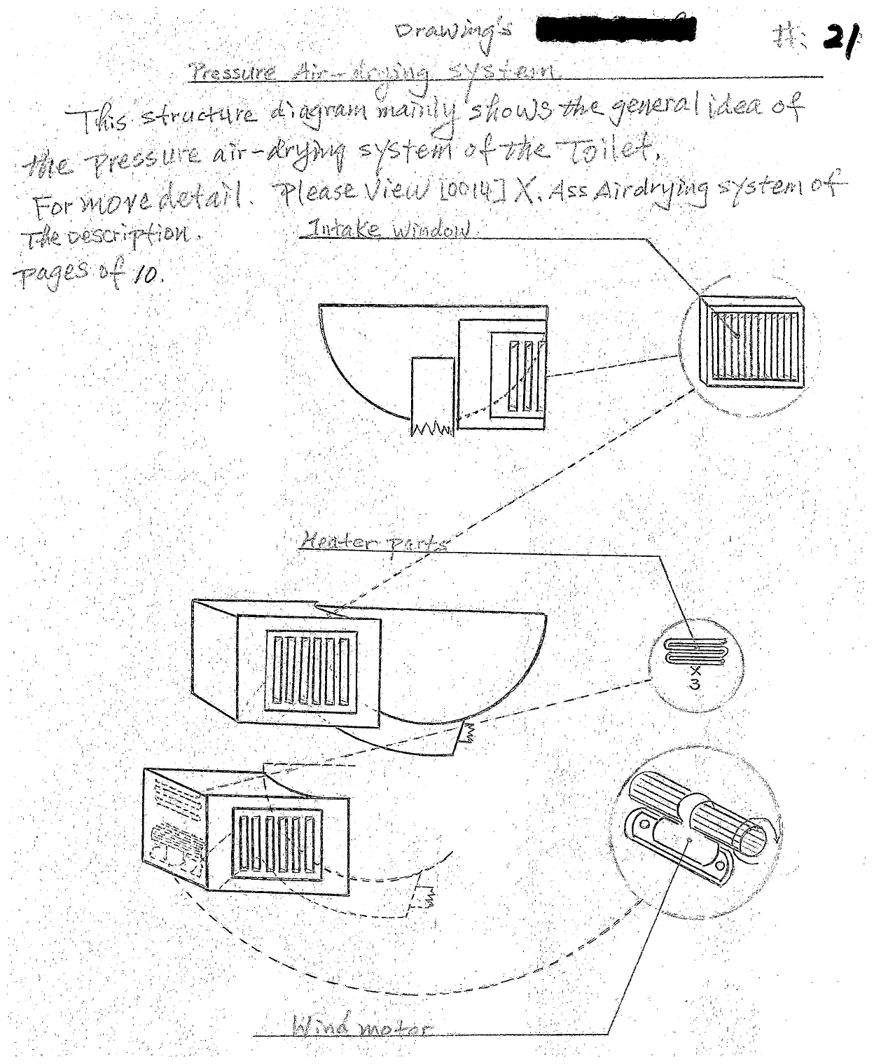

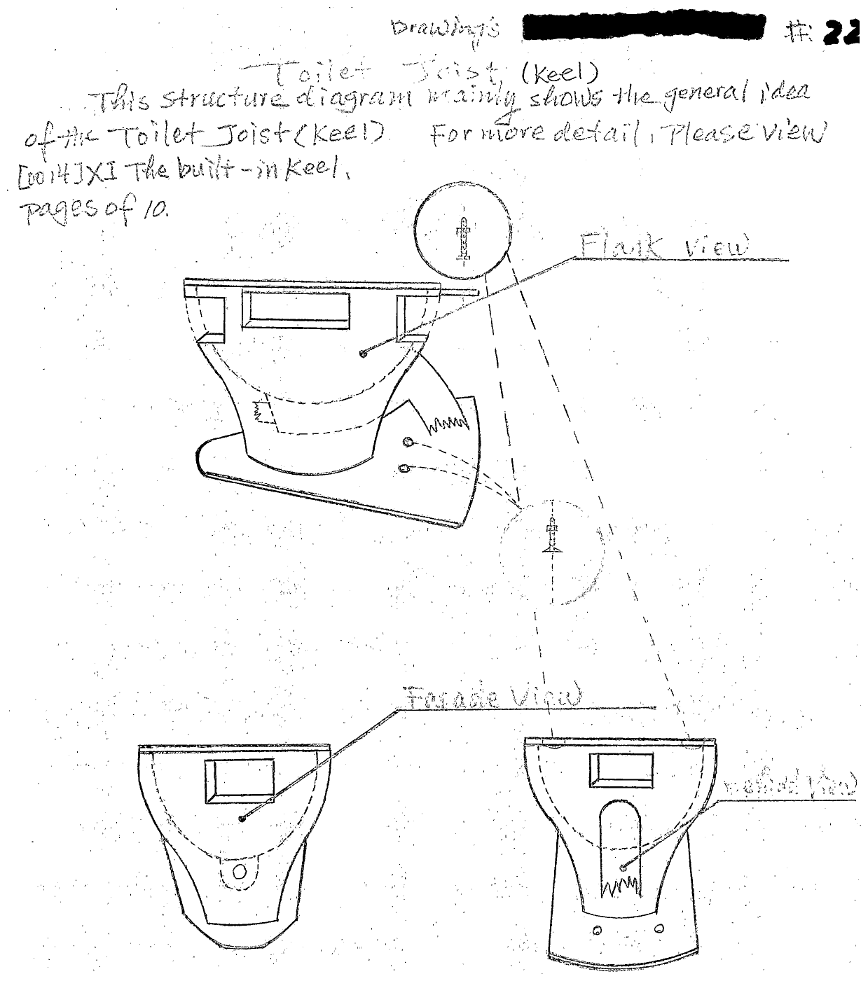

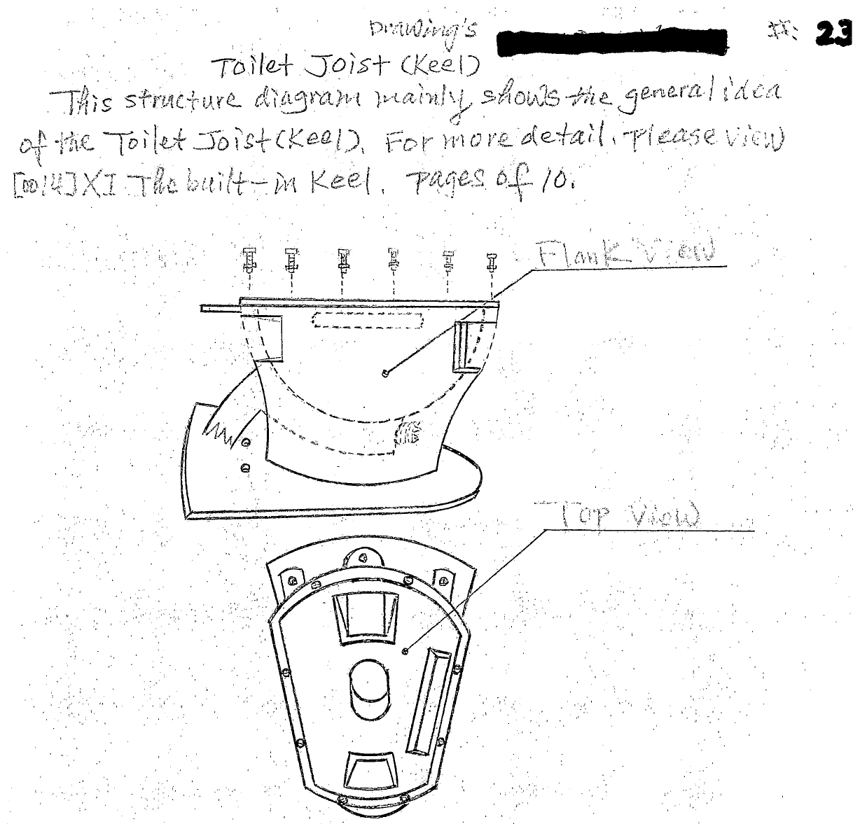

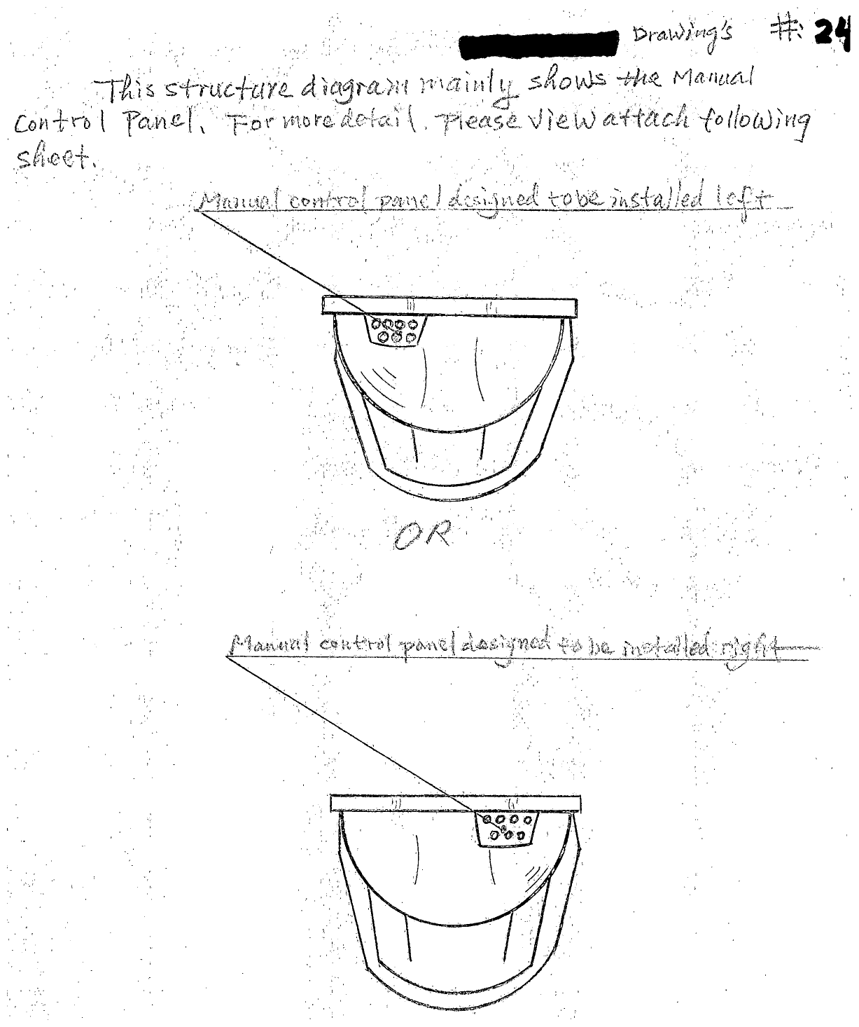

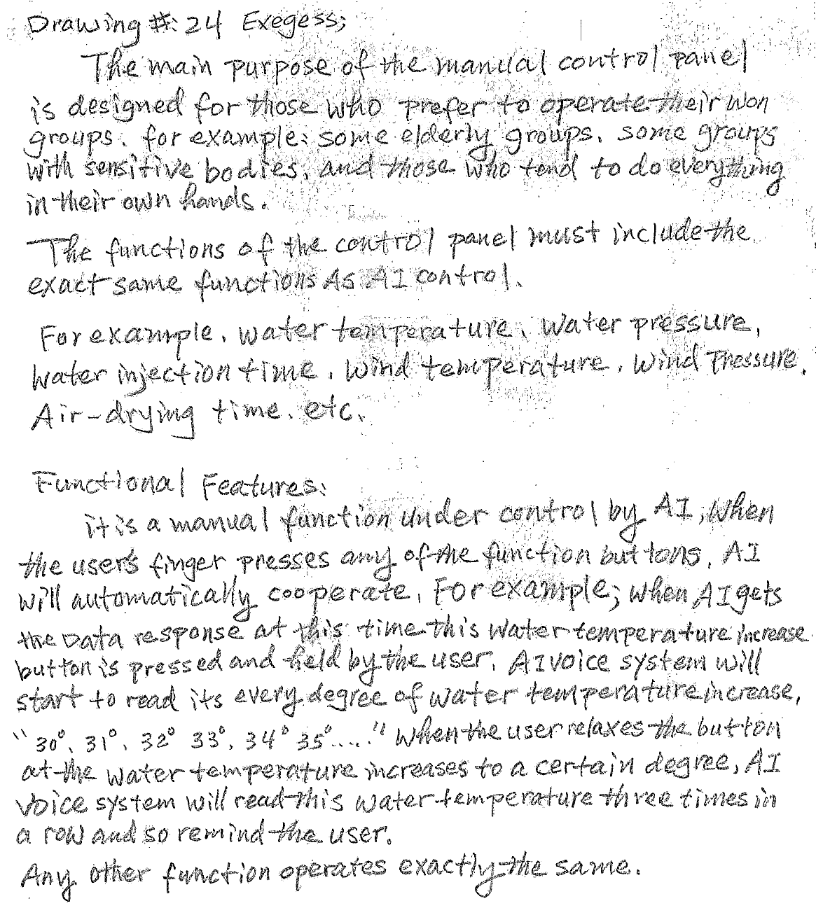

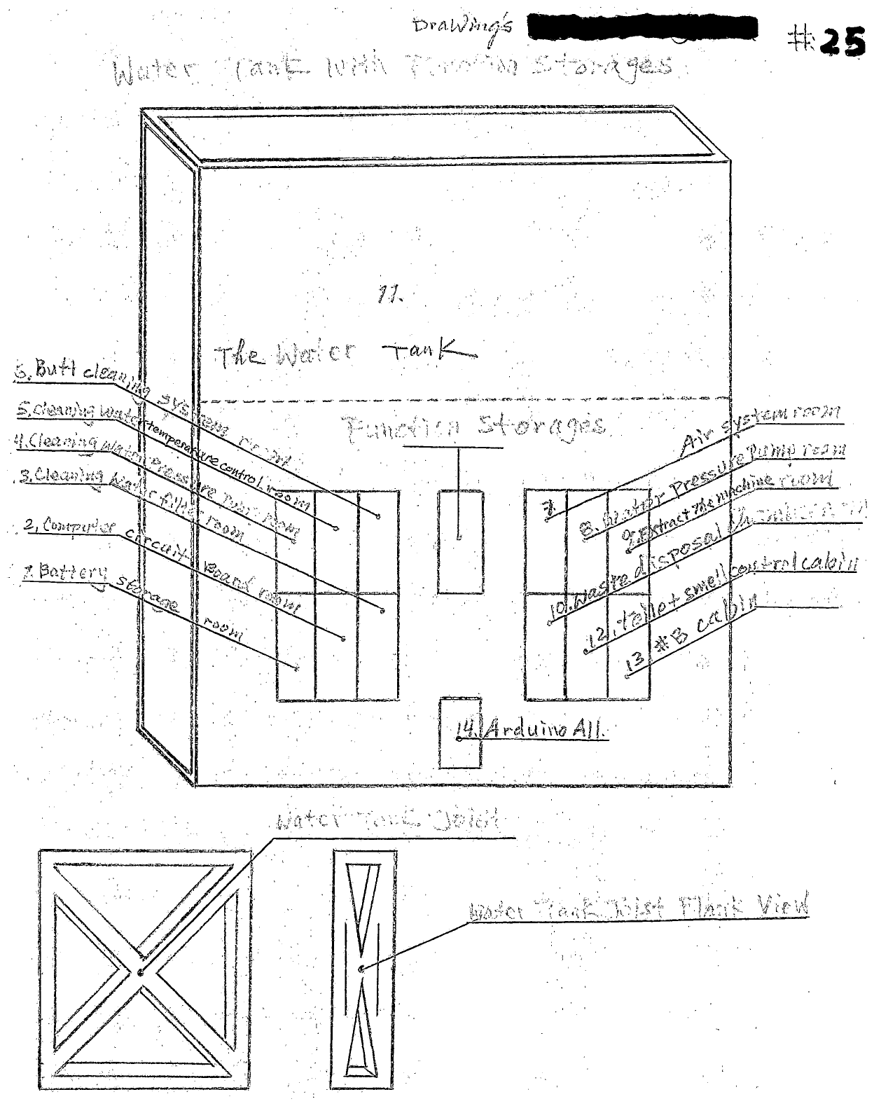

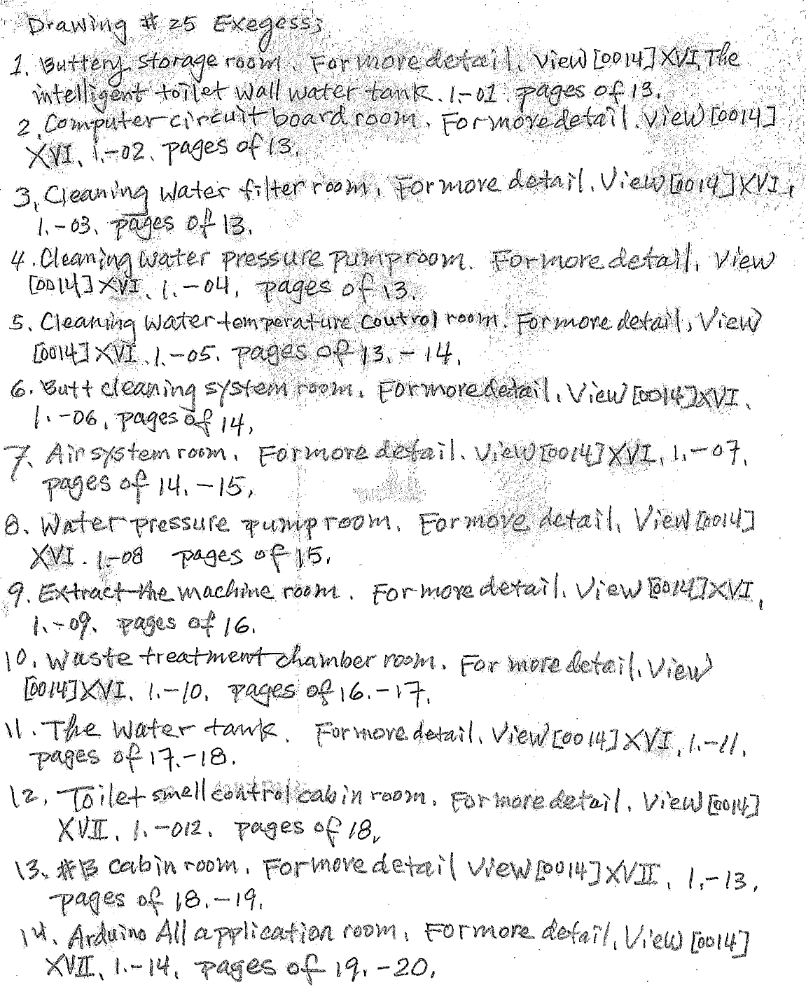

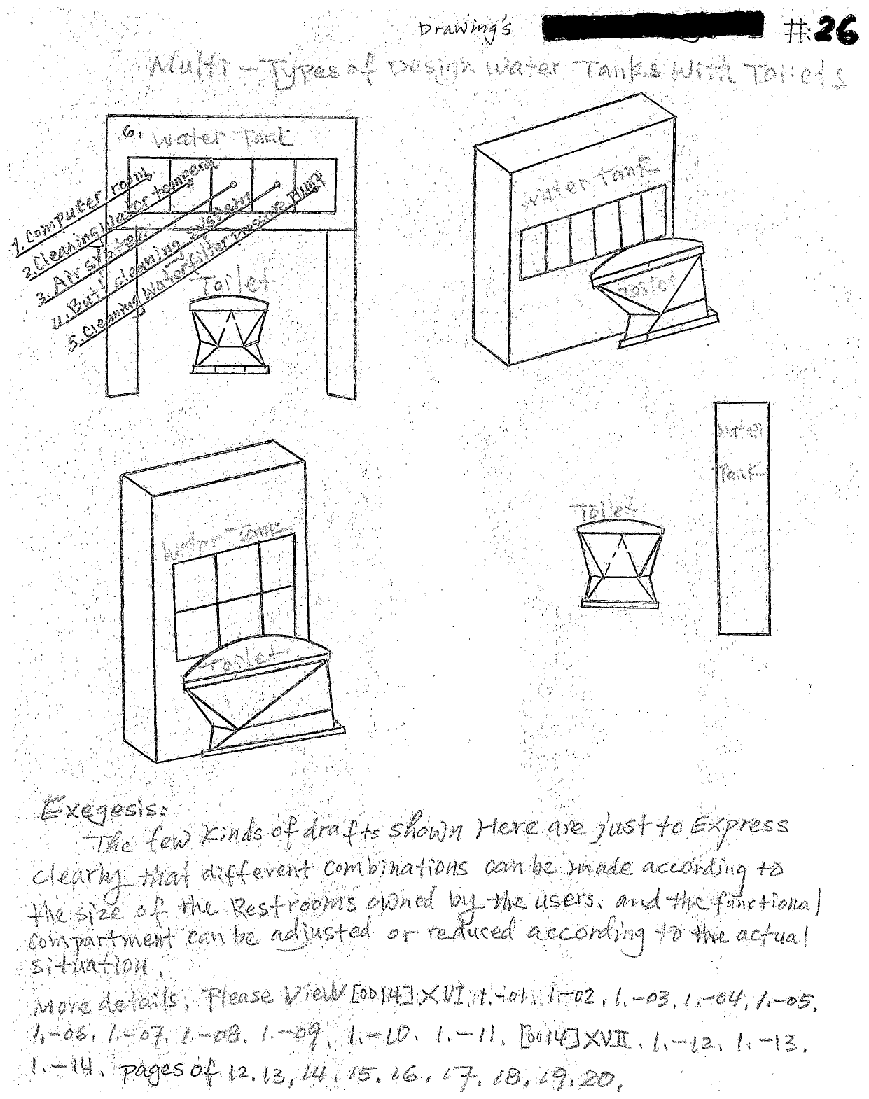

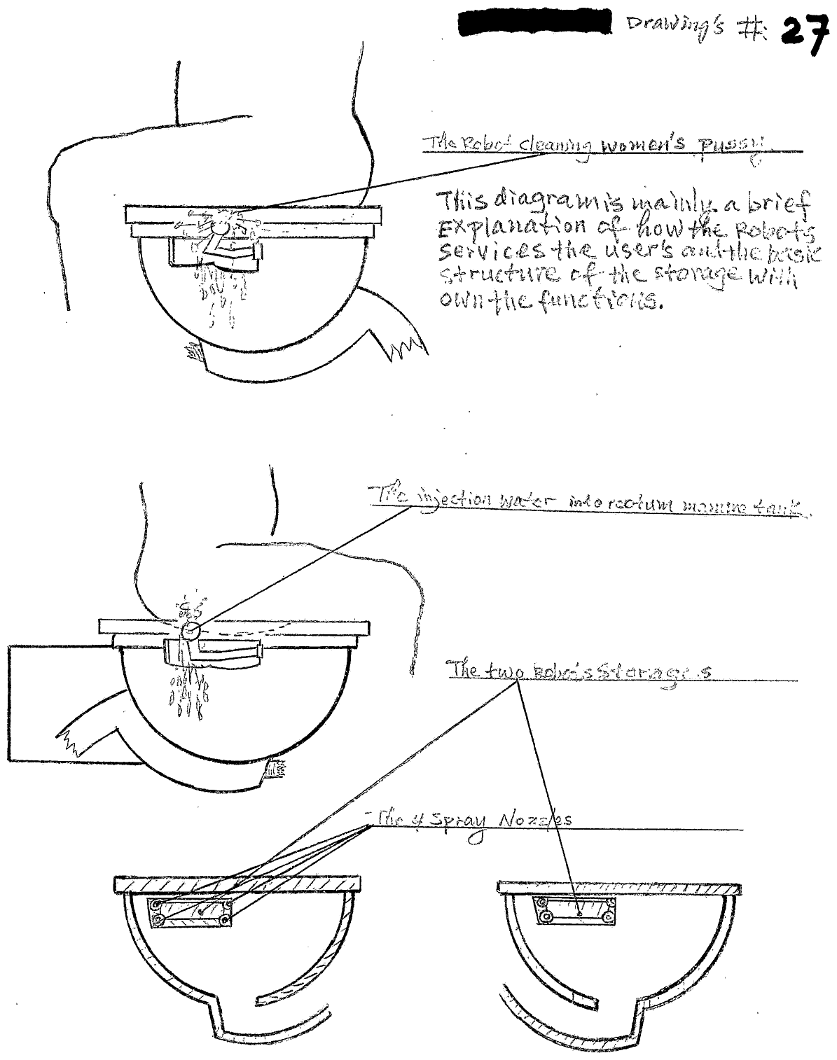

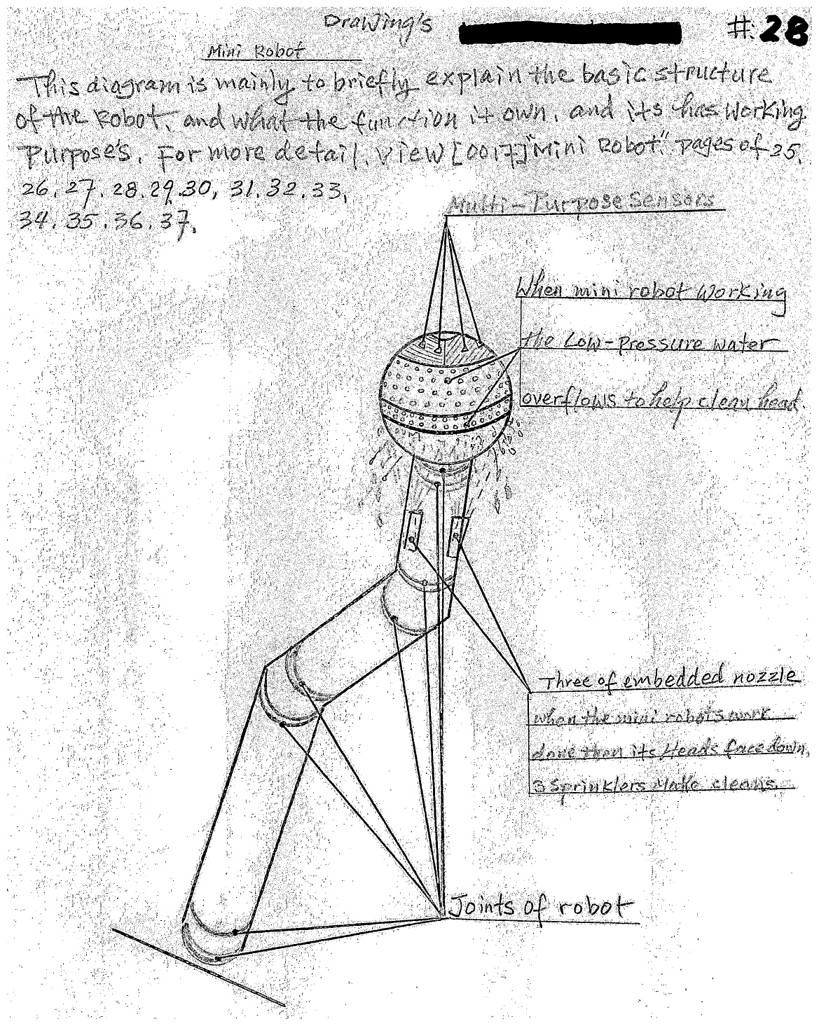

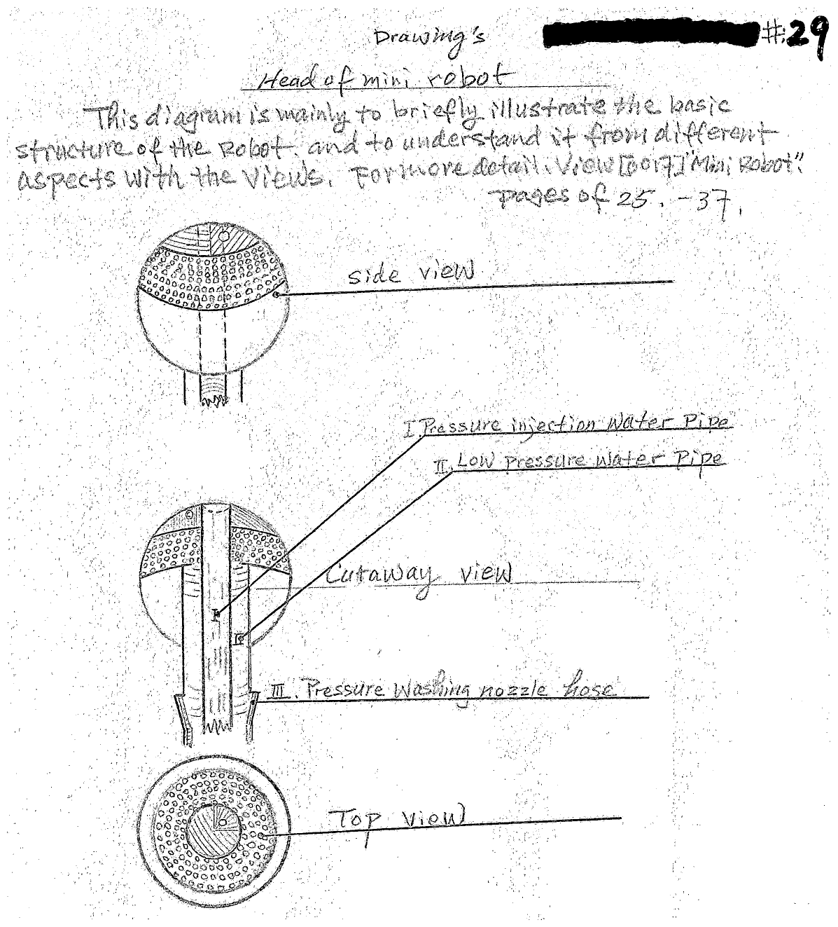

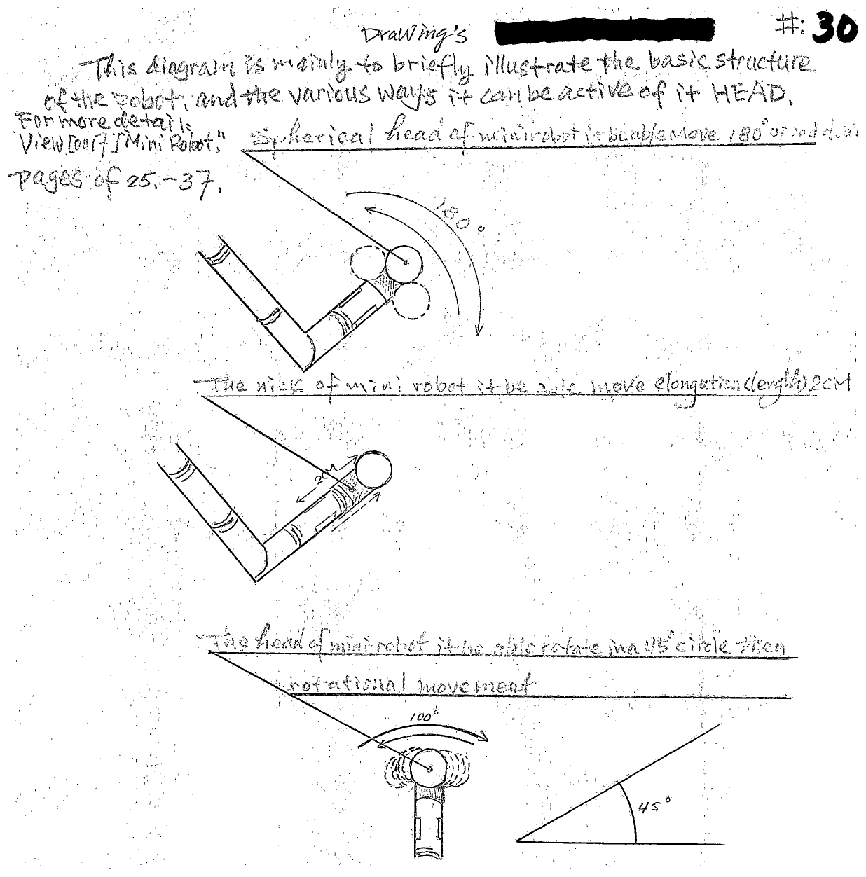

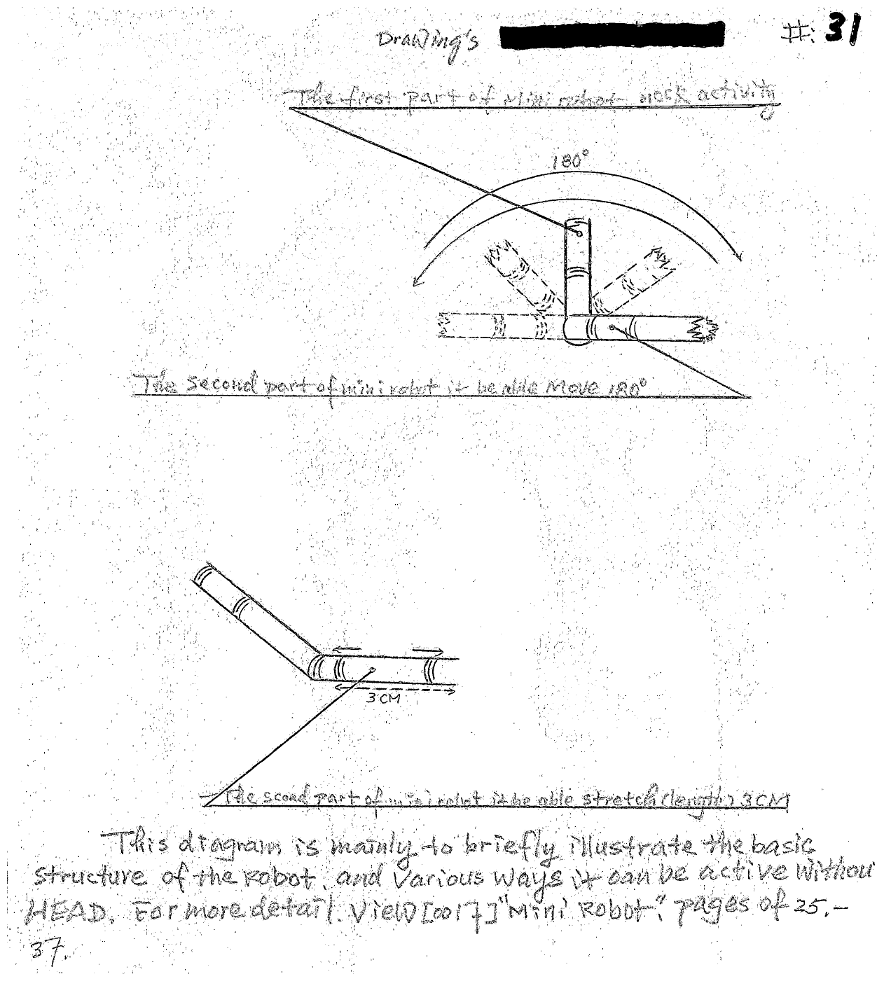

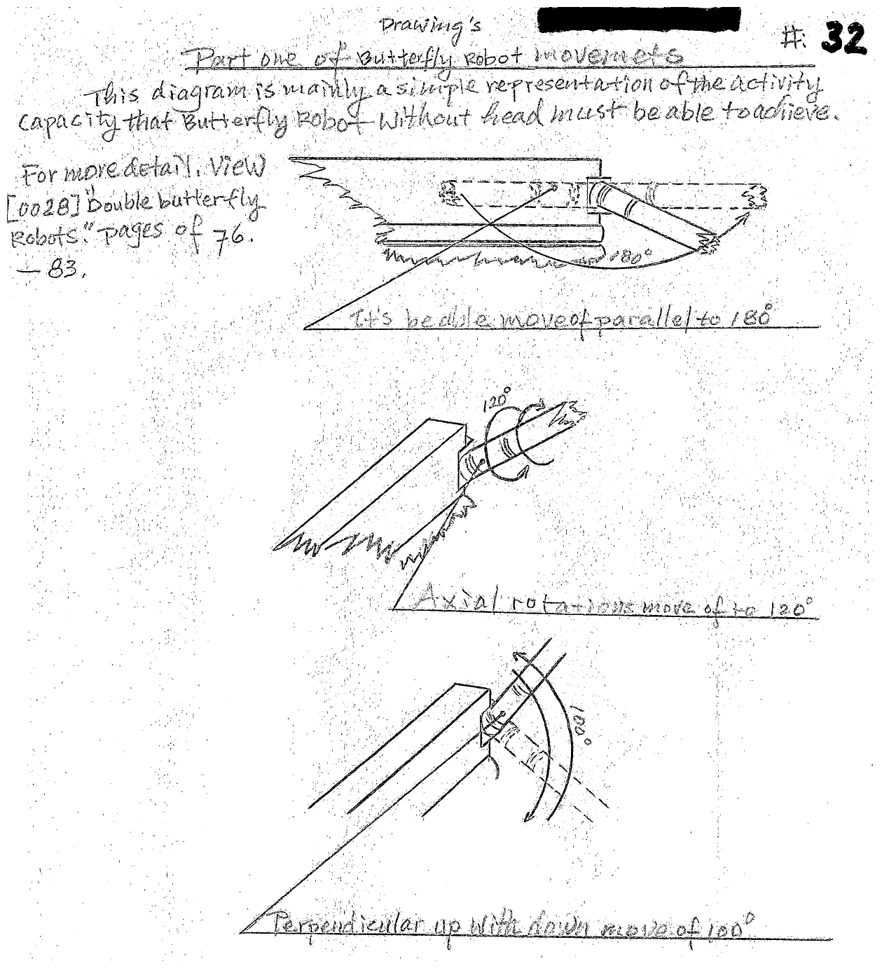

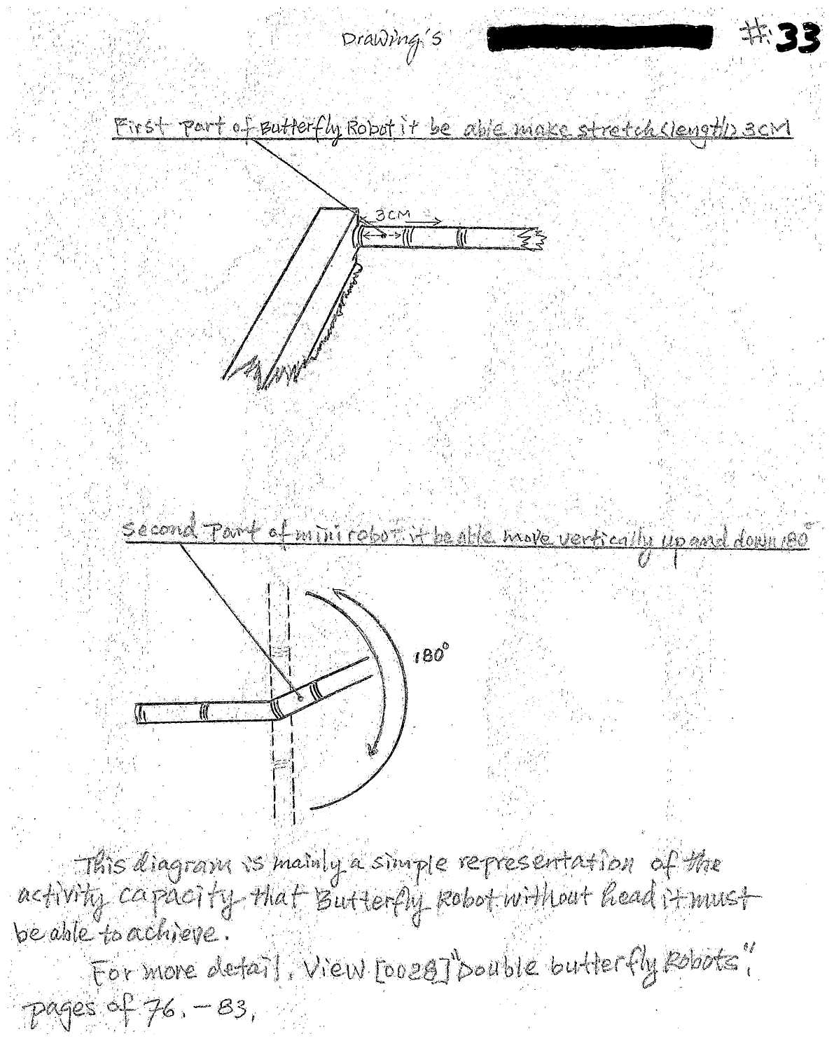

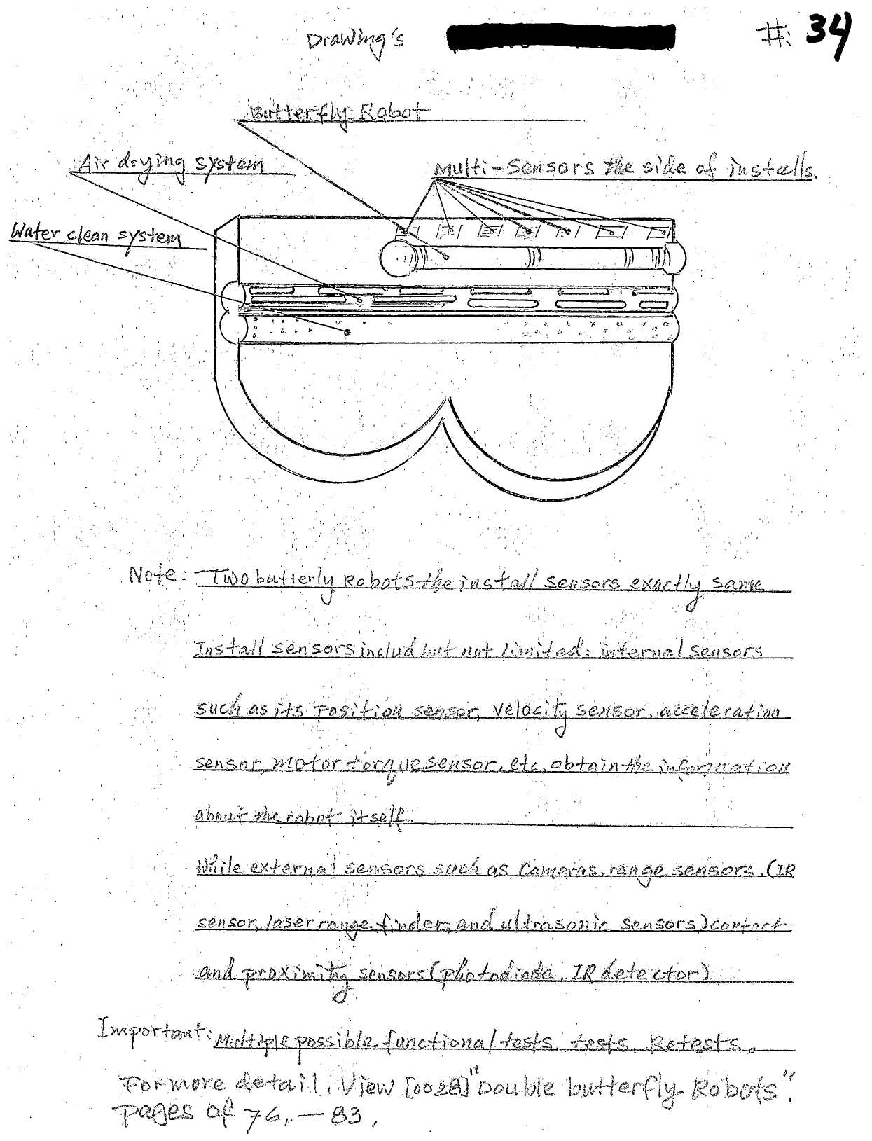

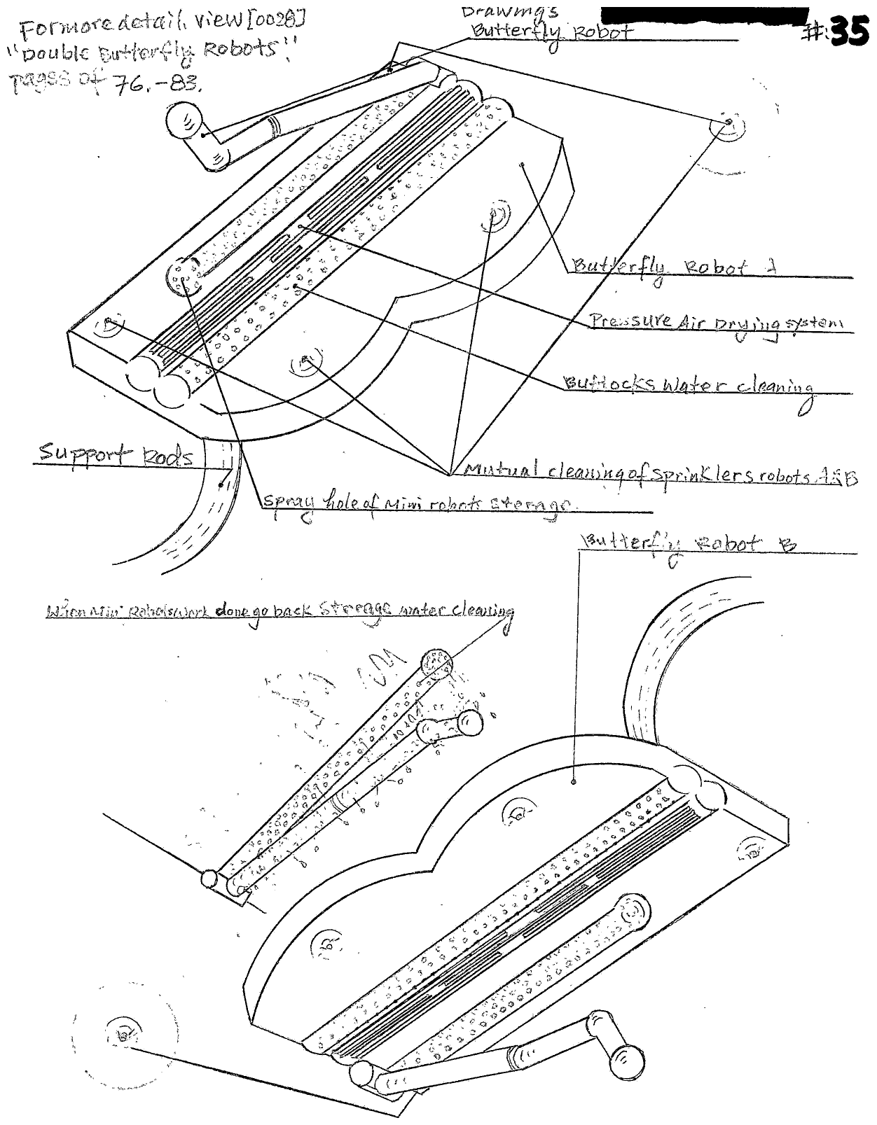

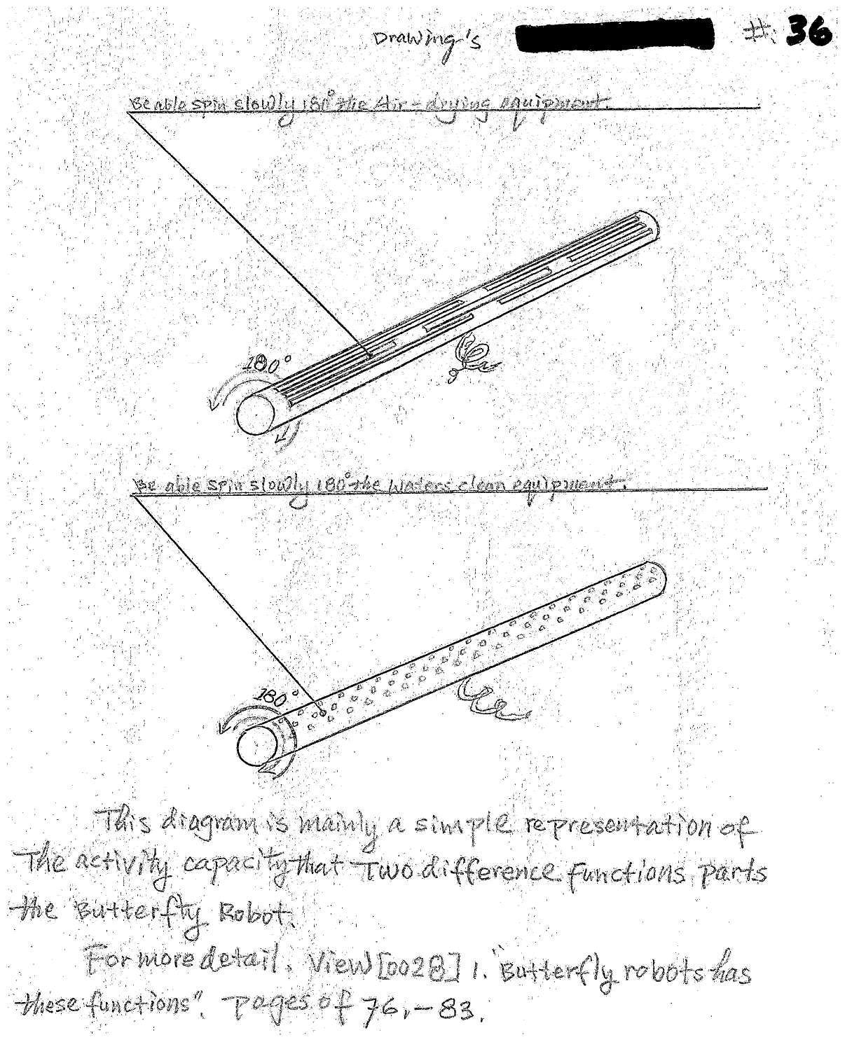

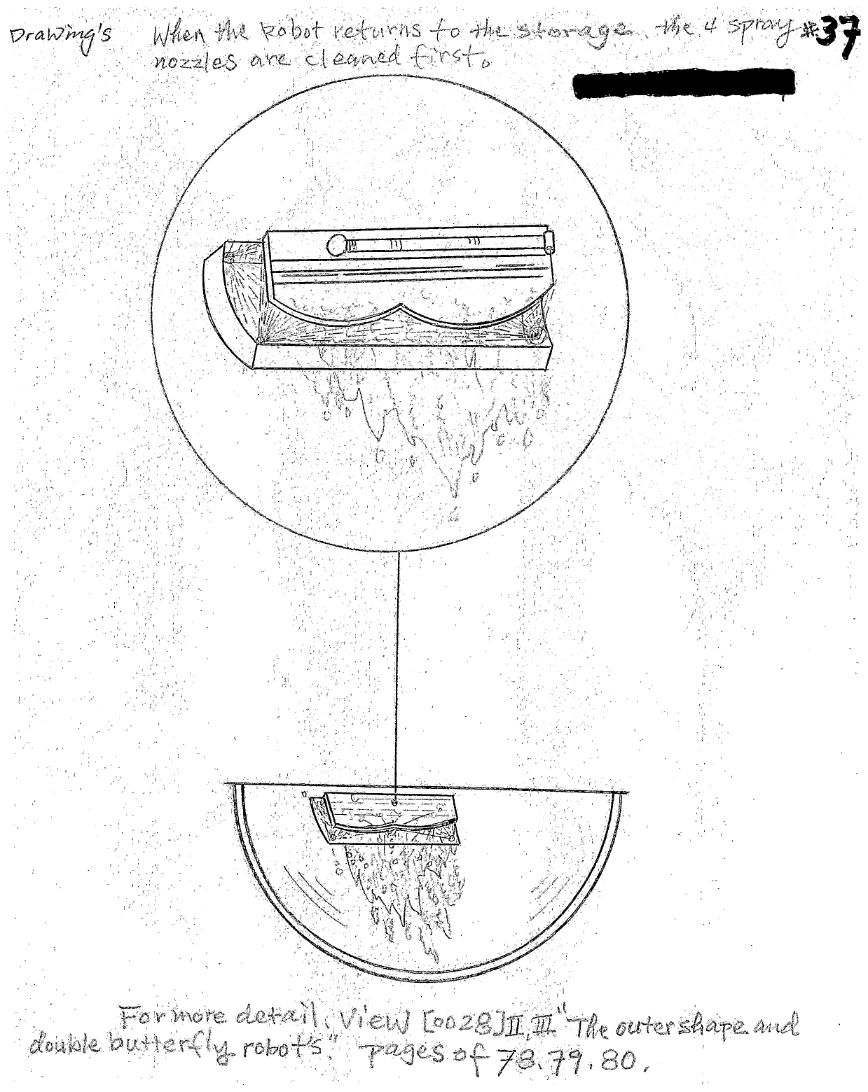

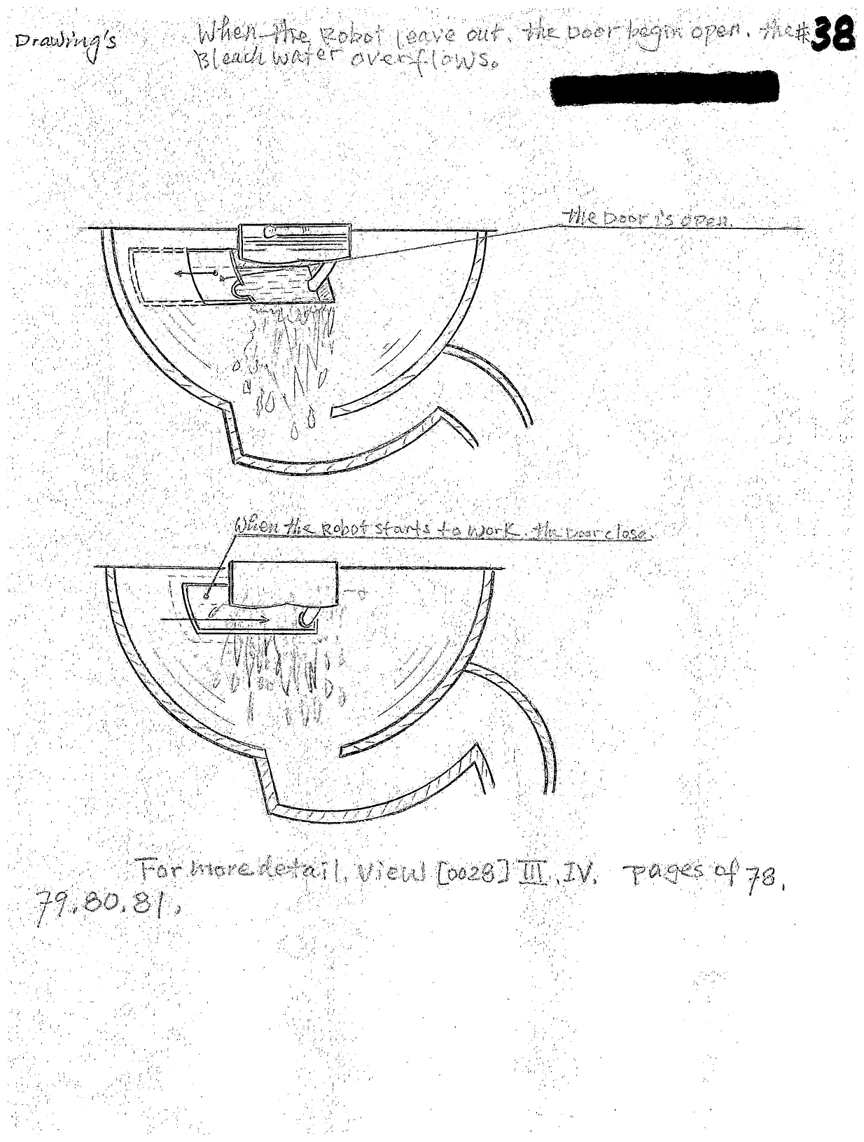

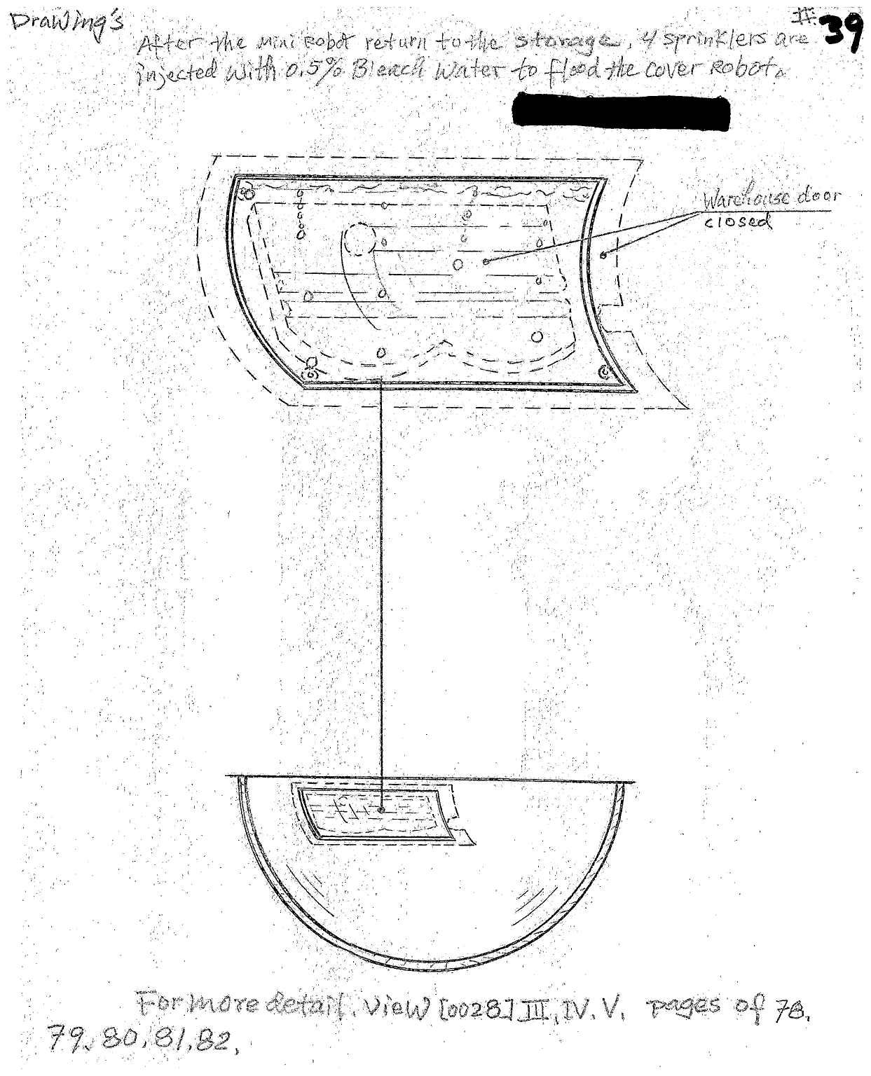

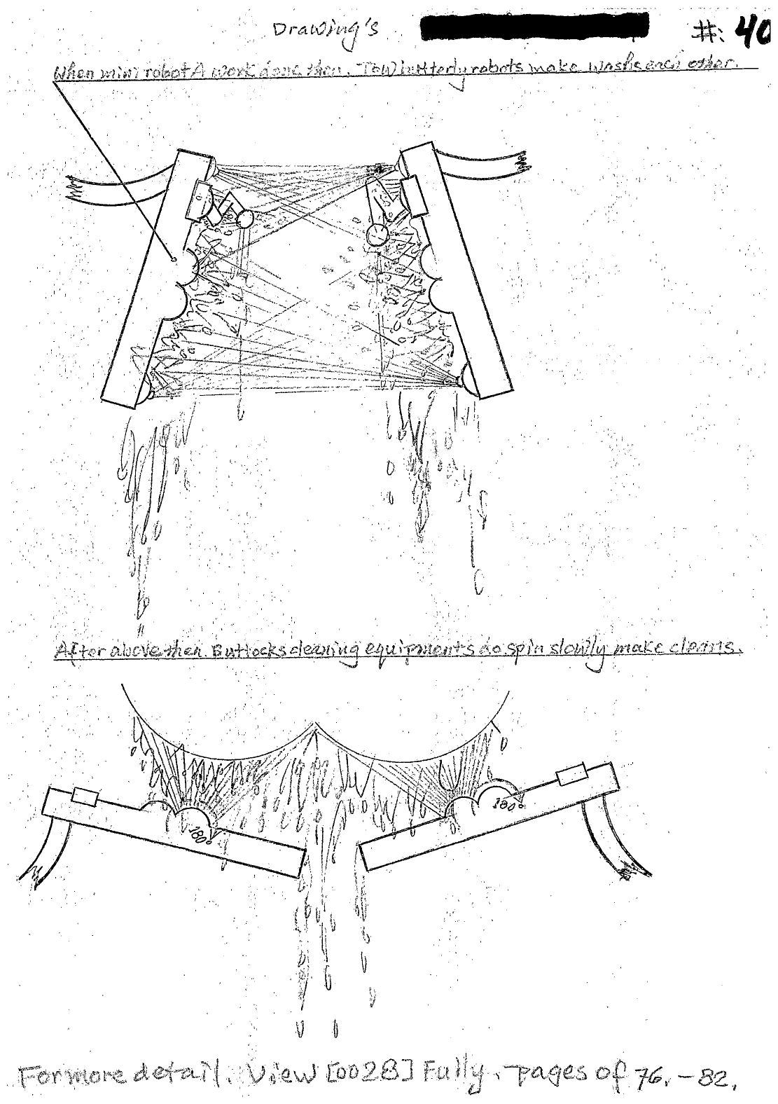

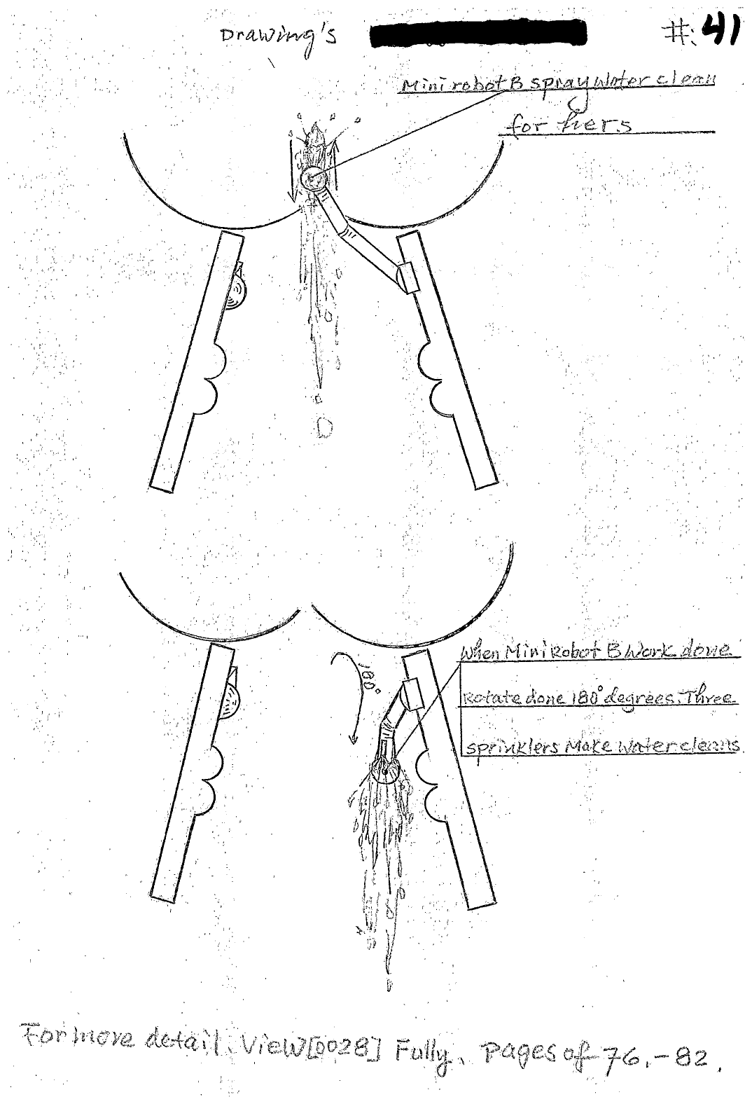

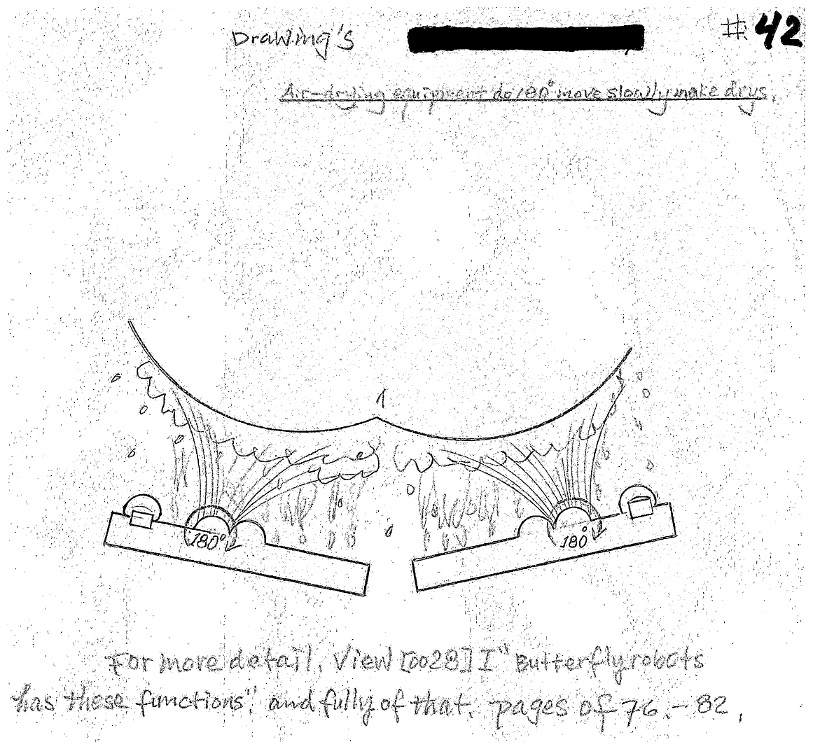

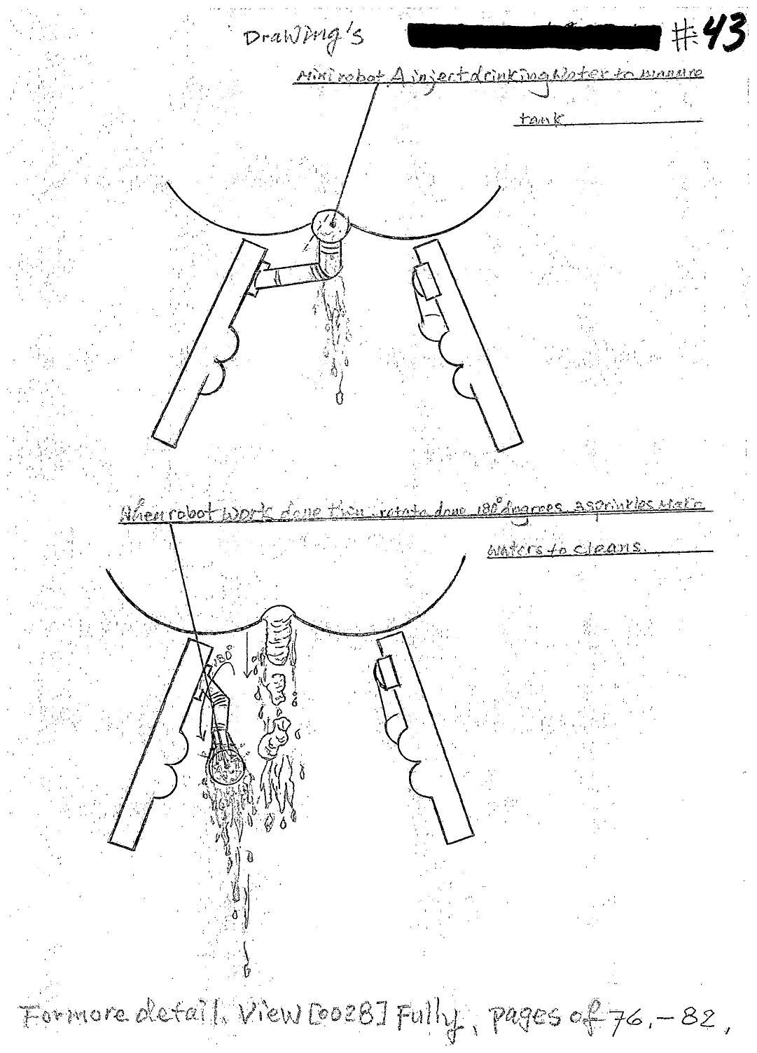

Above nutual most advanced AI GPU, AI CPU, FPGA AI edgd computing, AI local database, AI remotely database, big data analytics, AI algorithms, Customized AI-IC designs.

### SUMMARY

This is a turn Humanity from animal style stool excretion then fundamental change to technology application, do by the invention. Gain human intestinal probiotic multiplication.

### Classification;

### BACKGROUND

The internal tract is the second brain of the human body and the largest immune organ in the body. Human mood, taste, skin, and even the length of life is closely related to the internes. Currently, the global incidence of internal cancer is increasing at an average annual rate of 2%, Moreover, the paint populator is younger and most internal cancers are found at mid-to-late stages. Among them, the high-risk group was those who seeded, had a high proper on of meat in food, and had a history of internal polyps and internal cancers.

Please Note. The invention made by Jesse O Sung & Bright R Sung, everyone creates detail parts listing on the end side up.

Although the following detailed description contains many details for the purpose of explanans, it is intended to enable those of ordinary skill in the art to accurately understand, produce, or so make several changes or changes to the details of the present Invention, all such changes regardless of their scale, Specificness, their All should be included in this disclosure.

Therefore, the following examples are elaborated without losing their generality and without imposing rest icons on any rights or claims raised. It should also be 2 understood that the terminology used herein is intended only to describe the purpose of a piacular implement on, not to be restrike. Unless otherwise defined, all technical and science terms used herein have the same meaning as commonly understood by those of ordinary skill in the art to which this Invention belongs.

In this disclosure, “containing”, “including” and “containing” and “having” should have meaning under U.S. patent law and may indicate “contain”, “include” and “have”, etc., which are generally interpreted as open terms. The terms “consigns of”, “or . . . consigns of” are closed terms, and include components, structures, steps, etc. that are specifically arranged in conjunction with these terms, as well as those in accordance with US patent laws. “Basically by . . . compassion” or basically by . . . Compassion “has the meaning that U.S. patent laws usually give them. In piacular, these terms are usually closed terms but are allowed to contain other. 1 items, materials, components, steps or elements, but do not have a substernal impact on the basic and novel features or fun cons of the items used in the connexon. For example, if “basically by . . . Compassion “Exists under the language, and trace elements present in the compassion that do not affect the compassion substance or feature are allowed, even if the list of items is these terms are not clearly documented.” When using open-ended terms in the specific on, such as “contains” or “includes”, direct support should also be “consigns Essen ally of . . . language” and “consigns of . . . ” Language, as clearly stated and adverbs, and vice versa.

“The terms “first”, “second”, “third”, “fourth” and I, II, III, IV, V, VI, VII, VIII, IX, X . . . , so on (if any) in the specific on and claim form are used to disguise seminaries components that are not necessarily used to describe a specific order or chronological order. It should be understood that the terms thus used in the appropriate is interchangeable, allowing the embodiments described in this Aircel, for example, to be able to operate in a different order than shown in this Aircel or otherwise described made. Similarly, if the method is described here as including a series of steps, the order of these steps presented here is not necessarily in a unique order to perform these steps, and some of the steps described and/or some other steps not described in this Aircel may be aimed to add to the method.

The terms “le”, “right”, “front”, “back”, “top”, “boom”, “top”, “below” etc., etc. (if any) in the instructor manual and claim, etc. Used to describe purposes and not necessarily to describe permanent relate poisons. The terminology so used in appropriate cases the following is interchangeable, making the embodiments described in this Aircel, for example, capable of It operates in the director.

As used in this Aircel, when used in conjunction with the description of the device or process, “enhanced,” “improved,” “enhanced,” “upgrade refers to the characterizes of the device or process provided. Beer form or work that can be measured than previously known devices or processes Yes. This applies to both the form and facility of the device or the individual components in the process, as well as to the erne such device or process.

As used herein, the term “basically” refers to acorns, characterizes, natures, states, structures, projects or results that are completely or close to full the degree or degree. For example, a “basically” closed object means that the object is completely or almost completely closed. In some feelings the exact degree of permissibility deviant from absolute integrity may depend on the circumstances. In general, however, the close-up to complain degrees will have the same overall result, as if gong absolute and complete. When used in negate meaning, 2 “basically” The same applies to the complete or almost complete lack of acorn, characterizes, airbuses, states, structures, items, or results. For example, “basically free” parcel compassions are either completely free of parcels or almost completely parcel-free, with the effect of having not the effect of the parcels is the same. In other words, if there is no measurable effect, the compassion of the “basically non-contained” ingredient or element is sell May contain the substance.

As used in this Aircel, the term “approximate” is used to provide a given value that can be used at the endpoint “slightly above” or “slightly below” to the end point for the numeric range Provides flexibility. However, even when the term “about” is used in conjunto with specific values in this specific on, the Support for precise values with different terms of “about”.

As used in this Aircel, for convenience, mulled items, structural elements, constant elements, and/or materials can be presented in a common list Material. However, these lists should be interpreted as if each member of the list is individually defied as a separate and unique staff. Therefore, no individual member of such list should be understood as being in fact equivalent to any other member of the same list, only based on their rendering in a common group and no indicant to the contrary.

Concentrators, quants, and other numeric data can be expressed or presented in a range format in this Aircel. Such a range format merely Used for convenience and simplicity, it should be interpreted flexibly to include not only explicitly enumerated values as scope limits, but also It also includes all individual numeric or sub-data.—The range contained in this range, as if each value and sub-range were clearly stated described. As an explanans, the numerical range of “about 1 to about 5” should be interpreted to include not only the values of approximately 1 to about 5 that are explicitly listed, but also Includes a single value and subrange within the specified range. Therefore, including a single value in the range of these values, such as 2, 3 and 4, and Sub-ranges, such as 1-3, 2-4 and 3-5, and 1,1.5, are 2, 2.3, 3, 3.8, 4, 4.6, 5 and 5.1, reservedly. (If any)

The same principle applies to the range where only one value is recorded as a minimum or maximum value. In add-on, regardless of the breadth of the range or this interpretant should be applied to the characterizes described.

A reference to the “example” throughout this specific on means that, in conjunction with the specific characterizes described in the sample, the structure or characters sin is included in at least one real example. Therefore, the phrase “in one example” that appears in various places throughout this specific on does not necessarily refer to the same implement on Cases.

A initial overview of the technical embodiments is provided below, followed by a further description of the specific technical embodiments. This preliminary overview is intended to help read to understand the technology more quickly, but not to Identify key or basic technical characterizes, nor to limit the model of the subject required for proteron Surrounding.

The main structure of the toilet the machine is mainly composed of three large parts. (Please view FIGURES: 2, 3, 4, 5, 6, 7, 8, 9, 10, 11.)
[1], Toilet Lid
[2], Toilet Seat Board
[3], Circular Flushes
[4], Built-in Barrel Body
[5], Non-Stick Coating
[6], Sexual Organ Cleaners
[7], Anus Automatic Water Injectors
[8], Three Cabins of The Toilet
[9], Butt Cleaning System
[10], Air-Drying System
[11], The Built-In Keel
[12], The Shell

I, Toilet Lid (Each component requires a 2 mm thickness ceramic non-stick coating), It is made of 316 food grade stainless steel sheets with a thickness of 3 mm. The appearance is rough-pulled, an 8-inch display is installed (linked computer circuit boards show the amount of bacteria on the toilet seat plate) and the bacteria index of the toilet seat board is reported to the user at any time. Toilet cover designed as a dual-channel, 1, cleaning water system.

II, air-drying system. It is also designed with two arc-type UV sterilization lamps, (It fits perfectly with the toilet design arc of the seat.) In addition, (the PIR and the ultrasonic sensors) and the ultrasonic sensors installed on the toilet cover left and right sides will be able to detect the arrival and departure of the user. They are automatically opened and closed by computer linked cloud computing software and artificial intelligence operating toilet lid. (The PIR and the ultrasonic sensors) cleaning system; At the Toilet Cover edge position below one (Towards the side of the seat and the bucket), there are three cleaning heads (a small pressure water particles spouting out at work), toilet cover design that has three nozzles working at work Moving tracks. The cleaning range of the cleaning area is completely matched with the Toilet seat design arc of. during their work they will repeatedly move and target the pressure water of 40 psi out of toilet cover. The toilet seat they are working responsible for is directly for each of their three distinct areas, each of which has a 1 inch overlapping area of work. the three nozzles relate to the water outlet pipe of the pressure pump by the pipeline, the software installed in the computer cloud computing and the artificial intelligence can monitor the user to leave, the toilet cover is automatically closed, and the water spraying head starts to work. The toilet seat air-drying system the air-drying system is composed of two air outlets nozzles installed under toilet cover Each air outlet nozzle is responsible for the air-drying work of half area toilet seat When the water outlet nozzle is cleaned, the software in the cloud computing and artificial intelligence will give instructions, then the two air outlet nozzles work, the two air outlet nozzles (each responsible for 50% of the area) move along their own arc orbit when working, and the toilet cover and toilet seat design arc type completely match. After two repeated air-drying work, the work was completed. Ultraviolet sterilizing lamp; Two sterilizing lamps with the same arc with toilet seat arc are completely covered with the seat from the left and right sides, the digital working 8 switch relates to the cloud computing and artificial intelligence through the computer Arduino, according to the instruction, the operation of the air-conditioning system is started after the operation is completed, and the operation is stopped until the toilet cover is automatically opened, thereby ensuring (M) standard aseptic.

III, Toilet Seat; (Each Part Requires a Ceramic (Ceramic) Non-Stick Coating of 2 mm Thickness)
[A], Made of 316 food grade stainless steel casting, its structure is hollow design, seat wall thickness, the upper and lower sides are 7 mm, two vertical side support weight position its wall thickness is 1 cm.
[B], the appearance is rough drawing, and the high-quality feeling is displayed. The arc design of the toilet seat plate is completely matched with the barrel body.
[C], A low-pressure heating system can be built in to provide a comfortable environment for users in winter, and toilet seat the heating device is linked to the heating system of the water tank. The quality requirements of the material can be up to 350 kg, and will not be deformed during long-term use.

IV, Biosensors Around the surface of the toilet seat (the part that touches the user's skin) is mounted with four bacterial sensors (the products on the market are currently larger, so custom micro-biosensors are required), and linked Arduino transmits data to cloud computing and artificial intelligence via 5G. After big data analysis under the control of the software, the seat plate bacteria index is displayed on the display above the toilet lid. Bio-impedance sensor Around the surface of the toilet seat (the part that touches the user's skin) is mounted with four bio-impedance sensors and optical sensors, which collect the user's heart rate data and blood pressure through the user's skin contact. Sensors monitor all data generated by subtle changes in the body's critical organs during excretion, 9 transmitted to cloud computing and artificial intelligence at high speed through arduino-5G, while the center computes and analyzes the user's physical condition at high speed.

The aim is to monitor changes in the user's heart rate and blood pressure when feces is excreted, and when any of these shows elevated changes, the software-controlled Artificial Intelligence voice alerts the user to relax, and the AI voice can also ask the user if they need easy music to help them relax, if the user gets a positive response. The Cloud Computing and Artificial Intelligence Center immediately releases light music with four speakers (two trebles, two basses) mounted on a wall-mounted water tank. This feature can especially help those patients and the elderly, when it is excreted, it is difficult to avoid increasing heart rate and blood pressure by naturally increasing the pressure of the abdominal cavity. The data changes will be immediately obtained by cloud computing and artificial intelligence. Users will be prompted, the physical method of the smart toilet can provide perfect help, the user just needs to relax, the intelligent system will help him to be very comfortable, help him to complete everything, please relax and enjoy.

V, NOTE; The bio-impedance sensor is mainly a monitoring user when excreting the blood pressure. Optimal sensor monitors heart rate changes. The toilet seat was designed to have three different functions and working channels.

[a], Built-in low-pressure heating system.

[b], Convulsion channel.

[c], Pressure air seasoning channel. Built-in low-pressure heating system: in winter can maintain the surface of the seat plate at a temperature of about 40 degrees Celsius, it is controlled by temperature control sensors and electronic heating system through the Arduino and 5G, linked cloud computing operation software and artificial intelligence system, according to the temperature control instructions. Ventilation passage: It is designed on the front, rear, left and right sides of the seat plate. The equidistant position consists of 6 wide and 3″ high 0.20″ exhaust vents. When the user drains, the odor is removed. The exhaust pipe connects the odor in the wall tank. Road processing system. Its working procedure, when the user sits on the toilet and ends when the user leaves the toilet, the period is always working. The Exhaust Channel is equipped with two Proximity sensors, it's thought arduino&5G to the cloud computing center and artificial intelligence. The center calculates, analyzes, and then issues work orders based on the acquired data.

Pressure air-drying channel: designed on the inside edge of the seating plate, consisting of 6 4 mm×1 mm air outlets, when working in the air-drying system this air outlet will spray the same pressure as the air-drying system warm air, the purpose is to assist the air-drying user ass. The annular flushing ring is made of 316 food-grade stainless steel. The thickness of the annular water ring wall is 6 mm, the outer surface is square, and the inner diameter is circular. The arc design is completely matched with the barrel body and the seat plate, leaving a gap (Between the upper and lower parts and the front and the back) with a length of 10 mm*mm when the water injection device is working, and the gap is opened when the water injector is working. It turns on and off software controls installed in computer cloud computing and artificial intelligence. The ring-ring is designed with four sloping outlets, connected by pipes to the reservoir, working under the control of cloud computing and artificial intelligence, using the siphon effect of the water level difference generated by the reservoir, causing a strong rotating water flow along the barrel wall and washing away the feces. The ring is designed to be mounted between the bucket and the toilet seat, above the bucket body and below the seat plate.

An infrared camera. is installed at the central position behind the annular flushing ring, and the circuit is linked with the computer. The graphic data it collects is transmitted to the cloud. computing and artificial intelligence center via a computer. The function of the invention is to accurately detect the exact position of the (Ass) groove of the user activity and then transmit it to the cloud computing center by the computer; Two strip-shaped (5 mm*12 mm) embedded LCD lamps are installed on the left and right sides of the circular flushing ring. They will display a soft blue light when working. The switch is controlled by the Proximity sensor, and the Proximity sensor passes the arduino & 5G link cloud computing. And the artificial intelligence system, the software controls its correct work; when the user starts working when approaching the toilet, the departure will stop.

[d], built-in barrel body (each component requires a 2 mm thickness ceramic (ceramic) non-stick coating). Made from 316 food-to-stainless-steel, stainless-steel plate thickness of 3 mm, one stamping molding. There are 10 sensors installed on the edge of the outlet at the bottom of its bucket, which is mounted near the bottom flushing port of the barrel body.

Two groups, respectively;

1). FIT OC—Sensors. The main function is fit detection of invisible blood on feces (custom sensors are required to meet this need).

2). biological sensors. This is a more special sensor it is by detecting the presence of colorectal cancer in the DNA mutation in the feces, and its other use is to judge and separate the functions of different users in the same home, mainly by applying the differences in their DNA (this is a custom sensor).

[e], Non-stick coating. Toilet cover (up and down two sides), toilet seat plate (up and down two sides), ring flusher (whole), inner bucket body (inside and outside), sex organ cleaner (assembly), anal automatic water injector (assembly), butt cleaning system (assembly), air drying system (assembly). All require a 1.5 mm ceramic non-stick coating. Ceramic (ceramic) does not stick the coating the color is many and varied, designs by the enterprise according to the contour, or according to market demand choice.

[f], Sexual organs Washer; (each component is required to be coated with a ceramic non-stick coating of 2 mm thickness). Made of 316 food grade stainless steel, the thickness of the stainless-steel plate is 1 mm, its shape is spherical, its diameter is 3.5 cm, and it is equipped with an MPU-9250 system-in-package (SiP). The following are the basic performance indicators; “The MPU-9250 is a System in Package (SiP) that combines two chips: the MPU-6500, which contains a 3-axis gyroscope, a 3-axis accelerometer, and an onboard Digital Motion Processors™ (DMPTM) capable of Processing complex Motion Fusion algorithms; and the AK8963, the market leading 3-axis digital compass. The MPU-9250 is a system-in-package (SiP) containing two chips: the MPU-6500, which includes a 3-axis gyroscope, a 3-axis accelerometer, and an on-board Digital Motion Processors™ (DMP™) complex that can handle Motion Fusion algorithm, and the market leading 3-axis digital compass AK8963.

VI, “The MPU-9250 is a System in Package (SiP) that combines two chips: the MPU-6500, which contains a 3-axis gyroscope, a 3-axis accelerometer, and an onboard Digital Motion Processor™ (DM P™) capable of processing complex Motion Fusion algorithms; and the AK8963, the market leading 3-axis digital compass.” In the reproductive organ purifier crown nearby two, the installment has two infrared miniature cameras, their function is accurate found user's organ mouth for the purifier, the camera holds by inside the cloud computation and the artificial intelligence 3D image software controls, the infrared camera obtains the complete graph data after the arduino&5G transmission for the cloud computation and the artificial intelligence, passes through the high-speed operation and the analysis software unceasing carries on the adjustment to the 3D graph, helps the purifier to tally accurately the user organ mouth, under the MPU-9250 coordination, 3 axis localization establishment can enhance the work largely the accuracy.

The position design has one in center the reproductive organ purifier crown to be able to expand and contract, the diameter is the 1 cm head, inside is the hollow tube shape sponge, the outside is similar in manufactures the baby nipple the emulsion material, its main function makes the reproductive organ internal clean, the purifier and the organ mouth tally completely after the sensor accurate localization, it starts to stretch out slowly, highest may stretch out the ball to go against 2 cm, in will enter the user organ mouth later it to be able to spout has the low pressure water drop tiny, will not stop in clean organ. The reproductive organ purifier is a spherical design, is links by root diameter 1 cm 316 stainless steel pipes, inside the pipeline is the sensor line and a 0.5 cm emulsion hose, the sensor through the arduino&5G link cloud computation and the artificial intelligence center. The soft water pipe coupling passes through from the wall type water tank above tap water filter “the forcing pump” the temperature controller exportation. The sex organ cleaner is driven by a set of gears and a miniature motor that can be transferred up and down at will, and the digital control valve of the micro motor is connected by the arduino-5G link to cloud computing and artificial intelligence centers, which control its work to operate accurately.

VII, Anus automatic water injector; (each component is required to be coated with a ceramic non-stick coating of 2 mm thickness) It is a spherical body designed to pass through 5 cm straight and has an MPU-9250 system-in-package (SiP) installed inside. The following are the basic performance indicators: “The MPU-9250 is a System in Package (SiP) that combines two chips: the MPU-6500, which contains a 3-axis gyroscope, a 3-axis accelerometer, and an onboard Digital Motion Processors™ (DMP™) capable of Processing complex Motion Fusion algorithms; and the AK8963, the market leading 3-axis digital compass. The MPU-9250 is a system-in-package (SiP) containing two chips: the MPU-6500, which includes a 3-axis gyroscope, a 3-axis accelerometer, and an on-board Digital Motion Processors™ (DMP™) complex that can handle Motion Fusion algorithm; and the market leading 3-axis digital compass AK8963.” It is a design for straight after the 14 5 cm sphere body, has an MPU-9250 system-level in the among them in installment to seal (SiP), below is its basic performance index: The sphere is 5 cm in diameter and is made of 316 food grade stainless steel, as follows:

[A], the surface of the sphere is designed with 90 small holes with a diameter of 0.5 mm, which are evenly distributed across all parts of the sphere's departee key or basic technical characterizes, nor to limit the model of the subject required for proteron Surrounding.

[B], the sphere is designed to be double layer, which is designed with an inner sphere of 4.5 cm, which is made of the same material, the two spheres are linked on the bottom of the sphere and link with a 1.5 cm straight 316 stainless steel pipe.

[C], two spheroids separately have two same caliber 0.8 mm hoses to connect the wall type water tank above tap water filter>>forcing pump>>temperature controller exportation. After the automatic syringe outward moves from cabin door opening from inside, starts to supply water, this time entire spheroid surfaces these eyelets start to work, syringe also starts to work, they all do not stop outward overflow clean tap water.

[D], another soft water pipe in the sphere is linked to the drinking water filter above the wall-type water tank>>pressure pump>>the outlet of the temperature controller is installed with aCMOSens®Liquid flow sensor, Sensation's liquid flow meters establish new standards wherever monitoring of low liquid flow rates, liquid handling, and liquid dispensing are important. Our unique CMOSens® Technology allows bidirectional measurement of the liquid flow through the wall of the sensor's flow channel in milliliters, microliters, and down to single digit nanoliters per minute. Applications in fields such as medical devices, diagnostics, process control, and automation technology benefit daily from our safe and reliable sensor solutions.

https://www.sensirion.com/en/flow-sensors/liquid-flow-meters/It links the cloud computation after arduino&5G and the artificial intelligence center, designs specially the software holds controls its accurate work.

VIII, [a], the inner layer is directly connected to a 0.8 mm diameter hose, which is connected 15 to the drinking water filter>>pressure pump>>temperature controller outlet A on the wall tank. When the water injection head enters the organ, under the control of the software, it starts to inject the filtered drinking water with pressure. The pressure is controlled by specially designed software. The injection volume and pressure are strictly limited in software design, and the software writes. A powerful data error correction code is entered, and its working process is monitored and controlled by software cloud computing and artificial intelligence to ensure its security and accuracy.

[b], the outer design has a ring-shaped water outlet at the top, which is connected by a 0.8 mm hose to the drinking water filter on the wall tank>>pressure pump>>temperature controller outlet B, which is the sphere shares a water supply pipe and a water outlet B. It works the same way as the ball. It starts working immediately when it comes out of the

[c], hatch. The circular outlet starts to rush out of the low-pressure filtered drinking water. Under the lubrication of the water, the water-filling head can be easily and easily accessed. organ. The top of the sphere is also designed with two infrared miniature 3D cameras distance sensor, a pressure sensor. The bottom of the sphere links a 1.5 cm straight 316 stainless steel tube with a wall thickness of 4 mm, which must be able to support pressures above 50 kg. The wires of all sensors and infrared cameras are linked to the cloud computing and artificial intelligence centers via stainless steel tubes, linked to the cloud computing and artificial intelligence centers, and the software designed for them (patently patented) controls their accurate work. A soft water pipe with a diameter of 0.8 mm is connected to the water injector head at the top of the ball, and the other end relates to a soft water pipe connected through the drinking water filter>>pressure pump>>temperature controller outlet A-B from the wall water tank.

IX, Technical Requirements:

[a], the control rods of the three doors are designed between the annular flushing ring and the barrel body.

[b], the production of the three cabin doors must be 100% Identical to the radian of the inner wall of the barrel body.

[c]. The combination of the three doors and the inner wall of the barrel must be minimal, meaning that the joint parts of the two must reach a high degree of consistency and appear to be just a line.

[d]. There is an absolute high requirement for sealing properties. In any case, the water in the three chambers must be guaranteed to be impermeable to each other when the door is closed, and water is used in the barrel.

[e], all of the enclosed spaces need to require a ceramic (ceramic) non-stick coating with a thickness of 2 mm. In the face of the right side of the toilet (from the back of the toilet is left) the design has a long 5 cm-width 13 cm, high 4 cm of the closed compartment, its main function is to receive the “ass air-drying system stainless steel air rod”, this closed compartment its main function is to collect “the ass air-drying system stainless steel air rod”, On the top of this closed compartment is designed with two nozzles that can be extended outward (from the barrel wall to the center of the barrel), the length of the outstretched 1 cm, in the ass air-drying system of stainless steel out of theory to complete its work will automatically retract the closed compartment, the two nozzles are to clean the ass air-drying system of stainless steel aired for one minute, When the closed door is closed, the two nozzles begin to fill the closed compartment with water until the washer is 18 completely flooded. The two nozzles are controlled by sensors, the sensor through the arduino-5G link cloud computing and artificial intelligence center, the software controls the entire closed compartment every step of the work, after the user completes the large, urinating, toilet design installed application sensors automatically opened through the software-controlled closed door, the stainless-steel air rod of the ass air-drying system is protruding from the inside out and the entire cleaning process is carried out after the exact design of the specified location. The two nozzles are connected by hoses to the outlet of the bleach tank in the wall water tank. Specially designed stainless steel water spray rod: 7.5 inches in length, 0.25 inches straight (diameter) shape and the same shape as the ass air-drying system of stainless steel air-drying rod, the two parallel links (and connections) are fully combined with two functions.

X, Ass Air drying system; (each component is required to be coated with a ceramic non-stick coating of 2 mm thickness). The air-drying system consists of two filters installed on the outside of the outside of the toilet, two air inlets, and an air outlet installed on the inner edge of the toilet seat, and a set of butt air drying system; I, two air filters on both sides of the toilet, HEPA Filters, which capture 99.97% of bacteria, can prevent the spread of bacteria in the home restroom during use.

They are designed to be installed in a confined space, where air enters through an oblique lead cap, leads from a filter to the pressure pump, and then under the influence of the pressure pump through the air outlet on the inside edge of the toilet seat plate, and the stainless steel air-drying rod of the ass air-drying system sprays out, directly to the user's buttocks. The power system of the stainless-steel air-drying rod is designed to be driven by a mute motor and several interacting small gears, its special sensor and digital switch are operated by the software and artificial intelligence center, software and artificial intelligence in the computer link cloud to operate the whole working procedure.

XI, A built-in keel (each of which requires a 2 mm thick ceramic (ceramic) non-stick coating) Is made of aluminum alloy material with a maximum bearing weight of 350 kg (see FIGURE?), which is linked up through 8 stainless SCREWS; rubber waterproof ring B, built-in bucket body, rubber waterproof ring A, annular flush ring. The toilet SCREWS fixed position close to the sewer is linked to the common pedestal pan by two SCREWS.

XII, the shell (each component requires a 2 mm thick ceramic (ceramic) non-stick coating) To be made of 316 food-grade stainless steel sheets with a thickness of 2 mm, which can be designed to be of various popular styles (the designs will be patented separately).

XIII, the Intelligent Toilet Wall Waters Tank: (See FIGURES: 25, 26.)

[Please Note: the words “Water Tank with Water Box” in this description of all means exactly same's.]

The wall-type water tank depends on its market demand: it is designed into a variety of specifications to suit the needs of various houses on the previous market (its standard specifications: 1.5 feet-6 feet wide-7.8 feet high), it is made of Various functional cabins and water boxes are combined, and the following is the specific design:
I.-01, battery storage compartment
I.-02, computer circuit board compartment
I.-03, cleaning water filter compartment
I.-04, cleaning water pressure pump compartment
I.-05, cleaning water temperature controller compartment
I.-06, butt cleaning system
I.-07, air system (butt empty space)
I.-08, water pressure pump room (increase water pressure to flush the toilet)
I.-09, pumping engine room (The peculiar smell generated during extraction and use)
I.-10, waste disposal chamber (the peculiar smell generated by feces is transported through the pipeline and is processed here)
I.-11, water box (toilet flushing should be done by computer software Control.)
I.-12, toilet smell control cabin
I.-13, #B cabin
I.-14, Arduino All applications of the sensors

XIV, The control system of each function of the water tank; With the development of previous technology, the production of pressure and flow control, and timely monitoring according to needs, no longer need to choose between pressure control or flow, for example, Auto Micro Fluid pump: Including pressure pump and pressure controller, no need for compressor/body pipeline.

Use USB Control Option:

Use special software (optional) to control the flow in the microfluidic core through the computer. If you choose a self-designed control application software, you need to complete its design according to the various requirements presented below and be able to operate smoothly in cloud computing, and human intelligence, 5G transmission, including large data calculations at the same time, it is absolutely required to be able to work accurately and achieve good results (because this is a special software, after its design is completed, it will apply for a patent separately from the present invention).

Of course, the design of the control software can also be outsourced to a professional software design company. When developing a new microfluidic analysis card suitable for the present invention, it is necessary to be able to quickly produce a prototype and test its controllable and changeable according to the design requirements. When adjusting and testing the corresponding application program, I hope to be able to easily try different speeds and times when using the pump valve and pump to move. The actuator components can be reliably operated by the microfluidic actuator. control. In addition, it needs to be programmable, for solenoid valves or pumps to pass multiple (designed more than 10 or more) independent inputs. It also needs to be able to provide manual operation switch (or rotary switch) control and program editing through the computer interface.

XV, the mixed use of manual and software control is the technical guarantee required by the present invention. It should also be equipped with, pressure regulator, pressure sensor, internal pressure and vacuum source. Many mature microfluidic motion controllers on the market are modular systems, which can be easily expanded to meet various design requirements of different customers. In addition, the design requires that it must be configured with a network link, and it can be controlled through any web browser, including Safari on the iPad. In addition, it can also use (manually) any combination of physical switches, software control and storage The program on the microSD card can be controlled by clicking a virtual button in the web interface. At the same time, the web interface will also display the current operating status of each valve.

Of course, the user can perform remote monitoring. For safety reasons, this function should be able to be manually turned off at any time. Quality control function test: The valve function can be verified by inserting the manifold manually or program driven. Pressure test: It can be used to measure the pressure decay in the fluid circuit to evaluate its potential functional failure mode. Metrology: The computer interface of the optical comparator camera can be used to create CAD files with dimensional tolerance limits, which can be overlaid on the actual parts. Direct measurement of lines and circles can be used to measure dimensional variability between or within parts. Of course, companies can also choose to customize various other applications that meet their needs, and there are many high-tech companies with mature technologies in the market that can provide support.

The design contractor of the micro-flow control system will build a customized application system that meets the needs of customers, which can fully meet the needs of customers in various applications. Reference design points.

[1], integrated valves and pumps into microfluid design.

[2], the unique & control of 4-15 valves are chosen, so the company's special & needs are met.

[3], a vacuum pump from laboratory empty & source or an integrated & vacuum pump.

[4], empty-pan regulator and pressure, sensors, temperature sensors, etc., and, uh, and . . .

[5], internal and external sensors are integrated to achieve interaction.

[6]. Control software writes error correct code, and luck correct code to help advance fail exclusion. The appearance and function of the water tank; The material of the wall type water box should be 316 grade stainless steel with a thickness of 3 mm. 316 was chosen because it contains metal molybdenum, which can resist salt corrosion. Of course, its price will be higher. However, its service life will be several times longer than that of other stainless steels.

XVI, the appearance of 316 stainless steel should be coarsely brushed to make the appearance look more magnificent. Various functional compartments must be designed as drawer type, that is, a tray is installed on two sliding rods, and they can be gently pulled out when required for maintenance. Every functional cabin should be designed with a micro-extraction duct, and a super-quiet and strong exhaust fan can draw in the heat and lower the temperature in the cabin at any time, to ensure the long-term and accurate operation of each function.

I.-01, Requirements for storage battery; The voltage of the storage battery must be able to support 110V-220V, and its stored energy can support the operation of the entire system by relying on the stored energy when there is no electricity supply 15 Days to 30 days, note-due to limited space, when customizing battery storage, the smaller the requirements, the better, leaving more space to store the water. Write the error correction code in the control software, and run the error correction code to help troubleshoot.

I.-02, computer circuit board compartment; it is supported by a stainless-steel bracket, which supports the computer circuit Arduino circuit board, so the space does not need to be large.

I.-03, Clean the water filter; The three-pack drinking water filter system controlled by the system program can prompt the user when the use is about to expire, so that it can be replaced at any time. The water inlet is connected to the water tank by the stainless-steel pipe of the filter, and its outlet should be connected to the cleaning water pressure pump into the water and other requirements.

I.-04, Cleaning the water pressure pump room; a small water pressure pump controlled by the system program requires its advanced control system to be able to change a variety of different operating speeds according to the instructions of the computer, and can produce 20 psi-40 psi Water pressure. A new cutting-edge pressure sensor is installed on the inner wall of its outlet.

This pressure sensor is connected to Arduino, and the pressure data is transmitted to the cloud computing and human intelligence center at any time through WIFI and fixed 5G, and its accuracy is controlled by software. do. Write the error correction code in the control software. Its static performance requirements are very good. Its inlet pipe is linked to the outlet of the cleaning water filter, and its outlet pipe is linked to the cleaning water temperature control system. Write the error correction code in the control software, and run the error correction code to help troubleshoot.

I.-05, Clean the water temperature controller compartment, The small temperature controller controlled by the system has the following main functions.

[a]. It must be able to raise the water temperature immediately and accurately, and it must be installed on the inner wall of the water temperature controller. A temperature sensor. This sensor uses Arduino and computer circuit board to transmit data to cloud computing in time through WIFI and fixed 5G, and the intelligent data center is used to accurately change the water temperature by software. In addition, it can provide users with high-quality personalized services. Use: Platinum RTDs are also referred to as PRTDs. They are often available with a 100Ω and 1000Ω resistance at 0° C. They are referred to as PT100 and PT1000 respectively. Platinum RTDs are used because they offer a near linear response to temperature changes, they are stable and accurate, they provide repeatable responses, and they have a wide temperature range. RTDs are often used in precision applications because of their accuracy and repeatability. Four-wire is the most accurate, as separate force and sense leads eliminate the effect of wire resistance.

The MAX31865 offers a dedicated RTD signal conditioning circuit for each configuration with 15-bit resolution and offers a solution to accelerate designs for both PT100 and PT1000 RTDs. Local temperature sensors can use either analog or digital outputs. Analog outputs can be either voltage or current while digital outputs can be seen in several formats such as I²C, SM Bus, 1-Wire®, and Serial Peripheral Interface (SPI). Local temperature sensors sense the temperature on printed circuit boards or the ambient air around it. The MAX31875 is an extremely small local temperature sensor and can be used in multiple applications including battery powered applications. Remote digital temperature sensors work like local temperature sensors by using the physical properties of a transistor. The difference is the transistor is located away from the sensor chip. Some microprocessors and FPGAs include a bipolar sensing transistor to measure die temperature of the target IC. White RTD is also called PRTD. They usually have 1000 and 10000 resistance at 0° C. They are called PT100 and PT1000 respectively.

The reason why platinum RTDs are used is that they have a nearly linear response to temperature changes, stable and accurate, repeatable response, and a small temperature range. RTD is often used in precision applications due to its accuracy and repeatability. The four-wire system is the most accurate because the separate wire and sense leads eliminate the influence of wire resistance. MAX31865 provides a dedicated RTD signal conditioning circuit for each configuration with a resolution of 15 bits, and provides solutions to speed up the design of PT100 and PT1000 RTDs. The local temperature sensor can use analog or digital output. The analog output can be voltage or current, while the digital output can be displayed in several formats, such as I²C, SM Bus, 1-Wire® and serial peripheral interface (SPI). The local temperature sensor can sense the temperature on the printed circuit board or the air around it. MAX31875 is a very small local temperature sensor that can be used in a variety of applications, including battery-powered applications. The remote digital temperature sensor works like a local temperature sensor by using the physical characteristics of the transistor. The difference is that the location of the transistor is far away from the sensor core. Some microprocessors and FPGAs include a bipolar sensing transistor that is used to measure the core temperature of the target IC.

[b]. The temperature can be accurately controlled between 65 F degrees and 125 F degrees, and the temperature can be adjusted and changed by the software automatic system operation according to manual or voice control to meet the user's comfort needs.

Its inlet pipe is connected to the outlet of the cleaning water pressure pump, and its outlet is connected to the injector and cleaning system. Write the error correction code in the control software and run the error correction code to help troubleshoot.

I.-06, Butt cleaning system; its inlet pipe is connected to the outlet of the temperature controller, and its outlet is connected to the butt cleaner (for the specific design of the butt cleaner, please refer to and read the chapter about the barrel).

I.-07, Fan System; Performance:

[1]. The system controls its working process with a drying time of 30-45 seconds.

[2]. Adjustable speed and sound control. Adjustable heat control-high, medium, low and off.

[3]. Install a HEPA filter system to ensure that it can remove 99.97% of the 0.3 micrometers of potential bacteria in the air.

[4]. The computer system controls the operation of the moving sensor. Mechanism (MECHANISM). [A]. The motor should be thermally protected, series commutation, and a vacuum up/off machine (⅝ length/20,000 rpm) with flow-through discharge to provide high-speed air. The output is 13,000 LFM (linear feet per minute), and the butt side is 10,000 LFM (2 inches [61 millimeters] is higher than the output). Including replaceable metal filters and reliable performance. [B], The heating element (500w) is composed of nickel-chromium wire and installed inside the machine, so it is anti-vandalism. It should be protected by a thermostat with automatic reset. Closed when air is flowing. It should be able to produce an air temperature of up to 109° F. (43° C.) at a temperature of 72° F. (22° C.), but in winter it is slightly higher than the user's body temperature. The user's preference is adjusted. (From the above 2 inches [61 millimeters]).

[c]. The control component is activated by an infrared optical sensor located next to the exit. This sensor is connected to the computer circuit board. It transmits data to cloud computing and a smart database through WIFIi6 and fixed 5G. The system controls and manages its entire work process, starting work when needed, and stopping after completion. Computer system control includes speed and sound, adjustable heat control and high, medium, low and off. In addition, a filter sensor is also set, and if the filter is clogged, it will be activated. Designed with a professional error correction code, and, in conjunction with large data calculations, the sensor is equipped with an external red LED light flashing, and the error correction code is operated to assist in troubleshooting. According to the user's manual and voice control and.

Cloud computing and smart central applications use large data calculations and analysis, and then the software issues instructions to provide the best-feeling personalized interface. The channels are respectively linked to the output of the handheld device, the seat board, and the buttock device. connector. It can accurately execute various instructions obtained from cloud computing and human intelligence and control the output of each outlet to adjust arbitrarily. Write the error correction code in the control software and run the error correction code to help troubleshoot.

I.-08, Water Pressure Pump Room. The Functional Requirements are as Follows:

[a]. The small water pressure pump controlled by the system program can produce a water pressure of 20 psi-50 psi. A high-end pressure sensor is installed at its output. This sensor is connected to the computer circuit board via Arduino, and is transmitted to cloud computing and human intelligent database via WIFIi6 via 5G network.

[b]. Perform accurate operations according to instructions obtained by cloud computing and human intelligence, and can adjust and change the pressure, and provide pressure to clean the barrel, seat plate, and other needs of the barrel. The water inlet of the water pressure pump is connected to the water box with a stainless-steel pipe, and the water outlet is connected to the drum cleaning system of the drum cover (for details, refer to the drum cover part). Write the error correction code in the control software, and run the error correction code to help troubleshoot.

I.-09, Extract the Machine Compartment. The Specific Requirements are as Follows:

[1], The small pump controlled by the system program must be able to operate quietly, and be able to transmit the peculiar smell to the waste disposal compartment in time when the user excretes feces.

[2], It is required that its pumping capacity must have a general pumping intensity of 3/2.

[3], Use environmental air to exercise. Transport the peculiar smell through the pipeline to the waste treatment chamber System control and cloud computing, the intelligent system forms an organic whole, and controls the degree of abstraction to provide users with a very comfortable environment. Write the error correction code in the control software, and run the error correction code to help troubleshoot.

I.-10, Waste treatment chamber (the peculiar smell produced by excrement is transported through pipelines for treatment) The specific requirements are as follows.

[1]. Software-controlled waste treatment chamber, with a chemical sensor installed on the top of the inner wall, (It links computer cloud computing and human intelligent system through Arduino) Supervise and inspect the waste of treatment liquid treatment, feed the produced data back to cloud computing and human intelligent system in time and install software on cloud computing.

The data will be analyzed and calculated.

[2]. This processing chamber is designed on either side of the water box.

[3]. Size: It is set vertically, the top of 3′×1′×2.5′ is designed as a double layer, and the waste detection sensor is installed at the bottom of the lower layer, facing downwards to the waste disposal bin. The bottom floor is designed as a semi-open type, and the clean air after treatment can be eliminated from the upper roof window through it.

[4]. The outlet tube of the extractor is linked to the bottom of the waste disposal bin, and a cone-shaped drain designed specifically for waste disposal is linked to the outlet tube from the inside to the outside. It is designed to have a lot of small holes to remove waste from the outside, and it is designed with a dedicated valve. A pressure sensor is installed beside the valve. This sensor is connected to computer cloud computing and human intelligence system through Arduino, and WIFIi6-5G transmits data to cloud computing and human intelligence. The system will control it to turn on at the beginning of drainage and turn off at the end of drainage according to the command.

[5], the waste gas processing cabin storehouse causes the use the processing fluid, has following two kinds of choices.

[A]. Use Febreze Air Effects products use fancy chemical reactions to break down stinky molecules to the point where you can't smell them anymore. The product works well, especially because you don't need to spray it before you go. The one downside is the scents like “morning herbs and mist” and “clean splash” leave a vaguely chemical scent lingering in your bathroom. Febreze The company's Air Effects products have made the use strange chemical reaction to the odor that the method has been repeated. Effects of the product Good, especially given the fact that you don't need to spray the medicine before you make the 12132nd. The shortcomings are the morning herbs and mists and “net the taste of bamboo like splash leaves a vague? chemical flavor in your bathroom.

[B]. Use Essential Oils These natural beauties work wonders when combined with rubbing alcohol in a spray bottle. Essential oils come with all sorts of fascinating properties. Take cedar oil, for example. “When the fog rolls in, cedar trees retain anti-fungal properties, The oils can do the same thing right in your bathroom.” Pick your favorite scents (we love lemongrass and jasmine) and say bye-bye to any unpleasant odors. Using this method requires designing a storage warehouse and installing a repair fluid position sensor to tell the user when they should add into.

I.-011, The specific requirements of the water box are as follows.

[1], High-rack water box This water box is like a high-rack water tank because it is higher than a barrel. It is installed with a liquid level sensor connected to the computer cloud computing and human intelligent control system via Arduino, and it is self-coded and set the running level in the upper/lower tank. Once the water level touches the predetermined maximum limit, the liquid level sensor control system automatically shuts down the water. When the water level is lower than the present position, the control system turns on the water.

[2], Auto water level controller circuit. There are two methods to choose from.

[A]. Install the liquid level sensor on the top of the water box. The sensor is connected to the computer cloud computing and the human intelligent control system through Arduino. Water level changes, for example, when the water level rises or falls, the water tank will produce a pressure change. The liquid level sensor will send these changes to the computer cloud computing center, and the software will issue instructions to control the opening of the valve.

And closed.

[B]. The following is an example of a mature application; the two sensors are floated on two stainless steel rods in the water box. This arrangement is installed in the PVC pipe and fixed vertically on the inner wall of the water tank. This sensor is more reliable than an inductive sensor. Sensor 1 detects the lowest water level, and sensor 2 detects the highest water level. The leaf switches S1 and S2 (used in the recorder) are fixed on the top of the sensor unit so that when the float is lifted, the diameter is 5 mm. (Approximately) The aluminum rod pushes the moving contacts (P1 and P2) of the leaf switches S1 and S2 from the normally closed (N/C) position to the normally open (N/O) position. Similarly, when the water level drops, the movable contact returns to its original position. Usually, the N/C contact of switch S1 is grounded, and the N/C contact of switch S2 is connected to a 12V power supply. The wiring method of IC 555 is as follows: when its trigger pin 2 is grounded, it will be triggered, and when the reset pin 4 is grounded, it will be reset. The threshold pin 6 and discharge pin 7 are not used in the circuit. When the water in the water box drops below the lowest water level, the movable contacts (P1 and p2) of the two leaf switches will be in the N/C position. This means that the trigger pin 2 and reset pin 4 of IC1 are grounded and 12V respectively. This flip-flop IC1 is grounded and 12V respectively. This will trigger IC1, and its output will go to high level to power relay RL1 through the driver transistor SL100 (T1). If the switch S3 is in the “on” state, the pump motor has been turned on and the water pump starts to be placed in the high-rack water box. As the water level in the water tank rises, the float of sensor 1 also rises. This will move the moving contact of switch S1 to the N/O position, and the trigger pin 2 of IC1 will be connected to 12 V. this will not have any effect on IC1, and its output is still very high, which can keep the water running. As the water level further rises to the maximum water level, the floating of sensor 2 pushes the movable contact of S2 to the N/O position and grounds it.

Now, IC1 is reset and its output goes low to turn off the pump. As it is consumed, its liquid level in the overhead tank drops. Therefore, the float of the sensor 2 also decreases. This will move the moving contact of switch S2 back to the NC position. When the water level further drops to the lowest water level, the moving contact of switch S1 will move back to the N/C position to ground the trigger pin 2 of IC1.

This will trigger IC1 and turn it on to start water. The system controls the operation of the two sensors and the automatic water level controller. The control software will operate the automatic water level controller according to cloud computing and intelligent analysis and calculation instructions. Write the error correction code in the control software, and run the error correction code to help troubleshoot. Water in and out of the water tank.

The water in this water tank uses public private water. There are three different pipes for the output.

[A]. A stainless-steel pipe (2 inch diameter) is directly connected to the flushing system of the barrel, and when the control system detects that the user needs to flush the feces, it will issue an instruction the water outlet valve of the rear water tank is opened, and the water flows down from the height, creating a siphon effect and flushing the excrement.

[B]. A pipe is connected to the inlet pipe of the cleaning water filter. The volume of each flush is automatically adjusted by the software control system after obtaining the data from the chemical sensor installed on the barrel body: according to the user's excrement volume.

[C]. A pipeline is linked to #B cabin (details see #B cabin section).

I.-012, Toilet smell control cabin; this cabin is storing 300 ml Poo Pouria. Its main function is to have a nozzle hidden in the lid of the bucket facing the bucket body. When the proximity sensor is found When the user approaches the barrel, and before the lid is automatically opened, the nozzle is quickly extended under the control of the software, and then the water surface of the barrel body sprays Poo Pouria 5 times, and the essential oil state Poo Pouria will cover the water surface. When the user doesn't think it is convenient or convenient, a layer of film is formed on the water surface to trap the stench on the surface. When the user's excrement is splashed on the upper surface, the film will release the essential oil of Poo-Pouria and give out a faint flower. This bin is connected to the side of a small pressure pump on the lid of the barrel by a hose, and its outlet is connected to the nozzle. The pressure produced by the small pressure pump is 20 psi. A pressure sensor is installed at the outlet of the small pressure pump. The data collected by the pressure sensor is connected to the computer cloud computing and the intelligent system through Arduino, and the software controls it. The entire work process. Write the error correction code in the control software, and run the error correction code to help troubleshoot.

I.-13, #B cabin; The size of this storage cabin: 1′*0.8′*2′, and the sides are divided into two parts.

[a]. One space is 2″*3″*5″, its function is to store BLEACH liquid, it is equipped with a liquid level sensor (connected with computer cloud computing and intelligent control system via Arduino) and a micro pump, and their control system will work according to the instructions of the software.

[b]. The rest the space is a water tank, where a liquid level sensor and a micro pump (Connected with computer cloud computing and human intelligent control system via Arduino) are installed and repaired, and its water inlet is connected to the water pipe C of the water tank. When the water level drops to the designated position after use, the cloud computing and human intelligence center will open the water inlet valve connected to the water tank outlet pipe C when receiving the data sent back by the liquid level sensor. The position sensor will continuously send data to the computer cloud computing and human intelligence center. When the water level reaches a predetermined height, the valve will be closed according to the instructions issued by the cloud computing and human intelligence.

The micro pump is installed by the installation. In the cloud computing database's software control, a digital pressure sensor is connected to its outlet, and the sensor data is continuously sent to the cloud computing and human intelligence center. When cleaning the sex organ sprayer, it works. After completion, the pressure pump produces 40 psi pressure water according to the instruction.

These waters are sprayed out in the form of small water droplets through the two nozzles installed on the left and right sides of the sprayer cleaning chamber. When the sex organ sprayer is returned to the cleaning chamber Go into a one-minute rinsing and cleaning. After rinsing, the sex organ sprayer will be completely returned to the cleaning chamber, and the cleaning chamber with sealing function will be closed. Currently, the two cleaning nozzles will start to inject water and install them in the cleaning chamber.

The liquid level sensor on the surface will continuously send data to the cloud computing center. When the water level completely floods the sex organ sprayer, the software controls its two spray heads to stop working. When the anal water injector is completed, the pressure pump produces 40 psi pressure water according to the instruction.

These waters are sprayed out as small water droplets through the two nozzles installed on the left and right sides of the injector cleaning chamber. The anal injector is rinsed and cleaned for one minute. After the flushing is completed, the anal injector will be completely returned to the cleaning chamber, and the cleaning chamber with sealing function will be closed. At this time, the two cleaning nozzles will start to inject water, and the liquid level sensor installed in the cleaning chamber the data will be continuously sent to the cloud computing center. When the water level completely submerges the sex organ sprayers, the software controls its two sprays heads to stop working. Write the error correction code in the control software, and run the error correction code to help troubleshoot.

I.-14, Arduino All applications of the sensor of the present invention are connected to computer cloud computing and human intelligence through Arduino. Because every sensor manufacturer is researching and adopting different algorithms to design and improve the competitiveness of products. There are already sensors on the market that do not need to transfer data through the relay platform, and the sensor can directly send the data to the cloud computing center. If such a sensor is used, it is excluded to link to Arduino. The manual control board the manual control board can be installed on the front left or right side of the toilet according to the user's choice. the control board should be designed There are manual knobs, as follows.

[a], seat board temperature control knob, can be used for temperature increase and decrease adjustment.

[b], inject a water temperature control knob, can increase water temperature increase and reduce regulation.

[c], the adjustment of the amount of water injected can increase or decrease the amount of water that needs to be injected.

[d], cleaning water temperature regulation, can raise or reduce the stability of water.

[e], cleaning water pressure regulation, can raise or reduce the pressure of water.

[f], cleaning time adjustment, can increase the cleaning or reduce the number of cleanings.

[g], the dry pressure adjustment, can raise or lower the dry pressure.

[h], dry time adjustment, can increase dry time or reduce dry time. The eight adjustments knobs on the upper face should be designed so that each degree feels clear and manual, with a force between each degree, and one degree the knob must have a magnetic force of entry when entering another degree. The manual manipulation of the knob can only go from one degree to the second degree to avoid overtaking. It is impossible to increase or decrease the knob by two degrees at a time. The line must be clean and clear.

The Internet of Things (IoT)

I, Since the present invention uses a unique AI intelligent computing and privacy cloud terminal, it is a unique operation with multiple lines and multiple cores system. Therefore, the present invention is designed to be the center of every single family, IoT and privacy cloud dual AI control terminal (AI edge computing and AI smart privacy cloud computing terminal for IoT). All connected devices can be controlled through it. It makes the data transmission of all connected smart sensors better, Classes and integration can be safer, maintenance is more concise and easier, and the cost is lower. At the same time, it can store a very large amount of user privacy Data, the present invention uses a large-capacity SATA hard disk of 1 TB for this privacy cloud design, and the upgrade is not limited and can reach unlimited TB.

The software design must be friendly and easy to store, read and edit (for specific indicators, please refer to the “software design” chapter of the present invention), and many more, that means when necessary. Because the privacy cloud is aimed at protecting users' privacy data to the greatest extent. Therefore, the privacy cloud can not only store and read access to all private electronic data of the user and the entire family members, it is also protected by up to 256-bit digital encryption (with please refer to the “Privacy Cloud” chapter of the present invention for physical indicators).

II, the most important thing is that it does not need to transmit these private data to any other place it is not even transmitted to a distributed (local) cloud or remote computing center. Because there is no need for data transmission, it is maliciously taken and the risk of improper use by any administrator is greatly reduced, so that the greatest user privacy protection can be provided.

The combination of IoT and cloud computing designed by the system of the present invention can collect non-private data information and analysis of users and their family members. These data information and create specific operations to help users achieve them comfortable use characteristics and fully cooperate with users. Often personalized needs, provide targeted services. At the same time, the dual AI intelligent computing terminal system established by the invention is generated by the transfer and storage of data from the Internet of Things to cloud computing Personalized data streams that are constantly designed to be installed in distributed (local) cloud and remote cloud computing centers for AI neural network training learning and deep thinking result in very valuable executive instructions that assemble at the low peak of each day used by the network.

Design the dual AI intelligence installed in the invention system for training. Achieve full mastery of user personalization needs and some very special the use habits that enable the system to deliver a wide range of targeted and thoughtful quality services in a very short time enhance the user's sense of well-being in life.

Various equipment: including but not limited to various household appliances, various personal computer equipment, and various smart wearable devices, including various kinds of intelligent transportation tools, and any type of personal communication equipment, as well as many other types of intelligent vehicles that will appear on the market in the future. Application, etc.

III, this network is a two-way operation, it can carry out internal private data transmission, private data storage. Can also hide submit private data to cloud computing.

These are all gathered together via a smart network to build a true sense of IoT and family privacy. Private cloud database center. The system of the present invention can establish a closed, dedicated Internet network for each single family and connect the various families of the family. It provides devices not only for information exchange within close families, but also for safe and accurate information transfer across different types of networks.

The application of the present invention to the Internet of Things is about networks, devices, and data processing. It can improve the working efficiency of all equipment, save time, money and reduce emissions. Previously, all content connected to the Internet may be invaded by customers, and IoT products are no exception. Insecure IoT systems may cause user data to be maliciously invaded, even exploited, and maliciously monitored, etc.

[a], If the electronic smart devices of each family are connected, the data is stored securely in the user's home, and there is no need for transmission. Then no one can maliciously observe and monitor users without restriction, or gain malicious access to the network, and other privacy harms, and so on. The invention system designs new data obtained on the day transmission during low peak hours to distribute (local) and remote clouds computing Center, but this data must be encrypted and specially specified to exclude the user's personal privacy. Special attention needs to be paid to immediate processing of potential defects in software (both old and well-used). Real-time hair it is essential that any irregularities in the transmission of data and information be addressed in a timely manner. In addition, the software system specially customized for the invention must be targeted to prevent and deter hackers from intruding, who are usually actively targeted attacks on IoT devices (such as routers and AI smart cameras) require enhancement of the security inherent in these devices.

[b], The IoT dual AI intelligent edge computing terminal designed by the system of the present invention for users and their families is for privacy protection and the greatest reduction in usage costs. Dual AI intelligent edge computing can partially replace distributed (local) cloud and remote Cloud computing, its special feature is that it can perform various pre-set functions very accurately and provide users with high-quality services without a network connection. The user's personal voice can be identified, collected, and stored during streaming (these are private data). There are special needs, when necessary, the dual AI system of the present invention, AI edge computing and AI smart terminals of IoT will perform operation management, including the use of the present invention equipment, personal needs, special hobbies, and others, etc. With the continuous increase of application systems, processing data in the cloud It will naturally rise in a straight line. In order to reduce costs, the data produced by each user (or his family) will be included in the AI of the system of the present invention. Edge computing and IoT's AI intelligent edge computing terminal completes its pre-processing, only during the low peak period (12:30 AM in the evening-06:00 AM) Send the specified data back to the cloud (of course, not including the user's personal privacy data).

Collect and analyze the book after revealing the data submitted by the system equipment, the AI intelligent deep neural network system designed and installed in the cloud will use different the algorithm performs calculations and analyzes these data. Then, a training index set is produced, and the dual AI smart system installed in the user's home get training.

[c], These trainings can quickly and effectively upgrade the dual AI smart terminal installed in the user's home to perform perfectly and accurately. Various necessary service capabilities. The system of the present invention also requires customized software and must be able to provide audio frequency identification functions through different algorithms, in the exchange of data and information. In addition, the IoT design of each device has different UX requirements for each of its equipment, such as: “Remote controlled oven needs minimum disaster stricken.” The refrigerator's “is kept in space whenever it discovers the new production of” under the surveillance of intelligent sensors computer software will be performed at the speed of computer, while the memory, the image, software system, originally placed in the space two charts and no-goods messages will be sent to the 'EM to 'EM, reminding them to purchase, and to make 'EM sensors when they leave their home the device will be moving all the lights, furnace natural valve shut and other, etc. The IoT system designed to help balance the safety and needs of vulnerable populations while maintaining their privacy and the “master” of the invention sex. “Certain smart home systems have rules and models that apply to certain specific conditions when certain conditions, for example when returns open or close some equipment when home, wake up or leave. “Equipment must comply with regulatory requirements such as ‘radio’ disturbances or waste recovery targets'”. It should be noted that the inventor does not specify the features of IoT here, such as the need for an electronic controller to perform IoT the need for some kind of functionality is because today countless manufacturers are developing applications for the future development of IoT. Each manufacturer uses a different data algorithm designed to be more powerful and easily manipulated and safer use, lower cost, etc. If the invention now specifies the application of one or more of these electronic products, this is not fair for future user groups, as electronic products of any kind are currently growing rapidly, almost every more innovative products are on the market all day long, and prices are lower.

IV, Moreover, it may take a long period of time for the patent of the invention to be applied for to be approved, and the invention is specified when the patent is approved the use of any kind of electronics is likely to be outdated and replaced by more advanced ones. In this way, science and technology development should first improve people class quality-of-life services are likely to be empty words. To avoid such a situation, the invention simply provides below some references, rather than specifying any kind of electronics. In the final analysis, the IoT system of the present invention is compared with the traditional screen-based application. The UX faces are the same, only the thoughtful design of the present invention is combined in the process, and the result is a new creation.

Create something that every user is happy to use every day, and really improve the user's happiness. The purpose of selecting electronic products of the present invention is the latest, more stable functions, stronger functions, more functions, and safer applications. Such as If the electronic products on the market cannot fully meet the requirements of the present invention at a time, if possible, the technical staff of the manufacturer can be used Upgrade to meet the needs of the system of the present invention.

Regardless of the use of any form of electronic products, these should be protected in the present invention of patents. In order to meet the software design requirements of the system of the present invention, the IoT system of the present invention needs to use the selected AI smart terminal for reference as follows. In addition, special attention is needed to be paid to the professional software design, which is often important, and the different choices of the following are needed and software The discussion, and the repeated tests needed to be tested to get the best choice. Often suitable for cloud virtualization, network devices, and embedded applications. This energy-efficient and space-efficient system is based on Supermicro X11 SDV-8C-TP8 F flexible ATX motherboard with 8-core, 80-watt Intel Xeon D-2146 NT SoC support. It also has built-in Intel QAT encryption and compression capabilities that support up to 512 GB memory, four GbE RJ45 ports, dual 10 GbE SFP+ and dual 10 GBE RJ45 ports, dual USB 3.0 ports, four 2.5 “internal SATA/SAS hard disk drives or SSD and internal storage expansion options including mini-PCIe, M.2, and NVMe support. Supermicro's new SYS-E300-9D is a compact embedded system suitable for network security, SD-WAN, vCPE controller and NFV edge computing equipment. The system is based on Supermicro's X11SDV-4C-TLN2 F mini ITX master board, equipped with quad-core, 60-bit Intel Xeon D-21231T SoC, supporting up to 512 GB memory, dual 10 GbE RJ45 ports, four USB ports and one SATA/SAS hard disk, SSD or NVMe SSD. Supermicro's new SYS-E300-9D is a compact embedded system suitable for network security, SD-WAN, vCPE controller and NFV edge computing equipment. The system is based on Supermicro's X11SDV-4C-TLN2 F mini ITX master. The board is equipped with a quad-core, 60-bit Intel Xeon D-21231T SoC, supports up to 512 GB of memory, dual 10 GbE RJ45 ports, four USB ports and a SATA/SAS hard drive, SSD or NVMe SSD. ARM's two new processors with AI capabilities-Arm Cortex-M55 and Ethos-U55, which are a neural processing unit (NPU)-specifically designed for Internet of Things (IoT) endpoint devices, and support software libraries, Tool chain and model. ARM claims that these two cores are expected to be available in early 2021. In certain language and visual scenarios, they will jointly provide up to 480 times the machine learning performance improvement. Cortex-M55 is the latest member of Arm's Cortex-M processor product portfolio.

V, this product portfolio has cost-optimized and energy-efficient microcontroller devices. It is like the previous Cortex-M and previous generations.

AI performance has been improved by 15 times. Customize instructions and configuration options. Like Ethos-U55, it is available in the reference design Corstone-300, which comes with many safety sub-systems and kits for building safety embedded systems. Cortex-M55 also has the first on-board system based on Arm helium technology, which is an extension of Armv8.1-M architecture, which is optimized for low-power silicon and adds more than 150 new extensions and Quantity instructions. Integer Helium can efficiently calculate 8-bit, 16-bit and 32-bit fixed-point data, the last two of which are widely used for audio Processing and other traditional signal processing applications.

Up to 8-bit fixed-point format, in computer learning and processing (such as neural network calculation and image processing it is very common in management, it supplements floating-point data types, including single-precision floating (32-bit) and half-precision floating (16-bit). according to Arm said that Helium can achieve up to 5 times the performance improvement in the digital signal processing side, and 15 times the performance under the Cortex-M55. Machine learning. It also allows advanced memory interfaces to provide fast access to machine learning data, and it is built on Arm's Trust Zone system-wide embedded security technology.

Ethos-U55-Intended to be compatible with floor-M55, floor-M33, floor-M7 or Layer-M4 and other layers-M processor pairing-Comparing with Cortex-M55, configurable computing unit can realize 32 times higher machine improved learning performance. Energy efficiency beamforming, echo elimination, equalization, mixing, keyword discovery and automatic voice recognition in noises, double air grams increase by 25 times. On the software side, both Ethos-U55 and Cortex-M55 benefit from a unified software development process that will be embedded code, digital signal processor code and AI model code folded into one. Importantly, it can be linked to popular machine learning boxes racks (such as Google's TensorFlow and Facebook's PyTorch) and Arm's own solutions work well together with use.

Data movement is a factor in the energy consumption of the edge. Recently, there's a MAX 78000 on the market, which will be a low performance the consumer is matched with a neuro-neuro-compact processor, which can be transported on the IoT device that provides electricity in the battery.

Marginalization computer vision has become an important example of AI, especially in the form of deep learning, which takes use multilayered neuro—neuro—neuro—and Supervision the technique is to realize the results of image pattern recognition.

Today's visual system architecture is changing because the most marginal camera passes the ink-style hardware increases the processing of deep learning energy. But finding the best response to the target may be a challenge. On the edge analysis of image data is proven to be a correct solution to the problem. Arm also claims that Ethos-U55 and Cortex-M55 are up to 50 times faster at reasoning speed, detecting and reducing speech activity.

Sensor's Network Data Transmission

I. The sensor network designed by the system of the present invention may be transmitted by wired and wireless means for the sensor and its peripheral electrons data transfer for the device. In addition, when using the present invention, the user may have different habits or preferences due to each person's usage habits the sensors of the system equipment of the invention and various electronic devices of the IoT device will produce a large amount of data, which shall be collected and transmitted “User data” is referred to simply in the following narrative.

II. This invention equipment and the IoT equipment its intelligence sensor can produce every time the data stream needs the correct transmission technology. Picks regularly the collection sensor data stream is an important work. Regarding the user data stream transmission, the receiving system needs to have the different transmission week the time carries on the same sensor data stream the exchange.

For example: Using the AI edge computation, avoids in high the peak time transmission data (reducing causes with cost) to distribution cloud and control cloud, even does not carry on directly the user important privacy information storage in this invention equipment the transmission from this, may achieve safe and protects the user privacy the maximization. If needs to use not the line sensor network to wind, may consider causes with standard “spoke” or “Star type” analysis situs construction, because the sensor distributes in each application equipment its region, may consider uses is using in the family scope applies “jumps on the line network shape analysis situs”, in which data in arrives before the AI edge computation.

Mini Robot At present invention (Please view FIGURES: 11, 12, 13, 14, 15, 16, 17, 18, 19, 20, 28, 29.)

I, With the demand and development of industrial robots, aerospace equipment and medical equipment, the extensive application of high-precision robots has become very common, today in the medical field robots for patients to do surgery is not news, unmanned aircraft, unmanned ship, unmanned vehicles, a ubiquitous.

The most critical part of the present invention is the injection machine, which is the soul of the present invention. A variety of AI systems are its brain. When different high-end sensors transmit data to the AI system, the machine must be able to think about how to operate according to various instructions and how to perform accurately.

There are two injection machines in the present invention. They are the AI smart “butterfly wing type” machines on the inside and two sides of the present invention. They are part of it when they are not working. Each has basically the same function, but the size is different. When the AI intelligent system senses that the user is sitting down, the two “butterfly wing” robots will slowly rise from the inner sides of the toilet to the left and right sides of the user's buttocks under the instructions of the AI system, It stops automatically when it is close to the human body by two millimeters.

The upper part (A) of the AI smart “butterfly wing” on the left is small.

II, when it starts to work, it will slowly separate and extend from the AI smart “butterfly wing” machine. The various high-end sensors and white cameras on the “butterfly wing” will transmit the distance and position of the target to the AI intelligent system through data at a high speed, and the AI intelligent system will at the same time inject the water machine.

III, Issue instructions to guide it to accurately align the user's urinary organs for cleaning. In addition, if the user is a woman, the injection machine can directly extend 5 millimeters into the woman's vagina to clean the internal spray, and then clean the outside of the organ in all directions. Special attention is needed: AI intelligent “butterfly wing” robot and injection robot are designed with many 0.5 millimeters of overflow holes (interval 3 millimeters apart) on the entire body.

When it starts the water leaks out continuously during operation, and the goal is to keep it as clean and clean as possible. Until the entire work is completed, the pressure spray heads designed in the left and right sides of the barrel will automatically flush them, to ensure a high standard of cleanliness.

The basic function of the note machine. on the right is the same as that of:

[a], When the user sits down to excrete, the first time: the various high-end sensors and the body camera on the “butterfly wing” The target distance and position are transmitted to the AI intelligent system through data at a high speed.

The AI intelligent system also sends instructions to the injection machine

[b], to guide it to accurately locate the user's anal position. Currently, the injection machine Slowly and accurately 100% anastomosis with the user's anus under the instruction of the AI intelligent system, and then lifted 3 millimeters to make the anastomosis basically tight, and began to contact the user's rectum (human body's anus). The urinal) is filled with drinking water.

IV, Note: The AI Smart Motion Functions Designed by the Robots (A) and (B) are as Follows:

[a]. Move 1 cm to the left→2 cm→3 cm→4 cm→→→→50 cm→

[b], move 1 cm to the right→2 cm→3 cm→4 cm→→→→50 cm→

[c], move up 1 cm→2 cm→3 cm→4 cm→→→→50 cm→

[d], move down 1 cm→2 cm→3 cm→4 cm→→→→50 cm→

The high-end sensor and the body camera transmit the data of the target distance and position to the AI edge intelligence system. The AI edge intelligence system obtains the input data and performs high-speed calculations, and then outputs the calculation results (instructions) to the medical machine.

Note: The machine knows its own task and target position to move quickly and accurately. The first time needs to pour into the probably 50 milliliters water, lubricates the user rectum wall (separation rectum wall and bowel movement adhesion), helps the bowel movement May quite easy overflow smoothly. After completes the first irrigation, the AI intelligence robot can rapid crash downward a centimeter, with to side Moves a centimeter. This invention AI intelligence system can act according to each kind of camera and the electronic transducer to user's excretion the condition carries on the observation, by determined drains whether already started, or the user merely drains the gas, also or was the water which already poured into the nature flows out, the water has not entered user's rectum, the excretion simply has not started no discusses is front any kind of situation, this time AI wisdom Can the robot need to carry on the second irrigation.

For the second time, 100 fml of water needs to be

injected. After completion, the AI intelligent machine will quickly fall by one centimeter and move to the side by one centimeter.

If the amount of water injected at the first time cannot reach the immediate target, the amount of water injected at the second injection can basically cause the user's rectal cavity to dilate (this amount of water can be used to enter the user's rectal cavity). The inside size is about 3 cm. This position is the key to direct adhesion between the stool and the rectum.), these water help separate the stool from the rectum, and lubricate the rectum, which effectively helps the user to excrete smoothly and quickly. This process will not More than 3 seconds. Maybe someone will worry about whether the water volume of 100 fml will be a safety issue when the user is unable to excrete normally? the answer is negative.

V, Because the various organs of the human body are soft and elastic, when the water is injected, it will naturally support the rectal menstruation.

The user here is sitting on the system of the present invention for excretion, and the anus is almost Vertically to the ground, when the injected water supports the rectal menstruation (the water separates the close adhesion between the rectum and the stool): the user cannot effectively maintain these water and stools, and the rectum will contract naturally, Under the action of the ground attracting people at the same time, it will be smoothly discharged downward (just like when you are rinsing, if you drink too much water, it will naturally overflow from the lips.), and then all the tension and pressure The swelling and swelling disappear in an instant. This smooth and relaxed feeling is an indescribable happiness, especially for those users who have problems with excretion during the period. For the third time, 200 fml of water needs to be injected. After completion, the AI intelligent machine will quickly fall down one centimeter and move one centimeter to the side.

Of course, there are exceptions to everything, and there may be some very special users, such as a certain period of patients, and the first two injections cannot reach the predetermined target, then the second injection The action will be repeated until the user completes the first excretion. If after the first and second injections have reached the predetermined target, the user's rectum has enough space to hold 200 fml of water.

This water can help clean up the remaining stool and excrete. For the fourth time, you need to inject 300 fml of water.

After completion, the AI intelligent machine will quickly fall by one centimeter and move to the side by one centimeter. This water cleans the user's rectum, the human body urinal (just like a human rinsing is used to clean the cavity after brushing), and it also takes a step towards cleaning up the waste remaining on the surface. You can do it repeatedly until the user is satisfied.

This requires special attention. Due to the differences in the size of the body, for some people, whether the amount of these injections is sufficient will be a problem, and the individual user feels that it will be different. However, there are differences. In order to meet the personal needs of various users, the AI intelligent system of the present invention has a voice control program, and the user can control various functions of the system of the present invention through natural voice communication.

VI, However, for safe use, the system of the present invention locks the maximum injection volume at 450 ml at a time. In fact, the real safety does not need to be doubted.

Because the user is sitting on the toilet almost vertically, the AI smart injection head machine injects water vertically upwards, and the water injected in the process will naturally flow downwards, no one can be effective in fact, the water that can be injected is only about 70% of the injected water, and it is impossible to cause any harm to the human body.

This is because the amount of excretion of the body is about 450 grams (about one pound) each time, and the amount of water injected is almost the same or even not enough. The most important part of the machine—the volume double cycloid reducer is an important invention in the field of precision motion control.

It has overturned the 100-year history of traditional wheel transmission technology and will be an epoch-making in the machine industry. Meaning. It is a kind of precision reducer that can directly replace RV and harmonics according to its operating principle and replace the star wheel box. Compared with other spherical reducers, it has a larger transmission range and higher overload capacity. But it takes the outstanding performance, the entire joint application (uses in industry or human form robot) as well as the more cost superiority easily as the market institute Accepts, and uses in the driver profession.

The HSOAR double pendulum armature speed reducer took high (The stiffness of the boat.) the precision control speed reducer, the innovation has used the double pendulum Linear discrepancy fast output. Because all steel balls all completely contact suspend the coil, therefore, this transmission gearbox has the volume small, the weight is light, rigidity high, Carries the ability strong characteristic.

Moreover, its revolving vibration, inertia extremely small, therefore is adding the deceleration aspect to maintain the good performance, localization Precision high. Therefore, all axes of the micromachine of the system of the present invention can use this type of precision reducer in one stop, without distinguishing J1, J2, J3 or J4, J5, J6 axis.

These reducers are available in coaxial and straight configurations. They use precision ground steel balls as the transmission medium, which is different from the more common wheel boxes. Compared with the more traditional star-wheel reducer or cycloid reducer, this method of using eccentricity to produce deceleration is different. It has no backlash.

Therefore, while preloading the ball, there is of course zero backlash to ensure that the entire drive has 100% meshing. One feature of rolling contact is that it reduces noise and extends the service life. In order to achieve the longest service life possible, the designer adopts the rolling friction transmission method, which effectively reduces the temperature rise and wear during the operation.

VII, the output mechanism of the cycloidal pin wheel is never worn, and deformation is usually impossible, which has obtained the longest service life reducer technology.

The low-noise and zero-vibration transmission meshing mechanism belongs to the rolling contact method, which has no impact and has low operating noise. When a person is moving forward, resonance occurs. The ability of the reducer is specifically to check whether there is vibration. Two cycloid motions of different frequencies will eliminate the source of vibration.

A variety of ratios use differential transmission, the first-level maximum speed can reach hundreds of thousands, through the corresponding combination, it can reach thousands, covering a wide range of speeds, the lowest speed is used the single digit 5 is calculated. High load output adopts cross-roller bearings (or double row contact bearings).

All steel balls are meshed and driven with high contact degree, which has high load capacity and overload capacity. In addition, it is designed to be an ideal choice for the micro-machine of the invention system, which has cables, pipelines, and various axes to cross the rotating axis.

This structure is also suitable for synchronization & belt drive, which can save space effectively. Efficiency is due to the combination of rolling contact with steel balls and pendulum, which effectively reduces friction resistance in the fortune hence the efficiency of the transmission is high, often 90 percent or more. The zero-backlash steel ball is used as a precision reducer for the ball to replace the traditional fixed wheel. The seamless rolling pair is formed through the pretension and the pendulum raceway to achieve zero backlash and high accuracy.

VIII, there is no dead cycloid motion trajectory, realizing an all-around movement without deadlock. The maintenance-free reducer adopts a closed structure and is pre-filled with high-viscosity, corrosion-resistant, wear-resistant, water-resistant, and antioxidant grease. It can effectively prevent oil leakage, and there is no need to fill or replace grease during the specified operating life of the reducer. It can be used in conjunction with any type of motor through appropriate connection methods to meet various mission requirements in different environments and locations. This is a very mature technology that has been widely used in the past. To smart medical care, aerospace, unmanned airplanes, automobiles, etc. How can we achieve the goal pursued by the present? invention? The following items are the key points that must be paid attention to.

IX, The main types of precision reducers for machines the precision reducers for machines often include:

[a]. RV reducer. The RV decelerator is a combination of the planetary decelerator and the swing needle wheel decelerator. It offers excellent performance: high rigidity, low contact force, high precision in parts machining and installation, and high drive efficiency. The combination of planetary drive mechanism and compact W output makes the machine compact, small and lightweight. The use of single-gear or less gear differential transmission, transmission ratio is large, meshing gear Large, strong carrying capacity, the use of life long and so on.

[b]. Harmonic reducer. The harmonic reducer is a new type of reducer developed by the principle of star-wheel drive. It consists of wave generator, steel wheels, flexible wheels, flexible bearings and cross-roller bearings. The harmonic reducer has the characteristics of high motion accuracy, large transmission, light weight, small volume, and small moment of inertia.

[c]. Precision planetary decelerators, etc. The main transmission structure of precision planetary gearboxes are the solar wheel, the planetary gear, wheel, the inner gear circle. Because of it Structural reasons, single-stage deceleration ratio of 3 to 10, usually integer, with high rigidity, high precision, high transmission efficiency and maintenance-free peculiarity. Each of the above three types of “reducers” has its own advantages. Specifically, which one should be used in the present invention, and only the results obtained after repeated tests are the previous use cases. Special consideration is needed in testing: smart sensors, AI edge computing, micromachines, the fusion state of the three, from data transmission to data analysis and instruction generation, to execution of instructions, and so on. In short, integration is the key to success and the basis for achieving user experience.

By this guaranteed they work accuracy and validity.

[d]. This invention system design needs all to have the essential use in the complete AI intelligence robot each spot its connection system “the reduction gear”.

[e]. The accurate motion requires a micro-motor to provide it with a motion, and the intelligent micro-machine of the invention system is an AI smart micro-machine. Step in (1.8) motor. Or, name stepped in Ida servo motor is also a good choice because it's made with an inner feedback circuit, they can accurately reach the exact degree and position required by the given invention system.

X, Electrical machinery driver. How in this invention system AI intelligence robot use electrical? machinery driver in assembly and industry establishment electric motor the driver is for the control motor speed, revolving and the order. They receive the position switch the input, air fan barometric pressure, logic the setpoint, and inputs them to the PID return route in, by transmits the best reference signal the electric motor.

They also integrated the NC security electricity The road, the protection device and the personnel, for example use in the coil the freeze controller, the electrical machinery overload or the more complex strength sensor, these sensing's but may examine the manpower is not the process material. Arduino and Raspberry Pi all are inexpensive operates the source controller, and has the prefabricated script storehouse, may defer to in this invention system Each kind of demand uses or revises them. Simultaneously pays attention to the understanding proportion integral or the proportion integral differential circulation working, may with ease for this invention design specific script.

XI, the variable frequency drive (“vfd”) controls the speed of the induction motor by changing the frequency of the alternating current fed to the motor, so the speed of the motor will change, and can be used for any reduction or increase in the control system and the automation system The speed of most processes. It is usually called “vfd” in the process. Special attention should be paid to: General-purpose machines usually require 12 V brushless DC motors. (Although they may have some other specifications) Now, microprocessors/controllers such as Arduino, 8085/91, etc. cannot provide that much voltage (The output pins of the Arduino board can provide up to 5V), The remaining current cannot be transmitted to the machine. Here, a motor driver IC like L293D/N is needed, which can solve these low voltages and act as the driving motor of the AI micro machine, without overloading the microprocessor part of the machine.

[a] Think of it as a coupling circuit like a relay. When using a low-voltage electrical circuit (Such as an IR switch) to drive a system with high power requirements (such as a 220V or 110V AC household power supply), a relay will be used. These can be searched on the web, and then selected after obtaining the correct answer. During this period, repeated tests are required to meet the requirements of the invention. For example, the motor driver IC that is often seem is L293D. In a normal linear robot, the signal voltage from the sensing is 5 V DC. Not enough to drive the 12 V DC motor used in linear robots. Therefore, the driver is connected from the sensor like a relay Once a 5 V signal is received, 12 V DC can be used to drive the motor. An L293D can be used from two sensors at the same time the signal drives both motors at the same time. However, it needs to provide 12 V DC power to the IC alone. [b]. Microcontrollers in linear robots.

The invention micro-robot in the test phase: can use 4-5 basic portal to build perfectly A functioning basic line follower for decision making. But the robot is only “basic.” If you must build a smart line The road follower (robot) requires a microcontroller. A microcontroller is a processor, and other peripherals, such as ADCs, RAM, EEPROM, timers, etc. are all integrated in the same package. Unlike the original portal, microcontrollers are fine Programmed according to the requirements of the present invention. The microcontroller in the system of the invention must be able to program it to portal follow this The special need of inventing the system makes the robot have some sense of rules of intelligence.

XII, for example, if it runs on a straight line or curve and moves to the right, or if the robot exceeds the line, and if the sensor array Reading all black allows the controller to temporarily stop the robot there based on the last active sensor data. to wait for data Work continues after the update (these problems are completed in milliseconds from occurrence to end). In addition, if the sensor emits noise, then You can use ADC to determine what is a “high” signal and what is a “low” signal. Use a timer to control motor speed and also to use “PWM” for faster robot speeds. These microcontrollers (robots) are easy to program and can be debugged immediately What's wrong! Of course, you can also use a few triggers IC, timer IC, ADC, etc. to integrate to meet the requirements of the invention Special functions of seeking. Microcontrollers should be manufactured so that all peripherals can accommodate processors in minimal space.

Thus, Microcontroller is necessary for AI intelligent robot of the invention system. And to have programmable functionality, not with a separate IC The same. In short, they allow rapid prototyping. Microcontrollers are like human brains. Because humans have brains that can Actions and reactions are performed at the same time, so robots are also required to perform tasks and respond to situations.

If the Robot Is Fitted Microcontroller, which can then handle everything that can happen when a robot performs a task. The microcontroller acts as the robot's large Brain. It is essential to receive input from the sensor and to control the motor's motion accordingly. In addition, the invention system AI intelligence Microcontrollers needed by robots must be able to easily implement algorithms for improving line followers, such as the PID algorithm. This This is why the invention system needs to use microcontrollers in micro-robots. Therefore, a note is required when customizing or selecting in the market to ensure the normal realization of the invention system.

XIII, [a]. Which microcontrollers can be adapted to the requirements of the system? mini robot of the invention? The answer depends on the sensor used and the algorithm used.

You can use a microcontroller like the at mega series (At mega 32, 32A, 8, 16, 328) that is operating at 16 GHz. However, in order to obtain the best results, the accurate sensor and PID algorithm should be considered. In addition, the number of sensors used needs to be considered. For example, use three sensors: Left Road test, right road test and obstacle detection as it moves toward the target. Two indicators, forward and stop two motor drive pins; 7 GPIO total Pins.

Of course, manufacturers can search on the Internet, and the keyword should be “strong function but low price”, for example: pic12/16, and some AT tiny can also be considered. 8051 is the simplest microcontroller used in line follower applications? The line follower (machine) uses a closed-loop feedback algorithm, in which the controller uses the feedback from the line sensor in the future to correct the path.

You can also try Arduino-based circuits to learn how to use different controllers to develop the microcomputers required by the system of the present invention. It is also necessary to consider the requirements of the available programming tools for its components, such as ADC, port, timer, etc. Has the micro controller linear follower robot is the simple design robot, may? follow the specific way or the feeling. May cause and so on designs it with Arduino, AVR,8051. The code is extremely simple, very easy to renovate. The use portal and the logic circuit design needs Must careful processing, have first to design the power source specially, then, may use the electric motor driver to design the electric motor the movement. Moreover, but also may act according to this invention system special demand to design the electric circuit other parts. Design use controller, then may approach the regulation The foreword provides this invention the concrete set of instructions, the robot in the duty when which the followed execution designs may follow these sets of instructions. Uses micro controls The regulator is giving the cerebrum the robot, is not merely for them the eye.

[b], machine software program. ROS (http://www.ros.org) can be regarded as an open source collection of programs, tools, algorithms, and even drivers for various machines and applications. It supports C++ and Python as programming languages. About ROS Robot Operating System (ROS) is a flexible framework for writing robotic software. It is a collection of tools, libraries and conventions designed to simplify the task of creating complex and robust robots across various machine platforms. It is more difficult to create truly powerful universal machine software. From the standpoint of the machine, the insignificant problems in the human category usually differ greatly between task instances and environmental instances. It is very difficult to deal with these changes, so without any individual, the laboratory or institution can hope to do it themselves. Therefore, ROS was built from the ground up to encourage the development of collaborative machine software.

For example, a laboratory may have experts in indoor environmental mapping, and may provide a world-class system for making maps. Another team may have experts using maps to navigate, while another team may have discovered a computer vision method that allows It is good to identify small, messy objects. ROS is designed specifically for such groups and can collaborate and work with each other as Foundations.

Is ROS suitable for the specific use case of the invention system? Some reasons for using ROS may be considered. Distributed Modularity Design. ROS is designed to be as distributed and modular as possible so that users can use as much ROS as they want. The distributed nature of ROS also promotes a broad community of user-contributed software packages that add to the top of the core ROS system Added a lot of value.

Ultimately, there are more than 3,000 packages in the ROS ecosystem, and that's just the time people spend announcing to the public ROS package of. These packages range from proof of concept for new algorithms to implementation of industrial-grade drivers and features All content.

The ROS user community builds on a common infrastructure to provide an integration point that provides access to hardware drives Access to dynamic programs, general-purpose robot functions, development tools, useful external libraries, etc. In addition, the dynamic ROS community has evolved over the past few years to include large-scale use communities Worldwide. historically See, most Hu applications are in the research laboratory, but more and more see its wide application in the commercial field, especially in the industry and service robotics.

ROS itself provides a lot of value for most robotics projects, but it also provides a lot of value with ROS The opportunity for world-class robotics experts in the zone to connect and collaborate.

One of ROS nucleus core philosophy is the public module sharing development. Certainly, this invention system future producer might also consider the AI wisdom Can outside the robot development and the production wraps, or outside the part wraps.

At present, in the market has the very many technical extremely mature producers to be possible to elect Selecting.

[c], select the necessary smart sensor to install in the micro machine. Due to the size limitation of the micro machine, if the smart sensor is produced by custom-made products, it may be able to meet the requirements of the present invention. On the small size of the micro machine body, consider installing a design that can meet the function. Enough smart sensors. But whether this can guarantee the performance of its work, including accurate response functions, conversion between functions, integration execution between functions and functions, and others, etc.

XIV, all of these require repeated tests during the actual production of the system equipment of the present invention in order to obtain good results.

Therefore, this invention system design two choices. if you can install all the required intelligent sensors in the small size body of a miniature robot, of course, is the best choice. In this selection, the following sensors need to be installed in the miniature robot; AI intelligent photography sensor IMU (Gyro+magnetic+accelerometer integration−starting), Smart infrared sensors Smart distance sensors Smart optical sensors, Smart pressure & sensors. The function of the upper sensor is to ensure that the micromachine can accurately match the user's cylinder, and then lift it up by 3 mm to ensure a certain tightness after the anastomosis to ensure correct infusion. Water enters the user tank. First, at each step of the entire motion process by the AI smart camera sensor, all the motion image data is continuously transmitted to the AI edge computing brain.

Through the eyes of the AI smart camera, plus the brain of dual AI edge computing, IMU sensors are controlled. It starts from the micro-machine “B” and separates from the “butterfly” machine. The location of the user's tank is close, and any obstacles (if any) that may appear in the trajectory of the movement is eliminated during the movement. For example, when a micro machine is close to the user's tank; it is very likely that feces will be removed at this time. It is leaking downwards.

At this time, the IMU sensor will transmit the data in this state to the AI edge computing at high speed. The instructions generated after the high-speed calculation will immediately stop the micro machine from moving, and quickly move to the side Avoid.

After the user's excretion ceases, the IMU sensor will tell the AI edge computing the new data, and proceed to produce new instructions, and the micromachine will continue to match the user's cylinder. At this time, the intelligent infrared sensor and the intelligent distance sensor will determine the timely state between the micro machine and the user's cylinder, including the distance between the two and find the position deviation between the head of the micro machine and the cylinder.,

These data will be transmitted to the AI edge computing at a high speed, and new instructions will be generated to indicate the direction adjustments that microcomputers need to make. In addition, intelligent optics and distance sensors use AI edge computing to control the machine to slowly, kindly and softly and accurately contact the cylinder when the head of the micro machine is ready to match the cylinder. After completion, the head of the machine is lifted. Now, the intelligent pressure sensor uses AI edge computing to control and grasp the pressure produced by the contact between the head of the machine and the cylinder.

This pressure must be controlled to no more than 50 grams. After completing the previous steps, AI edge computing will perform the last data check, and start to make notes after confirming that everything is completely normal. The system of the present invention is designed for micro-machines. This is the “multi-core and multi-threaded” IC designed to be installed on the AI edge of the device, and the AI edge computing (it is also multi-core and multi-threaded) IC that is used in the IoT system to process household data.

According to the software design of the system of the present invention, when the user uses the system equipment of the present invention, this situation perfectly satisfies the first priority program set by the software. Therefore, dual AI edge computing will give priority to the users' various services to provide the highest priority computing and support.

XV, The invention has designed eyes for a micro machine This is two butterfly machines and two attached to it Mini robot; A and 4 smart photographic sensors on. The following_describes in detail the location that needs to be correctly installed in the machine:

[1]. The smart camera sensor is installed in the correct position on the upper side of the machine on the left (double “butterfly”). This location must be able to observe and supervise the entire operation process of the micromachine to the maximum extent, and be able to easily transmit the data produced during the observation and supervision process through various smart sensors installed on the body. Communicate with AI edge computing in a timely manner. It is an intelligent supplement to the micro machine. It supervises and helps the micro machine to accurately perform the set tasks. At the same time, it constantly communicates with the AI edge computing through data in the process to correct and correct the micro machine in operation. The possible deviations in the trajectory. Therefore, this correct position must be most approaches the miniature robot the spot, and this spot cannot have the barrier with the miniature robot between, must be able to carry on the observation clearly. Must test repeatedly in the concrete production process found the best position.

[2]. The right-side (double butterfly) machine, the right position of the top and the left requirement, and two butterfly machines, respectively There's 1,200 mini robot, 1,000 A, and B. So the requirements are basically eloquent. (Please refer to the section of smart camera)

[3]. The present invention designs a “nervous” system for micromachines. Let the micro machines have the same sensory system as the human, it is realized by the various smart sensors installed on the body of the machine of the present invention. These smart sensors will be able to operate during the operation of the system of the present invention.

A large amount of data is produced. These data are obtained by AI edge computing in a timely manner and then produced instructions to help the machine accurately perform various tasks. (Please refer to the “Sensor” chapter) Select the necessary smart sensor to install in the micro machine. Due to the size limitation of the micro machine, if the smart sensor is produced by custom-made products, it may be able to meet the requirements of the present invention. Consider the installation of a design that can satisfy the function on the small size of the micro machine. Enough smart sensors.

[4], but whether this can guarantee the performance of its work, including accurate response functions, conversion between functions, integration execution between functions and functions, and others, etc. All of these require repeated tests during the actual production of the system equipment of the present invention in order to obtain good results. Therefore, the invention system design two choices; If it is possible to install all the intelligent sensors required in micro-machines, it is certainly the best option.

Here, we need to put these sensors below and design them to be installed in mini robot. AI intelligent photographic sensor IMU (Gyro+magnetic+accelerometer+accelerometer+integration+starting,) Smart infrared sensors, Smart distance sensors, Smart optical sensors, Smart pressure & sensors. The function of the upper sensor is to ensure that the micromachine can accurately match the user's cylinder, and then lift it up by 3 mm to ensure a certain tightness after the anastomosis to ensure correct infusion. Water enters the user tank. First, at each step of the entire motion process by the AI smart camera sensor, all the motion image data is continuously transmitted to the AI edge computing brain. Through the eyes of the AI smart camera and the brain of dual AI edge computing, IMU sensors are controlled.

It starts from the micro machine “B” and separates from the “butterfly” machine, and uses the position of the cylinder is close, and any obstacles (if any) that may appear in the trajectory of the movement are eliminated during the movement. For example: When a micro machine is close to the user's tank, it is likely that the feces are leaking downwards currently. At this time, the IMU sensor will transmit the data in this state to the AI edge computing at high speed.

[5], the completed command will immediately stop the microcomputer from moving, and quickly avoid it to the side. After the user's excretion ceases, the IMU sensor will tell the AI edge computing the new data, and proceed to produce new instructions, and the micromachine will continue to match the user's cylinder.

Currently, the intelligent infrared sensor and the intelligent distance sensor will determine the timely state between the micro machine and the user's cylinder, including the distance between the two, and find the position deviation between the head of the micro machine and the cylinder., These data will be transmitted to the AI edge computing at a high speed, and new instructions will be generated to indicate the direction adjustments that microcomputers need to make. In addition, intelligent optics and distance sensors use AI edge computing to control the machine to slowly, kindly and softly and accurately contact the cylinder when the head of the micro machine is ready to match the cylinder. After completion, the head of the machine is lifted. At present, the intelligent pressure sensor uses AI edge computing to control and grasp the pressure produced by the contact between the head of the machine and the cylinder. This pressure must be controlled to no more than 50 grams. After completing the previous steps, AI edge computing will perform the last data check, and start to make notes after confirming that everything is completely normal.

XVI, the following indicators can help achieve the right choice

[a], IMU technology: IMU is primarily used to measure the direction and gravity of velocity in equipment. The earliest IM Us with two sensor types appeared, this IMU consists of an accelerometer and a gyroscope. Typically, two to two per sensor define three for the x, y, and z axes degrees of freedom, combined with two sensors, will reach a total of four to six degrees of freedom. The acceleration value obtained from the accelerometer and the gyroscope the velocity is saved separately, and two sensor measurements can be obtained.

So, two data can be calibrated for a more accurate loss out of the data. The advantage of using this type of IMU is that it is not disturbed by the surrounding external magnetic field. Generally, all the values measured on three different axes are obtained in three axes, and a total of 9 DOF can be obtained. Magnetometer is used for measuring the amount is tilted and rotated, so it can be calibrated to the gyroscope data and improve the problem of large drift. This type of sensor is suitable for dynamic when calculating for short-term and long-term, drift errors are less likely to occur. The important factors that the system of the present invention needs to consider when choosing IMU, these factors it is produced by the results that must be achieved, and then the consideration depends on the final usage and tolerances.

[b]. New IMU: Three types of sensor combinations. The new IMU used in the system of the present invention is composed of accelerometer, gyroscope and magnet.

[c], Package size: the IMU sensor is selected for the application system of the present invention, and the customized and designed sensor package must be small and light in weight to adapt to the various application characteristics of the application system of the present invention. For example: the smart phone products used by ordinary consumers and the smart baseball track trajectory uses to measure the are the preferred small-scale IMU sensor embedded in a small space, and mobile applications usually use the IMU know as M EMS sensor in the industry.

[d]. Accuracy of data transmission: As we all know, gyroscopes have drifting errors for a long time, but accelerometers have made positive improvements based on the object's translational acceleration or rapid rotation. For example, use Kalman to calibrate the filtering data of the accelerometer and gyroscope. Some applications only require a certain range of measurement values, so they can tolerate a certain threshold.

[e]. Response rate: A good sensor should have a fast response speed. For example, a sensor with a sampling rate of 50 Hz should complete every second sampling the sample under measurement 50 times. Most devices need to have a higher response rate to handle sports applications. They are in the preliminary during verification, the normal frequency range before the next evaluation is 1 Hz to 50 Hz. Some advanced applications, such as vehicle navigation, may require a higher response rate of up to 200 Hz to ensure timely and accurate data capture according to.

[f], degrees of freedom: Degrees of freedom (DOF) determine the independent parameters in the system. There are many IMU sensors available on the market, may vary from two degrees of freedom to nine degrees of freedom, depending on the sensor contained in the IMU and what the sensor will measure the number of axes of the quantity. Similarly, the overall degree of freedom may vary based on application usage and functional requirements. Tracking from Location in terms of degree, most applications will be 6-DOF for two-sensor type IM Us or 9-DOF for three-sensor type IM Us. A DOF number represents the measurement of x, the y and z axes of each sensor. Generally, the higher the number of degrees of freedom, the greater the number of degrees of freedom More data is sampled. Introduced in the application system of the present invention, the specific design of the sensor is fully considered, and various functional characteristics meet the requirements of the system of the present invention and IoT feature requirements. Also need to pay special attention, different IMU types, regardless of accelerometer-gyroscope IMU or accelerometer+gyroscope+magnetometer IMU. These will have their advantages and disadvantages. When the application system of the present invention adopts the IMU, it needs to take advantage of these differences and be correct.

The above all require the technology of the future manufacturer, the technology of different, repeated tests to test it. Today IMU is widely used in industrial and human daily life, and most market applications in IMU have corrected the resulting sensing measurement deviation caused by a significant error in the data. This is due to the development and progress of IMU technology, in order to have better sensory measurements, and make it more in line with the application of the present invention purpose, at the same time reach the cost of inventing the absolute improvement of users' happiness in life.

Data Transmission

I. The sensor network designed by the system of the present invention can use wired and wireless transmission methods for sensors and their peripheral electronics Data transmission of the device. In addition, the user in the use of the present invention, due to the use of each person's habits, or preferences vary, the system equipment of the present invention and a variety of electronic devices of IoT devices its sensors will produce a large amount of data, the collection and transmission of these data in the following description is referred to as “user data.”

II. The smart sensor of the device of the present invention and the IoT device will need the correct transmission technology for the data stream generated at all times. Regular picking Collecting the data stream of sensors is an important task. For the transmission of user data streams, the receiving system needs to have different transmission cycles. The exchange of data streams from the same sensor will be carried out periodically.

For example: using AI edge computing to avoid data transmission during peak periods (to reduce the use of Cost) to the distributed cloud and the central cloud, and even directly store the user's important privacy data in the device of the invention without transmitting it, Thereby, the maximum security and protection of user privacy can be achieved. If you need to use a wireless sensor network, you can consider using It is constructed with a standard “spoke” or “star” topology. Since the sensors are distributed in the area of each application device, it can be considered the “multi-hop wireless topology” is applied within the home range of the individual, in which data is transferred between sensor nodes before reaching the AI edge computing.

Transfer in steps. Sensor nodes have three functions in the network of the present invention:

[1]. Collect information from sensors.

[2]. Connect via a wireless network or direct link Sensor data is transmitted to AI edge computing.

[3]. Sensor data is relayed from other sensor nodes to the AI side through the network or direct link AI edge computing. Edge calculation. Each sensor node is composed of simple components that help achieve its basic goal: low-power batteries or it has a power supply, as well as a microcontroller, an electrical circuit that links the microcontroller to the sensor and power supply, and a wireless communication that is used to facilitate network communication.

Line data exchange.

III. The grid coordinator is designed to be used in the system of the present invention with great significance: the user data is transmitted to the Ram of the AI smart center of AI edge computing and IoT through the sensor network with the use of the grid coordinator.

The grid coordinator can collect data from the distributed sensors and control the activities of the sensors, and the grid coordinator can transmit the data through the sensor network to the Ram of the AI intelligence center of AI edge computing and IoT, which is bidirectional. The network coordinator can collect data from distributed sensors and control the activities of the sensors. Because the network coordinator is used in a sensor network, it provides a wireless sensor network WSN that can improve transmission performance and prevent data loss.

The coordinator works in a sensor network WSN environment; it scans and sends beacons, and stores the information in the beacons. The coordinator works in the sensor network WSN environment: scans and sends beacons and stores information on the channels included in the beacons: and determines, based on the information on the channels, that the home channel communicating with the node is inactive.

[a], When the home channel is determined to be in inactive mode based on the information on the channel, another channel at the same level as the home channel is activated is synchronized to activate an attribution channel to communicate with sub node, and the sub node is communicated with via the sub node channel. The sub-channel communicates with the sub-node through a sub-channel whose frequency band is different from the frequency band of the home channel in which the sub-node communicates with other sub-channels of the sub-node. It is always in active mode. It uses a spatially dispersed group of sensors to monitor environmental changes in the area defined by the system of the present invention. It uses spatially dispersed groups of sensors to monitor environmental changes in the area defined by the system.

[b], The WSN consists of individual nodes that can be linked to the various sensors of the invention to The WSN consists of individual nodes that can be linked to the various sensors of the invention to collect data from the user's environment about temperature changes, sound, pollution levels, temperature, flammability, and the time index of the user in using the various functions of the invention. The sensor nodes are linked to other nearby sensors in the network. The sensor nodes communicate with other nearby nodes in the network to facilitate sensor data transmission in a cooperative manner, and link to other nodes in the network. The sensor nodes communicate with other nearby nodes in the network to facilitate sensor data transmission in a cooperative manner and link to the system to receive sensor data from the AI edge computing and the AI intelligence center of the IoT's Ram, which is used in the non-high-volume period to transfer this data to the IoT. These data are transferred only during non-peak periods to, e.g. private clouds, public clouds, etc.

WSN acts as a relay station between data transfer to AI edge computing in each sensor node. In many of WSN's implementations, most sensor nodes are completely within the range of wireless link signal reception of the present invention: WSN relies on signal relay and network It nodes the collaboration to transmit consumer data and IoT device data to AI Edge Computing and IoT AI Intelligence Center.

[c], In addition, each sensor node in the WSN acts as a relay station for other sensor nodes in the network. Another form is: large Most sensor nodes are completely within or outside the wireless link range of AI Edge Computing and IoT's AI Intelligence Center: at this time, only rely entirely on the cooperation of the working signal relay and other nodes in the network to transmit its data. Therefore, AI Edge Computing and IoT AI Intelligence Center can receive data from completely different regions, and signal relaying enables AI Edge Computing and IoT AI Intelligence Center Ability to collect data that is not accessible with WSN. Like many smart devices, the increase in the use of the present invention is bound to produce extremes large amount of data.

Therefore, a scalable data processing platform is required to complete these huge data flow work, and the cloud is the hosting of the present invention Ideal platform for data processing applications. Delivered over the Internet, you can choose to use Platform as a Service (Paas), the “base shelf.” Service as a Service (laaS), and Software as a Service (SaaS). Compute nodes are dynamically configured and reconfigured in the cloud and can be picked in the form of a virtual machine or physical machine. The purpose of this setting is to enable sensor-based applications to be able to host private Benefit from cloud environments and public cloud services. To which of the above three services should ultimately be used. The interests of users should be the first priority, and the factors that must be considered are: Long-term price (including actual and potential costs), best experience (agility and accuracy of service), future development and upgrade (maintenance of capacity) Easy to transport, stable), etc. These require repeated tests in specific practice to get answers.

IV. User data will be sent to the cloud as event streams. Before storing the data, it is important to process the data as streams to Ensure real-time processing. Processing events from a single source in parallel helps reduce latency in most applications. Linking Large Numbers of Devices The ability to link many devices creates a need for scalable infrastructure to handle data. Instead, distributed event processing engines (DSPEs) have become an option.

An option exists in the present invention. DSPEs abstract event delivery, propagation, and processing semantics, greatly simplifying the development of real-time algorithms. It can also act as a messaging structure. It also acts as a messaging structure.

After data processing, the data is distributed to other data receivers (e.g., databases and file systems) for batch processing and archiving. The invention requires a cloud-based, data-intensive computing architecture that combines stream-based real-time and batch analytics to form a rich infrastructure for sensor applications.

A rich infrastructure for sensor applications. This is a cloud-based DIKW-(Data, Information, Knowledge, and Wisdom) architecture for It is based on the cloud DIKW (Data, Information, Knowledge, and Wisdom) architecture for sensor data analysis in the cloud.

Using the DIKW architecture, data enters the processing pipeline through the DSPE layer. Stream analysis and batch processing The DIKW architecture is a combination of streaming analysis and batch processing, evolving the data model and transitioning from raw data to decision making. The storage layer serves as the glue between batch and stream analysis. The storage layer acts as a glue between batch and stream analysis.

V. (SSLv3.0 & TLS) SSL file transfer or FTP-SSL is one of the protocols supported by the JSCAPE hosted file transfer server. The SSL authentication used by the system of the present invention for user data transmission; it is the public key of a server.

The public key has a pair The corresponding private key, which is stored on the server. This pair of keys is responsible for encrypting the session, and the session key is responsible for encrypting Data exchanged via FTPS connection.

[a], Since encryption makes the information unreadable, any attempt to control the data during transmission Attackers will not be able to read, tamper with or make unauthorized changes to the content. Therefore, even if the file must be the content of an overly insecure network (such as the Internet) can be kept secure when it is sent via SSL file transmission. An A full set of socket layer (SSL) connections are used to send encrypted data from the client AI edge computing and AI intelligence of IoT to the web server. Before the server, first use the certificate for identity verification. SSL terminal is a form of SSL offloading, which removes part of the responsibility from the Web The server is transferred to the AI intelligence center of AI edge computing and IoT.

[b], SSL termination works by intercepting encrypted traffic on servers that receive data from SSL connections. It is decrypted and verified not the same data on the device to help the server, so the server does not need to handle the process. SSL termination acts as the end of the line or SSL connection the termination point. This process prepares data for the server and organizes inbound connections to allow the Web server to focus on other tasks, such as adding The carrier network page. SSL termination allows servers with SSL connections to handle a large number of simultaneous connections, sessions, or cookies. SSL terminates back You can improve the performance of your site and Web applications by speeding up your servers. It does decryption by performing it on a separate device to ensure accuracy. SSL (secure socket layer) and TLS (transport layer security) are very similar in many ways.

They Protect data privacy with dynamic data encryption; Provide server and (optional) customer-side authentication;

Use message verification code checking Check the integrity of the message, and perform a preliminary handshake process in which two communicating parties negotiate a common cipher suite. The similarity between the first version of TLS (TLS 1.0) and the last version of SSL (SSL 3.0) is closest. TLS v 1.0 is generally considered SSL v 3.1. The former can even downgrade the connection in progress to SSL 3. Not in TLS There are no corticate error alerts In SSLv3.0, whenever the server requests a certificate for physical verification, the customer certificate is required, When possible.

[c], The customer side usually responds with no corticate alert message. In TLS, this alert is no longer required. But The customer side must (especially in TLS 1.2-RFC 5246) send a certificate that does not contain a certificate. TLS uses HMAC in Row message authentication SSL performs a message integrity check by using the message authentication code (MAC) of MD5 or SHA (to determine if the message is changed). TLS, on the other hand, uses H MAC so that it can use a variety of hash functions.

It's not just M D5 and SHA. TLS uses a pseudo-random function to create keying material, and TLS uses a pseudo-random function (PRF) based on HMAC. SSL does not. TLS has a simpler way to reach the Corticate Verify message. If the server requests a client certificate (to verify the client's identity), the client should send a follow-up message sometime after the certificate message (containing the client's certificate message) is sent. In the case of TLSv1.2, the client should send a follow-up message sometime after the certificate message (Containing the client's certificate) is sent. In TLSv1.2, this message must be sent immediately after the Client Key Exchange message. This follow-up message is called a Certificate Verify message, which will allow the server to verify that the client certificate originated from the actual client and not from an impostor.

[d], The This Corticate Verify message is actually a signature of a previous handshake message signed with the corresponding private key of the client certificate. Because the server already has the corresponding public key (along with the earlier client certificate), it can verify the signature. In TLS, everything needed to construct a Certificate Verify message can be found in the previous handshake message. The situation in SSL is different. In addition to the handshake message, SSL requires a master key and some other values (called pad_1 and pad_2). The data is very private information. The two options presented above are the best possible choices available in the market today. Which one should be used in the system of the invention will need? to be tested repeatedly in practice. The best results will need to be tested in practice.

The infrared camera on the water injector (mini robots) is then modified In the coordination of the three infrared cameras; accurate with the user.) The mole matches the butt, and then the clean water is injected.

I, Ring flushing ring; (each component requires a ceramic (ceramic) non-stick coating with a thickness of 2 mm) Its function is to accurately follow the instructions of the software, the amount of clean drinking water injected into the organ to monitor, for example, the software design is:

The first injection amount is 150 ml (150 g), mainly on feces and rectum. II, the note word head of the ball designed to be on the top of the ball, with a double layer of two layers, one of the internal and external layers;

Sensors and infrared micro-3D cameras, whose design requires the following functions.

[a], MPU-9250 System-in-Package (SiP) Its main function is to track the dynamic changes of the user's anal position in a timely manner. Calculate and analyze the data, and tell the results to the software designed for this purpose.

The software will adjust the movement of the sphere up, down, left, and right to ensure that it accurately fits the anus.

[b]. The 3D anal position graphics obtained by the infrared micro 3D camera are simultaneously transmitted to the cloud computing and the smart center at high speed. The specially designed 3D graphics software will perform high-speed calculation and analysis at the right time, and continuously issue position adjustment instructions. Make sure that the ball fits the user's anus accurately.

[c]. Distance sensor, which continuously transmits the distance data between the top of the sphere and the anus through arduino&5G and transmit it to cloud computing and smart center. After high-speed calculation and analysis, it is provided to the specially designed software, and the software controls it. Accurate work.

[d], pressure sensor, when the top of the sphere fits with the anus, the pressure sensor will transmit the pressure data obtained to the cloud computing and intelligent center in time, and the specially designed software will automatically move according to the design requirements The pouring hair gives instructions, and automatically pouring the water according to its instructions. The head slowly and vertically sticks out into the anal area. Pay attention, The pouring head keeps unceasingly yearning to overflow the filtered drinking water when it comes out of the cabin. The water head is very smooth when it slowly enters the user's organs.

In addition, its diameter is only 1 cm. The user's feeling is very small, because it is smaller than the smallest feces diameter.

Under the lubrication of water, the user feels comfortable, especially when the user's feces cause a huge swelling feeling in the intestines, the internal urgency cannot be excreted, which is very painful for people? At this time, a small amount of drinking water is injected into the lubrication produced by it, and the feces and water are discharged vertically in an instant, and it is smooth and non-stop. The pressure sensor has been monitoring the pressure changes produced by the user's organs throughout the entire process. Its software is designed to ensure that the pressure in the user's organs do not change.

A small amount of drinking water is injected to help the user get a smooth excretion process. Pressure monitoring is a very important link. We always add the minimum pressure to the user's organs to ensure that it will never exceed the pressure of the human body. The stool produces pressure in the intestines to ensure its safe use. Production requirements: Previously, there were four main types of pressure transmitters:

absolute pressure, gauge pressure, differential pressure and multivariable. It is necessary to select an excellent and reputable sensor manufacturer for customization. Since the present invention requires the use of a miniature pressure sensor, its operation is required to be accurate and sensitive.

Therefore, it is necessary to conduct repeated tests during production and use a variety of different pressure sensors to achieve the best results in order to meet the requirements. [e], injector head, it is designed to be made of grade 326 stainless steel, and it is required to be coated with a ceramic non-stick coating with a thickness of 2 mm. After the sphere and the organs are accurately anastomosed, the injection head will slowly extend, and at the same time, it will continuously overflow the clean filter water with a water pressure of 20 psi. The water temperature in winter is between 40 F and 42 F.

In summer, the water temperature is between 30 F and 34 F (the user can choose it). Under the lubrication of water, slowly extend into the organ's surface, and the height (depth) into the organ is 1 cm. Then start to design the time program according to the software. The first time you can only inject 100 ml of water, the second time you can only inject 200 ml of water, the third time you can use 250 ml of water, and the fourth time you can inject water for 250 ml. 300 ml, this can ensure that the clean water can only reach the user's rectal abdominal stool. Of course, users can choose their own favorites and repeatedly clean their own stools.

[1]. On the left side of the opposite barrel (the right side when viewed from the back of the barrel) is designed a closed cabin of 3′*width 5′*high 2′, and its main function is to store the “sex organ cleaner”. On the top of this airtight cabin, there are two sprinklers that can be extended outwards (from the wall of the barrel to the middle of the barrel).

The extension is 1 cm, and it will be retracted automatically after the genital washer finishes its work. In the airtight cabin, the job of the two nozzles is to clean the sex organ cleaner for one minute. After completion, the airtight cabin is closed, and the two nozzles start to fill the airtight cabin with water until the cleaner is completely submerged. The two nozzles are controlled by sensors. The sensors are connected to cloud computing and human intelligence through arduino&5G. The software controls every step of the entire confined cabin. After the user completes his tasks, the application sensor designed and installed in the barrel passes the airtight compartment controlled by the software is automatically opened, and the sex organ cleaning device extends from the inside to the outside, and after it is accurately matched with the sex organ, the whole cleaning process is started.

[2]. On the opposite side of the barrel, facing the wall-type water tank, there is an anal auto-injector airtight compartment designed to be located between the annular flushing ring and the built-in barrel., Is a cabin of 20 cm*width 8 cm*height 8 mm. At the position facing the built-in barrel, it is designed with a sealed airtight. When it is closed, it perfectly integrates with the inner surface of the built-in barrel. The design has two spray heads. When the auto injector is completed and enters the cabin, the two spray heads can be automatically extended (0.5 cm) to clean the injector for one minute, The cabin is closed after the cleaning is completed. At this time, the two spray heads start to inject water containing BLEACH until the automatic syringe is completely submerged and then stops.

Two sprinklers are connected to the outlet of the BLEACH water tank designed on the wall of the water tank (the three cabins and six sprinklers are all connected to the outlet of the BLEACH water tank).

Butt cleaning system; (each component is required to be coated with a 2 mm thick ceramic nonstick coating) The butt cleaning system is designed as a stainless-steel spray bar that is slightly curved upwards.

After the butt cleaning system connected to the wall water box, after the user has completed the excretion, a pressure water mist of 25 psi-40 psi is sprayed to clean the user's butt. It moves back and forth repeatedly (usually 5 times, of course, the user can choose the cleaning method he likes.), spraying pressure water vertically upwards can clean the user's buttocks in a very short time.

I, in its non-working time, it is designed, and the stainless-steel rod of the buttock system is hidden together on the right side of the barrel, and a closed channel (2.5″*width 8.5″*1″) and long The barrel body is combined into a whole, and the airtight surface is a cleaning tank. The two functional stainless-steel rods are immersed in water containing 0.5% Bleach when they are not in operation and are closed during operation. When it is turned on, the water in the cleaning pool flows to the bottom of the bucket. It starts to work, and when its work is completed, it will automatically return to the cleaning pool, and then closed. It is specially designed to contain 0.2% BLEACH The clean water is automatically overflowed under the instructions of cloud computing and human intelligence, and the stainless-steel rod is soaked in the surface for future use.

II, the two inlets are designed on both sides of the barrel shell, and the positions are exactly the same as the filter. The inlet window is designed as a stripe from diagonally downward to the back and front, and its shape and size are the same as the filter core.

III, the buttock system. It is designed as a stainless-steel rod that is slightly curved upwards. The filter passes through the pressure pump to produce 50 psi pressure air, which will repeatedly move back and forth during operation, and spray the pressure body vertically upward, which can reduce the user's pressure in a very short period. Butt length. Specially designed stainless-steel rod: It has a length of 7.5 inches and a diameter of 8 mm. It is designed to be hidden on the right side of the barrel during its non-working time, and it is sealed (20 mm*long) 2 cm″) is combined with the barrel body as a whole.

Wireless Sensor Network

I. Among the various sensors used in the system of the present invention, each BSN sensor collects data from the user's environment during operation. according to. Sensor data may be related to different sensing parameters such as temperature, pressure, chemical composition, acoustic signal, photoelectric signal, distance, etc.

As mentioned earlier, each BSN is in the range of at least one DRN. BSN uses the most recent DRN to register. Subsequently, BSN Its information is periodically transmitted to DRN. When corresponding instructions are issued from the command center, DRN can also poll them. In practice, it is possible to detect the temperature, water pressure, and amount of injection of each person in the application process of the present invention and use the injection at a constant speed. Time, personalized preferences, and pressure requirements during the time, and the time is short.

The software indicates that multiple sensors are positioned so that therefore, the sensor can record relevant data during the application process. Such as magnetometer, Accelerator, gyroscope, and others How does the smart sensor combination use the micro-manipulator to perform accurate actions as specified in the software text, gently and gradually Physically couple the user's anus and inject the drinking water slowly. The mini robot is designed to have a built-in hollow for the installation of water pipes and various smart sensor link lines. A variety of smart sensors are designed Installed on the head of a micro machine; including smart image sensor, smart pressure sensor, smart infrared sensor, smart acoustics Data sensor, and any other type of sensor capable of measuring any potential course indication.

[a], The data generated by the sensor will automatically reflect the various specific conditions of the user during the excretion process, and these conditions data are intelligently used by AI. After the image processor and AI edge computing are obtained, high-speed calculations are performed, and the entire AI intelligent system will be compared to the system software design text, and then issue instructions to instruct the micro-machine to perform accurately. The data produced by these smart sensors can be used to supplement and support data from magnetometers, gyroscopes, and accelerometers, or as a substitute for generation. In some cases: all these smart sensor data can be stored on non-volatile memory storage devices (for example: IoT AI smart terminal) and analyze it after the delay time. The smart sensor installed on the head of the micro machine will transmit the data produced in time to the AI edge computing. Quickly calculate the generated instructions, and further instruct the micro-machine to accurately and gently couple to the user's anus, and then push it up 3 cm, The goal is to be able to achieve a basic tight anastomosis and start to inject drinking water into the anus. For example, it can also be achieved by detecting that the motor “accelerometer” is physically coupled to the user's anus.

[b], Therefore, by accelerating Under the guidance of AI smart image sensor and AI edge computing, the smart sensor, which is a combination of the three, the magnetometer, and the gyroscope, Commands are issued through the AI neural network to guide the micro-machines to perform accurate operations. Accelerometers have been used in a wide variety of work environments and have demonstrated their reliable utility.

Accelerometers include many measurement indicators. For example, accelerometers are inertial sensors that can measure on one, two, or three orthogonal axes. Accelerometers can collect inertial measurements of velocity and target position, as well as two- and three-dimensional perceived tilt or orientation. Thus, these Smart sensors can therefore be used to collect drift and other motor weaknesses by measuring the speed, orientation, and tilt of the miniature machine during operation, and so on. Drift and other motor weaknesses are collected during operation, as well as all data related to this. Thus, the accelerometer may include motor response data, orientation data, target position data, distance data, etc., and include a combination thereof. In addition, new accelerometers, magnetometers and gyroscopes are available.

In addition, the new three-in-one smart sensor with accelerometer, magnetometer and gyroscope is perfect for various target tracking tasks. Gyroscope The gyroscope sensor detects and safeguards the directional changes of the miniature robot during operation, detects possible obstacles on the track, and improves internal rotation.

The gyroscope detects and safeguards the directional changes of the miniature robot during operation, detects possible obstacles on the track, and improves the accuracy of internal rotation measurements.

The smart camera used in the system design of the present invention can detect, identify and track the designed target at high speed; even if the user's anus, The camera can distinguish and recognize objects in the field of view according to the text of the system software of the present invention, and automatically and accurately track the designed target (Anal), and excretion of feces that may be in labor.

The core of smart cameras is INTEL MOVIDIUS VISION Processor unit. This is a low-cost smart processor. Can achieve depth on any mobile device, as well as other devices Learning application environment, a new generation of AI core with high parallel structure, its birth is promoting real-time visual life, installation Face recognition can be done on smart devices. Displays the AI analysis sensor data during the entire operation process to determine the user's An action command issued after leaking the potential use characteristics of the time. For example: devices include smart sensors used to associate moving objects The input channel 001 of the devices receiving data from the sensor or sensor, and the processor 01c on the coupling input channel 001, The analysis module 02G is shown coupled to processor.

[c]. Analysis module 02G is shown coupled to processor c. Analysis module 02G may be resident on processor 01c or performed by processor 01c as a separate data analysis process. The analysis module 02G may be a separate data analysis process residing on processor 01c or performed by processor 01c, using a program or instruction set or part thereof, or any other analysis implementation of a data evaluation algorithm. Analysis Module The analysis module 02G may identify potential stroke indicators in the data set received from input channel 001 in conjunction with processor 01c, and may further identify potential stroke indicators in the data set received from input channel 001.

The analysis module 02G can identify potential stroke indicators in the data set received from input channel 001 in conjunction with processor 01c, and can further determine the stroke conditions that are implied by the potential stroke indicators.

Memory 01m can be coupled to processor 01c and used to send the user's data to the processor. The memory 01m can be coupled to the processor 01c and used to send the various usage conditions generated by the user while using the invention. The output channel 1a of the status notification 102 can be coupled to the processor and/or analysis module 01c. In addition, it is understood that the preceding is only an example of an explanation, as the development of AI smart technology is new and changing.

[d] The real market situation of AI intelligent computing at the time the patent for the invention was granted is very difficult to predict. It would be unfair to the future consumers of the invention to limit the specific settings of AI intelligence and ICs now, because These consumer groups have the right to achieve the greatest happiness in life today with the development of technology. Therefore, the present invention is not limited and can be implemented Therefore, the present invention does not limit and can implement many different AI smart IC designs, each of which should be included in the scope of protection of the present invention. In addition, in some general use cases, the device may include a device that is configured to be used as a smart device.

In some general use cases, the device may include a circuit configured to receive data from an intelligent sensor or associated sensor using an input channel, a processor that uses AI edge computing to identify the sensor or associated sensor, and a processor that uses AI edge computing to identify the sensor or associated sensor. The AI edge computing processor is used to identify potential stroke indicators from said data, and the AI edge computing processor also determines potential stroke indicators.

The AI edge computing processor also determines the potential stroke indicator and the stroke status it indicates, and uses the output channel to send data on the various conditions of the potential users of the process using the invention.

[e], The AI edge computing processor also determines the process status of the potential process indicator and uses the output channel to send the potential user various status data for the process of the invention. In some example systems, instructions may be embodied in a non-transitory machine-readable storage medium i.e., an AI edge computing or IoT AI smart endpoint). In some example systems, instructions may be embodied on a non-transitory machine-readable storage medium (i.e., memory M of AI smart terminals for AI edge computing or IoT) that is instructed to execute the individualized needs of the users for which the system of the invention is intended, as well as the potential special needs conditions.

The FGCI can also be used to address the individual needs of the users of the inventive system, as well as potentially specific demand conditions. A specific example: when the instruction is executed so that the AI edge computing system is obtained through the input channel, positioned from the system of the present invention as the device is being used; multiple smart sensors that are collecting data receive the data stream and use an AI edge computing processor The data is presidio's AI intelligent terminal analysis module identifies indicators for potential user personalized needs.

Then, the AI edge computing processor and analysis module determines the user uses the personalized program indicator of the system device of the present invention, and the positive process indicator is used to determine the user uses the personalized program indicator of the system device of the present invention. Whether it appears or not during the process, and the specific state of use. And the state data of the potential use of the process is carried out the output channel is transmitted to the IoT's AI intelligent terminal storage.

[f], The input channel can be designed according to the device or system, the mobility of the subject, and the diversity of the nature of the input data. from wisdom Can sensor to microprocessor across links, and so on. Can be physical, wired or wireless, or Bluetooth, optical connection cellular connections, and so on. Include its combination. Note: In some specific examples, the input channel is wirelessly connected Fits into the smart sensor. In other concrete examples, the input channel is connected to the smart sensor via a Bluetooth connection. Other than that, the output channel can also be considered according to the device or system design, according to the subject's general use of special mobility, output notification number changes in other device outputs.

In one example, the output channel can send a notification directly at the system device of the present invention, for example, it can be checked by the device nearby Measured movement of people, changes in the perception of light, the properties of sound, or another general knowledge. In other examples, the output channel passes by wired or Wireless connectivity notifies AI smart terminals that send AI edge computing or IoT, and then transfers them to remotely distributed clouds and central cloud devices. not Wired connections should include any connections that can deliver notifications.

Non-restrictive examples include wireless network connectivity, Bluetooth connectivity, and optical science Connection, cellular connection. Cross-connections calculated from smart sensors to AI edges can be physical links, or wireless connections, Bluetooth connections optical connections, and so on, including any other combination. Notifications can be sent to multiple destinations as needed, so they are connected A combination of types can include a Bluetooth connection to one destination for a cellular call to another destination, or an optical connection, physical connectivity, wireless connectivity, and so on. This includes, of course, wired and wireless connections, as well as any other connection types.

It should also be Including the present invention system equipment during use of visual and auditory notifications. In some specific examples: the output channel passes through blue Tooth connections send notifications, while in other specific examples, output channels deliver notifications over cellular connections.

II, As mentioned above, various smart sensors can be used in conjunction with the technology of the system of the present invention, and the types of data can be analyzed. Similarly, it is diverse.

Non-restrictive examples of data types can include accelerometer data, magnetometer data, and gyroscope data.

[a], Temperature control sensor data, pressure sensor data, image data, acoustic data, electrical data, etc., should also include its combination.

Electrical data can include any type of data related to the electrical activity of derivatives, including but not limited to electromyography (EMG) data, pressure data, electrical (ED) data, etc., and include their combination. Acoustic data can include the user in the process of enjoying the application of the system of the present invention (excretion) the sound produced by it, or the data produced by the interaction of the sound, for example:

The user communicates with the voice of the AI intelligent voice system. Image data may include any type of data obtained using AI intelligence (camera) sensors, such as, but not limited to, face image data, body image data, 3D body position data, and combinations thereof. Image data can include any type of data obtained using AI intelligence (camera) sensors, such as, but not limited to, face image data, body image data, 3D body position data, etc., and combinations thereof.

The various system examples described herein can typically include a cluster of AI intelligent processors in communication with memory, input channels, and output channels. As the terminology used herein, the processors may as used herein, the processor may include one or more AI intelligent processors, such as: a dedicated processor for AI edge computing and AI intelligent endpoints for IoT or any other AI-intelligent processor.

As used in the term, the processor may include one or more AI intelligent processors, such as specialized processors for AI edge computing and AI smart terminals for IoT or any other AI type of high-end processor. The system of the invention uses an integrated sensor “hub” (ISH) processor. The ISH processor enables highly efficient, continuous data acquisition and analysis with lower power consumption.

[b], The ISH processor enables highly efficient, continuous data acquisition and analysis with low power consumption.

The memory can include any device, combination of devices, combinational circuitry, etc., capable of storing, accessing, organizing, and/or retrieving data. Non-limiting examples include SANs (storage area networks), cloud storage networks, volatile or non-volatile storage networks, and cloud storage networks.

Non-limiting examples include SANs (storage area networks), cloud storage networks, volatile or non-volatile RAM, phase change storage, optical media, hard drive type media, etc., including combinations thereof. IV. The system should also include local and remote communication interfaces for linking between the various components of a given system. For example, local communications the interface may be a local data bus and/or any associated address or control bus, the remote is similar, as desired.

System It may also include an I/O (output/input) interface, I/O functions for the control system, and I/O connections to external devices of the system, also May include a network interface which is used for network connection, the network interface can control network communication within the system and outside the system, the network interface can control network communication within the system and outside the system. Interface may include a wired interface, a wireless interface, a blue tooth interface, an optical interface, etc., including an appropriate combination thereof. In addition, the system may additionally include a user interface, a display device, and various other components of the system of the present invention are beneficial.

III. In one example, when drN receives its information from a registered sensor of the present invention, it performs data aggregation and information aggregation task. This process consists of the following actions.

DRN continuously receives readings from its registered sensors. However, it processes this information and aggregate it into one or more properties.

For example, it receives from a sub sensory for a period of time called an “induction interval.” Multiple temperature readings. During this time, each sensor Si may have a reported set of readings during the sensing cycle number j. DRN can calculate the average of all elements in the collection in period j. According to the design specifications selected during network installation, DRN can perform one of the following operations:

[1]. During the sensing period j sends each note the value of the BSN i of the book.

[2]. Calculate and send the average value of all registered BNs in period.

[3]. After calculating the average, DRN can Perform one of the following operations according to the network configuration:

[a]. Send actual value: send the actual current value Vc.

[b]. Send only re-changes: change the calculated value is compared with the reference, and only sent when the difference is greater than the threshold=th or (Vc=Vref)=th. Another aspect of the present invention an external option can be considered, and its function is to retain precious transmission energy, which is a key factor of WSN. but yes, if this strategy is adopted, NCC must periodically update the reference value to DRN.

The structure of the communication data packet of the present invention, every Each transmitted communication data packet has the following fields:

[a]. The data type of the present invention: this byte can support up to 256 different types of Type of data. For example, 00 can be used for temperature, 01 can be used for pressure, and so on.

[b]. Sensing location: This is the geographic location of the sensor The location is determined during the network initialization stage (location and installation are determined according to the specific requirements of the present invention).

[c]. Source sensor address: this word the section contains the address of the source sensor.

[d]. Measured value: This is a two-byte sensing data field, allowing a resolution of up to 216 different the same value.

The general state of communication from DRN to DDN of the sensor of the present invention: The communication between DRN and DDN node uses multi-hop It is completed by an algorithm, which works on the MAC protocol (such as the ZigBee system). The data collected on DDN can be used without the same communication technology is transmitted to the base station as the NCC. This means that different DDNs have different communication capabilities and can receive them. The information of the set is transmitted to the NCC, depending on its location.

IV, for example, a node located in a city can use the available cellular GSM Or GPRS network to send its information. On the other hand, nodes located in remote locations far away from metropolitan areas may not be able to use the standard Cellular communication, or consider using satellite cellular communication.

Another option is to deploy WiMax or other remote wireless network access points at each 30-meter location along a designated area of the pipe. It is possible to Merge the acknowledgement mechanism, where the DDN node sends correct authentication to the sending DRN node after successfully receiving DRN data.

For sensitive data, a positive acknowledgement mechanism should be used. As mentioned earlier, when a DRN prepares to send data collected from its sub-BSN, the DRN node will acknowledge the data by its neighboring DRNs.

When a DRN is ready to send data collected from its sub-BSN, it uses a multichip approach through its neighboring DRNs in order to reach its sub-DDN, which is usually, the closest to it. Multi-hop calculation the multi-hop method follows the addressing scheme described above. Each DRN keeps track of its connections to its neighbors by periodically broadcasting a hello message.

If a connection to the next hop is not available, the DRN can implement either of the two algorithms to solve the problem. Always Jump (JA) algorithm: In order to transmit its DRN data, a DRN can increase its transmission power and double its range in order to reach the first leap, even though it is not connected to its immediate neighbors. If multiple contiguous links are lost, the DRN can increase its transmission range appropriately to bypass broken links. If multiple contiguous links are lost, the DRN can increase its transmission range appropriately to bypass the broken links, and this process can be followed until the maximum transmission power is reached.

If it is not possible to bypass a broken link at maximum transmission power, the message is sent to the DRN. If the broken link cannot be bypassed at maximum transmission power, the message will be discarded. In the protocol, this maximum DRN transmission power is represented by a network variable named “MAX_TX_FACTOR”. Always reset RA algorithm: In this revised routing protocol, the DRN source node sends its DRN data message to its DDN. When the message is forwarded through the intermediate DRN, if it reaches the broken link, the DRN determines whether the data message has been reset to. This is done by checking the redirected token in the message.

V, If the redirect flag has been set, the message will be discarded and send a negative confirmation back to the source. Otherwise, you can send a short redirect message with its ID to notify the source of the redirection. Cheng. The source will then resend the data message in the opposite direction and update its database for this fact. In addition, in order to raise the agreement the efficiency of sending only a short redirect message with ID back to the source. The redirect message also informs other nodes on the side that there is a “dead end” in the direction. Same as “. In this case, each DRN that receives this message will check the redirection flag, and if the flag is set, it will continue to forward messages in the same direction. However, to prevent any loops, if you encounter another broken link in the opposite direction, the redirected message cannot be redirected again. In this case, the message will be discarded.

VII. The wireless node used in the present invention acts as a receiving sensor data and through

a wireless network consisting of multiple WNs transmission to the base station. It uses ZigBee technology to communicate and handles the 2.4 GHz band and OQPSK (offset quad phase shift). Keyed) modulation flow, OQPSK uses a maximum phase transition of 90 degrees. The wireless sensor network of the invention consists of three interconnected the composition of the device. The first is the network coordinator, which maintains the entire network system. The second is a full-featured device that collects sensors Data is sent to the network. The third is a reduced-functional device that acts only as a transceiver on the network. In the system of the invention, WN the power unit of the SP to charge with the help of the SP. The sensor connects to the WN and sends the data to another intermediate WN, however the data is then transmitted to the base radio, which connects to the server through a gateway.

VIII. The basic wireless power set by the present invention is used to collect sensor data from WN. It integrates wireless board, antenna and universal serial A bus (USB) interface board, which is pre-programmed as a low-power network protocol for communication with the deployed WN.

USB interface It is used to transfer data between basic wireless phones and applications running within the borders. The gateway set by the present invention acts as a server and a base The connection between basic wireless lines.

It has pre-loaded network management and data visualization software packages. When the switch is turned on, these programs It will start automatically. It receives data from the basic wireless network and transmits it to the application of the server software. The present invention is provided with Operate and monitor the target server remotely. The server is a bit (.) network software used as a front end.

SQL server is used for collection and storage Data storage backend. The application software can predict and view the slope failure parameters in real time. The minimum system requirements are 120 GB hard disk, 2 GB RAM and application software (.Net and SQL Server or other options). Platinum RTDs are also referred to as PRTDs. They are often available with a 100Ω and 1000Ω resistance at 0° C.

They are referred to as PT100 and PT1000 respectively. Platinum RTDs are used because they offer a near linear response to temperature changes, they are stable and accurate, they provide repeatable responses, and they have a wide temperature range. RTDs are often used in precision applications because of their accuracy and repeatability.

Four-wire is the most accurate, as separate force and sense leads eliminate the effect of wire resistance. The MAX31865 offers a dedicated RTD signal conditioning circuit for each configuration with 15-bit resolution and offers a solution to accelerate designs for both PT100 and PT1000 RTDs. Local temperature sensors can use either analog or digital outputs. Analog outputs can be either voltage or current while digital outputs can be seen in several formats such as I²C, SMBus, 1-Wire®, and Serial Peripheral Interface (SPI). Local temperature sensors sense the temperature on printed circuit boards or the ambient air around it. The MAX31875 is an extremely small local temperature sensor and can be used in multiple applications including battery powered applications. Remote digital temperature sensors work like local temperature sensors by using the physical properties of a transistor.

The difference is the transistor is located away from the sensor chip. Some microprocessors and FPGAs include a bipolar sensing transistor to measure die temperature of the target IC. [A]. Use Febreze Air Effects products use fancy chemical reactions to break down stinky molecules to the point where you can't smell them anymore. The product works well, especially because you don't need to spray it before you go.

The one downside is the scents like “morning herbs and mist” and “clean splash” leave a vaguely chemical scent lingering in your bathroom. Febreze [B]. Use Essential Oils These natural beauties work wonders when combined with rubbing alcohol in a spray bottle. Essential oils come with all sorts of fascinating properties. Take cedar oil, for example. “When the fog rolls in, cedar trees retain anti-fungal properties, The oils can do the same thing right in your bathroom.” Pick your favorite scents (we love lemongrass and jasmine) and say bye-bye to any unpleasant odors. Using this method requires designing a storage warehouse and installing a repair fluid position sensor to tell the user when they should add into The airtight surface is a clean tank. The stainless-steel rod is immersed in water containing

0.2% Bleach when it is not working. When the airtight is turned on, the water in the cleaning pool flows naturally to the bottom of the bucket, it starts to work, and when its work is completed, it will automatically return to the cleaning pool, and then the airtight is closed. It is specially designed to contain the clean water of 0.2% BLEACH is automatically overflowed under the instructions of cloud computing and human intelligence, and the stainless steel rod is soaked in the surface for use.

Sensor's Network & Sensors Data Transmission

I, the sensor network designed by the system of the present invention may be transmitted by wired and wireless means for the sensor and its peripheral electrons data transfer for the device. In addition, when using the present invention, the user may have different habits or preferences due to each person's usage habits the sensors of the system equipment of the invention and various electronic devices of the IoT device will produce a large amount of data, which shall be collected and transmitted “User data” is referred to simply in the following narrative.

II, this invention equipment and the IoT equipment its intelligence sensor can produce every time the data stream needs the correct transmission technology. Picks regularly the collection sensor data stream is an important work. Regarding the user data stream transmission, the receiving system needs to have the different transmission week the time carries on the same sensor data stream the exchange.

For example: Using the AI edge computation, avoids in high the peak time transmission data (Reducing causes with cost) to distribution cloud and control cloud, even does not carry on directly the user important privacy information storage in this invention equipment the transmission from this, may achieve safe and protects the user privacy the maximization.

If needs to use not the line sensor network to wind, may consider causes with standard “spoke” or “Star type” analysis situs construction, because the sensor distributes in each application equipment its region, may consider uses is using in the family scope applies “jumps on the line network shape analysis situs”, in which data in arrives before the AI edge computation between sensor node by many a step carries on the transmission. The sensor node network winds in this invention have three functions:

[1]. from sensor collection information.

[2]. network will wind or the direct link through on the line sensor data transmission to AI edge computation.

[3]. sensor data through network wind or the direct link from another sensor node relay to AI nearby Reason computation.

Each sensor node is composed by the simple module, these modules are helpful in achieve its basic goal: Low power battery or its power source, as well as the micro controller, links the sensor the micro controller and the power source electronic circuit as well as uses in promoting network to wind the correspondence no line electricity data exchange.

A subchannel communicates with a sub node whose frequency band is different from a home channel frequency in which the sub node communicates with other node subchannels strip and is always in active mode. (WSN) wireless sensor network It uses a spatially dispersed sensor group to monitor the system change in the environment of a collectively defined area.

The WSN is composed of a single node that can be linked to various sensors of the invention. Temperature changes, sounds, pollution levels, temperatures, air forces are collected from the user's environment and the user use the invention the time index, etc. of each function.

The sensor node communicates with other nearby nodes in the network in a cooperative manner to facilitate AI edge computation and Ram of AI Intelligence Center of IoT, which are linked to the system receiving sensor data.

These data are transmitted during off-peak periods, for example. private cloud, public cloud, etc.

III, the network coordinator is designed and applied in the system of the invention has important significance: User data under the function of network coordinator, which is transmitted over a sensor network to the AI Edge Computing and IoT's AI Intelligence Center's Ram, which is bidirectional and the network coordinator can be accessed from distributed sensors collect data and control sensor activity. Since the network coordinator acts in a sensor network, it provides a non-state that can improve transmission performance and prevent data loss line sensor network WSN. The work of coordinator in WSN is discussed. Scan and send beacons and store information on the channel included in the beacon:

And when a home channel communicating with a parent node is determined inactive based on information on the channel in the mode, another channel which is the same as the level of the activated home channel is synchronized, and a home channel is activated to communicate with the sub-nodes and communicate with the sub-nodes. At each sensor node, WSN acts as a relay station between data transfers in the network and AI edge calculations. In many implementations of WSN, most sensor nodes are fully within the wireless link signal reception range of the invention: WSN relies on the signal relay and its network its cooperation of nodes to transfer user data and IoT device data to AI edge computing and IoT's AI Intelligence Center. In addition, each sensor node in the WSN acts as a relay station for other sensor nodes in the network.

Another form is: Large most sensor nodes are fully within the wireless link range of AI edge Computing and AI Smart Center of IoT, or outside: relying solely on the cooperation of working signal trunks and other nodes in the network to transmit their data. Therefore, AI edge computing and IoT, AI Smart Center can receive data from completely different regions, signal relay enables AI edge computing and IoT AI Smart Center ability to collect data that is inaccessible using WSN. Like many smart devices; The increase in the use of the invention will certainly, produce the poles large amount of data. Therefore, a scalable data processing platform is needed to complete these vast data streams, and the cloud is hosting the invention ideal platform for data processing applications. Via Internet delivery, you can choose to use Platform as a Service, Infrastructure Structure Service (laaS), and Software Service (SaaS). Computing nodes are dynamically configured and reconfigured in the cloud and can be selected in the form of a virtual machine or a physical machine.

This setting is designed to allow sensor-based applications to host private from within the organization there are cloud environments and public cloud services benefiting. As for the final adoption of one of the three services mentioned above? First priority should be given to the interests of the user, and the factors that must be taken into account are Phase long period price (including real and potential costs), best experience (agility and accuracy of service), future development and upgrades (maintenance) easy to run stable), etc. These require repeated testing in concrete practice to obtain answers.

IV, Consumer data is sent to the cloud as an event stream. Before you store data, it is important to process the data as a stream real-time processing assurance. Handling events from a single source in parallel helps reduce latency in most applications. The link is large the ability to measure devices create a need for a scalable infrastructure to process data. The distributed event processing engine (DSPEs) became an option exists in the present invention. DSPE abstracts event delivery, propagation and processing semantics, greatly simplifying the development of real-time algorithms. It also acts as a message delivery junction frame. After data is processed, the data is distributed to other data receivers, such as databases and file systems, for batching and archiving.

The Invention Requires a Cloud-Based

Data-intensive computing architecture that combines real-time flow-based analysis and batch analysis in one form rich infrastructure for sensor applications. This is a cloud-based DIKW-(data, information, knowledge, and intelligence) architecture for use sensor data analysis in the cloud.

Using the DIKW architecture, data enters the processing pipeline through the DSPE layer. Stream analysis and batch processing combines and evolve data models to transition from raw data to decision making. The storage layer acts as a glue between batch analysis and flow analysis Mixture. V. (SSLv3.0 & TLS) the SSL file transfer or FTP-SSL are one of agreements which the JSCAPE trust file transfer server supports.

[a], This invention system carries on when the user data transmission uses SSL authentication; Is an item of server public key. This public key has rightly should the private key, this private key saves on the server. This is responsible for the key to encrypt the conversation, but converses the key also to be responsible to encrypt through FTPS connection exchange data. Because encrypts causes the information to become cannot read, therefore any tries in the transmission period control data Aggressors all no law read, also no the law interpolation content or carries on to the content without the authorized change. Therefore, even if the document must pass high unsafe network has wound (e.g., Internet), when through SSL file transfer transmission, its content also may maintain the security. Peaceful the entire sleeve joint character level (SSL) connection will be encrypting the data account will carry the AI edge computation and in the IoT AI intelligence from the guest transmits to the Web clothing before service, uses the certificate to carry on the identification authentication first.

The SSL termination is the SSL unloading one form, it can the partial responsibilities from Web the server shifts to the AI edge computation and in the IoT AI intelligence center. SSL termination works by blocking encrypted traffic on servers that receive data from an SSL connection. It decrypts and verifies no data on the same device helps the server, so the server does not need to the process. SSL Terminate Serves as the end of the line or end point.

[b], This procedure prepares data for the server and organizes inbound connections to allow the web server to centralize other tasks, such as adding net page. SSL termination allows a server with an SSL connection to handle many simultaneous connections, sessions, or cookie. SSL Termination Return it can improve the performance of people owns site and web applications by increasing server speed. It performs decryption on a separate device to ensure accuracy. SSL (Secure Sockets Layer) and TLS (Transport Layer Security) are similar in many ways. They are protecting data privacy through dynamic data encryption; Provides server and (optional) client hu authentication: using message authentication codes check the integrity of the message: An initial handshake process is performed in which two communicators negotiate a common cipher suite. The similarity between the first version of TLS (TLS 1.0) and the last version of SSL (SSL 3.0) is closest. TLS v 1.0 is generally considered SSL v 3.1. The former can even downgrade an active connection to SSL 3. Not in TLS there are no corticated error alerts In SSLv3.0, the required but guest certificate is required every time the server requests an authentication hu certificate when available, the client hu usually responds with an no corticate alert message.

This alert is no longer needed in TLS. The client must (especially in TLS 1.2-RFC 5246) send a certificate message that does not contain a certificate. TLS uses HMAC to Row Message Authentication SSL performs message integrity checks by using a message authentication code (MAC) of MD5 or SHA (to determine if the message has changed). On the other hand, TLS uses HMAC, which enables it to use multiple hash functions. not only MD5 and SHA. The TLS uses a pseudorandom function to generate the key material, and the TLS uses a HMAC-based pseudorandom function (PRF). SSL is not. The two options prompted above are the best options that may be available in the current market. should be applied to the invention system, It needs to be tested repeatedly in specific practices for optimal results. TLS has one simpler way to arrive reaches the Corticate Verify news in the server to request the guest account end certificate (confirms the guest account end status) in the situation, the guest account end should (contain guest account end certificate in the transmission certificate news) after some time, transmission following to disappear Rest. In TLSv1.2, must after the Client Key Exchange news transmits this news immediately.

This following news is called but the Corticate Verify news, it will enable the server to confirm the guest account end certificate will in fact be the source is not assuming a false name from the actual guest account end to go against for. This Corticate Verify news in fact was uses the guest account end certificate the corresponding private key to sign formerly the handshake news signature. Because the server already had the corresponding public key (to follow guest account end certificate which transmitted early), therefore, it might confirm the signature. In TLS, may find all contents in beforehand handshake news which the structure Corticate Verify news needs. In SSL sentiment the situation is not same, besides the handshake news, SSL also needs host the key and some other values (is called pad_1 and pad_2) the user The data is the unusual privacy information.

Database Management Software

Databases have become ubiquitous elements of modern technology infrastructure. Database software can be used to simplify and speed management processes from the invention is helpful to ensure that the invention can closely meet the development requirements of the current system operation. Database management software is usually classified as a database management system (DBMS).

The main purpose of these software packages is to assist in people editing, retrieving and managing the inventive devices in the database each unit of user data is provided. The DBMS adopted by the invention can select various formats to organize data. These are often called silos system database, plane database, object-oriented database and hierarchical database. The database management system allows the function to be performed quickly and automatically within the technical framework of the system of the present invention. Especially in data DBMS is necessary when libraries are monitoring large amounts of content or are using multiple databases.

If there is no DBMS, an error occurs the likelihood will increase dramatically. There is no shortage of possible matches in the search for systems to integrate DBMS into the present invention. Some of the most popular DBMSs today include Microcosm SQL Server, SAP Sybase ASE, Teradata, and ADABAS, MySQL, etc.

As always, it is important to thoroughly study all available options for the operational requirements of the present invention system to ensure that the selected DBMS meets the unique needs of the present invention system. Therefore, testing, testing, retesting, must go through repeated only after testing can find the database management software which is most suitable for the system of the present invention. The database application is used in the system of the present invention to search, sort, calculate, train, report and share information. The database is fine containing code to perform mathematical and statistical calculations on data to support queries submitted with a snub.

The database application procedure based on uses the name and the password data accessing through the limit provides the security. Majority database application procedure all is using the database to program the language from the definition, the automated specific type of work. Moreover, in the market opens exudes the use network to wind the database at present; It is for the purpose of through Internet carrying on the management and the visit database application regulation foreword.

Operation business may manage these data collection, and reveals highline its analysis result according to the Web database application procedure in data. The Web database enables the collection the data to carry on the comprehensive organization and the classification in several hundred parameters. The Web database does not need high the level computation machine skill, and many database software procedure has all provided simple “single-clicks and founds” the pattern, but not needs the complex code. Filling in writes the field and preserves each record. Organizes the data at will, for example according to the time order, or passes a group of specific parameter platoon according to the character words listing order Row, and so on.

Quality Factors of Software Design

The following detailed requirements for software design, it is only for the relevant developers can clearly understand, the present invention for the software wring in all aspects should be achieved in all aspects of some specific condones, they are not intended to set limits on any Software it is applied to the present invention. Software development should be thoroughly clear every detail of the present invention, in piacular must do all the details of the design is the user experience as the priority.

I, Of course, software developers must also understand that; precise sensor operons depend on the careful design of Software and hardware interfaces to meet specific performance requirements. At the same time, developers need to carefully consider the placement of sensors on the board and the nature of the housing used to protect sensile sensors, and optimize the accuracy and reliability of the sensors. For mail-sensors how to coordinate accurate applicants on the present invention, developers need to solve the problem of each individual sensor to avoid electrical or physical intercom between the sensors in the final board design.

They also need to be aware that at every stage of Software and hardware design, reliable humidity and temperature can be achieved for its data conversion and transmission. Software developers should always remember when designing the applicant software of the present invention. the reliability and accuracy of its 10 important quality factors: Flexibility and Extensibility:

Flexibility is the ability of software to add/modify/remove facility without damaging the current system. Extensibility is the ability of software to add facility without damaging system, so it may be thought of as a 22 subset of flexibility. Those facility changes may occur according to changing requirements, or an obligor if the development process is one of the iterate methods. Change is inevitable in software development and so, this is one of the most important proper's of quality software.

Maintainability and Readability; Maintainability is a Lile similar with flexibility, but it focuses on Dominicans about error Corecon's and minor falcon Dominicans, not major uncinal extensivities. It can be supported with useful interface defines, document on, and self-document code and/or code document on.

The more correct and useful document on exists, the more maintainability can be performed. Performance and Efficiency Performance is mostly about the response me of the Software. This response me should be in acceptable intervals (e.g., max. a few seconds), and should not increase if transactor count increases.

And resources are expensive. Efficiency must be supported with resource elision. As an exaggerated example, the ability to perform a simple fanon only by using a 32-processor machine or 1 TB disk space is not acceptable. Opal source/performance Rao must be aimed.

II, Scalability;

A scalable system responds user acorns in an acceptable amount of, even if load increases. Of course, more hardware may be added for handling increasing user transition, but the architecture should not change while doing this. This is called verbal scalability.

Ability of running on Multiple, increasing count of machines is multiple processing. If the software can perform that type of processing, this is called horizontal scalability. A preferred scalable system should suit both methods.

Availability, Robustness, Fault Tolerance and Reliability: A robust Software should not lose its availability even in most failure states. Even if some components are broken down; it may connote running. Besides, even if whole applicants crashes, it may recover itself using backup hardware and data with fault tolerance approaches.

There should always be B and even C, D. plans. Reliability also 23 stands for the integrity and consistency of the software even under high load condones. So, it is relevant with availability and scalability.

An unreliable system is also unscalable. Usability and Accessibility; User interfaces are the only visible parts of Software according to the viewpoint of user. So, simplicity, taking less me to complete a job, fast learnability etc. are very important in this case. The most well-known principle for this property is KISS (Keep It Simple Stupid). Simple is always the best.

A usable Software should also support different accessibility types of control for people with disables. Palermo Combability and Portability A quality Software should run on as much various pharms as it can.

So, more people can make use of it. In different contexts we may Menon different pharms, this may be OS pharms, browser types etc. And portability is about adapting Software that can run on different pharms, for being more pharm comp able. In this sense, portability is also related with flexibility III, Testability and Manageability.

Quality software requires quality testing. Source code should be tested with the most coverage and with the most efficient testing methods. This can be performed by using encapsulant, interfaces, parents, low coupling etc. techniques correctly.

Besides testability, a qualified s=Software should be manageable are deployment. It may be monitored for e.g., performance or data usage status, or may enable developer to configure system easily.

Cream a successful logging system is another very important issue about manageability. Security: Security is a very important issue on software development, especially for web or mobile based ones which may have millions of users with the ability of remote accessing to system.

You should construct a security policy and apply it correctly by leaving no entry points. This may include authorizing and Athenian techniques, network aback proterons, data encryption and so on. all possible types of security leaks should be considered, otherwise one day only one aback may crash your whole applicants and whole company. Focality and Correctness facility (or correctness) is the conformity of the Software with actual requirements and Specificness. In fact, this is the precondemn tribute of an applicants, and maybe not a quality factor but we wanted to point 24 that as the last quality factor, for taking anon:

Quality factors are not meaningful when we are talking about unfarcical Software. First, perform desired finicality and produce correct Software, then apply quality factors on it.

If you can perform both parallelly, it is the best. In adding to the above elements, the quality of the code wire will be another very important issue. If developers just want to complete the project quickly, they may not focus on the quality and operability of the Software. While hiring developers to create programs may now cost more, you should compare it to poor program design and future maintenance costs.

The Software Design and Development of the Priority's

We can consider the use of code plus image software combined with each other to protect and improve the exact execution power of a robot in the operation of the system of the present invention.

I, Of course, this approach is not certain if software development and design embrace There is or in the actual process of discovery, and find a better solution, that is the purpose of the pursuit of the present invention.

In short, on the software open the process of 12 development and design needs to be tested repeatedly, with different scenarios, and then tested until the best solution is found.

II, Before the user sits down, the first priority should be to make some basic judgments. For example, judging whether the user is close to the device is directly required to use the device, or just something that has nothing to do with the use.

When it is judged that the user has a need for use, the data obtained by the smart camera sensor is used to determine whether the user is facing the device or the user's back facing the device. After the judgment is completed, the command must be issued immediately. Various services must be fully developed.

When the user starts to sit down; the first priority is immediately transferred to the four robots of the present invention, where all calculations are concentrated. This is to ensure that users get high-quality services.

III, When the system of the present invention senses that someone is approaching the device of the present invention, the dual AI edge computing system must start to perform the first priority of operations.

This means that when a person approaches, all sensors begin to mass-produce data. IV, these data require high-speed computing by the dual AI edge computing system, production and instructions to serve the user's all needs. The first priority of the calculation designed by this software must be coordinated with the user's entire use process until the use is completed.

[a], The classification of the computation of bi AI edge in the process of transportation by software development and design of the invention; Complete the “part of this” and the absolute priority to transfer the “Robots”. Imagine this: Smart camera sensors are like the eyes of a robot, smart sensors are the sensory nerves of the robot, and dual AI edge computing is the brain of the robot. During movement, the smart camera sensor is responsible for telling the AI edge computing machine's movement direction. The smart sensor group is responsible for telling the AI edge to calculate the distance and correct the deviations that may occur during the movement of the machine. The other smart sensors installed on the butterfly machine perform their duties, continuously transmitting the data produced during the movement to the AI edge computing system to fully guarantee the enhancement, safety, and effectiveness of the movement.

The user provides the service and the comfort that the user feels.

[b], Under the control of the dual AI edge computing system, the drive motor starts to push the two butterfly robots upwards so that they gradually approach the left and right sides of the user's temple (buttock) and approach the user The body stops at 3 mm-5 mm. After the machine stops, the straight-line distance between the tops of the two machines must be maintained between 2.5-3 inches, and the two machines show a 45-degree stop. The drive motor controls the machine to complete the previous statement.

These actions must rely on the smart sensor group already installed on the machine, including but not limited to smart camera sensor, smart flood sensor, smart distance sensor, and others, etc. (please refer to the smart sensor chapter).

Now, the “absolute priority” transfer—the robot's—drive motor controller. There is a problem with a certain part of the equipment or a certain component. In this state, the dual AI edge 13 computing has undergone high-speed calculations.

In order to ensure the safety of users, it is judged that only ordinary operation mode services can be provided. At this time, the dual AI edge computing system will shut down most of the functions. Now the system equipment of the present invention is basically the same as the ordinary bucket.

However, it can also provide some other safety services: for example, after the use is completed, the barrel is automatically flushed, and after the lid is automatically closed, the barrel cleaning system designed on the lid is in use. After the user leaves, the entire bucket is thoroughly cleaned and sterilized. after the comprehensive physical examination, the equipment is completely normal, and all equipment's is perfect, can immediately provide the high-quality service for the user. At this point “absolute priority” transfer—“bi AI margin computing system.

[c], installed in the system of the present invention, the dual AI edge computing system will be high-speed operation, the various systems of the present invention, including various sensors for another comprehensive physical examination, to determine the working status of the device of the present invention. Of course, the result can only be two.

[1]. After comparing the above data, it is judged whether the user is her or him. At this time, the dual AI edge computing will start based on the data stored in the past, and users will provide the service standards they like to enjoy. Under the control of the dual AI edge computing system, the temperature controller will immediately adjust the seat board to its satisfaction. The water temperature controller will adjust the temperature of the water to meet the user's preference. At the same time, even if the system completes the regulation of the water pressure through the pressure pump controller, the water temperature controller will also control the water pressure. It can adjust the machine to meet the user's favorite amount of water injection, and the number of times. After completing these, adjust the user's favorite cleaning time to be short, control the pressure and time of the user, and other requirements, and many more.

[2]. The person who is close is a new user, and there is no reference data available in the family data center. Therefore, the AI edge computing system will provide services for it in accordance with the designed system service program of the present invention (please refer to the standard service program section). In addition, it collects data generated during its use.

[a], the intelligent photographic sensor installed outside the device of the present invention intensive image ingestion of the user, and began to transmit all the obtained image data to the dual AI edge computing system. At this point, the “Absolute Priority” transfer—dual AI edge computing system.

[b], the dual AI edge computing system after obtaining these data, began to divide the processing of these data. Even on the AI edge of the IoT system, all the data submitted by the smart camera sensor is compared to all the data stored in the memory (including data stored in the SSHD) and certified. There should be only two results for this work.

IV, AI edge computing also has absolute priority, which is a state of continuous conversion. For example: when the device of the present invention finds that someone starts to appear, the AI edge computing will start to use 14 (exclusive) first.

[a], At this time, all the sensor systems are activated, and people are intensively observed to see if there is a demand for use. Therefore, an “absolute priority” based on the first priority is established. Starting from the smart camera sensor, all other sensor groups began to cooperate, including but not limited to smart infrared sensors, smart distance sensors, and all other smart sensor groups, and began to pay close attention to all the body movements of the close person. When the approaching person comes to the front of the system equipment of the present invention, they start to have actions, and all the sensor data obtained by the dual AI edge of these actions are processed by high-speed calculations to determine that they have use requirements. Currently, “absolute priority” transfer—“Smart photography sensor.

[b], the second priority: the time slots are prioritized respectively. (During the high peak period of the network NETWORK, the system of the present invention uses AI edge computing in order to avoid possible high network charges.) At this time, production is given priority.

The AI Edge even needs to undergo a physical examination every 30 minutes according to a set schedule (as stated above). Priority is given to production during off-peak hours (12/00 am-06/00 am). AI edge computing needs to submit all data produced on the day to the distributed (local) cloud and remote cloud computing center according to the set goal, and then accept the current training of the cloud computing center after completion.

[c], first priority: Use first. At any time of the 24 novels per day, once usage requirements are generated, all computing resources must be discarded, and all are centralized to use requirements (including all computing resources).

This priority is exclusive and unique. AI edge calculations take precedence The above basic details describe the various changes of absolute excellence, the purpose of which is to establish absolute priority software development design for the user's personalized needs, coupled with dual AI edge computing and cloud database computing analysis, to establish new technology for human services and change the goal of human life.

[d]. The data calculation of the “manual control” command has special priority.

The system of the present invention is designed with the user's manual rotation control instructions. The so-called manual control refers to the establishment of the use of the system settings of the present invention on the basis of maintaining the “standard services” of the “voice instructions” The form of service controlled by the user.

Each of the various items above shows standard services, for example: the standard time set by the system of the present invention is 2 minutes, and so on. It can be understood that “manual control” is also based on the same standard service.

The difference is the manual control selection, which changes the different levels of voice selection to through manual rotation to achieve various levels of selection. For example: The design has 10 different pressures to choose from: 18P, 20P, 22P, 24P, 26P, 28P, 30P, 32P, 34P, 36P. There are two different time options from the design: 1 minute, 1 minute and 20 seconds, 1 minute and 40 seconds, 2 minutes, 2 minutes and 20 seconds, 2 minutes and 40 seconds, 3 minutes, 3 minutes and 20 seconds, 3 minutes and 40 seconds, 4 minutes, and others, etc. All are 15 achieved by manual “manual rotation”.

For example: The above description shows that there are 10 different levels of choices. The manual control knob set by the system of the present invention is also designed with 10 different levels of scales.

[e], The user manually rotates one scale each time, and the level is selected. Just go up or down one level. It should be noted here that the software needs to develop and design the AI smart voice prompt function specially for the manual rotation, for example:

when the user twists two scales manually, the AI smart voice needs to be sent out immediately Wake up, “Now the water temperature has risen to a certain degree or has dropped to a certain degree.”(Please refer to the manual control chapter). After the above different system settings of the present invention are issued by the user with a voice command, at this time, special priority is given to the construction. The dual AI edge computing is supported by the voice data, and all smart sensor groups perform their duties.

Launch full functional cooperation, and begin to give special priority to the

[f], user's voice needs, and at the same time, suspend or delay other matters. In short, voice control is a different choice based on standard services.

[1]. The standard lifetime set by the system of the present invention is 2 minutes. In addition, the design has two different time options: 1 minute, 1 minute and 20 seconds, 1 minute and 40 seconds, 2 minutes, 2 minutes and 20 seconds, 2 minutes and 40 seconds, 3 minutes, 3 minutes and 20 seconds, 3 minutes and 40 seconds.

[2] minutes. The user can choose the voice command according to his or her preference.

[3]. In addition, there are 10 different pressures to choose from: 18P, 20P, 22P, 24P, 26P, 28P, 30P, 32P, 34P, 36P. The user can choose his/her favorite pressure within this range.

[4]. In addition, the design has 6 different cleaning times: 1 minute, 1 minute 20 seconds, 1 minute 40 seconds, 2 minutes, 2 minutes 20 seconds, 2 minutes 40 seconds, 3 minutes, 3 minutes 20 seconds, 3 minutes 40 Seconds, 4 minutes. The user can choose the voice command according to his or her preference. The standard pressure set by the system of the present invention is 26P.

[5], The standard cleaning & pressure of 20 P is set by the invention system. In addition, 10 water pressure levels are designed to be regulated: 12 P, 14P, 16P, 18P, 20P, 22P, 24P, 26P, 28P, 30P. To enable the person to take the “language” instruction to regulate the cleaning pressure of the “people” like. The standard cleaning time set by the invention system is 1 minute and 30 seconds.

V, the injection volume designed by the system of the present invention is 15 different levels, from high to low: 400 ml, 390 ml, 430 ml, 380 ml, 370 ml, 360 ml, 350 ml, 340 ml, 330 ml, 320 ml, 310 ml, 300 ml, 290 ml, 280 ml, 270 ml. In the service of the system of the present invention, a first water injection volume is designed, which is 150 ml.

For the safety of use, it cannot be changed. When anyone uses it, the first injection of water provided by the system service of the present invention can only be this amount, and there is no other choice. According to the best results and requirements of the test, all functions are changed.

However, any changes should be included in the patent for this invention.). In addition, as the number of injections changes, the injection volume will gradually increase under the command control of dual AI edge computing, 16 from low to high. For example: 270 ml, 280 ml, 290 ml, etc. The user can select the amount of note he or she likes by verbal command.

The standard number of injections set by the system of the present invention is: 10 times.

The minimum number of injections set by the system of the present invention is five times, and there is not a smaller number of times to choose? The maximum is 20 times, and there are no more options. Users can control the number of injections they like through voice commands. The water pressure designed by the system of the present invention is 15 different P levels, which are from high to low: 33P, 32P, 31P, 30P, 29P, 28P, 27P, 26P, 25P, 24P, 23P, 22P, 21P, 20P, 19P. The standard service designed by the system of the present invention is no more than 26P. The user can put forward regulatory requirements with voice commands within these ranges. The operating requirements of the dual AI edge computing system are the same as the above-mentioned water temperature control.

VI, “voice instructions” software function data operations are particularly preferred. The invention system designs the temperature of its water to adjust the range to 11 levels, from the summer low temperature (F standard) 32 degrees, 33 degrees, 34 degrees, 35 degrees, 36 degrees, (winter) 37 degrees, 38 degrees, 39 degrees, 40 degrees, 41 degrees, 42 degrees. Consumers can request adjustments between these degree levels. Standard services generally only provide the body's temperature, that is, 36 degrees or 37 degrees. If the user's voice suggests: the water temperature is 32 degrees. or water temperature of 39 degrees. At this point, special priority is given to establishing with the support of voice data, dual AI edge computing begins to give special priority to the user's voice needs, while suspending or delaying other matters.

VII, the data operation of the dual AI edge computing system has a special priority. In the software development and design of the system of the present invention, it is also necessary to consider that the data calculations that the equipment will produce during the use process have special priority.

It is an extremely necessary software function, and this function is very common in actual applications. important. During the normal operation of the system of the present invention, the user is temporarily or temporarily dissatisfied with the standard service provided by the system of the present invention, or the user is temporarily or temporarily dissatisfied with the use habits (data) established by the user in the period. These dissatisfactions are mainly manifested in the use process.

The users are not satisfied with the services provided by the system of the present invention, including but not limited to water temperature, water pressure, water injection volume (for safety, this function is designed to limit, the user can adjust within a limited range.) As well as the number of water injections, cleaning water pressure, short cleaning time, high pressure, short time, and other services, etc., propose changes.

Installed on the front and rear sides of the butterfly machine on the right, its function is the same as that of the butterfly machine on the left.

Therefore, it can be clearly understood that when every micro machine is working, two camera sensors (one for each of the left and right butterfly machines) are involved in the work at the same time. That is 17 to say, three photographic sensors work together at the same time to ensure the accuracy of the work of the micro machine.

The timely data generated by the above six smarts camera sensors during operation will be transmitted to the AI edge computing at a high speed. At the same time, the instructions generated by the AI edge computing will also be transmitted to the machine driver and the controller at a high speed.

Under the control of dual AI edge computing, it can operate the machine system accurately. In the process, all smart sensor groups perform their duties (please refer to the chapter on smart sensors), and continuously transmit the data stored in their own work to the dual AI edge computing system.

AI analyzes and judges these data. Into instructions to control the machine and the system to perform accurate operations.

[1]. Installed on the micro machine A.

[2], Installed on the micro machine B.

[3]. Installed on the front and back sides of the butterfly machine on the left, where the micro machines A and B are the closest to when they are working.

Because, as the auxiliary observation photographic sensor of the micro machine, its purpose is to calibrate and correct the deviation that may occur during the operation of the micro machines The data provided by these two photographic sensors are the upper surface of the micro Machines. Supplement of photographic sensor data. Absolute priority transfer, installed on the machine, six intelligent photographic sensors. The distribution is as follows: That's super priority third.

[4]. In the process of software development and design, the dual AI edge computing was observing a certain use process and found that a female user was in the period of menstruation. Software development and design should consider a special design: “Voice reminder program”, the AI intelligent voice system should ask the messenger, “Now that your body is normal and menstrual, do you need to clean the vagina with normal water injection? In general, the system does not recommend using injection water. Clean,” However, the user needs to inject water to clean. Currently, after the dual AI edge computing obtains the user's voice command, it chooses to take the appropriate action. When injecting water into the vagina, the software design should consider reducing the injection volume by half.

For example: the standard injection water cleaning should have a water injection volume of 10, so the injection volume can only be 5 at this time. analogy.

[5]. In the process of using the device of the present invention, the user adjusts a certain function or function of the standard program through the manual knob, for example: the injection water temperature increases by 1 degree, and the latter two degrees.

Or note that the water pressure is reduced by 1p, 2p, etc. The dual AI edge calculation will be executed as soon as the manual knob command is obtained. The user's manual knob command is the second type of super priority. It can be understood as follows: when super priority is executed, the other functions of the program remain unchanged after the dual AI edge calculation, such as—the temperature of the seat plate, the temperature of the water, Note the number of times of water, cleaning water pressure, cleaning time, water pressure, working time, etc.

If the user adjusts two of them through the manual knob, then all other functions must be kept in use. The location that 18 the user likes, or, before the user's favorite is established, should be maintained in the standard program service state, unless the user adjusts, otherwise, all other functions must be maintained.

This is a very special case: Dual AI edge computing observes a certain use process and finds that a woman user is in the menstrual period. Software development and design should consider special designs: “Voice mention program”, the AI intelligent voice system should ask the user, “Now that your body is normal and menstrual, do you need to perform normal water injection to the vagina? Generally, the system is not recommended to use Note water cleaning,” After obtaining the user's voice command, choose the appropriate action.

[6]. In the process of using the device of the present invention, the user adjusts a certain function or function of the standard program through voice, for example: the temperature of the injection water increases by 1 degree, and the last two degrees. Or note that the water pressure is reduced by 1p, 2p, etc., and the dual AI edge computing will be executed as soon as the voice command is obtained.

VIII, the user's voice command is the first type of super priority, which can be understood as follows: when super priority is executed, the other functions of the program remain unchanged after the dual AI edge calculations, such as: the temperature of the seat plate, the temperature of the water, and the note Water frequency, cleaning water pressure, cleaning time, water pressure, working time, etc., if the user adjusts two of them through voice, then all other functions must be maintained by the user The favorite position, or, before the user likes it, should be maintained in the standard program service state, except for the user to adjust, all other functions must be maintained.

The following three super-priority categories exist in software development and design, taking fully into account all the priorities of the former: super priority In addition, for these problem groups, the number of standard-setting notes will change to 20 percent to be satisfied to the best of the person. And, again, the problem discharges will be improved by the beginning of the 28 inventions of the invention, and the problem will be improved by the end of the week, and the basic restoration of health is beyond doubt. Then, the normal program service phase, this is the importance of bi AI margin computing carefully observed during the process, adopting conservative strategies when there is a discharge problem, and restoring normal procedures when the problem is resolved This is the bi-AI edge computation of the important point. Also use the above example: when the excretion does not reach the goal after the previous three injections, at this time, AI edge computing should adopt a conservative strategy and continue to maintain the injection volume at 290 ml until the user has excretion logistics out.

In addition, you can consider gradually increasing the amount of water injection to help users, but you must be very cautious. Only a small amount of water can be added each time, for example, from 290 ml, to 295 ml, and then to 300 ml, 305 ml, 310 ml, and many more.

Until the problem is resolved, then proceed to the normal procedure. However, in the normal procedure, the amount of injection that has been set must be reduced by 75%. For example, the standard is set to 300 ml, now it is 19 reduced to 225 ml, because these are for the problem groups listed above.

IX, AI margin calculation after the problem is observed It is important to note here that a user who is usually healthy and healthy may become a person with excretion problems for various? reasons within a certain period.

AI intelligent edge computing uses the present invention. It is very necessary to observe carefully during the equipment process and take effective measures for further reaction. This is also the important core of the present invention. Another situation: these groups with excretion problems, after starting to use the system equipment of the present invention, them excretion status will definitely be greatly improved within 48 hours (the inventor and the relatives of the present invention have used There is no exception after use), and it will return to a healthy state in time. Therefore, it is unquestionable to change from a person with excretion problems to a healthy person.

Therefore, after the problems of these users are completely solved, AI intelligent edge computing should respond immediately, adopting standard services or programs that these groups like (after these users are self-regulated) to provide services to them. As mentioned, above, after observing the problem user, inject 290 ml of drinking water repeatedly until the user's feces are excreted, and then inject the water according to 75% of the amount of the help program. Run Service. In addition, the number of injections can be controlled by 20% more than the standard program, or, according to the user's favorite (modified on the standard program) program, only the injection volume the upper reduction is 75% that the user usually likes, and the increase frequency is 20%. Special note is needed: AI smart local cloud (distributed) and remote cloud computing centers can obtain a large amount of user data always, which can effectively train AI smart cloud computing systems.

Therefore, it is very easy to find and find problematic users in such a huge amount of data. Analyzing these data, generating judgments and upgrading instructions, will be very effective in helping any problematic users. The purpose of the present invention is to help these user groups to further improve their health. Therefore, it is necessary to design a full-scale monitoring of the use process of the system equipment of the present invention by the user, for example: the third injection as mentioned above has been completed, unfortunately the user is listed above The user still cannot excrete normally.

X, this situation is observed by AI edge computing in the process, and the solution that should be available must be implemented immediately.

I, For example: continue to inject 290 ml of water until the user is observed to have the first excretion. Or the user may repeatedly excrete the injection water without any other response as it should, and so on. In short, the user group is extremely complex, and it is very necessary for dual AI edge computing to carefully observe the excretion process through various sensors. In the function of the system design of the present invention, the first injection volume is: 270 ml, the second time: 280 ml, and the third time: 290 ml. It is a standard program and is intended for ordinary health users.

It is designed and cannot be changed by the user. However, it may be difficult to solve the problems of these special users by applying this function to the 20 groups listed above.

[A]. In the process of using the system equipment of the present invention, AI edge computing must observe the process in detail through all the smart sensors.

The purpose is to carefully observe the process and discover possible problems in time.

Because people are very complicated, although the excretion process of most people is basically, the same, but some people will show different forms and normal needs, for example: some living habits are not very healthy People who consume less vegetables and fruits in them daily life, or those who have basic diseases in the past few years, and those who have already suffered from anorectal diseases, will experience different changes during their use. Problems, these important requirements need to be paid special attention to during software development and design, and careful observation becomes a must.

[B], The following example can illustrate The AI intelligent system carefully observes the functional requirements of the system equipment of the present invention for each user during its use.

These are very important software functions. Therefore, the software development and design need to be handled carefully, and the specific requirements are as follows. First, we can consider the graphic data (including three-D graphics) obtained through the smart camera sensor, to recognize and distinguish the “shape” of each user in the use environment, and then track and collect each user.

II “usage” data (including usage habits) of a user is aligned, compared and analyzed, and any discrepancies found and found are recorded. In addition, you can also consider the special likes expressed by each different user in the process of use, as a mark, to identify and recognize each user.

The purpose of this goal is to recognize and distinguish each user. Different users conduct data analysis and processing on their usage habits, and the AI intelligent system establishes targeted and personalized services. Software development and design requires special consideration to strengthen the AI Edge Computing and AI Smart Cloud (including distributed clouds and remote cloud computing centers) databases, and how AI Edge Computing can be trained in a real-world environment to accurately distinguish between each consumer (in a normal home environment or all others). AI margin computing needs to understand the differentiation and judgment of different users.

AI Edge Calculations Take Precedence

I, The classification of the computation of bi AI edge in the process of transportation by software development and design of the invention.

[1]. When the system of the present invention senses that someone is approaching the device of the present invention, the dual AI edge computing system must start to perform the first priority of operations. This means that when a person approaches, all sensors begin to mass-produce data. These data require high-speed computing by the dual AI edge computing system, production and instructions to serve the user's all needs. The first priority of the calculation designed by this software must be coordinated with the user's entire use process until the use is completed.

[2]. Before the user sits down, the first priority should be to make some basic judgments. For example, judging whether the user is close to the device is directly required to use the device, or just something that has nothing to do with the use. When it is judged that the user has a need for use, the data obtained by the smart camera sensor is used to determine whether the user is facing the device or the user's back facing the device. After the judgment is completed, the command must be issued immediately. Various services must be fully developed. When the user starts to sit down; the first priority is immediately transferred to the four robots of the present invention, where all calculations are concentrated. This is to ensure that users get high-quality services.

[3], in the software design and development of the present invention, we can consider the use of code plus image software combined with each other to protect and improve the exact execution power of a robot in the operation of the system of the present invention. Of course, this approach is not certain if software development and design embrace There is or in the actual process of discovery, and find a better solution, that is the purpose of the pursuit of the present invention. In short, on the software open the process of development and design needs to be tested repeatedly, with different scenarios, and then tested until the best solution is found. For example the below has two priorities.

[a] First priority: Use first. At any time of the 24 hours per day, once usage requirements are generated, all computing resources must be discarded, and all are centralized to use requirements (including all computing resources). This priority is exclusive and unique.

[b], the second priority: the time slots are prioritized respectively. (During the high peak period of the network, the system of the present invention uses AI edge computing in order to avoid possible high network charges.) At this time, production is given priority. The AI Edge even needs to undergo a physical examination every 30 minutes according to a set schedule (as stated above). Priority is given to production during off-peak hours (12/00 am-06/00 am). AI edge computing needs to submit all data produced on the day to the distributed (local) cloud and remote cloud computing center according to the set goal, and then accept the current training of the cloud computing center after completion.

II, AI Edge Computing Also has Absolute Priority;

[1], AI edge computing also has absolute priority, which is a state of continuous conversion. For example: when the device of the present invention finds that someone starts to appear, the AI edge computing will start to use (exclusive) first. At this time, all the sensor systems are activated, and people are intensively observed to see if there is a demand for use. Therefore, an “absolute priority” based on the first priority is established. Starting from the smart camera sensor, all other sensor groups began to cooperate, including but not limited to smart infrared sensors, smart distance sensors, and all other smart sensor groups and began to pay close attention to all the body movements of the close person. When the approaching person comes to the front of the system equipment of the present invention, they start to have actions, and all the sensor data obtained by the dual AI edge of these actions are processed by high-speed calculations to determine that they have use requirements. Currently, “absolute priority” transfer—“Smart photography sensor.

[2], the intelligent photographic sensor installed outside the device of the present invention intensive image ingestion of the user, and began to transmit all the obtained image data to the dual AI edge computing system. At this point, the “Absolute Priority” transfer—dual AI edge computing system.

[3], the dual AI edge computing system after obtaining these data, began to divide the processing of these data. Even on the AI edge of the IoT system, all the data submitted by the smart camera sensor is compared to all the data stored in the memory (including data stored in the SATA hard drive) and certified. There should be only two results for this work.

[a]. After comparing the above data, it is judged whether the user is her or him. Currently, the dual AI edge computing will start based on the data stored in the past, and users will provide the service standards they like to enjoy.

Under the control of the dual AI edge computing system, the temperature controller will immediately adjust the seat board to its satisfaction. The water temperature controller will adjust the temperature of the water to meet the user's preference.

At the same time, even if the system completes the regulation of the water pressure through the pressure pump controller, the water temperature controller will also control the water pressure. It can adjust the machine to meet the user's favorite amount of water injection, and the number of times. After completing these, adjust the user's favorite cleaning time to be short, control the pressure and time of the user, and other requirements, and many more.

[b]. The person who is close is a new user, and there is no reference data available in the family data center. Therefore, the AI edge computing system will provide services for it in accordance with the designed system service program of the present invention (please refer to the standard service program section). In addition, it collects data generated during its use.

[4] At this key point “absolute priority” transfer—“two AI margin computing system installed in the system of the present invention, the dual AI edge computing system will be high-speed operation, the various systems of the present invention, including various sensors for another comprehensive physical examination, to determine the working status of the device of the present invention.

Of course, the result can only be two.

[A], after the comprehensive physical examination the equipment is completely normal, and all equipment's is perfect, can immediately provide the high-quality service for the user. [B]. There is a problem with a certain part of the equipment or a certain component. In this state, the dual AI edge computing has undergone high-speed calculations. In order to ensure the safety of users, it is judged that only ordinary operation mode services can be provided. At this time, the dual AI edge computing system will shut down most of the functions.

Now the system equipment of the present invention is basically the same as the ordinary bucket. However, it can also provide some other safety services: for example, after the use is completed, the barrel is automatically flushed, and after the lid is automatically closed, the barrel cleaning system designed on the lid is in use. After the user leaves, the entire bucket is thoroughly cleaned and sterilized. Now, the “absolute priority” transfer—the robot's—drive motor controller.

III, Under the control of the dual AI edge computing system the drive motor starts to push the two butterfly robots upwards so that they gradually approach the left and right sides of the user's temple (buttock) and approach the user The body stops at 3 mm-5 mm. After the machine stops, the straight-line distance between the tops of the two machines must be maintained between 2.5-3 inches, and the two machines show a 45-degree stop. The drive motor controls the machine to complete the previous statement.

These actions must rely on the smart sensor group already installed on the machine, including but not limited to: smart camera sensor, smart flood sensor, smart distance sensor, and others, etc. (please refer to the smart sensor chapter). Imagine this: Smart camera sensors are like the eyes of a robot, smart sensors are the sensory nerves of the robot, and dual AI edge computing is the brain of the robot. During movement, the smart camera sensor is responsible for telling the AI edge computing machine's movement direction.

The smart sensor group is responsible for telling the AI edge to calculate the distance and correct the deviations that may occur during the movement of the machine. The other smart sensors installed on the butterfly machine perform their duties, continuously transmitting the data produced during the movement to 4 the AI edge computing system to fully guarantee the enhancement, safety, and effectiveness of the movement. The user provides the service and the comfort that the user feels. Complete the “part of this” and the absolute priority to transfer the “Robots”.

IV, the data operation of the dual AI edge computing system has a special priority In the software development and design of the system of the present invention, it is also necessary to consider that the data calculations that the equipment will produce during the use process have special priority. It is an extremely necessary software function, and this function is very common in actual applications important.

During the normal operation of the system of the present invention, the user is temporarily or temporarily dissatisfied with the standard service provided by the system of the present invention, or the user is temporarily or temporarily dissatisfied with the use habits (data) established by the user in the period. These dissatisfactions are mainly manifested in the use process.

The users are not satisfied with the services provided by the system of the present invention, including but not limited to water temperature, water pressure, water injection volume (for safety, this function is designed to limit, the user can adjust within a limited range.) As well as the number of water injections, cleaning water pressure, short cleaning time, high pressure, short time, and other services, etc., propose changes.

[1],“voice instructions” software function data operations are particularly preferred. The invention system designs the temperature of its water to adjust the range to 11 levels, from the summer low temperature (F standard) 32 degrees, 33 degrees, 34 degrees, 35 degrees, 36 degrees, (winter) 37 degrees, 38 degrees, 39 degrees, 40 degrees, 41 degrees, 42 degrees. Consumers can request adjustments between these degree levels. Standard services generally only provide the body's temperature, that is, 36 degrees or 37 degrees. If the user's voice suggests the water temperature is 32 degrees. or water temperature of 39 degrees.

At this point, special priority is given to establishing with the support of voice data, dual AI edge computing begins to give special priority to the user's voice needs, while suspending or delaying other matters.

[2]. The water pressure designed by the system of the present invention is 15 different P levels, which are from high to low: 33P, 32P, 31P, 30P, 29P, 28P, 27P, 26P, 25P, 24P, 23P, 22P, 21P, 20P, 19P. The standard service designed by the system of the present invention is no more than 26P. The user can put forward regulatory requirements with voice commands within these ranges. The operating requirements of the dual AI edge computing system are exactly the same as the above-mentioned water temperature control.

[3]. The injection volume designed by the system of the present invention is 15 different levels, from high to low: 400 ml, 390 ml, 430 ml, 380 ml, 370 ml, 360 ml, 350 ml, 340 ml, 330 ml, 320 ml, 310 ml, 300 ml, 290 ml, 280 ml, 270 ml. In the service of the system of the present invention, a first water injection volume is designed, which is 150 ml.

For the safety of use, it cannot be changed. When anyone uses it, the first injection of water provided by the system service of the present invention can only be this amount, and there is no other choice. According to the best results and requirements of the test, all functions are changed. However, any changes should be included in the patent for this invention.).

In addition, as the number of injections changes, the injection volume will gradually increase under the command control of dual AI edge computing, from low to high.

For example: 270 ml, 280 ml, 290 ml, etc. The user can select the amount of note he or she likes by verbal command. The standard number of injections set by the system of the present invention is: 10 times.

The minimum number of injections set by the system of the present invention is five times, and there is not a smaller number of times to choose. The maximum is 20 times, and there are no more options. Users can control the number of injections they like through voice commands.

[4] The standard cleaning & pressure of 20 P is set by the invention system. In addition, waters pressure levels are designed to be regulated: 12 P, 14P, 16P, 18P, 20P, 22P, 24P, 26P, 28P, 30P. To enable the person to take the “language” instruction to regulate the cleaning pressure of the “people” like. The standard cleaning time set by the invention system is 1 minute and 30 seconds.

[5]. In addition, the design has 6 different cleaning times: 1 minute, 1 minute 20 seconds, 1 minute 40 seconds, 2 minutes, 2 minutes 20 seconds, 2 minutes 40 seconds, 3 minutes, 3 minutes 20 seconds, 3 minutes 40 Seconds, 4 minutes. The user can choose the voice command according to his or her preference. The standard pressure set by the system of the present invention is 26P.

[6]. In addition, there are 10 different pressures to choose from: 18P, 20P, 22P, 24P, 26P, 28P, 30P, 32P, 34P, 36P. The user can choose his/her favorite pressure within this range.

[7]. The standard lifetime set by the system of the present invention is 2 minutes. In addition, the design has two different time options: 1 minute, 1 minute and 20 seconds, 1 minute and 40 seconds, 2 minutes, 2 minutes and 20 seconds, 2 minutes and 40 seconds, 3 6 minutes, 3 minutes and 20 seconds, 3 minutes and 40 seconds, 4 minutes. The user can choose the voice command according to his or her preference.

[8]. The data calculation of the “manual control” command has special priority. The system of the present invention is designed with the user's manual rotation control instructions.

The so-called manual control refers to the establishment of the use of the system settings of the present invention based on maintaining the “standard services” of the “voice instructions” The form of service controlled by the user.

Each of the various items above shows standard services, for example: the standard time set by the system of the present invention is 2 minutes, and so on.

It can be understood that “manual control” is also based on the same standard service. The difference is the manual control selection, which changes the different levels of voice selection to through manual rotation to achieve various levels of selection. For example: The design has 10 different pressures to choose from. 18P, 20P, 22P, 24P, 26P, 28P, 30P, 32P, 34P, 36P. There are two different time options from the design: 1 minute, 1 minute and 20 seconds, 1 minute and 40 seconds, 2 minutes, 2 minutes and 20 seconds, 2 minutes and 40 seconds, 3 minutes, 3 minutes and 20 seconds, 3 minutes and 40 seconds, 4 minutes, and others, etc.

All are achieved by manual “manual rotation”. For example: The above description shows that there are 10 different levels of choices. The manual control knob set by the system of the present invention is also designed with 10 different levels of scales.

The user manually rotates one scale each time, and the level is selected. Just go up or down one level. It should be noted here that the software needs to develop and design the AI smart voice prompt function specially for the manual rotation, for example: when the user twists two scales manually, the AI smart voice needs to be sent out immediately Wake up, “Now the water temperature has risen to a certain degree or has dropped to a certain degree.”(Please refer to the manual control chapter) After the above different system settings of the present invention are issued by the user with a voice command, at this time, special priority is given to the construction.

The dual AI edge computing is supported by the voice data, and all smart sensor groups perform their duties., Launch full functional cooperation, and begin to give special priority to the user's voice needs, and at the same time, suspend or delay other matters. In short, voice control is a different choice based on standard services.

The above basic details describe the various changes of absolute excellence, the purpose of which is to establish absolute priority software development design for the user's personalized needs, coupled with dual AI edge computing and cloud database computing analysis, to establish new technology for human services and change the goal of human life.

V, Absolute priority transfer installed on the machine, six intelligent photographic sensors. The distribution is as follows:

[1]. Installed on the mini robot A.

[2]. Installed on the mini robot B.

[3]. Installed on the front and back sides of the butterfly robots on the left, where the micro machines A and B are the closest to when they are working. Because, as the auxiliary observation photographic sensor of the micro machine, its purpose is to calibrate and correct the deviation that may occur during the operation of the mini robots. The data provided by these two photographic sensors is the upper surface of the micro machine. Supplement of photographic sensor data.

[4]. Installed on the front and rear sides of the butterfly robots on the right, its function is exactly the same as that of the butterfly machine on the left.

Therefore, it can be clearly understood that when every mini robot is working, two camera sensors (one for each of the left and right butterfly machines) are involved in the work at the same time.

That is to say, three photographic sensors work together at the same time to ensure the accuracy of the work of the micro machine. The timely data generated by the above six smart camera sensors during operation will be transmitted to the AI edge computing at a high speed. At the same time, the instructions generated by the AI edge computing will also be transmitted to the machine driver and the controller at a high speed.

Under the control of dual AI edge computing, it can operate the machine system accurately. In the process, all smart sensor groups perform their duties (Please refer to the chapter on smart sensors), and continuously transmit the data stored in them own work to the dual AI edge computing system. AI analyzes and judges these data. Into instructions to control the machine and the system to perform accurate operations.

VI, AI margin computing needs to understand the differentiation and judgment of different users. Software development and design requires special consideration to strengthen the AI Edge Computing and AI Smart Cloud (including distributed clouds and remote cloud computing centers) databases, and how AI Edge Computing can be trained in a real-world environment to accurately distinguish between each consumer (in a normal home environment or all others). First, we can consider the graphic data (including three-D graphics) obtained through the smart camera sensor, to recognize and distinguish the “shape” of each user in the use environment, and then track and collect each user. All “usage” data (including usage habits) of a user is aligned, compared and analyzed, and any discrepancies found and found are recorded. In addition, you can also consider the special likes expressed by each different user in the process of use, as a mark, to identify and recognize each user. The purpose of this goal is to recognize and distinguish each user. Different users conduct data analysis and processing on their usage habits, and the AI intelligent system establishes targeted and personalized services.

VII, The AI intelligent system carefully observes the functional requirements of the system equipment of the present invention for each user during its use.

These are very important software functions. Therefore, the software development and design need to be handled carefully, and the specific requirements are as follows. In the process of using the system equipment of the present invention, AI edge computing must observe the process in great detail through all the smart sensors. The purpose is to carefully observe the process and discover possible problems in time.

Because people are very complicated, although the excretion process of most people is basically, the same, but some people will show different forms and normal needs, for example: some living habits are not very healthy People who consume less vegetables and fruits in them daily life, or those who have basic diseases in the past few years, and those who have already suffered from anorectal diseases, will experience different changes during their use. Problems, these important requirements need to be paid special attention to during software development and design, and careful observation becomes a must.

The following example can illustrate, In the function of the system design of the present invention, the first injection volume is: 270 ml, the second time: 280 ml, and the third time: 290 ml. It is a standard program and is intended for ordinary health users. It is designed and cannot be changed by the user. However, it may be difficult to solve the problems of these special users by applying this function to the groups listed above. Therefore, it is necessary to design a full-scale monitoring of the use process of the system equipment of the present invention by the user, for example: the third injection as mentioned above has been completed, unfortunately the user is listed above The user still cannot excrete normally.

This situation is observed by AI edge computing in the process, and the solution that should be available must be implemented immediately. For example: continue to inject 290 ml of water until the user is observed to have the first excretion. Or the user may repeatedly excrete the injection water without any other response as it should, and so on. In short, the user group is extremely complex, and it is very necessary for 9 dual AI edge computing to carefully observe the excretion process through various sensors.

Special note is needed: AI smart local cloud (distributed) and remote cloud computing centers can obtain a large amount of user data always, which can effectively train AI smart cloud computing systems. Therefore, it is very easy to find and find problematic users in such a huge amount of data. Analyzing these data, generating judgments and upgrading instructions, will be very effective in helping any problematic users.

The purpose of the present invention is to help these user groups to further improve their health. As mentioned above, after observing the problem user, inject 290 ml of drinking water repeatedly until the user's feces are excreted, and then inject the water according to 75% of the amount of the help program, Service. In addition, the number of injections can be controlled by 20% more than the standard program, or, according to the user's favorite (modified on the standard program) program, only the injection volume the upper reduction is 75% that the user usually likes, and the increase frequency is 20%. It is important to note here that a user who is usually healthy and healthy may become a person with excretion problems for various reasons within a certain period.

VIII, AI intelligent edge computing uses the present invention. It is very necessary to observe carefully during the equipment process and take effective measures for further reaction. This is also, the important core of the present invention. Another situation: these groups with excretion problems, after starting to use the system equipment of the present invention, their excretion status will definitely be greatly improved within 48 hours (the inventor and the relatives of the present invention have used There is no exception after use), and it will return to a healthy state in time. Therefore, it is unquestionable to change from a person with excretion problems to a healthy person. Therefore, after the problems of these users are completely solved, AI intelligent edge computing should respond immediately, adopting standard services or programs that these groups like (after these users are self-regulated) to provide services to them.

IX, AI margin calculation after the problem is observed Also use the above example: when the excretion does not reach the goal after the previous three injections, currently, AI edge computing should adopt a conservative strategy and continue to maintain the injection volume at 290 ml until the user has excretion logistics out. In addition, you can consider gradually increasing the amount of water injection to help users, but you must be very cautious. Only a small amount of water can be added each time. for example, from 290 ml, to 295 ml, and then to 300 ml, 305 ml, 10 310 ml, and many more. Until the problem is resolved, then proceed to the normal procedure. However, in the normal procedure, the amount of injection that has been set must be reduced by 75%. For example, the standard is set to 300 ml, now it is reduced to 225 ml, because these are for the problem groups listed above.

And, again, the problem discharges will be improved by the beginning of the 28 hours invention of the invention, and the problem will be improved by the end of the week, and the basic restoration of health is beyond doubt. Then, the normal program service phase, this is the importance of bi AI margin computing carefully observed during the process, adopting conservative strategies when there is a discharge problem, and restoring normal procedures when the problem is resolved This is the bi-AI edge computation of the important point. In addition, for these problem groups, the number of standard-setting notes will change to 20% to be satisfied to the best of the person.

X, Super Priority

The following three super-priority categories exist in software development and design, taking fully into account all the priorities of the former:

[1]. In the process of using the device of the present invention, the user adjusts a certain function or function of the standard program through voice, for example: the temperature of the injection water increases by 1 degree, and the last two degrees. Or note that the water pressure is reduced by 1p, 2p, etc., and the dual AI edge computing will be executed as soon as the voice command is obtained. The user's voice command is the first type of super priority, which can be understood as follows: when super priority is executed, the other functions of the program remain unchanged after the dual AI edge calculations, such as: the temperature of the seat plate, the temperature of the water, and the note Water frequency, cleaning water pressure, cleaning time, water pressure, working time, etc., If the user adjusts two of them through voice, then all other functions must be maintained by the user the favorite position, or, before the user likes it, should be maintained in the standard program service state, except for the user to adjust, all other functions must be maintained.

This is a very special case: Dual AI edge computing observes a certain use process and finds that a woman user is in the menstrual period. Software development and design should consider special designs: “Voice mention program”, the AI intelligent voice system should ask the user, “Now that your body is normal and menstrual, do you need to perform normal water injection to the vagina? Generally, the system is not recommended to use Note water cleaning,” After obtaining the user's voice command, choose the appropriate action.

[2]. In the process of using the device of the present invention, the user adjusts a certain function or function of the standard program through the manual knob, for example: the injection water temperature increases by 1 degree, and the latter two degrees. Or note that the water pressure is reduced by 1p, 2p, etc. The dual AI edge calculation will be executed as soon as the manual knob command is obtained. The user's manual knob command is the second type of super priority. It can be understood as follows: when super priority is executed, the other functions of the program remain unchanged after the dual AI edge calculation, such as: the temperature of the seat plate, the temperature of the water, Note the number of times of water, cleaning water pressure, cleaning time, water pressure, working time, etc. If the user adjusts two of them through the manual knob, then all other functions must be kept in use. The location that the user likes, or, before the user's favorite is established, should be maintained in the standard program service state, unless the user makes adjustments, otherwise, all other functions must be maintained.

[3]. In the process of software development and design, the dual AI edge computing was observing a certain use process and found that a female user was in the period of menstruation. Software development and design should consider a special design: “Voice reminder program”, the AI intelligent voice system should ask the messenger, “Now that your body is normal and menstrual, do you need to clean the vagina with normal water injection? In general, the system does not recommend using injection water. Clean, “However, the user needs to inject water to clean. At this time, after the dual AI edge computing obtains the user's voice command, it chooses to take the appropriate action. When injecting water into the vagina, the software design should consider reducing the injection volume by half. For example: the standard injection water cleaning should have a water injection volume of 10, so the injection volume can only be 5 at this time. That's super priority third.

Double Butterfly Robots (Please View FIGURES: 27, 28, 29, 30, 31, 32, 33, 34, 35, 36, 37, 38, 39, 40, 41, 42, 43.)

The system of the present invention is designed with two butterfly robots. When the user sits on the equipment of the system of the present invention, one is left and right in the direction of his buttocks to legs.

When they are not in operation, they are designed to be placed on both sides of the upper end of the inside of the barrel. Once they start working, they will be slowly extended (raised) from both sides by two supporting arms under the instruction of the AI intelligent system (The two supporting arms are designed to be built-in hollow, so that water pipes and wires can pass through.).

Approach both sides of the user's buttocks, stop at a point 3 mm away from the user's buttocks, and keep this distance until the next working procedure starts. The two sides of the body of the double-butterfly robots are covered with small holes with a diameter of 1.5 mm, and each hole is kept at a distance of 3.5 mm between the holes. These small holes in the body continuously leak (Low pressure) water to the outside. When the dirt discharged by the user gets on the butterfly machine, these fine water flows will naturally form a protection, and the dirt will be protected. Objects carry niches to ensure their body cleanliness during operation.

I, Butterfly Robots has these Functions:

[a]. The double-butterfly robots are designed to install a variety of smart sensors with different functions on the top of the facing side. In addition to being in motion, these smart sensors are designed to detect and sense various actions of mini robots according to the system design of the present invention, and at the same time transmit the sensed data to the dual AI edge computing system to keep completing the tasks set by themselves In addition, they also need to be the nerve of the AI intelligent system when the micro machine starts to work, to monitor any movement deviations that may occur in the process of the mini robot's work. When these problems occur, the smart sensor will transmit the data in time.

For the AI edge computing system, the AI intelligent system generates various correct instructions through data analysis and judgment, and corrects the various deviations that may occur in the process of the WeChat machine, thus ensuring the accurate operation of the micro machine.

Note: The present invention cannot clearly specify the location were smart sensors need to be installed on the double butterfly robots, because the inventor believes that the most correct way should be to achieve the present after repeated tests. The perfect effect of invention and design can also benefit most users. However, the inventor has clearly listed every type of smart sensor that needs to be installed on the system equipment of the present invention (Please refer to the sensor chapter). In 2 additions, it needs to be specifically stated that any method to increase or decrease the sensor installation, as well as the installation state of the sensor at different positions, should be included in the patent of the present invention.

[b]. The present invention sets that the double butterfly robots are supported by the supporting arm, they must be able to move 2.5 inches back and forth horizontally, and also be able to perform a 180-degree arc flip, The arc-shaped flip is designed to clean the user's buttocks, when the double-butterfly robots can rotate upward to maintain 100 degrees, the pressure spray and pressure spray tube can complete the task of the design. This requirement should be fully considered in the art production side. In addition, the purpose of this function can also establish the foundation for the following two functions.

[c]. At the front side of the butterfly robot's (that is, the side facing the double-butterfly robots), in the middle of its middle transverse (for example, if a sheet of paper is folded in half transversely, the upper and lower components are equal.), 20 mm upwards and 20 mm downwards. This position is designed by the present invention with two gates. Each gate is an average of 20 mm. It is closed from top to bottom to the middle, and there is no hole in the upper surface of the gate. They are usually closed, and the gate opens when the user completes the excretion. In the gate, the invention is designed to be embedded and installed horizontally (two diameters of 10 mm), one is a pressure spray tube, and the other is a pressure spray tube. When the user completes the drainage, the double gates are opened, and the pressure spray pipes and pressure spray pipes on the upper side begin to move out of the gate from the inside to the outside and stop when they just exceed the level of the butterfly robots. First, the upper surface of the pressure spray pipe is designed with three rows of spray nozzles with a diameter of 2.5 mm, and the distance between each spray nozzle is 5 mm. The length and pressure of the spray nozzle arrangement the tube is slightly shorter (less than the two ends of two tubes). In addition, the pressure of the spray tube and the width of the gate are reduced by 10 mm on both sides, which means that the two spray tubes and the spray tube have a gap of 10 mm on the left and right sides of the gate.

In addition, the pressure nozzle and pressure nozzles are designed according to the present invention. They also need to build the function of 120 degrees of axial rolling rotation.

This function is more important. It is to protect the nozzle and the nozzle. The spray tube can complete the necessary range of work. Pressure spray tube: Its main function is to help the user clean the buttocks after the user completes the excretion. In addition, it is also designed with a function. After the user completes all the steps away, the double-butterfly robot's also needs to be able to perform face-to-face spray cleaning.

II, Details of the Pressure Nozzle

[a]. The upper face of the pressure nozzle is designed with multiple nozzles with a diameter of 7 mm and a width of 2 mm. The distance between each nozzle is 5 mm. These The spray holes are arranged horizontally, a total of two rows.

The length of the spray nozzle arrangement is the same as that of the pressure spray tube, which is slightly shorter than that of the spray tube? Similarly, the design requires that the pressure nozzle must be able to rotate in an axial direction of 120 degrees to ensure the scope of operation that the nozzle needs to complete. Its main function is to help the user use the water left on the user's buttocks after the butt cleaning is completed.

When the above tasks are completed, the pressure spray tube and pressure spray tube return to the gate at the same time, and then the gate is closed.

[b]. Mini robot's A and B are designed to be embedded and installed in the back of the upper part of the double butterfly robot's (please refer to the machine chapter) (the opposite side of the butterfly robot's). The top has a 50 mm position. When the mini robots are not working, they are shrunk behind the double-butterfly robots, and move forward and upward when they are working. They are accurately approached under the instructions of the intelligent sensor group monitoring and the AI intelligent system.

The user's anal, and women's fecal excretion (please refer to the chapter on the robot's), on the back of the butterfly robot's (the opposite side of the double butterfly robot's), the present invention is designed There are 4 pressure spray heads. Considering that the user may contaminate the storage position of the double butterfly machine during use, so after the user has drained and left, the double butterfly robot's Each will help with cleaning.

After the cleaning is completed, the two support arms of the double-butterfly robots will begin to shrink inward and stop when they shrink to 50%. At this time, 4 pressure spray heads Begin flushing with the storage compartment of the butterfly machine, and the time will be kept at 25 seconds.

III, [a], The outer shape and the double butterfly robot's, are completely shaped, but only a little bit of a little. Since the side of the double butterfly robots is not isolated, it is arc, and this emphasis needs to be considered in the process. When the double butterfly robot's is completed, they must be 100% matched by the inner diameter cylinder body of the barrel (notice that the cylinder is an arc type) and only see the double butterfly The machine's curve lines exist, which are perfectly consistent with the whole cylinder curve and should 4 not be flawed.

The invention was designed to install four curves of the receiver ((12) and the equivalent), with four pressure/nozzle heads.

The functions are mainly to clean double-micro machines, and the back-to-back, when the double-butterfly robot's is suspended when the two-arm-backed contraction process reaches 75%. At this point, four pressure spray heads started flushing on mini robot's every two head washed the selves.

Thus, at four pressure spray heads they should have axial rotations and_degrees rotate to 70 degrees, which will ensure that they can correctly complete their design tasks and clean up the back of two micro and double butterfly robots.

[b], The size of the double-butterfly robots. The design thickness of the double butterfly robots are 50 mm, excluding the mini robots. The mini robots are designed to be stored behind the double butterfly robots. Its size should be considered on the inner wall of the storage compartment and sink inward enough Space to maintain the storage of the mini robots.

The design width of the double butterfly robot's is each of 6 inches. This width refers to the direction from the bottom to the legs of the user.

The height of the double-butterfly robots is designed to be 3.5 inches. This height means from below (Bottom of the barrel) up (buttock direction). The size of the double-butterfly robots storage compartment

[c], The storage compartment is designed to have a thickness of 70 mm. In the storage position of the mini robot's, its thickness is 100 mm. The storage compartment is designed to be 6.1 inches wide. In order to ensure the high tightness of the storage compartment of the double butterfly robots, it is even smaller. The height of the storage bin is designed to be 3.6 inches, which is even smaller in order to ensure the close height of the storage bin of the double butterfly robots.

[d], When the storage compartment of the double butterfly robots is completed, the 4 pressure spray heads will start to inject clean water containing 1% Bleach into the storage compartment. It can be understood in this way that the mini robots are soaked in the disinfectant when it is not working. Therefore, leakage prevention is designed around the storage bin. The upgrade of the present invention separates.

[e], The upgrade of the present invention separates the person's body injection and cleaning water, which is performed and completed by using clean drinking water. 1% Bleach water must be used for equipment cleaning and foaming. Between the two needs to be transported by different water reservoirs and pipelines, special attention is required.

[f], Mini Robot at Present With the demand and development of industrial robots, aerospace equipment and medical equipment, the extensive application of high-precision robots has become very common, today in the medical field robots for patients to do surgery is not news, unmanned aircraft, unmanned ship, unmanned vehicles, a ubiquitous.

The most critical part of the present invention is the injection machine, which is the soul of the present invention. A variety of AI systems are its brain. When different high-end sensors transmit data to the AI system, the machine must be able to think about how to operate according to various instructions and how to perform accurately. There are two injection machines in the present invention.

They are the AI smart “butterfly wing type” machines on the inside and two sides of the present invention. They are part of it when they are not working. Each has basically the same function, but the size is different. When the AI intelligent system senses that the user is sitting down, the two “butterfly wing” robots will slowly rise from the inner sides of the toilet to the left and right sides of the user's buttocks under the instructions of the AI system. It stops automatically when it is close to the human body by two millimeters.

The upper part (A) of the AI smart “butterfly wing” on the left is small. When it starts to work, it will slowly separate and extend from the AI smart “butterfly wing” machine. The various high-end sensors and white cameras on the “butterfly wing” will transmit the distance and position of the target to the AI intelligent system through data at a high speed, and the AI intelligent system will at the same time inject the water machine

[g], Issue instructions to guide it to accurately align the user's urinary organs for cleaning. In addition, if the user is a woman, the injection machine can directly extend 5 millimeters into the woman's vagina to clean the internal spray, and then clean the outside of the organ in all directions. Special attention is needed: AI intelligent “butterfly wing” robot and injection robot are designed with many 0.5 millimeters of overflow holes (interval 3 millimeters apart) on the entire body.

When it starts the water leaks out continuously during operation, and the goal is to keep it as clean and clean as possible. Until the entire work is completed, the pressure spray heads 6 designed in the left and right sides of the barrel will automatically flush them, so as to ensure a high standard of cleanliness.

[h], The basic function of the note machine the basic function of the note machines on the right is the same as that of (A). When the user sits down to excrete, the first time: the various high-end sensors and the body camera on the “butterfly wing” The target distance and position is transmitted to the AI intelligent system through data at a high speed. The AI intelligent system also sends instructions to the injection machine (B) to guide it to accurately locate the user's anal position. Currently, the injection machine (B) Slowly and accurately 100% anastomosis with the user's anus under the instruction of the AI intelligent system, and then lifted up 3 millimeters to make the anastomosis basically tight, and began to contact the user's rectum (human body's anus). The urinal) is filled with drinking water. Note: The AI smart motion functions designed by the robots (A) and (B) are as follows:

[1]. Move 1 cm to the left→2 cm→3 cm→4 cm→→→→50 cm→

[2], move 1 cm to the right→2 cm→3 cm→4 cm→→→→50 cm→

[3], move up 1 cm→2 cm→3 cm→4 cm→→→→50 cm→

[4], move down 1 cm→2 cm→3 cm→4 cm→→→→50 cm→

IV, the high-end sensor and the body camera transmit the data of the target distance and position to the AI edge intelligence system. The AI edge intelligence system obtains the input data and performs high-speed calculations, and then outputs the calculation results (instructions) to the medical machine.

Note: The machine knows its own task and target position to move quickly and accurately. The first time needs to pour into the probably 50 milliliters water, lubricates the user rectum wall (Separation rectum wall and bowel movement adhesion), helps the bowel movement May quite easy overflow smoothly. After completes the first irrigation, the AI intelligence robot can rapid crash downward a centimeter, with to side Moves a centimeter. This invention AI intelligence system can act according to each kind of camera and the electronic transducer to user's excretion the condition carries on the observation, by determined drains whether already started, or the user merely drains the gas, also or was the water which already poured into The nature flows out, the water has not entered user's rectum, the excretion simply has not started. no discusses is front any kind of situation, this time AI wisdom Can the robot need to carry on the second irrigation.

For the second time, 100 fml of water needs to be injected. After completion, the AI intelligent machine will quickly fall down by one centimeter and move to the side by one centimeter. If the amount of water injected at the first time cannot reach the immediate target, the amount of water injected at the second injection can basically cause the user's rectal cavity to dilate (this amount of water can be used to enter the user's rectal cavity).

The inside size is about 3 cm. This position is the key to direct adhesion between the stool and the rectum.), these water help separate the stool from the rectum, and lubricate the rectum, which effectively helps the user to excrete smoothly and quickly.

This process will not More than 3 seconds. Maybe someone will worry about whether the water volume of 100 fml will be a safety issue when the user is unable to excrete normally? The answer is negative.

Because the various organs of the human body are soft and elastic, when the water is injected, it will naturally support the rectal menstruation. The user here is sitting on the system of the present invention for excretion, and the anus is almost Vertically to the ground, when the injected water supports the rectal menstruation (the water separates the close adhesion between the rectum and the stool): the user cannot effectively maintain these water and stools, and the rectum will contract naturally,

Under the action of the ground attracting people at the same time, it will be smoothly discharged downward (Just like when you are rinsing, if you drink too much water, it will naturally overflow from the lips.), and then all the tension and pressure the swelling and swelling disappear in an instant. This smooth and relaxed feeling is an indescribable happiness, especially for those users who have problems with excretion during the period. For the third time, 200 fml of water needs to be injected. After completion, the AI intelligent machine will quickly fall down one centimeter and move one centimeter to the side. Of course, there are exceptions to everything, and there may be some very special users, such as a certain period of patients, and the first two injections cannot reach the predetermined target, then the second injection The action will be repeated until the user completes the first excretion. If after the first and second injections have reached the predetermined target, the user's rectum has enough space to hold 200 fml of water.

V, this water can help clean up the remaining stool and excrete

For the fourth time, you need to inject 300 fml of water. After completion, the AI intelligent machine will quickly fall down by one centimeter and move to the side by one centimeter. This water cleans the user's rectum, the human body urinal (just like a human rinsing is used to clean the cavity after brushing), and it also takes a step towards cleaning up the waste remaining on the surface. You can do it repeatedly until the user is satisfied. This requires special attention.

Due to the differences in the size of the body, for some people, whether the amount of these injections is sufficient will be a problem, and the individual user feels that it will be different. However, there are differences. In order to meet the personal needs of various users, the AI intelligent system of the present invention has a voice control program, and the user can control various functions of the system of the present invention through natural voice communication. However, for safe use, the system of the present invention locks the maximum injection volume at 450 ml at a time. In fact, the real safety does not need to be doubted. Because the user is sitting on the toilet almost vertically, the AI smart injection head machine injects water vertically upwards, and the water injected in the process will naturally flow downwards, no one can be effective in fact, the water that can be injected is only about 70% of the injected water, and it is impossible to cause any harm to the human body. This is because the amount of excretion of the body is about 450 grams (about one pound) each time, and the amount of water injected is almost the same or even not enough.

The most important part of the machine—the volume double cycloid reducer is an important invention in the field of precision motion control. It has overturned the 100-year history of traditional wheel transmission technology and will be an epoch-making in the machine industry.

Meaning.

It is a kind of precision reducer that can directly replace RV and harmonics according to its operating principle and replace the star wheel box. Compared with other spherical reducers, it has a larger transmission range and higher overload capacity. But it takes the outstanding performance, the entire joint application (uses in industry or human form robot) as well as the more cost superiority easily as the market institute Accepts, and uses in the driver profession.

VI, The HSOAR double pendulum armature speed reducer took high (The stiffness of the boat.) the precision control speed reducer, the innovation has used the double pendulum Linear discrepancy fast output. Because all steel balls all completely contact suspend the coil, therefore, this transmission gearbox has the volume small, the weight is light, rigidity high, Carries the ability strong characteristic.

Moreover, its revolving vibration, inertia extremely small, therefore is adding the deceleration aspect to maintain the good performance, localization Precision high. Therefore, all axes of the micromachine of the system of the present invention can use this type of precision reducer in one stop, without distinguishing J1, J2, J3 or J4, J5, J6 axis. These reducers are available in coaxial and straight configurations.

They use precision ground steel balls as the transmission medium, which is different from the more common wheel boxes. Compared with the more traditional star-wheel reducer or cycloid reducer, this method of using eccentricity to produce deceleration is different.

It has no backlash. Therefore, while preloading the ball, there is of course zero backlash to ensure that the entire drive has 100% meshing. One feature of rolling contact is that it reduces noise and extends the service life. In order to achieve the longest service life possible, the designer adopts the rolling friction transmission method, which effectively reduces the temperature rise and wear during the operation.

The output mechanism of the cycloidal pin wheel is never worn, and deformation is usually impossible, which has obtained the longest service life reducer technology. VII, the low-noise and zero-vibration transmission meshing mechanism belongs to the rolling contact method, which has no impact and has low operating noise.

When a person is moving forward, resonance occurs. The ability of the reducer is specifically to check whether there is vibration. Two cycloid motions of different frequencies will eliminate the source of vibration. A variety of ratios use differential transmission, the first-level maximum speed can reach hundreds of thousands, through the corresponding combination, it can reach thousands, covering a wide range of speeds, the lowest speed is used the single digit 5 is calculated.

High load output adopts cross-roller bearings (or double row contact bearings). All steel balls are meshed and driven with high contact degree, which has high load capacity and overload capacity. In addition, it is designed to be an ideal choice for the micro-machine of the invention system, which has cables, pipelines, and various axes to cross the rotating axis. This structure is also suitable for synchronization & belt drive, which can save space effectively.

Efficiency is due to the combination of rolling contact with steel balls and pendulum, which effectively reduces friction resistance in the fortune hence the efficiency of the transmission is high, often 90 percent or more.

The zero-backlash steel ball is used as a precision reducer for the ball to replace the traditional fixed wheel. 10 The seamless rolling pair is formed through the pretension and the pendulum raceway to achieve zero backlash and high accuracy. There is no dead cycloid motion trajectory, realizing an all-around movement without deadlock.

The maintenance-free reducer adopts a closed structure and is pre-filled with high-viscosity, corrosion-resistant, wear-resistant, water-resistant, and antioxidant grease. It can effectively prevent oil leakage, and there is no need to fill or replace grease during the specified operating life of the reducer.

It can be used in conjunction with any type of motor through appropriate connection methods to meet various mission requirements in different environments and locations. This is a very mature technology that has been widely used in the past. To smart medical care, aerospace, unmanned airplanes, automobiles, etc.

How can we Achieve the Goal Pursued by the Present Invention

The following items are the key points that must be paid attention to.

I. The main types of precision reducers for machines the precision reducers for machines often include:

[a]. RV reducer. The RV decelerator is a combination of the planetary decelerator and the swing needle wheel decelerator. It offers excellent performance: high rigidity, low contact force, high precision in parts machining and installation, and high drive efficiency. The combination of planetary drive mechanism and compact W output makes the machine compact, small and lightweight. The use of single-gear or less gear differential transmission, transmission ratio is large, meshing gear Large, strong carrying capacity, the use of life long and so on.

[b]. Harmonic reducer. The harmonic reducer is a new type of reducer developed by the principle of star-wheel drive. It consists of wave generator, steel wheels, flexible wheels, flexible bearings and cross-roller bearings. The harmonic reducer has the characteristics of high motion accuracy, large transmission, light weight, small volume, and small moment of inertia. Precision planetary decelerators

[c]. Precision planetary decelerators, etc. The main transmission structure of precision planetary gearboxes are the solar wheel, the planetary gear, wheel, the inner gear circle. Because of it Structural reasons, single-stage deceleration ratio of 3 to 10, usually integer, with high rigidity, high precision, high transmission efficiency and maintenance-free peculiarity. Each of the above three types of “reducers” has its own advantages. 11 Specifically, which one should be used in the present invention, and only the results obtained after repeated tests are the previous use cases. Special consideration is needed in testing: smart sensors, AI edge computing, micromachines, the fusion state of the three, from data transmission to data analysis and instruction generation, to execution of instructions, and so on. In short, integration is the key to success and the basis for achieving user experience.

II, by this guaranteed they work accuracy and validity

[a], This invention system design needs all to have the essential use in the complete AI intelligence robot each spot its connection system “the reduction gear”.

[b], The accurate motion requires a micro-motor to provide it with a motion, and the intelligent micro-machine of the invention system is an AI smart micro-machine. Step in (1.8) motor. Or, name stepped in servo motor is also a good choice because it's made with inner feedback circuit, they can accurately reach the exact degree and position required by the given invention system.

III, Electrical machinery driver.

How in this invention system AI intelligence robot use? electrical machinery driver? In assembly and industry establishment electric motor the driver is for the control motor speed, revolving and the order. They receive the position switch the input, fan barometric pressure, logic The setpoint, and inputs them to the PID return route in, by transmits the best reference signal the electric motor. They also integrated the NC security electricity The road, the protection device and the personnel, for example use in the coil the freeze controller, the electrical machinery overload or the more complex strength sensor, these sensing's but may examine the manpower is not the process material.

Arduino and Raspberry Pi all are inexpensive operates the source controller, and has the prefabricated script storehouse, may defer to in this invention system Each kind of demand uses or revises them.

Simultaneously pays attention to the understanding proportion integral or the proportion integral differential circulation working, may with ease for this invention design specific script. The variable frequency drive (“vfd”) controls the speed of the induction motor by changing the frequency of the alternating current fed to the motor, so the speed of the motor will change, and can be used for any reduction or increase in the control system and the automation system The speed of most processes.

It is usually called “vfd” in the process. Special attention should be paid to: General-purpose machines usually require 12 V brushless DC motors. (Although they may have some other specifications) Now, microprocessors/controllers such as Arduino, 8085/91, etc. cannot provide that much voltage (the output pins of the Arduino board can provide up to 5V), 12 The remaining current cannot be transmitted to the machine. Here, a motor driver IC like L293D/N is needed, which can solve these low voltages and act as the driving motor of the AI micro machine, without overloading the microprocessor part of the machine. Think of it as a coupling circuit similar to a relay.

When using a low-voltage electrical circuit (such as an IR switch) to drive a system with high power requirements (such as a 220V or 110V AC household power supply), a relay will be used. These can be searched on the web, and then selected after obtaining the correct answer. During this period, repeated tests are required to meet the requirements of the invention. For example, the motor driver IC that is often seem is L293D. In a normal linear robot, the signal voltage from the sensing is 5 V DC. Not enough to drive the 12 V DC motor used in linear robots.

Therefore, the driver is connected from the sensor like a relay Once a 5 V signal is received, 12 V DC can be used to drive the motor. An L293D can be used from two sensors at the same time The signal drives both motors at the same time. However, it needs to provide 12 V DC power to the IC alone.

IV, Microcontrollers in Linear (Mini) Robots

The invention micro-robot in the test phase: can use 4-5 basic portal to build perfectly A functioning basic line follower for decision making. But the robot is only “basic.” If you must build a smart line the road follower (robot) requires a microcontroller. A microcontroller is a processor, and other peripherals, such as ADCs, RAM, EEPROM, timers, etc. are all integrated in the same package. Unlike the original portal, microcontrollers are fine Programmed according to the requirements of the present invention.

The microcontroller in the system of the invention must be able to program it to portal follow this The special need of inventing the system makes the robot have some sense of rules of intelligence. For example, if it runs on a straight line or curve and moves to the right, or if the robot exceeds the line, and if the sensor array Reading all black allows the controller to temporarily stop the robot there based on the last active sensor data. to wait for data Work continues after the update (these problems are completed in milliseconds from occurrence to end).

In addition, if the sensor emits noise, then You can use ADC to determine what is a “high” signal and what is a “low” signal. Use a timer to control motor speed and also to use “PWM” for faster robot speeds. IV, these microcontrollers (robots) are easy to program and can be debugged immediately What's wrong! Of course, you can also use a few triggers IC, timer IC, ADC, etc. to integrate to meet the requirements of the invention Special functions of seeking. Microcontrollers should be manufactured so that all peripherals can accommodate processors in minimal space. Thus, Microcontroller is necessary for AI intelligent robot of the invention system.

And to have programmable functionality, not with a separate IC The same. In short, they allow 13 rapids prototyping. Microcontrollers are like human brains. Because humans have brains that can Actions and reactions are performed at the same time, so robots are also required to perform tasks and respond to situations. If the Robot Is Fitted Microcontroller, which can then handle everything that can happen when a robot performs a task. The microcontroller acts as the robot's large Brain. It is essential to receive input from the sensor and to control the motor's motion accordingly. In addition, the invention system AI intelligence Microcontrollers needed by robots must be able to easily implement algorithms for improving line followers, such as the PID algorithm. This This is why the invention system needs to use microcontrollers in micro-robots. Therefore, a note is required when customizing or selecting in the market to ensure the normal realization of the invention system.

V, Which microcontrollers can be adapted to the requirements Which microcontrollers can be adapted to the requirements of the system mini-robot of the invention? The answer depends on the sensor used and the algorithm used. You can use a microcontroller like the at mega series (At mega 32, 32A, 8, 16, 328) that is operating at 16 GHz. However, in order to obtain the best results, the accurate sensor and PID algorithm should be considered. In addition, the number of sensors used needs to be considered.

For example, use three sensors: Left Road test, right road test and obstacle detection as it moves toward the target. Two indicators, forward and stop. two motor drive pins; 7 GPIO total Pins. Of course, manufacturers can search on the Internet, and the keyword should be “strong function but low price”, for example: pic12/16, and some AT tiny can also be considered. 8051 is the simplest microcontroller used in line follower applications.

The line follower (machine) uses a closed-loop feedback algorithm, in which the controller uses the feedback from the line sensor in the future to correct the path. You can also try Arduino-based circuits to learn how to use different controllers to develop the microcomputers required by the system of the present invention. It is also necessary to consider the requirements of the available programming tools for its components, such as ADC, port, timer, etc. Has the micro controller linear follower robot been the simple design robot, may follow the specific way or the feeling.

May cause and so on designs it with Arduino, AVR,8051. The code is extremely simple, very easy to renovate. The use portal and the logic circuit design needs Must be careful processing, have first to design the power source specially, then, may use the electric motor driver to design the electric motor the movement. Moreover, but also may act according to this invention system special demand to design the electric circuit other parts.

Design use controller, then may approach the regulation. The foreword provides this invention the concrete set of instructions, the robot in the duty when which the followed 14 execution designs may follow these sets of instructions. Uses micro controls the regulator is gives the cerebrum the robot, is not merely for them the eye.

VI, Machine software program ROS (http://www.ros.org) can be regarded as an open-source collection of programs, tools, algorithms, and even drivers for various machines and applications.

It supports C++ and Python as programming languages. About ROS Robot Operating System (ROS) is a flexible framework for writing robotic software. It is a collection of tools, libraries and conventions designed to simplify the task of creating complex and robust robots across various machine platforms. It is more difficult to create truly powerful universal machine software. From the standpoint of the machine, the insignificant problems in the human category usually differ greatly between task instances and environmental instances.

It is very difficult to deal with these changes, so without any individual, the laboratory or institution can hope to do it themselves. Therefore, ROS was built from the ground up to encourage the development of collaborative machine software. For example, a laboratory may have experts in indoor environmental mapping, and may provide a world-class system for making maps.

Another team may have experts using maps to navigate, while another team may have discovered a computer vision method that allows It is good to identify small, messy objects. ROS is designed specifically for such groups and can collaborate and work with each other as Foundations. Is ROS suitable for the specific use case of the invention system? Some reasons for using ROS may be considered. Distributed Modularity Design. ROS is designed to be as distributed and modular as possible so that users can use as much ROS as they want. [0146] The distributed nature of ROS also promotes a broad community of user-contributed software packages that add to the top of the core ROS system Added a lot of value. Ultimately, there are more than 3,000 packages in the ROS ecosystem, and that's just the time people spend announcing to the public ROS package of. These packages range from proof of concept for new algorithms to implementation of industrial-grade drivers and features All content. The ROS user community builds on a common infrastructure to provide an integration point that provides access to hardware drives Access to dynamic programs, general-purpose robot functions, development tools, useful external libraries, etc. In addition, the dynamic ROS community has evolved over the past few years to include large-scale use communities worldwide. historically See, most Hu applications are in the research laboratory, but more and more see its wide application in the commercial field, especially in the industry and service robotics. ROS itself provides a 15 lot of value for most robotics projects, but it also provides a lot of value with ROS The opportunity for world-class robotics experts in the zone to connect and collaborate.

One of ROS nucleus core philosophy is the public module sharing development. Certainly, this invention system future producer might also consider the AI wisdom Can outside the robot development and the production wraps, or outside the part wraps. At present, in the market has the very many technical extremely mature producers to be possible to elect Selecting. VII, select the necessary smart sensor to install in the micro machine (Mini robots). Due to the size limitation of the micro machine, if the smart sensor is produced by custom-made products, it may be able to meet the requirements of the present invention. On the small size of the micro machine body, consider installing a design that can meet the function.

A sufficient number of smart sensors. But whether this can guarantee the performance of its work, including accurate response functions, conversion between functions, integration execution between functions and functions, and others, etc. All of these require repeated tests during the actual production of the system equipment of the present invention in order to obtain good results.

Therefore, this invention system design two choices.

[1], if you can install all the required intelligent sensors in the small size body of a miniature robot, of course, is the best choice. In this selection, the following sensors need to be installed in the miniature robot. AI intelligent photography sensor IMU (Gyro+magnetic+accelerometer integration−starting), Smart infrared sensors Smart distance sensors Smart optical sensors, Smart pressure & sensors. The function of the upper sensor is to ensure that the micromachine can accurately match the user's cylinder, and then lift it up by 3 mm to ensure a certain tightness after the anastomosis to ensure correct infusion. Water enters the user tank.

First, at each step of the entire motion process by the AI smart camera sensor, all the motion image data is continuously transmitted to the AI edge computing brain. Through the eyes of the AI smart camera, plus the brain of dual AI edge computing, IMU sensors are controlled. It starts from the micro-machine “B” and separates from the “butterfly” machine. The location of the user's tank is close, and any obstacles (if any) that may appear in the trajectory of the movement are eliminated during the movement. For example, when a micro machine is close to the user's tank, it is very likely that feces will be removed at this time. It is leaking downwards. At this time, the IMU sensor will transmit the data in this state to the AI edge computing at high speed.

The instructions generated after the high 16 speed calculation will immediately stop the micro machine from moving, and quickly move to the side Avoid. After the user's excretion ceases, the IMU sensor will tell the AI edge computing the new data, and proceed to produce new instructions, and the micromachine will continue to match the user's cylinder. At this time, the intelligent infrared sensor and the intelligent distance sensor will determine the timely state between the micro machine and the user's cylinder, including the distance between the two, and find the position deviation between the head of the micro machine and the cylinder.

[2], These data will be transmitted to the AI edge computing at a high speed, and new instructions will be generated to indicate the direction adjustments that microcomputers need to make. In addition, intelligent optics and distance sensors use AI edge computing to control the machine to slowly, kindly and softly and accurately contact the cylinder when the head of the micro machine is ready to match the cylinder.

After completion, the head of the machine is lifted up. Now, the intelligent pressure sensor uses AI edge computing to control and grasp the pressure produced by the contact between the head of the machine and the cylinder. This pressure must be controlled to no more than 50 grams. After completing the previous steps, AI edge computing will perform the last data check, and start to make notes after confirming that everything is completely normal.

The system of the present invention is designed for micro-machines. This is the “multi-core and multi-threaded” IC designed to be installed on the AI edge of the device, and the AI edge computing (it is also multi-core and multi-threaded) IC that is used in the IoT system to process household data.

According to the software design of the system of the present invention, when the user uses the system equipment of the present invention, this situation perfectly satisfies the first priority program set by the software. Therefore, dual AI edge computing will give priority to the users' various services to provide the highest priority computing and support.

VIII, the invention has designed eyes for a micro machine (Mini robots) This is two butterfly machine and two attached to it Mini robot.

[A] and 4 smart photographic sensors on.

[B]. The following_describes in detail the location that needs to be correctly installed in the machine:

[1], The smart camera sensor is installed in the correct position on the upper side of the machine on the left (double “butterfly”). 17 This location must be able to observe and supervise the entire operation process of the micromachine to the maximum extent, and be able to easily transmit the data produced during the observation and supervision process through various smart sensors installed on the body. Communicate with AI edge computing in a timely manner. It is an intelligent supplement to the micro machine. It supervises and helps the micro machine to accurately perform the set tasks. At the same time, it constantly communicates with the AI edge computing through data in the process to correct and correct the micro machine in operation. The possible deviations in the trajectory. Therefore, this correct position must be most approaches the miniature robot the spot, and this spot cannot have the barrier with the miniature robot between, must be able to carry on the observation clearly. Must test repeatedly in the concrete production process found the best position.

[2], The right-side (double butterfly) machine, the right position of the top and the left requirement, and two butterfly machines, respectively There's 1,200 mini robot, 1,000 A, and B. So the requirements are basically eloquent. (Please refer to the section of smart camera)

IX, The present invention designs

The present invention designs a “nervous” system for micromachines. Let the micro Machines (mini robots) have the same sensory system as the human, it is realized by the various smart sensors installed on the body of the machine of the present invention.

These smart sensors will be able to operate during the operation of the system of the present invention. A large amount of data is produced. These data are obtained by AI edge computing in a timely manner and then produced instructions to help the machine accurately perform various tasks. (Please refer to the “Sensor” chapter) Select the necessary smart sensor to install in the micro machine. Due to the size limitation of the micro machine, if the smart sensor is produced by custom-made products, it may be able to meet the requirements of the present invention. Consider the installation of a design that can satisfy the function on the small size of the micro machine.

A sufficient number of smart sensors. But whether this can guarantee the performance of its work, including accurate response functions, conversion between functions, integration execution between functions and functions, and others, etc. All of these require repeated tests during the actual production of the system equipment of the present invention in order to obtain good results. Therefore, the invention system design two choices;

If it is possible to install all the intelligent sensors required in micro-machines; it is certainly the best option. Here, we need to put these sensors below and design them to be installed in mini robot. AI intelligent photographic sensor IMU (Gyro+magnetic+accelerometer+18 accelerometer+integration+starting,) Smart infrared sensors, Smart distance sensors, Smart optical sensors, Smart pressure & sensors.

X, the function of the upper sensor is to ensure that the micromachine can accurately match the user's cylinder, and then lift it up by 3 mm to ensure a certain tightness after the anastomosis to ensure correct infusion. Water enters the user tank.

First, at each step of the entire motion process by the AI smart camera sensor, all the motion image data is continuously transmitted to the AI edge computing brain.

Through the eyes of the AI smart camera and the brain of dual AI edge computing, IMU sensors are controlled. It starts from the micro machine “B” and separates from the “butterfly” machine, and uses the position of the cylinder is close, and any obstacles (if any) that may appear in the trajectory of the movement are eliminated during the movement. For example: When a micro machine is close to the user's tank, it is likely that the feces are leaking downwards at this time. At this time, the IMU sensor will transmit the data in this state to the AI edge computing at high speed.

The completed command will immediately stop the microcomputer from moving, and quickly avoid it to the side. After the user's excretion ceases, the IMU sensor will tell the AI edge computing the new data, and proceed to produce new instructions, and the micromachine will continue to match the user's cylinder. At this time, the intelligent infrared sensor and the intelligent distance sensor will determine the timely state between the micro machine and the user's cylinder, including the distance between the two and find the position deviation between the head of the micro machine and the cylinder.

These data will be transmitted to the AI edge computing at a high speed, and new instructions will be generated to indicate the direction adjustments that microcomputers need to make. In addition, intelligent optics and distance sensors use AI edge computing to control the machine to slowly, kindly and softly and accurately contact the cylinder when the head of the micro machine is ready to match the cylinder.

After completion, the head of the machine is lifted up. At present, the intelligent pressure sensor uses AI edge computing to control and grasp the pressure produced by the contact between the head of the machine and the cylinder. This pressure must be controlled to no more than 50 grams. After completing the previous steps, AI edge computing will perform the last data check, and start to make notes after confirming that everything is completely normal.

XI, The invention in software designs The following detailed requirements for software design are only for the purpose of making relevant developers clear; the present invention sets out some basic requirements that should be met in various aspects of software writing, and they are not intended to provide any software design and to be applied to the present invention, set restrictions, any type of software design and applied to the present invention should be included in the patent of the present invention.

The text editing and design of the software of the present invention system must be entrusted to the specialty of good reputation, reliable quality, and willingness to pursue design details industry companies. The software design method to describe the system functions of the present invention based on logic: Logic is used to describe requirements, specifications, designs and procedures. Requirements: Specifications and procedures are required to build “software” to control the accurate operation of the various functions of the system of the present invention, as well as their mutual integration.

It requires software engineers to edit and write codes to achieve the construction. The system of the present invention passes Intelligent sensor control “water level control”, “Water temperature control”, “water pressure control”, “injection (anal) water volume control”, “Washing (butt) water pressure control”, “seat plate temperature control” “,” “Bottom (butt) pressure (air) control”, “Mini Robots movement (accurately anal anal) control”, “Barrel lid induction opening and closing control”, and other things that were not shown in the system function of this, etc. In addition, it is necessary to thoroughly understand and understand the relationship between these functions and AI edge computing, as well as the accuracy of the work produced by mutual integration, implementation and development requirements for some non-conventional functions. These include requirements determination, specific functional analysis and design, implementation, software, file editing, code writing (including selection positive the exact code) then tests repeatedly to meet the design requirements of the invention system.

The writing of software documentation must be delegated to a reliable and reputable professional company. Because the system of the present invention is particularly emphasis on the execution of fine section is written, it is related to the very important user's personal feelings. Each element of the invention has its unique characteristics, which determine the interaction of software and machine. The real world the phenomenon determines the specific requirements of the invention system.

That's why it's possible to make demand capture a little difficult because it's in the crossing the invention, system should be used to check the software compilation and software design really understand the invention, The system's functional requirements and the software design is complete with its true commitment. So, after delivery, it's been returned to the test there are many problems, only in repeated tests to discover, modify, upgrade, etc.

XII, for Software Development

The blogger is a good idea. It is easy to ignore the real demand for the various functions of the invention system, because the direct shift can be made to start the “solve the problem” the general nature of the system's functionality is easier, but the accuracy of the detail will be a bit sleepy difficulty; this invention emphasizes the “pursuit of details” and is also a place to be noted. The gap between requirements and procedures should (probably) exist, and not all phenomena of the system function of the present invention are easy to design Software and machine fusion. Therefore, the various functional requirements of the present invention system and the software and machine can directly interact between the product there can be gaps, which require special attention, cannot be due to some problems in the software design and change any of the present invention system the ability to perform functions accurately.

XIII, Traditional software is from text to code writing—the transition from requirements to implementation procedures may be a solution to bridge the gap between the system function phenomenon of the present invention and this phenomenon. In a reasonable development process, each step in it follows the sequence from 1 to 10 and starts with the sequence and steps. For example, when the sensor designed and installed in the system of the present invention (AI smart bucket) finds that the user enters the toilet and then gradually approaches, the first (first) lid of the bucket is automatically opened.

When the AI intelligent system determines that the user is facing the system equipment of the present invention and begins to take out the excretory organs, the AI intelligent system will automatically use the system of the present invention designed in the bucket during the excretion process of the user. The cleaning system progresses slowly and orderly, producing small water flows out, and constantly cleaning the inner diameter of the barrel until the user completes the excretion, and then closes the lid to clean the entire barrel.

In this example, the order of the functions can be clearly understood:

[1]. The user is found

[2]. It is judged that the user has excretion needs (gradually approaching the device)

[3]. The lid is opened

[4]. It is judged whether the user is on the device

[5]. The function starts to cooperate with the user's excretion process

[6], determine that the user has completed the excretion

[7], close the lid of the bucket

[8], clean the entire inner diameter of the bucket, The above-mentioned |all are in the most elegant and economical order, is not the complicated thing that exists in the reality of the living. You can taste it try to follow established procedures as far as possible and, if not departed from established procedures, the final product and the archive would be the desired result.

In addition, the editing of software text and code design also need to emphasize the following three steps.

[a], according to the system design of the present invention a variety of functions Document each requirement in detail.

[b], From the various requirements expressed in the system of the present invention, it is found that the phenomena of sharing these functions are tabled the specifications of various functions of the system of the present invention. Therefore, the specification describes the various functions and application domains required in the system of the present invention the interface or boundary of.

[9], from the specification we draw the program. The procedure relates to the sharing phenomenon and inner of various functions of the system of the present invention phenomenon. The writing and code design of the software text is to provide proof that the software program meets all the functional needs of the system of the present invention reasons for seeking. How to produce a specification, assuming—If the system equipment (machine) of the present invention behaves similarly, then the specification requirements can be met. That is, implementation correctness: (Equation 1) implies that it is a more specific or defined product requirement than a more abstract specification beg. This makes the program more useful and easier to implement than the specification, because the program describes how the specification is implemented, whereas the specification describes the necessity what needs to be achieved without any unnecessary attraction to the internal details.

XIV, the implementation of the specification is a program that can be used with assertions from logically describe it. Since predicate is a theorem of proposition logic, the system equipment (machine) of the present invention meets its specification. If the rules are met fan requirements, then the requirements are also met, that is, specification correctness (Equation 2), system correctness: (Equation 3) in the above development in the process, software text and code design need to be distinguished between specifications and requirements.

The term “norm” is one of three terms that represent requirements, specifications, and procedures. Demand only with the present invention system equipment (machine) Environment-related, that is, related to the real environment. Programming_will certainly be interested in phenomena on the boundary, but this interest is that the acquisition of the device (machine) must be in the demand for data on its upper shipment is triggered by the demand for data. The norms form a bridge between demand and program, and the norms are only about common phenomena—yeah.

The specification is therefore a requirement of a ‘species’ (which relate to the various functional phenomena of the invention system), but it is also part of the program which is They are involved in certain equipment (machine) phenomena. Because the specification is the function of the device of the invention system through many reasoning steps in fact, it is necessary to ensure that these functions are not affected by the deviation of implementation, i.e., the “machine” details Interest.

The quality of the final software will be determined to a very degree by the correctness of the description of the system domain and demand of the invention. The logic of software design is often a novel way to save work that has already been done. Deliver products on time and within time and cost overriding requirements often mean that at least logical analysis and calculations cannot always be done carefully in detail.

Software development is now just because you can't find an accurate mathematical description doesn't mean you can't find one. Software engineers will seek a balance between sketching and accurate descriptions and calculations weigh. Therefore, useful software development methods will allow software engineers to choose the appropriate level between mathematical and informal descriptions balance. Logic is a useful tool for verifying the correctness and achievability of specifications.

Once the software text is written and designed to verify the module specifications, Logic E and theorem proofs can be used. Although the complete development from specification to implementation can be completed mathematically, it is also possible to use logic calculations to derive routines from the specification, and the program meets the conditions for correctness. If you use a programming language that does not support simultaneous assignment, you may need to further optimize the code.

Use the same type of calculation as the design calculus for this derivation, logical connectives and quantitative words, such as combination Taken, implication can be used for program optimization, also known as program correctness (Equation 1). If (that is, all the actions described by the program) also meet the specification, the program will implement the specification. Connection is a common method for expressing connection and interaction in an assembly composed of two or more components. For example, consider two classes that each satisfy invariants.

If both classes are used in a given program, then the behavior of the assembly can basically be guaranteed to be consistent.

XV, if a specification is complex, we can decompose it into two sub-standards (or design into).

Then, each design can be implemented in a separate program and provide theorems. The final realization is to ensure various functional requirements of the system of the present invention through planned calculations. The above has shown how to use logic to describe requirements, specifications and procedures.

In addition, logic can be used as descriptive calculations throughout the software life cycle (including design, implementation, and documentation). Finally, the logic calculation format can be used in all phases of the software life cycle. How to realize the various functional programs that regulate the system equipment of the present invention, or determine the set of components of the system components of the present invention that meets its specifications combine.

Well, the computational format must have the advantages of simplicity, ease of reading, ease of use, and how to make it in all stages of software design using computational logic is an important problem in software text editing and code design. The system of the invention has various functional needs and fusion stronger theorems will be required to simplify calculations, which can greatly improve the reliability and safety of the present invention system. Informal description of the case study is provided below:

As an example of the wall-type water tank of the system equipment of the present invention, if the value of the water in the water tank is 10 units when it is fully loaded, then “when the water in the water tank is reduced by 1 unit or more, the water in the water tank is reduced by 1 unit or more. The level sensor should send out low liquid level warning data.

Then the software controls the water controller to open the water valve when the liquid level is low, and fill the wall water box until there are 9 units of water in the water box. The maximum capacity of the water tank is 10 units, but the water level should always be between 1 and 9 units. The sensor readings are updated once every cycle, that is, every 20 seconds (a cycle).

Every time.

One cycle uses a certain unit of water, and then up to 9 units of water can be added back in one cycle. After studying the above problems, the programmer may immediately write reasonable code for the controller module. The main body of the module executes “set alarm. once per cycle.

If the tank level is already 0 units, the flank routine will the wall water tank input set point is set to 9 units. If the wall water tank level is 1 unit, the wall water tank input set point is set to 8 units. In this way, at the end of the cycle Fill the wall tank to exactly 9 units. However, there may be errors in the above procedure because the recommended design method described above is not followed.

XVI, in fact, if there is no specification that satisfies the correctness of the specification (Formula 2), We can't even start debugging the program.

A reasonable software design method requires the designer to first divide the system of interest into the actual domain (the system equipment of the present invention) and determine the relevant phenomena. In this case Below, the actual area is the wall-type water box, which is out and in. Including the phenomenon shared with the machine. (Water level and alarm).

Outflow is not a common phenomenon, because the machine cannot enter it Measurement. There are some requirements that it is not formal and cannot be expressed accurately; mathematical descriptions that can be used can be used to eliminate the ambiguity in the non-formal description. After determining the phenomenon of interest, the next step is to write the water tank.

It is assumed that the machine will read the level sensor data at the beginning of a cycle, immediately calculate the new value of in and produce Alarm, and then repeat this operation at the beginning of the next cycle after 20 seconds. Therefore., The demand can be described in terms of variables of interest at the beginning and end of any cycle. Water tank requirements is generated by the initial value of the water level, the alarm signal and flow rate are specified by the water level, the alarm and the discharge, and the cycle ends the water level value of the time. Therefore, the requirement states that the final value of the water level must be within the specified range if the water tank level is low (at the beginning of the cycle), the water tank must be filled (at the end of the cycle) to 9 units, and the alarm must be low at any level warning when level water level (at the beginning of the cycle).

Of course, there is another state that must be considered. For example, when the water tank is in front of the user, the user has just completed the use, and the other user has a need for use (this is in the life of the user). It is very common).

Currently, the water position of the water box may be at a lower water level, and the software controller should be executed separately, that is, the software control water valve is at the water tank water position.

XVII, When the set 9 water levels are not reached, the inlet valve should not be affected by any use status. The inlet of the water valve and the outlet during use by the user will naturally operate at the same time, even, Increase the amount of water input to ensure the normal use of users.

The next step in the recommended design approach is to describe the properties that characterize real-world domains. Real-world description: Domain attributes are guaranteed from what is required the physical law of holding traffic is derived from the fact that the traffic at the end of the loop is the level that the original traffic must maintain, and depending on the volume of the traffic small adjustment.

This is a hypothetical assertion that the outflow at the beginning of a cycle is a unit unless there is no remaining water to flow out (the Ministry). is not in the informal description, but must be added if you want to describe it accurately). In the absence of a controller, the water tank's “Self.” By “Run will not be able to meet the requirements.” This is because the inflow setting can be set to any value.

Therefore, in order to meet the requirements, we must a value must be specified. Requirements and descriptions in the real world can be referenced. However, without sensors, outflow is not a common and the machine's controller may not reference it. This is the machine specification: If the instant device is assumed to be fast-circulating (quickly) the instant's speed of the invention system much. Therefore, software and design must ensure that the above values are set and reported at the beginning of each cycle. Specification refers only to sharing phenomenon.

The specification of the software controller module described is realized. seems correct at first glance, because if water is zero it would add nine units' water if the water were to be 1+8=9, it would add eight units' water otherwise it would not add anything. Like the counter-case show up that's wrong. Consider the state of the cycle at the beginning of the cycle, in which it. This requirement is therefore, based on the above specification the method is to be full, as at the end of the cycle the water box is to be 9 units. The failure specifications do not take into account the fluid the fact that one unit of flow is available (note that there will be zero flow when the liquid level is 0). When performing the logical calculation of logical correctness (Equation 2), a counterexample was detected.

The correct specification of the controller is the machine specification. It points out whether the water level at the beginning of the cycle is zero units or one unit water, it must be added to 9 units. If we can prove the validity, then specify the correctness factor, determine what the level at the beginning of the irrelevant cycle is, and as long as the application domain meets the specifications of the actual machine, the requirements can be met. Therefore, the software design needs to read the data of the water level sensor immediately before the start of each application, not during the process or after the process is completed.

The above example leads to a situation that may occur in actual application: the occurrence of an accident. In order to fully guarantee the normal use of users, it is necessary to emphasize during software text editing and code design. Take the previous example as an example: when a wall-mounted water tank executes the output of the water, the water level of the water tank may be “0”. There are many possibilities for this phenomenon, including but not limited to network attacks, or software BIGs, etc.

This is a very important event. Therefore, it is necessary to make pre-settings during software text and code design, such as periodic system physical examination. The specific requirements are as follows:

[a], in a busy use cycle, every 30 minutes dedicated to set the software medical examination procedure will be the invention system for a comprehensive body the program reads all sensor data and checks and tests all controllers for their operating status, if used during this time period is in use and can wait for its use to complete.

[b], in the non-busy use cycle, every hour to carry out a full-face system physical examination.

[c], if abnormal state is found in testing and inspection, software text writing and code design should be designed with a set of programs capable of pairing abnormal state recovery, or removal of obstacles and removal of BIGs, to ensure that the system equipment of the present invention can rely on the operation. [d], if the above software fails, first, must pass the software to correctly assess the abnormal state, one problem cannot there are three steps that must be performed to recover from the set software:

If the above software fails, first, the software must be used to correctly evaluate the normal state.

Once the problem cannot be recovered through the set software, the following three steps must be performed:

[1], Turn off all the functions of the “mini robot” through the software system (that is, the mini robot stops working) to ensure the safety of the user.

[2]. After performing the above A, the set software will perform another physical examination to evaluate whether the remaining functions can be safely used by the user without the involvement of micro-machines demand. After three repeated physical examinations, in order to obtain a correct answer, whether the system of the present invention can be used safely at this time. If the answer is YES, all functions except the micro machine can provide safe services to users.

[3]. If B has been executed, the answer is NO, and the software must close most of the system functions. Currently, the system equipment of the present invention is similar to an ordinary bucket, but it still needs to retain some basic functions, because any time these functions are performed, the user has no security concerns:

[A]. The bucket is used After using the auto impulse function.

[B]. The automatic opening and closing function of the lid.

[C]. The designed drum cover has all the functions of cleaning the inner diameter of the drum and the seat plate. In some cases, software design must follow a hybrid approach to continuous and discrete mathematics.

For example, in the flow volume of more in the precise model, you may want to represent the relationship between the water tank flow and the valve setting as: until time, discharge from the tank the total amount is what, while the water tank flow setting is the time function State Time, Step and Hitch tools are software design tools, set examples of these toolsets can use algorithms and theorem proof techniques to analyze and calculate descriptions using real-time time logic or hybrid.

The properties of the system, these tools enable designers to analyze and discover uncertain reactive programs can be made throughout the process with the logical software development life cycle, can be used as a design calculus, but also can be used to record requirements, regulations, design and sequence. The use of logic provides both accuracy and the ability to predict software behavior, providing developers with something like it tools used in his engineering disciplines.

Spice has been used to analyze key analog circuits in almost all ICs designed in the United States. In addition, software text and code design require special consideration. For example, the first argument in the appendix of logic E6.1 inference rules is monotonous and expressed by theorems: one.

You can try to use PVS to verify the AI edge computing IC transistors and its microprocessors, and software to check the microcode instructions. Check for errors or lack of functional requirements. It is also necessary to check whether there are coding errors in AI edge computing (whether the stack size is correct). Of course, perhaps more effective methods have been produced on the market in the past to complete the previous tasks, but these software functions are very necessary and must not be lacking.

Software text writing and code design also need special consideration: dynamic sequencing (standards) when the software is operating normally, and constantly looking for the first priority that the software should perform. For example, when a user is found approaching, the first priority of the software is “Automatically open the lid”.

After this action is completed, the new first priority will be automatically changed to use the smart camera to distinguish the user. Body shape “is it facing the barrel or back to the barrel? When the AI edge calculation is completed, and the judgment is completed, the AI intelligent system of the barrel will take corresponding cooperation, such as (The first priority of the new product) seat plate heating or cooling, (the first priority of the new product) double butterfly intelligence Protection, (the first priority of new production) Micromachines began to work accurately. This example is to show that the software text and code design must be considered.

AI Edge Computing can Constantly Search

For and determine the new first execution priority during normal operations. In the gap period when the device of the invention is used, AI edge calculation will also be carried out non-stop physical examination to read the intelligence sensing data, to find out what may arise, to find and judge possible first priority.

The same water tank as the front for example, when using idle time, AI edge calculations check the water level in the water tank at any time, and even, test the discharge of a small amount of water to detect the data reaction generated by water level sensors, as well as various other intelligent sensor tests, and so on. The software development should thoroughly understand every detail of the present invention, especially the design of all the details that must be done is based on the user experience as the first priority.

Of course, software developers must also be aware; accurate sensor operation depends on the sophisticated design of software and hardware interfaces to meet specific performance requirements. At the same time, developers need to carefully consider the placement of the sensor on the circuit board and the nature of the housing used to protect the sensitive sensor, and optimize the accuracy and reliability of the sensor. Software development also needs to consider how the multi-sensor combination can be coordinated and accurately work on the system of the present invention at the same time.

Developers need to solve the problem of each individual sensor to avoid electrical or physical interaction between the sensors in the final circuit board design. They also need to pay attention to the reliable data conversion and transmission of various types of sensors in the system of the present invention at each stage of software and hardware design. The software development of the system of the present invention requires a specially designed application that can realize the various functions designed by the present invention, and can fully guarantee the accurate execution of the various functions of the present invention. In this operating system, there are some key factors that require special attention in software development. These key factors have the following points: sort and find out the first priority, the second priority, and the third priority category. First, software development needs to classify the raw data obtained from sensors. Including but not limited to personal privacy data of the user of the present invention obtained by the smart camera sensor. For example, the body, face, excretory organs, and some privacy actions of any user during use, and so on.

These are the first priority privacy data and need to be specially stored in the designated;

I, family data center (SSD or SSHD) and cannot be shared or transmitted. Here, the inventor cannot prejudge the complete definition of privacy for all users. Software development should design user options in the privacy definition function so that the user can determine in addition to the above. In addition to this privacy, the user is willing to add any other data to the privacy that needs to be protected.

Of course, too much data generated by the user during the excretion process is limited to the scope that needs to be protected. The complete operation of the AI system has a greater impact on the production. Therefore, the software needs to design a suggestion program that can tell the user that its choice has limited the service performance of the AI intelligent system. Perhaps the user can only choose the special purpose of this invention. The “manual operation” program is designed to ensure that the privacy of users can be completely and thoroughly protected, and normal use will not be affected.

The second priority category. The user's performance requirements during the excretion process, such as water temperature, water pressure, the amount of water injected (out of the limit), the short cleaning time, the specific needs of the user, and the production of these requirements What time of the day, and others, etc. After obtaining these raw data from the sensor, it is necessary to store the data on a designated storage card, and transmit the data to the distributed (local) cloud and remote cloud computing center during the designated time period when the network usage is low. The cloud computing AI intelligent system needs to perform calculations and analysis on these raw data, and then generate service instructions, and further train the AI edge computing designed in the system equipment of the present invention. The third priority category. The IoT system controls the raw data generated by various devices, which also need to be stored in the storage card. During the network low peak period set by the system of the present invention, the data is transmitted to the distribution (local) cloud and the remote transport computing center, which is AI The intelligent system analyzes and processes, and then generates instructions for the dual AI intelligent edge calculation designed for the present invention system and the IoT control system Train. The invention system and IoT can also carry out more classification, above just some tips, specific needs in the software open hair design process to perfect.

II, sorting the acquired sensor raw data may help the AI edge calculation to decide which order of services should be generated. Below are examples of sorting that are intended to help software development and design clear examples, not specific designations and limitations any possibility is worth noting:

[1], The privacy-level data specified in the first priority category above should be sorted in place.

[2], The above-mentioned first priority category clearly specifies that user-defined privacy data should be sorted behind.

[3], The original data of user requirements should be sorted in three.

[4], The raw data produced by the equipment controlled by the IoT system should be sorted in four.

[5], IoT system control equipment inside, refrigerator, home automatic lighting system, air conditioning system, smart wear system, smartphone, The raw data of the home hot water system, and others, should be reordered and reclassified.

The above indicates that there are many systems in the system of the present invention and IoT that can be sorted in detail, and the inventor of the present invention is not able to do so because of the length problem the law is arranged one by one, just to do a demonstration.

III, multi-essence AI edge computation software design in other all condition same situation, more essence usual table show up bigger energy strength. (The correct compilation software may use many essences to come one time to process the duty a part.) In this invention system-wide, the polynuclear usual performance is better. Therefore, the software development and design required by the system of the present invention should be multi-threaded (this is especially suitable for content creation and editing of graphics and video packages), and more cores will help.

AI edge computing cores should support multi-threading. In short, multithreading allows software to run two discrete processing tasks or threads on each core of the PC. Assuming software and operating systems can take advantage of it, the potential of simultaneous processing will be doubled. Intel calls this feature Hyper-Threading (HT), but in the AM D world, the generic term SMT calls it symmetric multi-threading. In fact, this is the same thing. For CPU-intensive tasks such as video rendering, supporting HT/SMT is the same thing. As with core counts, these numbers are only stated within a given processor family. For example: 3.5 GHz Intel Core X-series cores and 4 GHz AMD sharp mainstream cores are only based on clocks and cannot be directly compared. These are just the judgments due to formal benchmark tests and laboratory-based reviews.

The above-mentioned suggestions are the places that require special attention in the development and design of the system software of the present invention. A full understanding of the AI edge calculation IC index used by the system of the present invention is very important for software development and design, and is also the key to its success.

IV, the system design of the present invention has a home data center, its function and function is to protect the privacy of users; it is designed as the original Inventing the system dual AI edge computing manipulation, its physical properties should be a SSD or SSHD. Software must be designed with its none in mind limited scalability, no specification limits, can be extended to N GB. The data center needs to be designed by software: by 256 digits full coverage of protected home data centers must be password protected, and password systems must be able to accept and certify the specialty of computers characters, e.g.: smh.com.au, etc.

Software design must support password non-transferability, that is, in the user set after you have determined your own password, it can only be stored in the home data center, cannot be submitted or transferred, the password is also 256 bits digital encryption, because there is 256-bit data encryption, the user's privacy including password cannot be stolen by anyone. In family data center software design:

V, Classification. The software design family data center is divided into two categories (partitions): A, the private data storage area produced by the user when using the system of the present invention. These data include, but are not limited to, the graphics acquired by the user by the smart camera, the state actions during excretion, the graphics of excretory organs, and others, and so on. These data cannot be downloaded and moved outside. any electronic data uploaded by users and family members.

These data include the storage of any smart data of the user's family. The software must be designed to be able to upload and download. The storage functions must include graphic data storage, file data storage, image data storage, text data storage, App storage, Bookmarks storage, History storage, Theme Wallpapers storage, Password storage, Address storage, Phone number storage, Notepad storage, Date storage, and others, etc. To sort the above privacy data, the first priority should be the use of the privacy data generated in the course of the present invention, which data cannot be downloaded and moved out.

The second priority is the privacy data that users' homes can upload and download. Of course, the first and the second priority class can also be sorted because the user has such a need. Therefore, software design must create a “The Settings feature allows users to sort and sort “Customize” themselves, as well as a number of other options.

Software development and design should also consider the ability to support two design ideas:

[a], can be from local to global. From the local to the whole, it means that researchers think and design the local knot from the functional fragment first in this way, the characteristics of the local structure can be precisely designed, and the precise control thereof can be maintained.

[b], from the whole to the local, is a major advance in helping to complex design. From the whole to the local means software development designer determines the overall shape of the device of the invention system and then consider how to combine the functional sections as required get up full of the whole requirement. The two design ideas combine & design, which can design a more complex set of equipment functionality and maintain the fine of individual parts quasi control. In addition, the development and design of software requires repeated simulation and testing of actual usage, and designers can model inside the software, The system equipment of the present invention will produce various complex uses in the real world.

[c], As structural complexity increases, it needs to be evaluated the accuracy of the last appearance, and behavior of various functions of the present invention system. So, it is important to be able to simulate the operation of the system of the present invention, no A lot of design and development time is wasted.

Below are some essential factors which the software development needs to pay attention.

[1]. Consider the final use and implement the use test. In the whole process, it is very important to fully understand the needs of the users of the system equipment of the present invention. When creating a value-driven statement, software development and design must fully understand the product's target and the problem the product will use to solve the target. Consider the various stages of the project to be tested. Different methods can be used, depending on what kind of value feedback the software developer and designer want to get. Performing the user test of the system of the present invention before designing can determine whether the software design has sufficient user boundaries, while constructing it and ensuring that participants and test areas are prepared to obtain accurate test results.

[2], have clear targets and specifications. Create a road map for software development and design and develop a strategic plan to highlight the target. Detailed apparatus indicates what the team needs to help achieve the final design of the target. Before the Software Development & Life Cycle, create—value-driven statements to help set a precedent for the items, targets, and targets and the problems that the item will solve.

[3], hire experienced developers. Hiring skilled developers allows the development process to proceed smoothly. For senior developers investments are sure to cost more, but view from a long period, this can effectively reduce software development and design difficulties and save time and money.

[4], pay attention to the plan. The right planning will ensure that everyone knows what they are responsible for throughout the project. Before you start working, you should first determine the project strategy and approach that will guide you to your goal. Take the time to find out which opens you will use throughout the process tools and determine the technical architecture that supports your software. Sprint plans with clear milestones, application frameworks, generations code review, automated testing, error and task tracking.

[5], implements the effective project management. The project all benefit counterparts must agree a set may pay the achievement and the approval standard, avoids scope slow change and following extra cost. Between the service and the software development team's official agreement is the hypothesis is clear about the expectation and the elimination no matter what a what confusion very good method.

[6], there's a clear communication. Clear and coherent agreement is the pillar of successful software item's helping to avoid confusion, delay and mistakes. The stage in which communication is essential. Whether you understand your focus or achievement is still in progress the update should have specific communication channels (i.e. Slack, Skype, electro-mail, etc.) to coordinate the whole Team function effectively.

[7], focus on your design. At the design stage, the designer shall create a detailed design & file, specifying the technology for the product & target and the tools. Software development workers should then view the gear to correct the technological changes. Design is a blueprint to be built. It may take many times Test the luck to find the right design. That's why testing and improvement stages are important in the whole development process cause. You should form a team of excellent designers, who should give priority to the experience. They need some technical & technical & technical & technical such as the wire frame and prototype design of a flow model.

[8]. Implementing risks management. Software development and design always go wrong before testing is complete, so failure should be as elegant as possible. for this purpose, create risks Log and include action plans to mitigate and handle insurance early in the process. The software development team should develop a plan for the risk.

[9]. Follow the best practices of software development. Development teams should follow the best practices of software development. The development team should follow the code standard guidelines. Source management is another important component because it allows you to manage changes to code and provide a set of code medium source code. The software development team should be reviewed by the code before the program start. Code review is one weight of the software item to have components, you can help you identify any errors and defects. Code review ensures that software development & staff follow best practices while make sure the entire team reviews the code.

[10], for final and post-release review. At the beginning of the project, you should measure it using settings and data that are as close to production as possible Test the system. Once all of this is done and the final acceptance test is complete, the next step, deployment, is to be completed. The deployment process is project-based specific requirements for customization. The operations team should review, confirm, and approve the deployment documentation. No two projects are the same because each company has different requirements and expectations. As the project progresses, there will be others in the process some variables work, which can lead to additional time and cost, keeping software development and design out of order.

Combining Data Analysis and the Internet of Things

IoT will have a possible impact on the business of the present invention;

I, Quantity: IoT applications use a large number of data sets. Businesses need to manage this massive amount of data and divide it to extract the relevant patterns. These datasets, as well as real-time data, can be easily and efficiently analyzed using data analysis software. The data analysis of the system of the invention can play an important role in the increase and success of Internet of Things applications and investment. Analysis tools, The business department of the enterprise in which the present invention operates parts can make effective use of these data sets, the following are some important points.

II, Structure: The data set involved in the system and IoT application of the present invention may have different structures of non-structured, semi-structured and structured data sets. There may also be significant differences in data formats and types. Data analysis will enable the business executives of the enterprises of the present invention to use automated tools and software to analyze all these different data sets.

III, Promote revenue growth: The use of data analysis in the system of the present invention and IoT investment will enable the business department of an enterprise to gain a deeper understanding of the preferences and choices of users. This will result in the ability to accurately develop future new services and new products based on customer needs and expectations. In turn, this will decisively improve the company's revenue and profits.

IV, Flow analysis: This form of data analysis is also called event flow processing, which can analyses the giant motion of the invention system and IoT production data sets. In this process, real-time data flow will be analyzed to predict and detect possible emergency outbreaks and the correct should be taken response measures.

V, Spatial analysis: This is a data analysis method, used to analyze the present invention system, and IoT its geographical pattern to determine physics spatial relationships between objects. Location-based systems and IoT applications can be derived from this form of data analysis benefit.

VI, Time series analysis: As the name implies, this form of data analysis is based on the present

invention system and IoT at different times data to reveal relevant trends and patterns. The invention system and IoT application (e.g., customer every time use this invent the time of the system and IoT various devices, as well as their interval time period, and so on. Enterprises can take this form of data analysis from the party benefit from the law.

VII, Descriptive analysis: This form of data analysis is a combination of descriptive and predictive analysis. It is used to understand in specific situations the best steps you can 18 takes. The user of the invention IoT application can use this form of data analysis to obtain better conclusion. The first thing to know about the system and IoT data analysis of the present invention is that it involves data sets generated by sensors, which are now both cheap and complex enough to support the endless variety of use cases of the future.

VIII, Digi team's data collection solutions the good news is that the system of IoT design effective data processing by means of edge computing, machine learning and other advanced technologies form; The surge in the pool of equipment and its general opportunities in all areas of life mean that business owners should be more aware of, The type of such systems and the risk of collecting the associated network data.

Through AI edge computing to pre-classify data, private data and successfully stored in the “Home data center.” [b], time-phase processing of collected data, data transmission and AI intelligence training at low peak times used by the network every day. These data are valuable only when IoT devices are analyzed, so that data analysis can be introduced into the screen. Data analysis (DA) is defined as a process used to examine large data sets with different data attributes to extract meaningful conclusions and operable solution instructions. These conclusions usually appear in the form of trends, patterns, and statistical data, which help companies manage improved data to help them implement effective decision-making processes. The power of artificial intelligence is used to ensure that the enterprise owners of the present invention system can make full use of this data to provide high quality to the user service, this is the first scientific and technological development to improve human life services.

AI Machine Learning at the Same Time

AI inputs data into machine learning algorithms and observes usage changes that each user makes at different times or create new usage habits. It produces a variety of programs through repeated learning and deep thinking to try to meet and master, different users like personalized service.

Each time the system of the present invention is used by a single user; these sensor combinations will produce a large amount of user data, and this data is an important resource for machine learning. After the system of the present invention is officially launched, the data produced every day is exponentially increased, which is where AI intervention is required. This type of data is dynamically updated, making it difficult for conventional database systems to extract all of it.

[A], Therefore, AI intelligent systems that collect and analyze data that is critical to every consumer. The invention uses a large number of high-end sensor combinations to achieve a lot of special functional requirements. At the same time, AI intelligent applications are required automation function system: It must be able to accurately, for each different user's individual needs to provide high-quality intimate service business. In addition, the system of the present invention uses the Python language for AI machine learning requirements.

[B], Due to its simplicity, Python is considered to be the first in the list of all AI development languages. The grammar belonging to python is very simple and easy to learn. Therefore, many AI algorithms can be easily implemented in it.

Compared with other languages (such as Java, C++ or Ruby), Python has a short 19 development time. Python supports programming styles of directional objects, functions, and directional processes. There are many libraries in python, which makes our work easier? For example: NumPy is a python library, which can help us solve many functional calculations of the system of the present invention and IoT.

Use machine learning in Python. The massive data generated by the system of the present invention and the IoT every day are a data set in PB units, which is too large for a large group of people. AI can browse the data as fast as the Xeon processor in the server, and analyze and obtain solutions from the data at a faster speed than a human. The system of the present invention uses “R” in the computer language of the machine learning algorithm. “R” is one of the most effective languages and environments for analyzing and processing data to achieve statistical purposes. Using “R”, you can easily create well-designed publication-quality drawings, including mathematical symbols and formulas when needed. In addition to being a general language, “R” also has many software packages used in the field of machine learning. For example, RODBC, Models, Class and Tm. These software packages make the implementation of machine learning algorithms easy, and have relatively easily solved some problems related to the system of the present invention and IoT applications.

At the same time, AI makes no mistakes, the only mistakes it makes is not programmed correctly. Regardless of the size of the dataset, AI processing ensures that the data is processed error-free. That's what AI has to do at that point, AI has an order of magnitude of rigor. In addition, machines do not need to rest like humans. They can be programmed indefinitely time, can Run continuously without getting bored or distracted. The machine does not get tired even if it must work continuously for several hours. These feature pairs the present invention is too important, human need to rest from time to time to improve work efficiency. However, for machines, they are efficiency is not affected by any external factors, and it will work accurately continuously.

Moreover, the machine is completely unimpaled because of it they can make the right decisions in a short time and are therefore more efficient. The best example is their use in health care. Open by integrating AI tools into the healthcare industry, you can minimize the risk of misdiagnosis, resulting in improved treatment outcomes rate.

[C], Type of machine learning. Statement, which includes a model chosen to represent data by a single invention that makes the person's habits.

So, three factors are needed: decision tree, for example, the set of rules are three example cases of this component. The decision tree is a habit and the habit of the person by a single invention the result is a tree shape model. When computers compare new problems with the previous distillation of the previous distributions the examples of the examples are distributed based on the examples—Study. Previously, thousands of new machine learning algorithms were newly developed on the market every year.

[D], The following are the representative important components of most of the algorithms: evaluation, evaluation is to provide the machine with evaluation and optimization assumptions (candidate program) components. It is also known as a target, utility, or meter 20 sub-functionality. Some examples of the evaluation include the accuracy of the system of the present invention and the users of IoT equipment and their usage habits, as well as the errors that can be generated, post-test probabilities, etc. Accuracy fundamentally measures or evaluates individual classification models. The post-test probability is considering an update the probability that the information will appear after it appears.

[E], optimization, optimization is the way to generate assumptions. Examples of optimization include habits for users and their use of the present invention system and IoT line combination optimization, highlighting optimization and constraint optimization.

Portfolio optimization uses combination technology to solve discrete combination problems.

[1], supervise learning. In the process, AI intelligence must be able to tag individual consumer datasets, which means that AI intelligence already knows the input and its corresponding output. The invention uses an algorithm to map inputs to its output to train the model. Here, Benfa try to minimize the error, and then you can use the new data to predict its results. As mentioned, earlier, supervised learning, its tasks are also packaged classification and regression.

[2], unsupported learning. When we do not label individual user data, we will use unsupported learning technology. Therefore, the machine only knows input data, and the information must be manipulated without any guidance or output data. As a result, the machine is restricted find hidden system and IoT consumer data in the input data, and its different usage patterns and similarity. Not supervised learning is used for clustering and identifying correlation issues.

[3], semi-supervised learning. When the present invention in the processing of user data problems are not very often sees, labeled data is very expensive and very difficult to find the case. At this point, semi-supervised learning is required, and we use a certain amount of tagged data with unlabeled data. You can improve the model accuracy of unlabeled data by using some tag data.

[4], intensive learning. In intensive learning, machines use previous data to develop and learn. It uses rewards and penalties to train method, is to take positive rewards for correct and good decisions and negative indications for bad decisions. This study does not require a number of trainings According to the set. This is a self-sustaining system, AI intelligence can learn from the real world self-improvement.

Open-Source Artificial Intelligence Software for Data

[a], Flow programming Developers trying to build their own intelligent applicants on top of a polar. As AI software polars are the ideal solion. These are the best Artificial Intelligence Software Pleroma: TensorFlow Azure Machine Learning Ayanda Placement Salesforce Einstein Cloud Machine Learning. Other extracts of the software selection of smart platform: In developing the intelligent response program of the invention system, the best intelligent software and these smart platforms should be carefully studied It's good and bad, then test it over and over. AI software is often important and needs to be understood in detail. And then, look for or test out the real AI software suitable for the intelligent response of the invention.

[b], Digiteum data collection solutions The proliferation of IoT devices and the wide range of opportunities they offer in all areas of life means business owners should be more aware of this How these systems operate and the risks associated with collecting IoT data. The good news is that by implementing edge computing, machine learning, and other advanced technologies, tech teams should be able to find affordable an effective and efficient way to organize data, process the most relevant solutions, and successfully store and pass them on to consumers.

Experienced in building connected applications for healthcare, energy, smart homes and other major industries.

Using the edge meter the power of computing and artificial intelligence to ensure that business owners can make the most of the data they capture. This data is only valuable when the IoT devices are analyzed, leading to data analysis in the frame. Data Analysis (DA) is defined as a process for examining large and small data sets with different data attributes to extract meaningful conclusions and actionable insights. DA is defined as a process that examines small data sets with different data attributes to extract meaningful conclusions and actionable insights. These conclusions, often in the form of trends, patterns, and statistics, help businesses organizations to proactively engage with data to implement effective decision-making Processes.

AI Intelligent Making & Works in the Invention

The strong intelligence is the key to the accurate application of the invention system and 21 IoT functions. It is an important part of the invention. Smart programmed is the basic problem that may require them to solve the problem of the invention. Smart is growing, benefiting many different industries. It's making 'elm based on mathematics, computer science, language the science, science, interdisciplinary/method of wiring machines. Smart targets include in-depth learning, reasoning and perception. The system of the invention and IoT require AI intelligence to do important work without human intervention. Today, these types of artificial intelligence they have matured so that they can be easily found in applications such as self-driving cars or hospital operating theatres. The use of human intelligence (AI) in the present invention is equivalent to the specific expression of human intelligence through machine intelligence. Its key features include reasoning, solving problems, making judgments, generating new plans, and the ability to continuously engage in deep learning and communication.

Sensors and Computer

AI systems are very important parts of the invention system and IoT network. To safeguard the application system of the present invention and the IoT network works and is easy to manage, requiring smart sensors (a combination of smart sensors with different functions) systems. In the actual application of each user of the present invention, the sensor will produce different users according to their individual use needs data. These data will be stored in non-volatile memory, and the analysis module of AI edge computing can perform data analysis and processing at any time.

[a], Require special attention, the processor can be a single processor, or a composite processor, applications or instructions or other parts. From these components are executed by processing equipment, or other analysis implementations of data evaluation algorithms. In short, this part of the application system of the present invention can be used on the processor or AI side to execute the instructions in the smart sensor text, It is realized on the edge calculation.

The processor can store data or processing results in the memory.

Any equipment described in the present invention needs to record one or more user date, and its related equipment will process the date separately according to security requirements. Later the non-privacy part of it will submit any related raw data of the user to the AI edge computing through the network or transmit it to the database cloud computing center. The system selects a sub-set of data based on specially designed software standards, such as the gender of the user, the time of use, and the device number used to record the user's original data, and so on. These can be analyzed using machine learning algorithms, a subset 22 of data generated by the

[b], user's original sensor, which can be rooted in analyze and judge the user's personalized use of its priority, according to user habits, allowing the computer AI edge to handle the palm with this data in hand, it is possible to provide a high level of AI in every use requirement of future users of the invention system service experience. The sensor technology of the system of the present invention and the IoT device group is the pillar of the application system of the present invention and the IoT network. If not able to detect Temperature, movement, humidity or acceleration, pressure and: infrared sensor, distance sensor, gyroscope sensor, as well as all other sensor groups, it is impossible to accurately collect user data of the present invention. In the application system of the present invention, the sensor is the most the use of resources to the limit, avoiding advances and reducing costs, and improving work efficiency can help enhance real-time data collection, Analyze and generate instructions to greatly improve the user's happiness when using the system of the present invention. The inertial measurement unit (IM U) sensor used in the system of the present invention has been widely used in many different mobile applications. Over the years, the progress of IMU and the types of applications in various fields have continued to increase, such as manufacturing, navigation, and robotics. For example, the most important function application (micromachine) in the system of the present invention is to select IMU sensors, which are used.

[c], to reflect higher accuracy than other types of senders. Of course, even better upgrades or deny type of new-generation IMU products have appeared on the market when the patent for this invention was approved, so it must be the choice for the patent for this invention. Recently, micro-electro-mechanical systems (M EMS) have launched some very attractive low-cost, compact, and constantly improving products on the market. IMU sensor products with improved algorithms and processing capabilities.

To ensure that IMU sensors are more accurate at user data output, avoid any possible data transfer errors. Most the advance of the new IMU sensor, which integrates a gyroscope+magnetometer+accelerometer, is excellent the application system of this invention is solved in this respect. According to the special requirement of the present invention system for sensor function, custom sensor is also a choice, in the market select some quality it is also a good way for manufacturers of sensors of reliable quality to entrust them with the custom production of a series of sensors dedicated to the present invention system law.

[d], Because all sensor manufacturers have their own different data reaction algorithms with other competitors to improve in the market competitiveness. If you delegate a custom sensor, the most important point is that it must be tested repeatedly, tested, and re-tested. Be sure to reach this Patent design requirements for invention systems. In addition, customized sensors require special attention, in addition to ensuring that these customized sensors have excellent IMU functions, the invention also has special requirements for customized sensors:

including but not limited to recording every hour during sensor-making Environmental conditions such as environmental temperature, environmental energy, environmental hydro, 23 environmental humidity, environmental pressure, various sensors combined the coordination between the two groups and the normal response of the “Hazard”. By recording the data of the environment and function usage process, the sensor network system thus supports AI edge computing-AI intelligent machine learning at the same time, the quality monitoring of user data and the management of diversified free options are carried out to help and realize the workflow of the system of the present invention the process of automation and diversity of individual needs, and to ensure accuracy and safety.

[e], The customized sensor must be able to work normally under harsh environmental conditions and produce accurate response data for a long time. In addition, if certain events or situations occur, custom sensor can also trigger alarms. Secondly both the system of the present invention and the IoT sensor group need to be embedded in the device itself, which will enable the project to produce better results. At the same time, it will transmit user date to the AI edge computing management system in real time.

The calculation and analysis of the computer can obtain accurate instructions generated by AI edge computing in a very short time. Then, multiple sensors are used to cooperate and cooperate to help improve the quality and accuracy of the instructions. If custom sensors are used, the types should include but are not limited to temperature sensor, pressure sensor, proximity sensor, acceleration meter+gyroscope sensor+magnetometer, infrared sensor, optical sensor, body sensor, distance sensor, and any other there are sensor groups shown here, and these should be included in the patent for this invention.

The invention and the IoT sensor system require miniaturized customization, which must have excellent stability. Currently, dedicated sensors on the market manufacturers are able to embed smart beacons in smart sensors, designed to measure space and time, and a lot of other special work can. Note: How to select or customize the correct sensor system for the present invention, first must check the application characteristics of the sensor in various fields, and carefully select the sensor that can meet the main functions of the present invention, and then test its performance. The working status and performance of the environment, the time requirements for the response and the accuracy of data production, the coordination of each other's operations, safety, and other response indicators that should be there.

[f] The following indicators can help achieve the right choice.

[1], IMU technology: IMU is primarily used to measure the direction and gravity of velocity in equipment. The earliest IM Us with two sensor types appeared, this IMU consists of an accelerometer and a gyroscope. Typically, two to two per sensor define three for the x, y, and z axes degrees of freedom, combined with two sensors, will reach a total of four to six degrees of freedom. The acceleration value obtained from the accelerometer and the gyroscope the velocity is saved separately, and two sensor measurements can be obtained. So, two data can be calibrated for a more accurate loss out of the data.

The advantage of using this type of IMU 24 is that it is not disturbed by the surrounding external magnetic field. Generally, all the values measured on three different axes are obtained in three axes, and a total of 9 DOF can be obtained. Magnetometer is used for measuring the amount is tilted and rotated, so it can be calibrated to the gyroscope data and improve the problem of large drift. This type of sensor is suitable for dynamic when calculating for short-term and long-term, drift errors are less likely to occur. The important factors that the system of the present invention needs to consider when choosing IMU, these factors it is produced by the results that must be achieved, and then the consideration depends on the final usage and tolerances. [II], New IMU:

Three types of sensor combinations.

The new IMU used in the system of the present invention is composed of accelerometer, gyroscope and magnet.

[2], Package size: the IMU sensor is selected for the application system of the present invention, and the customized and designed sensor package must be small and light in weight to adapt to the various application characteristics of the application system of the present invention. For example: the smart phone products used by ordinary consumers and the smart baseball track trajectory uses to measure the are the preferred small-scale IMU sensor embedded in a small space, and mobile applications usually use the IMU know as M EMS sensor in the industry.

[3], Accuracy of data transmission: As we all know, gyroscopes have drifting errors for a long time, but accelerometers have made positive improvements based on the object's translational acceleration or rapid rotation. For example, use Kalman to calibrate the filtering data of the accelerometer and gyroscope. Some applications only require a certain range of measurement values, so they can tolerate a certain threshold.

[4], Response rate: A good sensor should have a fast response speed. For example, a sensor with a sampling rate of 50 Hz should complete every second sampling the sample under measurement 50 times. Most devices need to have a higher response rate to handle sports applications. They are in the preliminary during verification, the normal frequency range before the next evaluation is 1 Hz to 50 Hz. Some advanced applications, such as vehicle navigation, may require a higher response rate of up to 200 Hz to ensure timely and accurate data capture according to.

[5], degrees of freedom: Degrees of freedom (DOF) determine the independent parameters in the system. There are many IMU sensors available on the market, may vary from two degrees of freedom to nine degrees of freedom, depending on the sensor contained in the IMU and what the sensor will measure the number of axes of the quantity. Similarly, the overall degree of freedom may vary based on application usage and functional requirements. Tracking from Location in terms of degree, most applications will be 6-DOF for two-sensor type IM Us or 9-DOF for three-sensor type IM Us.

[A], A DOF number represents the measurement of x, the y and z axes of each sensor. Generally, the higher the number of degrees of freedom, the greater the number of degrees of freedom More data is sampled. Introduced in the application system of the present invention, the specific design of the sensor is fully considered, and various functional characteristics meet the requirements of the system of the present invention 26 remote computing center. Because there is no need for data transmission, it is maliciously taken and the risk of improper use by any administrator is greatly reduced, so that the greatest user privacy protection can be provided. The combination of IoT and cloud computing designed by the system of the present invention can collect non-private data information and analysis of users and their family members. These data information and create specific operations to help users achieve their comfortable use characteristics and fully cooperate with users.

[B], Often personalized needs, provide targeted services. At the same time, the dual AI intelligent computing terminal system established by the invention is generated by the transfer and storage of data from the Internet of Things to cloud computing Personalized data streams that are constantly designed to be installed in distributed (local) cloud and remote cloud computing centers for AI neural network training learning and deep-thinking result in very valuable executive instructions that assemble at the low peak of each day used by the network. Design the dual AI intelligence installed in the invention system for training.

Achieve full mastery of user personalization needs and some very special the use habits that enable the system to deliver a wide range of targeted and thoughtful quality services in a very short time enhance the user's sense of well-being in life. Various equipment: including but not limited to various household appliances, various personal computer equipment, and various smart wearable devices, including various kinds of intelligent transportation tools, and any type of personal communication equipment, as well as many other types of intelligent vehicles that will appear on the market in the future. Application, etc.

This network is a two-way operation, it can carry out internal private data transmission, private data storage. Can also hide submit private data to cloud computing. These are all gathered together via a smart network to build a true sense of IoT and family privacy. Private cloud database center.

[C], The system of the present invention can establish a closed, dedicated Internet network for each single family and connect the various families of the family. It provides devices not only for information exchange within close families, but also for safe and accurate information transfer across different types of networks.

The application of the present invention to the Internet of Things is about networks, devices, and data processing.

[1], It can improve the working efficiency of all equipment, save time, money and reduce emissions. Previously, all content connected to the Internet may be invaded by customers, and IoT products are no exception. Insecure IoT systems may cause user data to be maliciously invaded, even exploited, and maliciously monitored, etc. If the electronic smart devices of each family are connected together, the data is stored securely in the user's home, and there is no need for transmission.

[2], Then no one can maliciously observe and monitor users without restriction, or gain malicious access to the network, and other privacy harms, and so on. The invention system designs new data obtained on the day of transmission during low peak hours to distribute (local) and remote clouds computing Center, but this data must be encrypted and specially specified to exclude the user's personal privacy.

[3], Special attention needs to be paid to immediate processing of potential defects in software (Both old and well-used). Real-time hair it is essential that any irregularities in the transmission of data and information be addressed in a timely manner. In addition, the software system specially customized for the invention must be targeted to prevent and deter hackers from intruding, who are usually actively targeted attacks on IoT devices (such as routers and AI smart cameras) require particular enhancement of the security inherent in these devices. The IoT dual AI intelligent edge computing terminal designed by the system of the present invention for users and their families is for privacy protection and the greatest reduction in usage costs. Dual AI intelligent edge computing can partially replace distributed (local) cloud and remote Cloud computing, its special feature is that it can perform various pre-set functions very accurately and provide users with high-quality services without a network connection.

[4], The user's personal voice can be identified, collected, and stored during streaming (these are private data). There is special needs, when necessary, the dual AI system of the present invention, AI edge computing and AI smart terminals of IoT will perform operation management, including the use of the present invention equipment, personal needs, special hobbies, and others, etc. With the continuous increase of application systems, processing data in the cloud It will naturally rise in a straight line. In order to reduce costs, the data produced by each user (or his family) will be included in the AI of the system of the present invention. Edge computing and IoT's AI intelligent edge computing terminal completes its pre-processing, only during the low peak period (12:30 AM in the evening-06:00 AM) Send the specified data back to the cloud (of course, not including the user's personal privacy data). Collect and analyze the book after revealing the data submitted by the system equipment, the AI intelligent deep neural network system designed and installed in the cloud will use different the algorithm performs calculations and analyzes these data. Then, a training index set is produced, and the dual AI smart system installed in the user's home get training.

[5], These trainings can quickly and effectively upgrade the dual AI smart terminal installed in the user's home to perform perfectly and accurately. Various necessary service capabilities. The system of the present invention also requires customized software and must be able to provide audio frequency identification functions through different algorithms; in the exchange of data and information. In addition, the IoT design of each device has different UX requirements for each of its equipment, such as: “Remote controlled oven needs minimum disaster stricken.”

The refrigerator's “is kept in space whenever it discovers the new production of” under the surveillance of intelligent sensors computer software will be performed at the speed of computer, while the memory, the image, software system, originally placed in the space two charts and no-goods messages will be sent to the 'em to 'em, reminding them to purchase, and to make 'em sensors when they leave their home the device will be moving all the lights, furnace natural valve shut and other, etc. The IoT system designed to help balance the safety and needs of vulnerable populations while 28 maintaining their privacy and the “master” of the invention sex. “Certain smart home systems have rules and models that apply to certain specific conditions when certain conditions, for example when returns open or close some equipment when home, wake up or leave.” Equipment must comply with regulatory requirements such as ‘radio’ disturbances or waste recovery targets”.

[6] It should be noted that the inventor does not specify the features of IoT here, such as the need for an electronic controller to perform IoT the need for some kind of functionality is because today countless manufacturers are developing applications for the future development of IoT. Each manufacturer uses a different data algorithm designed to be more powerful and easily manipulated and safer use, lower cost, etc. If the invention now specifies the application of one or more of these electronic products, this is not fair for future user groups, as electronic products of any kind are currently growing rapidly, almost every more innovative products are on the market all day long, and prices are lower. Moreover, it may take a long period of time for the patent of the invention to be applied for to be approved, and the invention is specified when the patent is approved the use of any kind of electronics is likely to be outdated and replaced by more advanced ones. In this way, science and technology development should first improve people class quality-of-life services are likely to be empty words. To avoid such a situation, the invention simply provides below some references, rather than specifying any kind of electronics. In the final analysis, the IoT system of the present invention is compared with the traditional screen-based application. The UX faces are exactly the same, only the thoughtful design of the present invention is combined in the process, and the result is a new creation. Create something that every user is happy to use every day, and really improve the user's happiness.

[7], The purpose of selecting electronic products of the present invention is the latest, more stable functions, stronger functions, more functions, and safer applications. Such as If the electronic products on the market cannot fully meet the requirements of the present invention at a time, if possible, the technical staff of the manufacturer can be used Upgrade to meet the needs of the system of the present invention. Regardless of the use of any form of electronic products, these should be protected in the present invention of patents. In order to meet the software design requirements of the system of the present invention, the IoT system of the present invention needs to use the selected AI smart terminal for reference as follows. In addition, special attention is needed to be paid to the professional software design, which is often important, and the different choices of the following are needed and software The discussion, and the repeated tests needed to be tested to get the best choice. Often suitable for cloud virtualization, network devices, and embedded applications. This energy-efficient and space-efficient system is based on Supermicro X11 SDV-8C-TP8 F flexible ATX motherboard with 8-core, 80-watt Intel Xeon D-2146 NT SoC support. It also has built-in Intel QAT encryption and compression capabilities that support up to 512 GB memory, four GbE RJ45 ports, dual 10 GbE SFP+ and dual 10 GBE RJ45 ports, dual USB 29 3.0 ports, four 2.5 “internal SSD or SSHD and internal storage expansion options including mini-PCIe, M.2, and NVMe support. Supermicro's new SYS-E300-9D is a compact embedded system suitable for network security, SD-WAN, vCPE controller and NFV edge computing equipment. The system is based on Supermicro's X11SDV-4C-TLN2 F mini ITX master board, equipped with quad-core, 60-bit Intel Xeon D-21231T SoC, supporting up to 512 GB memory, dual 10 GbE RJ45 ports, four USB ports and one SATA/SAS hard disk, SSD or NVMe SSD. Supermicro's new SYS-E300-9Dis a compact embedded system suitable for network security, SD-WAN, vCPE controller and NFV edge computing equipment. The system is based on Supermicro's X11SDV-4C-TLN2 F mini ITX master. The board is equipped with a quad-core, 60-bit Intel Xeon D-21231T SoC, supports up to 512 GB of memory, dual 10 GbE RJ45 ports, four USB ports and a SATA/SAS hard drive, SSD or NVMe SSD. ARM's two new processors with AI capabilities-Arm Cortex-M55 and Ethos-U55, which are a neural processing unit (NPU)-specifically designed for Internet of Things (IoT) endpoint devices, and support software libraries, Tool chain and model. ARM claims that these two cores are expected to be available in early 2021. In certain language and visual scenarios, they will jointly provide up to 480 times the machine learning performance improvement. Cortex-M55 is the latest member of Arm's Cortex-M processor product portfolio. This product portfolio has cost-optimized and [k], energy-efficient microcontroller devices. It is similar to the previous Cortex-M and previous generations.

AI performance has been improved by 15 times. Customize instructions and configuration options. Like Ethos-U55, it is available in the reference design Corstone-300, which comes with many safeties sub-systems and kits for building safety embedded systems. Cortex-M55 also has the first on-board system based on Arm helium technology, which is an extension of Armv8.1-M architecture, which is optimized for low-power silicon and adds more than 150 new extensions and Quantity instructions. Integer Helium can efficiently calculate 8-bit, 16-bit and 32-bit fixed-point data, the last two of which are widely used for audio Processing and other traditional signal processing applications.

[8] Up to 8-bit fixed-point format, in computer learning and processing (such as neural network calculation and image processing it is very common in management, it supplements floating-point data types, including single-precision floating (32-bit) and half-precision floating (16-bit). according to Arm said that Helium can achieve up to 5 times the performance improvement in the digital signal processing side, and 15 times the performance under the Cortex-M55. Machine learning. It also allows advanced memory interfaces to provide fast access to machine learning data, and it is built on Arm's Trust Zone system-wide embedded security technology.

Ethos-U55-Intended to be compatible with floor-M55, floor-M33, floor-M7 or Layer-M4 and other layers-M processor pairing-Comparing with Cortex-M55, configurable computing unit can realize 32 times higher machine improved learning performance. Energy efficiency beamforming, echo elimination, equalization, mixing, keyword discovery and automatic voice recognition 30 in noises, double air grams increase by 25 times. On the software side, both Ethos-U55 and Cortex-M55 benefit from a unified software development process that will be embedded code, digital signal processor code and AI model code folded into one. Importantly, it can be linked to popular machine learning boxes racks (such as Google's TensorFlow and Facebook's PyTorch) and Arm's own solutions work well together with use. Data movement is a factor in the energy consumption of the edge. Recently, there's a MAX 78000 on the market, which will be a low-performance the consumer is matched with a neuro-neuro-compact processor, which can be transported on the IoT device that provides electricity in the battery. Marginalization computer vision has become an important example of AI, especially in the form of deep learning, which takes use multilayered neuro—neuro—neuro—and super vision the technique is to realize the results of image pattern recognition. Today's visual system architecture is changing because the most marginal camera passes the ink-style hardware increases the processing of deep learning energy. But finding the best response to the target may be a challenge. On the edge analysis of image data is proven to be a correct solution to the problem. Arm also claims that Ethos-U55 and Cortex-M55 are up to 50 times faster at reasoning speed, detecting and reducing speech activity.

Database Basis Software

The system of the present invention has five mains technical features in terms of database management, the need to select the correct software to operate and process Management. They are Business Intelligence (AI), Big Data, Internet of Things (IoT), data analytics and data extraction.

I, the present invention has a very special functional requirements, and therefore the need for a rich database to cooperate. To do this, you must first use the number database foundation management software. This type of tool will allow the system of the present invention to accurately store, operate and retrieve the number of organizations data for further use in other software.

It should be a cloud-based relational database with form builder, user permission settings, data import/export, team calendar and e-mail/SMS notifications and other functions. The present invention requires; for example, a data table can be used to capture and display information, for managing user permissions of the database and having 44 a data table can be used to capture and display information, for managing user permissions of the database and for managing user permissions of the database. File storage and sharing with document history tracking. At the same time, you need to operate the dashboard, built-in calendar and electronics forms to manage and track tasks.

It needs to have the option to deploy in both the public cloud and on-premises cloud. Provides information such as data repositories, text analysis, and knowledge maps and so on. If you can semantically mark and analyze text data based on keywords, topics, or concepts. You can then mark the data visualizations as graphs to search and find relationships between different data. At the same time, it supports a general programming language, and supports Multilingual text search. Ideally, it also has a large open-source community that can continue to improve its functionality and improve its applicability to respond to system development needs that may arise in the future.

II, Large data analysis A key aspect of the Internet of Things platform of the present invention is managing the amount of data it generates and providing users with integrated actionable results the combined data analysis of the Internet of Things will have an important positive and far-reaching impact on the business of enterprises. Data analytics can play an important role in the growth and success of IoT applications and investments.

Analysis tools will enable the business unit can effectively use its data set, every day, we are surrounded by sensors, sensors can detect, measure and send a certain this form of data. Devices and technologies connected through the Internet of Things (IoT) can monitor and measure data in real time, these numbers of data can provide valuable insights into the future development of enterprises, help enterprises save time, energy and money, in the market always in the lead position in the competition. IoT data analysis is the analysis of a large amount of data generated by intelligent sensors of various devices connected to the system of the present invention.

These points analysis aims to optimize operations, automate user processes, create a richer user experience and increase user experience. Strong user happiness.

III, Today, the combination of IoT and data analytics has proven to be critical for retail, healthcare, telematics, manufacturing, and intelligence cities are good. However, its true value to the enterprise has not yet been fully realized. The invention is designed from, voice requests, video, temperature, tracking motion, accelerometer and gyroscope (motion), sound frequency (Cheering and booing), centrifugal rate (excitement), skin conductance (pressure) and other variables; or other sensors (cheering and booing), heart rate (arousal), skin contact (pressure) and other variables; or other sensors readings are mined, organized, and analyzed to gain insight into the real needs of the user and the state of use.

A data category is a growing source of data that needs to be managed and utilized. Metadata is a prime candidate to be imported into a NoSQL database like 48 MongoDB. Metadata is a prime candidate to be fed into NoSQL databases like MongoDB to introduce structure into unstructured content, or into cognitive systems to introduce understanding, intelligence, and order into external random environments. Metadata is a prime candidate for feeding structure into unstructured content like MongoDB, or into cognitive systems to introduce understanding, intelligence, and order into an external random environment.

The essence of data collection is the value of ‘unstructured’ data, the goal is to be able to truly recognize and find its value. The way to do this is to analyze, interpret, and re-present what is useful in the data. Internal sensors collect data from IoT devices, such as security systems, smart devices (this invention), smart TVs and wearable health meters. The data is transmitted, stored, and readily retrievable, and these functions form an essential part of the present invention.

IV, the invention requires the collection, storage, and analysis of IoT data. In this way, values that can be useful for business development are uncovered. However, the way to fully utilize this value is to feed it into an artificial intelligence (AI) system, which will learn and master this data. The AI system will learn and master this processed and purified (valuable) IoT data and use it to anticipate, determine, and provide accurate and sensitive service experiences for users' needs. The AI system will learn and grasp this processed and purified (valuable) IoT data and use it to predict, determine, and provide accurate and considerate service experiences for user needs. In addition, data from user device sensors can be used to predict when these devices need to be repaired or replaced. This enables maintenance to be scheduled at the optimal time to avoid disruptions to the normal needs of users, improve service quality, reduce breakdowns, and save money and save the companies maintenance costs. Today, no matter what kind of business, everyone is committed to creating a better, more personalized customer experience. The implementation of IoT data analytics can help accomplish this onerous task.

V, IoT data reveals a wealth of customer behaviors and preferences that can be analyzed and used to create a more personalized experience. It can be analyzed and used to predict customer needs. It's a win-win for both parties: users gain ease of use and save time, while companies can increase revenue and maintain their attractiveness to customers. IoT data analytics is designed to make users happier and enhance their experience. By collecting data about audience preferences, the invention can provide customers with a better understanding of their preferences.

This allows for a better understanding of the customer. This allows for a better understanding of the customer and helps the user find what they are looking for, as well as different ways to achieve a satisfying outcome. In this way, we can better understand our customers, help them find what they want, and achieve satisfying results in a variety of ways. In addition, sometimes we are overwhelmed by a large amount of data, giving up sifting through all the data and finding effective ways to use it on the Law. If multiple sensors provide information every 30 seconds, if the correct sensor is not used, it may cause data overload of a worker or computer. Before you can use information, you have to deal with the massive amount of 50 or people is another important function of IoT devices and sensors.

VI, connected systems use location data for user management, including smart furniture ecology, sports and health, office, travel. It is also possible to use time tracking, staff Monitoring and other administrative tasks. IoT can provide higher data processing speed and accuracy than GPS, which is why many the reason of many business owners and office managers use motion sensors instead of GPS trackers. Automate your data. this data helps IoT systems control the devices in the house, as well as the mobile rows generated by the use of any IoT system for. Processing automated data is a complex process because of the high risk of errors, from accidental locking to failure Life. Actionable data. These types of IoT datasets are extensions of state data. In addition to capturing the bare solution, the system will also process it the line is processed and converted into instructions that are easy to execute. Actionable data is often used to predict user demand, energy consumption, and optimization of IoT site efficiency and long-term decision-making.

VII, Data processing security In addition to focusing on building a responsive and easy-to-use IoT system, technical teams also need to create a secure and accessible IoT system within the sever system. Rely on data collection and processing practices. The reliability and scalability of the solution comes from the enterprise owner's use to capture, schedule, and manage the solution. The practice of sequencing, storing, and relaying IoT data. Combined with machine learning-based analysis, it is important to perform anomaly detection in a user environment. AGT uses a novel approach to detect anomalies in a user environment. The present invention allows machine learning to try to find out the state of the feed, and over time to obtain a normal or an unusual situation. And create an exception index, if something exceeds the threshold, it is counted as an exception. Monitoring Sensor Feeds the data is able to adjust the event threshold of attention.

Capturing data is the first layer of IoT application architecture—the team should ensure that the device captures relevant real-time information. If a sensor failure or processing error may end up with the wrong data from the user. Legal compliance is another point that teams should keep in mind when designing data collection practices. Developers need to integrate security into in all tiers of IoT applications, and the consent of smart device users is required when capturing data to avoid GDPR and other legal fines. In order to understand all the data collected by sensors, the technical team can also go from using metadata and assigning metadata to existing IoT data mark benefits. In this way, IoT engineers will facilitate sorting, monitoring, and storing processes for different types of data.

The system design of the invention establishes a security foundation from the following points:

[a]. Build tamper-proof hardware. Because IoT sensors and other devices typically operate 24/7, there is no way to continuously monitor them. To ensure that the first three parties do not have access to hardware, and business managers should consider placing IoT devices in isolated spaces to better understand who can access them. In addition, the three ways to improve endpoint security is: Disable the device automatically when someone tampered with the device's battery.

51 Use port locking to restrict access to USB, camcorder, and Ethernet ports—Create a strong boot password. Track access to serial ports, UDP/TCP ports. Create an obvious tamper-proof package—the device owner will immediately know if the hardware has been opened before it arrives.

[b], Run dynamic tests on IoT devices. In this way, the technical team will discover the various defects and vulnerabilities it may expose from the operating state of the hardware and software. Static analysis may not know much about processor and memory vulnerabilities. Ability to inspect new code when it interacts with the old processor the behavior is important step in verifying the reliability of the system before bringing it to market.

[c]. With a complete set of data processing algorithms. Tech teams should consider what happens to IoT data when users throw away smart devices. If you fail to discard the personal letter it may result in its misuse and exposure of users sensitive financial, location, or health-related data. The most commonly used data the disposal practice is “Discard, recycle or destroy”—in short, DRD.

IoT device manufacturers strongly encourage users to contact the company before deleting data from their smart devices so that a professional team can handle data deletion. Device manufacturers can allow users to enforce a single DRD policy that determines whether or not personal authentication and personal data should be stored on the device or on a remote server. The device manufacturer can allow the user to enforce a single DRD policy that determines whether the authentication and bodily information should be stored on the device or on a remote server. Here, the lack of technical skills among smart device users is a problem that needs to be addressed.

The lack of technical skills in smart devices is a problem that needs to be addressed, as most people have difficulty understanding the full complexity of IoT password storage. IoT Data Collection Techniques and Processes. To better understand how IoT-based data collection works, let's examine the mobile parts of any connected system. IoT application architectures are often complex, but most items are composed of standard components.

VIII, IoT Device Layer A series of devices that communicate with each other is the main layer of the IoT architecture. Here are the most widely used IoT data collection technologies Example: actuator; ZigBee equipment; Bluetooth and BLE devices;

Devices based on low power radios.

[a], All IoT devices are identified by one of the following categories: A built-in unique identifier (or UUID), such as a chip, placed inside a device; An identifier that relies on the Internet of Radio for Internet data collection system—Wi-Fi MAC, Bluetooth, etc.; An identifier located in the system's non-volatile memory (EEPROM); Refresh/host token. Communication Layer This part of the architecture allows devices to communicate and exchange data with each other. The communication layer consists of protocols, including the following: HTTP/HTTPS—A basic text-based protocol that supports even low-end 8-bit devices. MQTT—A protocol designed to handle embedded systems and optimized to support IoT. It has a broad community of followers and a strong asset bank. CoAP=Based on HTTP semantics, CoAP scores higher for footprint.

[b], This protocol is more difficult to connect than MQTT to the firewall and poor 52 library support. IT Edge Layer this layer is often considered the command station for the application because it agents' communication. In an IoT application, it performs the following tasks Can: Equipment Management; Ensuring processing security; Aggregating and replicating data; Routing data to/from the cloud; Prioritize messages; Process images, audio, and other types of data at the edge. The edge helps ensure that most data processing occurs on connected devices in a dedicated environment. This layer is used to support devices that are self-explanatory.

[c], This layer is used to support wide-network devices that have little processing power on them own, but will provide a large amount of data to the system. Event Processing Layer After collecting IoT data, the application needs to process and store it-this occurs in the event processing layer of the system. In this layer, multiple operations are handled.

Clean up the data; Build the collected solution; Storing information in a database; Add metadata to IoT data. There are several ways to build this part of the system—you can design a database-supported server-side application (such as JAX Use a large data analytics platform on IoT cloud services to process and store IoT data, or to support data from IoT Real-time event handling of the device.

Customer-side Communication Layer In this layer of the IoT architecture, all collected data is transmitted from the system facing the device to the system facing the client. All data collected in this layer of the IoT architecture is transmitted from the system facing the device to the system facing the client. In order to relay data from the mobile devices to the end users, the technical team needs to build a front-end that interacts with the database and the front-end. The front end. To ensure that IoT data can interact with external systems, developers use machine-to-machine APIs.

The most common way to relay IoT data to end-users is through web or mobile applications.

IX, AI used in the present invention Artificial intelligence is constantly evolving, and it benefits many different industries. It is used based on mathematics, computer science, language The interdisciplinary approach of language, psychology, etc. connects the machine. The goals of artificial intelligence include learning, reasoning, and perception. Strong human intelligence is the key to accurately perform the functions of the system of the present invention. It is the core part of the present invention. artificial Intelligence is programmed to deal with a number of problems that may require them to solve in the present invention, No human intervention is required. Today, these types of artificial intelligence have matured so that they can be easily automated Drive auto vehicle or hospital operating rooms and other applications found. Artificial intelligence (AI) is a theoretical form of machine intelligence equivalent to human intelligence. Its key features include reasoning, solving Difficulty, ability to make judgments, plan, learn and communicate. And these are precisely the most basic parts of the present invention.

X, use natural language processing (this happens when the computer reads the language. The NLP process converts the text into a structured Data), the computer will convert this plain text request into a self-encoding command. Now, the AI intelligent language system puts these data into the decision-making engine, because in the mind of AI intelligence, it has a satisfactory Some conditions of the dialogue loop, especially the user's custom-made personal preference requirements, such as “water temperature” or “notes “Quantity” and “Long”, users use various functions on the basis of standard procedures; increase or decrease the “number of actions” and so on.

Generated using natural language (this happens when a computer writes a language. The NLG process converts structured data to As the user does, when the AI intelligent language system asks the user how to provide more in line with their needs, the AI intelligent language system 59 asks the user how to provide more in line with their needs When the personalized service is returned, this series of responses is passed to the backend.

And presented to the user in the form of a question.

[a], They Or they tell the AI intelligent language system is trying to mention the temperature, the number of times, or something like that, and then these answers pass NLP returns to the decision engine. The AI intelligent language system begins to analyze specific targets about the requirements, their current status, and feeds with data about the user's current use. It then determines the specific actions that should be taken to satisfy the demand and then achieves the goal of satisfying the demand. It then determines the specific actions that should be taken to satisfy the requirement and then implements the requirement to satisfy the user's needs.

But at this point, the biggest difference between chat AI intelligent language systems and the humankind is what the industry calls empathic understanding. It simply does not understand the meaning of conversations as well as people do. It is simply not as good at understanding the meaning of conversations as people are.

For example, the difference between statements such as “We need to talk about the baby!” and “While this is immediately obvious to humans, it is very difficult for AI intelligent language systems to understand. It is difficult to understand.

However, progress is being made in this area, and soon machines will not only be able to understand what you are saying, but also, they will soon be able to understand not only what you are saying, but also how you are saying it and how you feel when you are saying it. Mythical intelligence (defined as intelligence displayed by machines) has many applications in today's society One of the most widespread uses of it is in the field of language.

[b], One of its most widespread uses is natural language creation. Natural language generation (NLG) simply means to generate text from computer data. It acts as a translator and computerizes the data is converted into natural language expressions. In this way, based on the collected data and the input provided by the user, a conclusion or Text. This is a natural language processing task that generates a natural language from the machine representation system. Natural language production and natural language Understand the opposite. In natural language comprehension, the system needs to eliminate the ambiguity of the input sentence in order to produce the machine representation language, which is in native language production, the system needs to make decisions about how to put concepts into words.

The process of generating text can be as simple as saving a list of copied and pasted out-of-the-box text.

[c], Results in astrological machines or personalities simple applications such as business letter generators may be satisfactory. But in a complex NLG system, you need to include a plan and the stage of merging information to generate text that looks natural and does not repeat. It is important to determine the content: identify the main content to be represented in the sentence or the information to be mentioned in the text.

For example, in this the invention system sets the water temperature standard of the automatic program as: (winter) 37° C. (auto), with four lower water temperature options down. 36° C., 35° C., 34° C., 33° C. degrees, 34 degrees, 33 degrees. Three higher water 60 temperature options are set upwards; 38° C., 39° C., 40° C., 40° C. 40° C. degrees, 33 degrees, 32 degrees, 31 degrees. Upwards there are three higher water temperature options: 37° C. degrees, 38 degrees, and 39 degrees.

In the case of these settings, the automatic procedure for deciding whether or not to specify the system of the present invention The standard water temperature is (in winter) 37 degrees. (Summer) 36° C. (Summer) 36° C. Based on the above, when the user tells the AI intelligent language system; “Please raise the water temperature” (in winter), the AI intelligent language system asks; “Now you can raise the water temperature.

The system will ask; “Now you have three options, 38 degrees, 39 degrees, 40 degrees, which one do you want? After obtaining After obtaining the user's answer, the AI system of the invention will immediately satisfy the user's need.

Other user requirements are similar or vice versa. Another user requirements are similar or vice versa. File structure: Determine the structure or organization of the information conveyed.

[d], For example, if you decide to describe the standard reading of water temperature first, don't Describe the low choice. For example: “Now it is the standard water temperature of 37 degrees Celsius (winter), 36 degrees Celsius (summer),” you need to mention Rise? Or is it lowered? Summary: Put similar sentences together to improve understanding and readability. For example, the set standard water temperature of 37 degrees Celsius (winter Day), now you can choose to increase the water temperature to 38 degrees, 39 degrees, and 40 degrees. Or down to 36 shots Degrees, 35 degrees, 34 degrees, 33 degrees. What is your choice, please tell me”. (Summer) is also the same Very different, basically consistent. Vocabulary selection: Use appropriate words to clearly convey its meaning. For example, when setting the standard water temperature to 37 degrees Celsius (winter Days), do you decide to use boost or down? Reference expression generation: Creating this type of reference expression helps to identify specific objects and requirements.

For example, decide to use (winter The standard water temperature is 37 degrees Celsius (day), and the standard water temperature is 36 degrees Celsius (in summer). The task also includes pronouns and other types of Type anaphora to make decisions. Implementation: Create and optimize files that should be correct according to grammar rules.

[e], For example, the use of will become the future tense of be. An example of interactive use of natural language creation is the WYSIWYM framework, which states that what you see is what you think” and allows users to view and manipulate the continuous file of the underlying formal language (NLG). It allows the user to view and manipulate the continuous rendered view (NLG output) of the underlying formal language file (NLG). It allows the user to view and manipulate a continuous rendered view of the underlying official language file (NLG output). This framework allows you to view and manipulate the continuous rendered view (NLG output) of the underlying official language files (NLG files) with no need to learn how to edit official languages. Another example includes a content generation system that can help human writers and make the writing process more efficient. already A content generation tool based on Web mining using 61 search engine APIs has been established. The tool mimics cutting and pasting writers were the writer forms its content through various search results. By far the most successful NLG application is the data-to-text system, which generates databases and data sets This summary. These systems typically perform data analysis as well as text generation. In particular, a number of systems have been put in place for these the system can generate text weather forecasts based on weather data.

XI, The Machine Learning for Sensors and Signal Data First, it needs to be clear; sensors have physical properties that are “perceived”—they turn things in the physical world into systems that can operate for the data. Traditionally, sensors have filled well-defined single-purpose roles: thermostats, pressure switches, motion probes Sensor, oxygen gas sensor, percussion detector, smoke detector, voltage controller. Measure one thing and pass on one thing Very simple information.

This thinking stems from hundreds of years of physical engineering of equipment, and today it persists, in part, because The convenience of modular thinking in system design. This situation is changing, fundamentally. software is becoming the new sensor. The current smart phone: it has sound and image functions, as well as a multi-axis accelerometer, 3-axis gyroscope, magnetic compass, air Pressure, luminosity, touch.

[a], The sensor kits on the previous generations of smart phones will completely surpass the U.S. military's not long ago of many sensor kits. Some of these phone-based sensors still use dedicated hardware to reduce the transduction data to information. Information, but more and more sensors are completed in software: acceleration, gyro and other data are reduced to the screen orientation, “electricity” Talk to the ear “detector and navigation input. Core can capture high-grained physical input at high frequency sampling rate, rather than style Sensor design that runs the feed software in the local memory on the local processor to restore the data stream to the operating system. And applications are specific inputs required for a variety of different purposes.

Even wireless electrical components are becoming software functions. Home security system based on similar thinking, with microphone and appropriate microcontroller, with software-defined audio processing Energy: Glass break detector, foot detector, heartbeat counter, hand noise detector, dog barking or shouting detection as well as fall sensors, unauthorized teen party alarms, all sensors defined in the software are in the same Software, flexible hardware box. No longer a “question and answer”, beyond the traditional safety sensor design. Modularity is increasingly moving from the physical layer to the network layer, where modules connect on peer-to-peer networks and exchange packet information. although however, this network layer began to be a digital alternative to a single circuit, but as.

[b], bandwidth capacity increased, it could also be available to devices Share basic data and the flexibility of local YES/NO decisions. This creates an unprecedented opportunity to both cross-pattern Integrate information and temporarily add new features in the form of software sensors. This shift in thinking also opens up a big door of integrating more complex AI-based algorithms, not just simple conditional thresholds value. Sensor information can be 62 integrated in an increasingly complex way. Machine learning of sensor and signal data is now easier than ever: hardware is getting smaller and sensors are becoming more affordable, making IoT devices available for a wide range of applications, from predictive maintenance to monitoring and control.

Hardware is getting smaller and sensors are becoming more affordable, making IoT devices available for a wide range of uses, from predictive maintenance to mobile phone monitoring. Whether you use sound, vibration, image, electrical signals or accelerometer data or other types of sensors, you can teach your machines to detect and classify data in real time by using a variety of sensors. Whether you use sound, vibration, image, electrical signal, or accelerometer data or other types of sensor data, you can teach the machine to detect and classify real-time events in real time and process them with an inexpensive microcontroller (even with noisy, highly variable data). You can build richer analyses by teaching the machine to detect and classify events in real time, using inexpensive microcontrollers to process them (even with noisy, highly variable data). In addition, the industry has extensively adopted and surpassed the fast four-leaf transform (FFT). The machine learning of sensor data at this high sampling rate reveals the correct guide contains tips from experts in signal processing and machine learning.

[c], Rich Data, Poor Data: getting the most out of Sensors; Here, the frequency information we obtain is much higher than the FFT resolution, plus important time information such as transient and phase Bit. However, we also see some noise, which can make human analysis more difficult to use. However, numbers like real AI Data-driven algorithms extract the maximum value from this type of data.

It collects and analyzes it; it contains what certain conditions will produce How to perform regular maintenance, discover various important features of the abnormal behavior of the user of the present invention. But with abundant data comes abundant problems—more expensive sensors, difficulty interrupting line mounted instruments, bandwidth requirements from local nodes to obtain data. Many people simply use the cheapest sensor packages, limiting themselves to simple metrics such as RMS and peak-to-peak, essentially discarding almost all information contained in certain anomalous vibrations. value to peak, essentially discarding nearly all information contained in some anomalous vibration. Others use sensor packages that sample at a much higher rate, and locally at a much higher rate. Other people use sensor packages that sample at higher rates and calculate FFF locally with good frequency resolution, and tools such as realistic AI can make full use of such data. Realistic AI and other tools can make full use of such data. However, some people invest in sensors that capture the raw time waveform itself at a high sampling rate and use realistic AI.

[d], However, some people invest in sensors that can capture the raw time waveform itself at high sampling rates and use tools such as realistic AI to get as much high-value data out of the data as possible. Rich & poor data. The time waveform and high resolution FFT are described by us as “rich data”.

There is a lot of information for finding signatures and Detect abnormalities. These analysis tools require a lot of data processing. They enable 63 data to tell. On the other hand, RMS and everything from peak to peak are “bad data”. They tell you too much and throw it away all the necessary information to make the judgment you most want to make.

They're basically, just advanced descriptive statistics, and they're we discarded almost all the important signature information that was needed to find fine events and conditions, and these events and conditions can first demonstrate the value of the sensor implementation. As this excellent example of another domain shows, descriptive statistical letters.

In the actual terminology of data analysis, it means relying only on high-level descriptive statistics (poor data), not time and frequency domain (rich data), you will miss anomalies, cannot detect signatures, and basically sacrifice what the implementation may provide value. Yes, it may be more complicated to implement. It may also be more expensive. But it can provide exponentially higher value. Tools like Reality AI can help. R&D engineers use Reality AI tools to create machine learning-based signal classifiers and detectors for real-world products, including wearable devices and machines, and can explore sampling rates, computational strengths, and other factors.

[e], R&D engineers use Reality AI tools to create machine learning-based signal classifiers and detectors for real products, including wearables and machines, and can explore the connection between sampling rate, computational intensity, and accuracy. They can train new models and run k-fold diagnostics (among other things) to prevent over-training and predictability. training and predictability. Once they have done so, they can deploy to the cloud or export code to be compiled for their specific inline environment. Compiled code for their specific embedded environment. There are two main paradigms for solving classification and detection problems in sensor data: model-driven and data-driven. Data-driven is a new way of thinking, driven by machine learning. Look for an algorithm that can discover that you might I don't even know the connections and correlations that I would suspect. Both methods have their positive and negative aspects:

[f], Model-Driven Approaches Limit Complexity Model-driven approaches are strong because they rely on a deep understanding of the system or process and can benefit from scientifically established relationships. They benefit from scientifically established relationships. Models cannot accommodate infinite complexity and often must be simplified. They are difficult to compute with noisy data and non-inclusive variables.

They are difficult to compute with noisy data and non-inclusive variables. Data driven is data starvation Data-driven methods based on machine learning require a lot of data to get decent results. Discovery function and training points. The AI tool of the classifier learns from examples and needs to have enough examples to cover all expected variants and empty situations. certain Some tools (such as real-life AI) are powerful enough to summarize from the limited training data and find out what they can do. Can set and decision-making standards, but many machine learning methods require real large data Specialists of your own type are required to set them up. Realization of a smart tool is a data-driven machine learning tool that systematically optimizes sensors and signals to ensure The system of the present 64 invention is absolutely accurate, high-quality and reliable in the use environment, and it is a strong foundation for the application of digital technology.

Build Up an AI Data and Private Cloud

From an artificial intelligence infrastructure perspective, organizations need to research them networks, data storage, data analytics and security platforms to ensure they are effectively responding to the growth of the IoT ecosystem.

I, this includes data generated by their own devices and devices from supply chain partners. Last, but certainly not least: Training and skills development are vital for any IT endeavor, and especially enterprise AI initiatives. Companies will need data analysts, data scientists, developers, cybersecurity experts, network engineers and IT professionals with a variety of skills to build and maintain their infrastructure to support AI and to use artificial intelligence technologies, such as machine learning, natural language processing and deep learning, on an ongoing basis.

They will also need people who are capable of managing the various aspects of infrastructure development, and who are well-versed in the business goals of the organization. Putting together a strong team is an essential part of any artificial intelligence infrastructure development effort. The characteristics of AI have always been the goal of deep understanding of the construction and training of analytical expert models. But all change with the drive and expansion of the AI program.

The forefront of this transformation is based on the valuable AI work framework, which is called the Data Training Inference (DTI) AI model. Before delving into the details, it is important to know that the DTI model is not a linear workflow. Instead, it is a three-phase that is always interacting. This process is underway, and the insights generated are more abundant and more valuable. Data that is questionable in quality, veracity or even quantity will create questionable AI models, generating dubious results.

AI experts point out that the data phase is the most important of the three phases that are time consuming. The work requires a huge amount of data, and loads common terminology data and inputs it into the AI model for training. This is an intensive task, which is more realistic than ever. Accuracy and even quantity from the data in question will produce business results of the suspicious AI model. It's not a solid start to the data foundation that will make your AI project fail or even start the wrong way. In all of these, training machine learning models is the most computationally intensive task.

If you talk about training models (which usually require a lot of computing power), then it's almost impossible without the right hardware to complete the process. Also, this dense portion of the neural network consists of various matrix multiplications. How to make the training model faster? This can be done simply by performing all the operations at the same time, rather than one after the other. This is where the GPU comes in.

Thousands of cores are designed to perform with almost 100% efficiency, and it turns out that these processors are also suitable for performing neural network calculations. The struggle between CPU and GPU is more beneficial to the latter, because a large number of GPU cores offset 2-3 times the CPU clock speed—about 3500 (GPU) and about 16 (CPU). The GPU cores is a simplified version of the more complex CPU core, but having so many cores gives the GPU? a higher degree of parallelism and therefore better performance. Since all devices do not contain the power required to run the GPU (approximately 450 W, including the CPU and motherboard), there are alternatives to GPUs such as FPGAs and ASICs. The TPU (Tensor Processing Unit) is another example of a machine learning-dedicated ASIC that is designed to accelerate the calculation of linear algebra and specifically performs fast and bulky matrix multiplication. When you understand the simple principles described above, lay a basic idea for any private cloud creation and know how to invest. Of course, talent is the first. If you just started to have no suitable data science talents, what should you do? There are two options here; You can choose to outsource the setup of the server. It is completed by a company with decades of hardware setup. The company only needs to provide a detailed implementation of various functional tasks.

II, those with experienced companies can follow the requirements of the enterprise. Design the perfect solution, for example, choose to configure CPU, GPU, TPU (tensor processing unit), TPU is a 28 nm, 700M Hz ASIC, suitable for SATA hard drive slot, and connected to its host through PCle Gen3X16 bus, the bus provides an effective bandwidth of 12.5 GB/s. The GPU is designed to generate polygon-based computer graphics. In recent years, GPUs have accumulated tremendous processing power due to the demand for fidelity in modern computer games and graphics engines.

A GPU is a parallel programming setup involving the GPU and CPU that can process and analyze data in a manner similar to an image or any other graphical form. The GPU was created for better, more general-purpose graphics processing, but it was later found to be very suitable for scientific computing. If the enterprise's mission is small and complex sequential processing is possible, no large systems are needed. You can even skip the GPU completely. A CPU such as the i7-7500U can train an average of about 115 examples per second. Therefore, if you plan to work on other ML domains or algorithms, you don't need a GPU.

If your task is cumbersome and has manageable data, then a powerful GPU would be a better choice. A server with a high-end dedicated graphics card should be able to do this. High-end servers such as the Nvidia GTX 1080 (8 GB VRAM) (which are expected to be heavy) can train an average of about 14,000 samples per second. In addition, the CPU must not be the bottleneck of the GPU. For example, the i7-7500U works seamlessly with the GTX 1080 GPU. If your business grows to deal with complex issues, or a company that uses deep learning, you should probably build your own deep learning systems and cloud services.

If your task is larger than usual and you have enough money to support it, you can choose a GPU cluster and do multi-GPU computing. In addition, there are more powerful options to choose from—TPU and faster FPGAs—designed for these purposes. The development of digital technology is changing with each passing day. Today, companies can also choose the latest: IEI TANK* A IoT Developer Kit 6th generation Intel@ Core™ i5 or i7 processor with Intel@ HD Graphics 530 Validated software stack to quickly deploy on AWS Greengrass* or Microsoft Azure* IoT Edge Preinstalled Intel@ Distribution of Open VINO™ toolkit for deep learning inference and computer vision applications Support for Intel@ Vision Accelerator Preinstalled Intel@ System Studio and Arduino Create* Or, choose to install Intel—Spring Hill, which is based on the 10 nm Ice Lake AI processor with the following features.

[a]. The best performance/efficacy for the inference workload of the data center reaches 4.8 TOPs/W.

[b]. 5 times power adjustment, expandable in a wide power range of 10-50 W.

[c]. highly editable, does not affect performance.

[d], with comprehensive RAS capabilities, can be seamlessly deployed in existing data centers.

[e]. Support all mainstream deep learning frameworks. The IT department of the enterprise can write the code or even the software according to the project requirements to match the requirements of the project, or the outsourcing software can be completed by other professional software companies.

[f]. If the company does not have the right digital science talent in the early stage, then another reasonable choice is to buy IBM—LC922, Power Systems LC922: The data server for AI The IBM Power System LC922 server is engineered to meet AI data and workload requirements. It has a storage-rich design that delivers industry-leading compute to analyze and explore data, along with the vast storage capacity to contain it. Up to 3.9× price-performance with popular DBs Up to 120 TB of data storage Superior I/O: PCle Gen 4.

You can also choose to buy: owner Systems LC922 AI data server Power Systems AC922: The training server for AI The IBM Power System AC922 server can deploy deep learning frameworks and accelerated databases for AI training. Combine the innovation data scientists desire with the dependability IT requires. Fast I/O—up to 5.6× more I/O throughput than x86 servers 2-6 NVIDIA® Tesla® V100 GPUs with NV Link. And buy a set: IBM Watson Machine Learning Accelerator software and the Power AC922 are a winning combination This powerful combination of software and hardware can reduce model training times, accelerate iterations and improve insights. 3.7× faster training for Caffe¹ 46× faster Machine Learning iterations with SnapM L² in addition, you can also choose to purchase including follow-up services: IBM Power Systems AI Starter Kit: The hardware, software and support toolkit for your AI journey The IBM AI Starter kit includes everything you need to start training models and discovering valuable insights with IBM AI servers, plus the human support to help you implement those tools, including: 2 IBM Power AC922 servers 1 IBM Power LC922 server Watson Machine Learning Accelerator (WM LA) software Five Units of IBM Systems Lab Services IBM Power Systems. note: A private cloud center should be established in each user's city, so that the distributed configuration can accurately grasp the data generated by the user and improve the rapid response to the user's needs. Distributed users are easier to manage and more efficient because users in each region have different usage habits.

III, Arduino and Computing ARDUINO is an open-source microcontroller that can be used with computers to connect to various types of sensors. It also has a very useful and active support community. Arduino is an open-source electronic platform based on easy-to-use hardware and software. It is suitable for;

[a], any need for interactive projects. Arduino senses the environment

by receiving input from many sensors and affects its surroundings by controlling lights, motors and other actuators. In addition; by writing code using the Arduino programming language and using the Arduino development environment to instruct Arduino to follow (abide by) and meet the various functional requirements of the present invention. Arduino is an open-source electronic platform based on easy-to-use hardware and software.

The Arduino board can read the input—the light on the sensor, the finger on the button or the Twitter message—and convert it to an output—activate the motor, turn on the LED, and publish the content online.

You can tell the board what to do by sending a set of instructions to the microcontroller on the board. To do this, you need to use the Arduino programming language (based on the connection) and the Processing-based Arduino software (IDE). For many years, Arduino has been the brain of thousands of projects, from everyday items to complex scientific instruments. Thanks to its easy-to-use user experience, Arduino has been used in thousands of different projects and applications. Arduino software is easy to use and flexible enough for advanced users. It runs on Mac, Windows and Linux. There are many other microcontroller and microcontroller platforms available for physical computing.

Parallax Basic Stamp, Net media's BX-24, Phi gets, MIT's Handy board and many other products offer similar functionality. All of these tools use the details of microcontroller programming and package them in an easy-to-use package. The Arduino also simplifies the process of using a microcontroller. Low price—Arduino boards are relatively inexpensive compared to other microcontroller platforms. The cheapest Arduino modules can be assembled by hand, and even pre-assembled Arduino modules are less than $50. Cross-platform—Arduino software (IDE) runs on Windows, Macintosh OSX and Linux operating systems. Most microcontroller systems are limited to Windows. Simple, clear programming environment—Arduino software (IDE) is flexible enough for advanced users. Open source and extensible software—Arduino software is released as an open-source tool for experienced programmers.

[b], The language can be extended through the C++ library, and those who want to know the technical details can jump from Arduino to the AVR C programming language on which it is based. Similarly, you can add AVR-C code directly to the Arduino program. Open Source and Scalable Hardware—The Arduino board is released under the Creative Commons license, so experienced circuit designers can build their own module versions, extend and improve. Even relatively inexperienced users can build aversion of the module to understand how it works and save money.

One configuration in which the sensor uses a frequency band is a mesh network consisting of a number of interconnected small low power radios that relay data from remote sensors at the outer edge of the area to the radio nodes of the collection point. Each collection point has access to the cloud. The various functional sensors of the present invention communicate with the cloud computing through the Arduino link after collecting the data of the user (using). After the data reaches the cloud, the database performs different algorithm operations, analyzes, and the software processes it, and then may decide to execute an item.

Operations, such as sending alerts or automatically adjusting sensors/devices without the user having to do it yourself. In addition, other internal sensors collect data from IoT consumer devices such as security systems, smart devices, smart TVs, and wearable health meters. Can also be used Thing Speak it is the open IoT platform with MATLAB analytics. Thing Speak™ is an IoT analytics platform service that allows you to aggregate, visualize and analyze live data streams in the cloud. Thing Speak provides instant visualizations of data posted by your devices to Thing Speak.

IV, Error-correcting Introduction All error-detection and correction schemes add some redundancy (i.e., some extra data) to a message, which receivers can use to check consistency of the delivered message, and to recover data that has been determined to be corrupted. Error-detection and correction schemes can be either systematic or non-systematic. In a systematic scheme, the transmitter sends the original data, and attaches a fixed number of check bits (or parity data), which are derived from the data bits by some deterministic algorithm.

[a], If only error detection is required, a receiver can simply apply the same algorithm to the received data bits and compare its output with the received check bits, if the values do not match, an error has occurred at some point during the transmission. In a system that uses a non-systematic code, the original message is transformed into an encoded message carrying the same information and that has at least as many bits as the original message. Good error control performance requires the scheme to be selected based on the characteristics of the communication channel.

Common channel models include memoryless models where errors occur randomly and with a certain probability, and dynamic models where errors occur primarily in bursts. Consequently, error-detecting and correcting codes can be generally distinguished between random-error-detecting/correcting and burst-error-detecting/correcting. Some codes can also be suitable for a mixture of random errors and burst errors. If the channel characteristics cannot be determined, or are highly variable, an error-detection scheme may be combined with a system for retransmissions of erroneous data. This is known as automatic repeat request (ARQ), and is most notably used on the Internet. An alternate approach for error control is hybrid automatic repeat request (HARQ), which is a combination of ARQ and error-correction coding. Types of error correction There are three major types of error correction. Automatic repeat request (ARQ) Main article: Automatic repeat request Automatic Repeat Re-Quest (ARQ) is an error control method for data transmission that makes use of error-detection codes, acknowledgment and/or negative acknowledgment messages, and timeouts to achieve reliable data transmission. An acknowledgment is a message sent by the receiver to indicate that it has correctly received a data frame.

Usually, when the transmitter does not receive the acknowledgment before the timeout occurs (i.e., within a reasonable amount of time after sending the data frame), it retransmits the frame until it is either correctly received or the error persists beyond a predetermined number of retransmissions. Three types of ARQ protocols are Stop-and-wait ARQ, Go-Back-N ARQ, and Selective Repeat ARQ. ARQ is appropriate if the communication channel has varying or unknown capacity, such as is the case on the Internet. [b], However, ARQ requires the availability of a back channel, results in possibly increased latency due to retransmissions, and requires the maintenance of buffers and timers for retransmissions, which in the case of network congestion can put a strain on the server and overall network? Capacity.

[b] For example, ARQ is used on shortwave radio data links in the form of ARQ-E, or combined with multiplexing as ARQ-M. Forward error correction Forward error correction (FEC) is a process of adding redundant data such as an error-correcting code (ECC) to a message so that it can be recovered by a receiver even when a number of errors (up to the capability of the code being used) were introduced, either during the process of transmission, or on storage. Since the receiver does not have to ask the sender for retransmission of the data, a backchannel is not required in forward error correction, and it is therefore suitable for simplex communication such as broadcasting. Error-correcting codes are frequently used in lower-layer communication, as well as for reliable storage in media such as CDs, DVDs, hard disks, and RAM.

[c], Error-correcting codes are usually distinguished between convolutional codes and block codes: Convolutional codes are processed on a bit-by-bit basis. They are particularly suitable for implementation in hardware, and the Viterbi decoder allows optimal decoding. Block codes are processed on a block-by-block basis. Early examples of block codes are repetition codes, Hamming codes and multidimensional parity-check codes.

They were followed by a number of efficient codes, Reed-Solomon codes being the most notable due to their current widespread use. Turbo codes and low-density parity-check codes (LDPC) are relatively new constructions that can provide almost optimal efficiency. Shannon's theorem is an important theorem in forward error correction, and describes the maximum information rate at which reliable communication is possible over a channel that has a certain error probability or signal-to-noise ratio (SNR).

This strict upper limit is expressed in terms of the channel capacity. More specifically, the theorem says that there exist codes such that with increasing encoding length the probability of error on a discrete memoryless channel can be made arbitrarily small, provided that the code rate is smaller than the channel capacity.

The code rate is defined as the fraction k/n of k source symbols and n encoded symbols. The actual maximum code rate allowed depends on the error-correcting code used, and may be lower. This is because Shannon's proof was only of existential nature, and did not show how to construct codes which are both optimal and have efficient encoding and decoding algorithms. Hybrid schemes Main article: Hybrid ARQ Hybrid ARQ is a combination of ARQ and forward error correction. There are two basic approaches: Messages are always transmitted with FEC parity data (and error-detection redundancy).

[d], A receiver decodes a message using the parity information, and requests retransmission using ARQ only if the parity data was not sufficient for successful decoding (identified through a failed integrity check). Messages are transmitted without parity data (only with error-detection information).

If a receiver detects an error, it requests FEC information from the transmitter using ARQ and uses it to reconstruct the original message. The latter approach is particularly attractive on an erasure channel when using a riteless erasure code.

Cyclic redundancy checks (CRCs) Main article: Cyclic redundancy check A cyclic redundancy check (CRC) is a non-secure hash function designed to detect accidental changes to digital data in computer networks; as a result, it is not suitable for detecting maliciously introduced errors. It is characterized by specification of what is called a generator polynomial, which is used as the divisor in a polynomial long division over a finite field, taking the input data as the dividend, such that the remainder becomes the result.

[e], A cyclic code has favorable properties that make it well suited for detecting burst errors. CRCs are particularly easy to implement in hardware, and are therefore commonly used in digital networks and storage devices such as hard disk drives.

Even parity is a special case of a cyclic redundancy check, where the single-bit CRC is generated by the divisor x+1. Cryptographic hash functions Main article: Cryptographic hash function the output of a cryptographic hash function, also known as a message digest, can provide strong assurances about data integrity, whether changes of the data are accidental (e.g., due to transmission errors) or maliciously introduced. Any modification to the data will likely be detected through a mismatching hash value. Furthermore, given some hash value, it is infeasible to find some input data (other than the one given) that will yield the same hash value. If an attacker can change not only the message but also the hash value, then a keyed hash or message authentication code (MAC) can be used for additional security.

Without knowing the key, it is not possible for the attacker to easily or conveniently calculate the correct keyed hash value for a modified message. Error-correcting codes Main articles: Forward error correction and Error correction code Any error-correcting code can be used for error detection.

A code with minimum Hamming distance, d, can detect up to d−1 errors in a code word. Using minimum-distance-based error-correcting codes for error detection can be suitable if a strict limit on the minimum number of errors to be detected is desired. Codes with minimum Hamming distance d=2 are degenerate cases of error-correcting codes, and can be used to detect single errors. The parity bit is an example of a single-error-detecting code.

Error-correcting memory Main article: ECC memory DRAM memory may provide stronger protection against soft errors by relying on error correcting codes.

[f] Such error-correcting memory, known as ECC or EDAC-protected memory, is particularly desirable for mission-critical applications, such as scientific computing, financial, medical, etc. as well as deep-space applications due to the increased radiation in space.

Error-correcting memory controllers traditionally use Hamming codes, although some use triple modular redundancy. Interleaving allows distributing the effect of a single cosmic ray potentially upsetting multiple physically neighboring bits across multiple words by associating neighboring bits to different words. As long as a single event upset (SEU) does not exceed the error threshold (e.g., a single error) in any particular word between accesses, it can be corrected (e.g., by a single-bit error correcting code), and the illusion of an error-free memory system may be maintained. In addition to hardware providing features required for ECC memory to operate, operating systems usually contain related reporting facilities that are used to provide notifications when soft errors are transparently recovered. An increasing rate of soft errors might indicate that a DIMM module needs replacing, and such feedback information would not be easily available without the related reporting capabilities. One example is the Linux kernel's EDAC subsystem (previously known as blue smoke), which collects the data from error-checking-enabled components inside a computer system; beside collecting and reporting back the events related to ECC memory, it also supports other check summing errors, including those detected on the PCI bus.

A few systems also support memory scrubbing. In coding theory, burst error-correcting codes employ methods of correcting burst errors, which are errors that occur in many consecutive bits rather than occurring in bits independently of each other. [g], Many codes have been designed to correct random errors. Sometimes, however, channels may introduce errors which are localized in a short interval. Such errors occur in a burst (called burst errors) because they occur in many consecutive bits.

Examples of burst errors can be found extensively in storage mediums. These errors may be due to physical damage such as scratch on a disc or a stroke of lightning in case of wireless channels. They are not independent; they tend to be spatially concentrated. If one bit has an error, it is likely that the adjacent bits could also be corrupted. The methods used to correct random errors are inefficient to correct burst errors. One of the most complex strong reliability properties is virtual synchrony. Strong reliability properties are offered by group communication systems (GCSs) such as IS-IS, Appia framework, Spread, JGroups or Quick Silver Scalable Multicast. The Quick Silver Properties Framework is a flexible platform that allows strong reliability properties to be expressed in a purely declarative manner, using a simple rule-based language, and automatically translated into a hierarchical protocol. When you understand some of the above basic concepts, the following applications are options you can refer to, Reliable delivery in real-time systems There is, however, a problem with the definition of reliability as “delivery or notification of failure” in real-time computing.

In such systems, failure to deliver the real-time data will adversely affect the performance of the systems, and some systems, e.g., safety-critical, safety-involved, and some secure mission-critical systems, must be proved to perform at some specified minimum level.

This, in turn, requires that there be a specified minimum reliability for the delivery of the critical data. Hence, it is only the delivery that matters, and notifying the sender does not negate or ameliorate this failure of the real-time system's transport layer to deliver. In hard and firm real-time systems the data has to be delivered within a deadline, i.e., data that is delivered late is valueless.

[g], In hard real-time systems all data must be delivered within its deadline, or it is considered a system failure. In firm real-time systems, late data is still valueless, but the system can tolerate some amount of late or missing data. There are a number of protocols that are capable of meeting real-time requirements for reliable delivery and timeliness, at least for firm real-time systems (due to the inevitable and unavoidable losses from, e.g., the physical layer bit error rates): MIL-STD-1553B and STANAG 3910 are well-known examples of such timely and reliable protocols for avionic data buses. M IL-1553 uses a 1 Mbit/s shared media for the transmission of data and the control of these transmissions, and is widely used in federated military avionics systems (in which “Each system has its own computers performing its own functions”).

It uses a Bus Controller (BC) to command the connected Remote Terminals (RTs) to receive or transmit this data. The BC can, therefore, ensure that there will be no congestion, and transfers are always timely. The MIL-1553 protocol also allows for automatic retries that can still ensure timely delivery and increase the reliability above that of the physical layer.

[h], STANAG 3910, also known as EFABus in its use on the Eurofighter Typhoon, is, in effect, a version of MIL-1553 augmented with a 20 Mbit/s shared media bus for data transfers, retaining the 1 Mbit/s shared media bus for control purposes. The Asynchronous Transfer Mode (ATM), the Avionics Full-Duplex Switched Ethernet (AFDX),

and Time Triggered Ethernet (TTEthernet) are examples of packet-switched networks protocols where the timeliness and reliability of data transfers can be assured by the network. AFDX and TTEthernet are also based on IEEE 802.3 Ethernet, though not entirely compatible with it.

ATM uses connection-oriented virtual channels (VCs) which have fully deterministic paths through the network, and usage and network parameter control (UPC/NPC), which are implemented within the network, to limit the traffic on each VC separately. This allows the usage of the shared resources (switch buffers) in the network to be calculated from the parameters of the traffic to be carried in advance, i.e., at system design time. That they are implemented by the network means that these calculations remain valid even when other users of the network behave in unexpected ways, i.e., transmit more data than they are expected to.

The calculated usages can then be compared with the capacities of these resources to show that, given the constraints on the routes and the bandwidths of these connections, the resource used for these transfers will never be over-subscribed. These transfers will therefore never be affected by congestion and there will be no losses due to this effect.

Then, from the predicted maximum usages of the switch buffers, the maximum delay through the network can also be predicted.

[i], However, for the reliability and timeliness to be proved, and for the proofs to be tolerant of faults in and malicious actions by the equipment connected to the network, the calculations of these resource usages cannot be based on any parameters that are not actively enforced by the network, i.e., they cannot be based on what the sources of the traffic are expected to do or on statistical analyses of the traffic characteristics (see network calculus).

V, The health excretion reference score indicator Another aspect of this disclosure provides a system for managing healthy excreta. The system includes sensors for recording the user's biometric data, and local computing devices that receive biometric data from the sensor, which can be configured to display one or more targets in response to the received biometric data to improve the health excretion reference score indicator.

The system may also include a remote server that receives biometric data from a local computing device, one or more of a local computing device or a remote server may include of one or more recommended references for a user to generate healthy excretion scores, the remote server also needs to be configured to allow professional medical personnel to access, a health evacuation score reference to one or more of the recommendations, or one or more of the reference targets may be generated by a medical professional. and is provided to the local computing device via a remote server. Large cloud providers have created AI products for many common tasks, and you can use them in the Pay As You model.

For example, Amazon's Recognition, Microsoft's Face API and Google's Vision API. However, these services are not completely suitable for the needs of the present invention. Therefore, the problem to be solved by the present invention is not very common. The simpler method is to use the google Tensorflow software library.

VI, Data processing security's In addition to focusing on building a responsive and easy-to-use IoT system, technical teams also need to create a secure and accessible IoT system within the sever system. Rely on data collection and processing practices. The reliability and scalability of the solution comes from the enterprise owner's use to capture, schedule, and manage the solution. The practice of sequencing, storing, and relaying IoT data.

Combined with machine learning-based analysis, it is important to perform anomaly detection in a user environment. AGT uses a novel approach to detect anomalies in a user environment.

[a], the present invention allows machine learning to try to find out the state of the feed, and over time to obtain a normal or an unusual situation. And create an exception index, if something exceeds the threshold, it is counted as an exception. Monitoring Sensor Feeds the data is able to adjust the event threshold of attention. Capturing data is the first layer of IoT application architecture—the team should ensure that the device captures relevant real-time information. If a sensor failure or processing error may end up with the wrong data from the user. Legal compliance is another point that teams should keep in mind when designing data collection practices. Developers need to integrate security into in all tiers of IoT applications, and the consent of smart device users is required when capturing data to avoid GDPR and other legal fines.

In order to understand all the data collected by sensors, the technical team can also go from using metadata and assigning metadata to existing IoT data mark benefits. In this way, IoT engineers will facilitate sorting, monitoring, and storing processes for different types of data. The system design of the invention establishes a security foundation from the following points:

[b], Build tamper-proof hardware. Because IoT sensors and other devices typically operate 24/7, there is no way to continuously monitor them.

To ensure that the first three parties do not have access to hardware, and business managers should consider placing IoT devices in isolated spaces to better understand who can access them? In addition, the three ways to improve endpoint security are: Disable the device automatically when someone tampered with the device's battery. Use port locking to restrict access to USB, camcorder, and Ethernet ports—Create a strong boot password.

Track access to serial ports, UDP/TCP ports. Create an obvious tamper-proof package—the device owner will immediately know if the hardware has been opened before it arrives. 2. Run dynamic tests on IoT devices. In this way, the technical team will discover the various defects and vulnerabilities it may expose from the operating state of the hardware and software. Static analysis may not know much about processor and memory vulnerabilities. Ability to inspect new code when it interacts with the old processor the behavior is important step in verifying the reliability of the system before bringing it to market. 3. With a complete set of data processing algorithms.

Tech teams should consider what happens to IoT data when users throw away smart devices. If you fail to discard the personal letter it may result in its misuse and exposure of users sensitive financial, location, or health-related data. The most commonly used data the disposal practice is “discard, recycle or destroy”—in short, DRD. IoT device manufacturers strongly encourage users to contact the company before deleting data from their smart devices so that a professional team can handle data deletion.

Device manufacturers can allow users to enforce a single DRD policy that determines whether or not personal authentication and personal data should be stored on the device or on a remote server. The device manufacturer can allow the user to enforce a single DRD policy that determines whether the authentication and bodily information should be stored on the device or on a remote server. Here, the lack of technical skills among smart device users is a problem that needs to be addressed. The lack of technical skills in smart devices is a problem that needs to be addressed, as most people have difficulty understanding the full complexity of IoT password storage.

[c], IoT Data Collection Techniques and Processes. To better understand how IoT-based data collection works, let's examine the mobile parts of any connected system. IoT application architectures are often complex, but most items are composed of standard components. In software development and design, of all the previous priorities fully taken into account, there are also, the following three super-priorities: In the process of the device of the present invention is used, the user adjusts one or more functions of the standard program by voice, for example: the temperature of the water is raised by 1 degree, and then by 2 degrees. Or inject water pressure to reduce. 1p,2p, etc., dual AI edge computing is obtained in the voice command is executed immediately. User voice commands are the first kind of super priority, which can be understood as follows: when executing super priority After the dual AI edge computing, keep the other functions of the program unchanged, such as: floor temperature, water temperature, water number of injections, clear Water pressure, cleaning time, air pressure, airtime, etc., if the user adjusts two of them by voice, then all other functions must be kept in the user's favorite position, or, before the user's favorite has not been established, should remain in the standard program service state, except for non-user adjustments, all remaining functions must be maintained. then all other functions must be kept in the user's favorite position, or, before the user's favorite has not been established, should remain in the standard program service state, except for non-user adjustments, all remaining functions must be maintained. Here is a very special example: dual AI edge computing in the process of observing a certain use, found that a woman user is During the month; “software development and design should consider the special design:” voice prompt program”, AI intelligent voice system should ask the User, “Now that you have a normal menstrual cycle, do you need a normal injection of water to clean the vagina?” In general, the system is not recommended Note water cleaning, after obtaining the user voice command, and then choose to take the appropriate action.

VII, in the process of using the device of the present invention, the user adjusts one or more functions of the standard program by a manual knob.

[a], For example, the temperature of the water is raised by 1 degree, and then by two degrees. Or inject water pressure to reduce 1p,2p, etc., dual AI edge computing in Execute immediately after obtaining the manual knob command. The user manual knob command is the second super-priority, it can be understood as follows: In the implementation of the manual knob command is the second super-priority; it can be understood as follows: in the implementation of When super priority is performed, the other functions of the program remain unchanged after dual AI edge computing, such as: Seat board temperatures, Injection water temperatures, Number of inputs, cleaning water pressure, Water cleaning time, Air pressure high or low, Air dry's time, etc., If the user adjusts it by manual knob The whole of two of them, then, all other functions must remain in the user's favorite position, or, in the user's favorite position Before it is built, it should remain in the standard program service state, unless the user makes adjustments, otherwise, all the rest of the function must be kept Number of inputs, cleaning water pressure, cleaning time, air pressure, airtime, etc., if the user adjusts it by manual knob The whole of two of them, then, all other functions must remain in the user's favorite position Before it is built, it should remain in the standard program service state, unless the user makes adjustments, otherwise, all the rest of the function must be Keep it.

[b], In the process of software development and design, dual AI edge computing in the process of observing a certain use, found that a woman user is During the month, software development and design should consider the special design: “voice prompt program”, AI intelligent voice system should ask the user, “Now that you have a normal menstrual cycle, do you need a normal injection of water to clean the vagina? “In general, the system is not recommended to adopt “However, the user needs to be injected with water, at this time, dual AI edge computing in obtaining the user language After the sound command, choose to take the appropriate action, that is, when the user's vagina is injected with water, the software design should consider the injection the amount of water should be reduced by half, for example: the standard injection of water should be injected into the amount of water is 10, then the need to inject water at this time can only be 5, And so on. That's Super Priority number three.

[c], AI Edge Computing needs to recognize and distinguish between different consumers Software development and design needs to give special consideration to strengthening the AI Edge Computing and AI Intelligent Cloud (including distributed clouds and remote cloud computing centers) data library, and how AI Edge Computing can be trained in a real-world environment to accurately distinguish each user (in the ordinary home environment or all others). First, it is possible to consider graphic data (including three-dimensional graphics) obtained by an intelligent photographic sensor for each of the use environments Individual users are identified and distinguished by “form”, and then all “usage” data (including usage) of each user is tracked and collected habit), make alignment and comparison and analysis, find out any differences between them and record. In addition, it is also possible to consider A particular preference shown by a different user during use as a marker to identify and recognize each user for this purpose, the purpose of the system is to recognize and distinguish each different user, analyze and process the data on their usage habits by AI intelligent system to build targeted personalized service.

[d], AI intelligent system in the use of each user in the process of careful observation These are very important software functions in terms of the functional requirements of the system device of the invention. Therefore, in software development and design we need to be very careful, specific requirements are as follows:

[1], AI edge calculation in the process of using the system equipment of the invention, the process must be very detailed through all intelligent sensors The purpose of careful observation is to observe the possible problems in a timely manner. Because people are very complex, although of course, most human excretion processes are largely consistent, but some people exhibit different morphological abnormal needs, such as: A group of people whose habits are not very healthy and who consume relatively little vegetable and fruit in their daily lives, or who have some basic diseases older people, but also people who are already suffering from anorectal disease, they have different problems with their use, software development and the design needs to pay special attention to these important needs, and careful observation is necessary. Here's an example; In the function of the system design of the invention, the water injection quantity for the first time is 270 ml, the second time is 280 ml, and the third time is: 290 ml, which is a standard procedure, is designed for the general healthy user, the user cannot change.

[2], However, the following these groups of people may have difficulty in solving these specific user problems by using this feature. Therefore, it is necessary to design a comprehensive monitoring of the use process of the system equipment of the invention by the user, for example: The third infusion set out above has already been completed, unfortunately for the user is the problem group listed above, and the user still cannot drain normally, this condition was observed by the AI edge calculation in the process, and the solution that should be available must be implemented immediately. For example: The 290 ml water injection continues until the first discharge is observed by the user. or the user repeatedly releases the injected water without any other response that should be expected, etc. In short, the user community is very complex, double AI edge computing in the process of excretion through a variety of sensors to observe carefully is very necessary. Need Special Note: AI Intelligent Local Cloud (Distributed) and Remote Cloud Computing Centers can get a large number of users at any one time according to this data it can be very effective training AI intelligent cloud computing systems.

[3], So, it's found and found in this huge data the problem user is very easy, the analysis of these data to produce the judgment and promotion instructions, will be very effective to help It is the aim of the invention to assist any problem user, to assist these user groups and to further improve their health level. In this need to pay special attention to a normal and healthy user may be in a certain period of time, for various reasons into a person with excretion problems, AI intelligent edge computing in the course of its use of the present invention equipment carefully observed, and further reaction to take effective measures, which is very necessary, this is also an important core of the present invention. Another situation: these groups with excretion problems, after the start of the use of the present invention system equipment, within 48 hours of its excretion status is not always sure to get a great improvement (the inventor and the relatives around after use without exception), will return to a healthy state in a timely manner. So there is no doubt that changing from an excretion problem to a healthy person is unquestionable. Therefore, once these users' problems are fully resolved, AI Intelligent Edge Computing should respond immediately, using standard services or programs that these groups themselves like (regulated by these users themselves).

VIII, AI edge calculation after observing the problem its reaction also uses the above example: When after the first three investments of water regime did not achieve the goal, at this time, AI edge calculation first takes a conservative strategy, continue to make the investment of water for 290 ml, until the user has created a relationship out of the. Furthermore, constructing a gradual increase the amount of water to help the user, but it must be very careful to add only a small amount of water at a time, for example, from 290 ml to 295 ml, then to 300 ml, 305 ml, 310 ml, and so on. Until the problem is resolved and then enter the normal process for example, the standard is set to 300 ml, now received to 225 ml because these are for the process groups within a few years, and the American people are very happy to be here.

Again, the problem defectors have a very big problem within 28 hours of starting using the inventive device good. Almost healthy in a week. Then, enter the normal program service phase, which is the double AI edge calculation is making the importance of careful observation in the process, when there is a problem of excretion adopts conservative strategy, when the problem has been resolved to resume normal procedures, which is the core of dual AI edge computing. In addition, in the face of these groups, the standard set water injection times will change to increase by 20% to the maximum satisfaction of users.

Translate documents of sevens Thank you proton mail all of Staffs. you always did Greats! (The infrared camera on the water injector is then modified, in the coordination of the three infrared cameras; accurate with the user.) The mole matches the butt, and then the clean water is injected.)

IX, the sphere is designed as a double layer, and there is a 4.5 cm inner sphere, which is made of the same material, and both spheres are connected to the sphere.

The bottom of the body is connected to the upper face of a 1.5 cm straight 316 stainless steel pipe. It is linked to the Cloud Computing and Artificial Intelligence Center by aduino-5G, and the software designed by the special design controls its precise work. it's the work Can be: accurately in accordance with the instructions of the software, the amount of clean drinking water injected into the organ to monitor, for example, the software design is the first time The injection amount is 150 ml (150 g), mainly on feces and rectum, QX 2, Sensors and infrared micro 3D cameras, their design requirements are as follows.

[a], MPU-9250 system-in-package (SiP) Its main function is to track the dynamic changes of the user's anal position in time, and the data it obtains is transmitted to Cloud computing and human intelligence center, after a large number of data calculations and analysis, the results are reported to the software designed for this purpose, the software will the movement of the body is adjusted up, down, left, and right to ensure that it accurately anatomizes the anus.

[b], 3D anus obtained by infrared micro 3D camera Position graphics are simultaneously transmitted to cloud computing and smart center at high speed, and the specially designed 3D graphics software will perform high-speed calculation and analysis at the right time, And continuously issue position adjustment instructions to ensure that the ball fits the user's anus accurately.

[c], distance sensor, keep the ball The distance data between the top of the body and the anus is transmitted to the cloud computing and intelligent center through arduino&5G, which can perform high-speed calculation and analysis. After analysis, it is provided to specially designed software, and the software controls its accurate work.

X, pressure sensor, when the top of the sphere kisses the anus After the integration, the pressure sensor will transmit the pressure data obtained to the cloud computing and intelligent center in time, and the specially designed software will be rooted in According to the design requirements, give instructions to the auto-injection hair. According to the instructions, the auto-injection head will slowly extend vertically upwards into the anus, pay attention; The injection head keeps unceasingly yearning to overflow the filtered drinking water when it comes out of the cabin.

Therefore, the injection head is slowly entering the user's organs Time is very smooth, and its diameter is only 1 cm, the user's feeling is very small, because it is smaller than the thinnest the diameter of feces is still small. Under the lubrication of water, the user feels comfortable, especially when the user's feces cause in the intestines. Driven by a huge swelling feeling, the internal urgency cannot be excreted.

This is a very painful thing for people. At this time, there is a small amount of drinking water. With its lubrication function, the feces and water are discharged vertically in an instant, and it is smooth and non-stop. The pressure sensor is in the whole process of up Zhidu is monitoring the pressure changes in the user's organs, and its software is designed to ensure that the pressure in the user's organs does not change. In case of change, use a small amount of drinking water injection to help the user get a smooth excretion process.

Pressure monitoring is very important A link to always add the minimum pressure to the user's organs, to ensure that it will never exceed the pressure of the human body. The stool produces pressure in the intestines. To ensure its safe use. Production requirements: Previously, there were four main types of pressure transmitters: absolute pressure, gauge pressure, Differential pressure and multivariate. Need to choose an excellent and reputable sensor manufacturer to customize, because the present invention requires the use of miniature pressure sensors the device requires its work to be accurate and absolutely sensitive. Therefore, it is necessary to conduct repeated tests during production and use a variety of different pressures. The sensor must achieve the best effect in order to meet the requirements.

XI, injector (mini robots) head, it is designed to use grade 326 stainless steel It is made of materials, and it is required to be coated with a ceramic non-stick coating with a thickness of 2 mm. After the sphere and the organ are accurately anastomosed, the nozzle will slowly extend, and at the same time, it will continuously overflow the clean filter water, the water pressure of which is 20 psi.

Water temperature in winter the degree is between 40 F degrees-42 F degrees. The water temperature in summer is 30 F-34 F (user can choose), under the water lubrication function, Slowly extend into the organ's surface, and the height (depth) into the organ is 1 cm. Then start to design the time program according to the software, first the second time can only be injected with water 100 ml, the second time can only be injected with water 200 ml, the third injection with water 250 ml, the fourth time Injecting 300 ml of water into the water ensures that the water can only reach the abdominal feces pool of the user's rectum. Of course, the user Choose your favorite and wash your faces pool over and over again. The water injector is driven by a set of gears and a micro motor. It can be front, back, up, down, left and right, and any transfer.

The digital control valve of the micro motor is controlled by arduino&5G link cloud computing and artificial intelligence center. The specially designed software controls its work accurately. The water injector is made up of one Group wheel and a micro-motor drive, can: front and back, up and down, left and right, arbitrary transfer, micro-motor digital control valve by the arduino-5G links is both cloud computing and artificial intelligence centers, specially designed software to control their work to run accurately. 8, 3 compartments of the toilet (each component requires a 2 mm thickness ceramic (ceramic) non-stick coating) 8, the barrel of 3 compartments (each component requires a 2 mm thickness ceramic (ceramic) non-stick Coating).

On the left side of the face of the barrel (from the back of the bucket is on the right) the design has a closed compartment of 3′×width 5′×height 2′, which is its main to function as a “sex organ cleaner”, On the top of this airtight cabin, there are two self-designed ones that can be outwards (from the wall of the barrel to the middle of the barrel). With a retractable nozzle, the extension is 1 cm. After the sex organ cleaner completes its work, it will automatically retract into the airtight chamber. Two nozzles the job of the head is to clean the sex organ cleaner for one minute. After completion, the airtight compartment is closed, and the two nozzles start to inject water into the airtight compartment.

Until the washer is completely submerged. The two nozzles are controlled by sensors, and the sensors are connected to cloud computing and human intelligence via arduino&5G In the middle, the software controls every step of the entire airtight cabin. After the user has completed the convenience, the application sensors designed and installed in the barrel are commonly used. The airtight compartment controlled by the software is automatically opened, and the sex organ cleaning device extends from the inside to the outside, and starts after the exact anastomosis with the sex organs Go through the entire cleaning process.

XII, compartments of the toilet (each component requires a 2 mm thickness ceramic (ceramic) non-stick coating).

[a], On the left side of the face of the bucket (from the back of the bucket is on the right) the design has a closed compartment with a width of 3′×width 5′×height 2′, its main function Is the “Sex organ cleaner”, in this closed compartment on top of the design has two can be outward (From the barrel wall to the center of the barrel inside) free telescopic the nozzle, with an outstretched crucifixion of 1 cm, automatically retracts the work of the two nozzles in the enclosed compartment after the sex organ cleaner has completed its work The work is to clean the sex organ washer for one minute, after the completion of the closed compartment closed, the two nozzles began to fill the closed compartment water until the end All over the cleaner. The two nozzles are controlled by sensors that pass through the arduino-5G link cloud computing and artificial intelligence center.

[b], The software controls every step of the way through the confined compartment, and after the user has completed urinating; the barrel is designed to install the application sensor through the software the controlled closed compartment is self-started, and the sex organ washer extends from the inside out, and the whole is carried out after accurately matching the sex organ mouth cleaning process work.

The two nozzles are connected by a hose to the wall tank BLEACH tank micro pump outlet. The two nozzles are connected by hoses to the wall water tank BLEACH water tank micro-pump outlet.

XIII, Butt cleaning system; (each component is required to be coated with a 2 mm thick ceramic non-stick coating) Butt cleaning the system is designed as a stainless-steel spray bar that is slightly curved upwards. After the butt cleaning system connected to the wall water box, After the user completes the excretion, spray 25 psi-40 psi pressure water mist to wash the user's buttocks.

It moves back and forth repeatedly (usually 5 times, of course the user can choose the cleaning method he likes.), spraying pressure water vertically upwards can be used in a very short time the ass of the person is cleaned.

XIV, in its off-hours is designed and ass dry system stainless steel slew dry rod hidden together on the right side of the bucket, together with a closed slug (The 2.5″ is a cleaning pool with a width of 8.5″ and a height of 1″) combined with the barrel body as a whole, the closed inside is a cleaning pool, two functions of rust-free When the steel rod is not working, it is soaked in water containing 0.5% of The Bleach while it is working. Close the door and clean the inside of the pool The water naturally flows to the bottom of the bucket, it starts to work, when its work is finished will automatically return to the cleaning pool, and then closed, special Designed for it contains 0.2% BLEACH clean water that automatically overflows under the instructions of cloud computing and artificial intelligence, stainless steel slugs Soaked in it for spare.

XV, On the opposite side of the barrel, facing the wall-type water box, there is an airtight compartment designed for anal automatic injection device, which is a closed cabin. Design Between the annular flushing ring and the built-in barrel, there is a cabin of 20 cm*width 8 cm*height 8 mm, which faces the built-in barrel. The location is designed with a sealed airtight surface. When it is closed, it perfectly integrates with the inner surface of the built-in barrel as a whole. Inside Designed with Two sprinkler heads, when the automatic injection device is completed and enters the cabin, the two sprinkler heads can be automatically extended (0.5 cm), and the injection The water tank is cleaned for one minute. After the cleaning is completed, the cabin is closed. At this time, the two spray heads start to inject the water containing BLEACH. Stop after the auto injector is completely submerged. Two spray heads are connected to the outlet of the BLEACH water tank designed on the wall of the water tank (The six water jets in the three cabins are all connected to the outlet of the BLEACH water box).

XVI, in its off-hours is designed and ass dry system stainless steel slew dry rod hidden together on the right side of the bucket, together with a closed slug (THE 2.5″ is a cleaning pool with a width of 8.5″ and a height of 1″) combined with the barrel body as a whole, the closed inside is a cleaning pool, two functions of rust-free When the steel rod is not working, it is soaked in water containing 0.5% of The Bleach while it is working. Close the door and clean the inside of the pool The water naturally flows to the bottom of the bucket, it starts to work, when its work is finished will automatically return to the cleaning pool, and then closed, special Designed for it contains 0.2% BLEACH clean water that automatically overflows under the instructions of cloud computing and artificial intelligence, stainless steel slugs Soaked in it for spare.

data-driven machine learning tool that systematically optimizes sensors and signals to ensure The system of the present 64 invention is absolutely accurate, high-quality and reliable in the use environment, and it is a strong foundation for the application of digital technology.

The Invention Uses Private Blockchains

It's use identity to confirm membership and access privileges and typically only permit known organizations to join. Together, the organizations form a private, members-only “business network.” A private blockchain in a permissioned network achieves consensus through a process called “selective endorsement,” where known users verify the transactions.

I, only members with special access and permissions can maintain the transaction ledger. This network type requires more identity and access controls. Private blockchains are restricted and usually limited to business networks. A single entity management controls membership. Blockchain security for the enterprise When building an enterprise blockchain application, it's important to consider security at all layers of the technology stack, and how to manage governance and permissions for the network. A comprehensive security strategy for an enterprise blockchain solution includes using traditional security controls and technology-unique controls. Some of the security controls specific to enterprise blockchain solutions include:

[a], Identity and access management

[b], Key management

[c], Data privacy

[d], Secure communication

[e], Smart contract security

Transaction endorsement Employ experts to help the invention design a compliant and secure solution and help achieve the invention business goals. Look for a production-grade platform for building blockchain solutions that can be deployed in the users environment of the invention choosing whether that is on-premises or users preferred cloud vendor. On the other hand, should notes; When designing a blockchain solution, consider these key questions: What is the governance model for participating organizations or members? What data will be captured in each block. What are the relevant regulatory requirements, and how can? they be met. How are the details of identity managed? Are block payloads encrypted? How are the keys managed and revoked? What is the disaster recovery plan for the blockchain? participants? What is the minimal security posture for blockchain the invention users for participation? What is the logic for resolving blockchain block collisions? When establishing a private blockchain, ensure that it's deployed in a secure, resilient infrastructure. Poor underlying technology choices for business needs and processes can lead to data security risks through their vulnerabilities. The invention use blockchain Blockchain can help clarify the provenance, transparency, understanding, and explanations of those outcomes and decisions.

[f], If decisions and associated data points are recorded via transactions on a blockchain, the inherent attributes of blockchain will make auditing them much simpler. Blockchain is a key technology that brings trust to transactions in a network; therefore, infusing blockchain into AI decision-making processes could be the element needed to achieve the transparency necessary to fully trust the decisions and outcomes derived from AI.

With the advancement in IoT, industries are now enabled to capture data, gain insight from the data, and make decisions based on the data. Therefore, there is a lot of “trust” in the information obtained. But the real truth of the matter is, do we really know where these data came from and should we be making decisions and transacting based on data we cannot validate? IoT with blockchain can bring real trust to captured data. The underlying idea is to give devices, at the time of their creation, an identity that can be validated and verified throughout their lifecycle with blockchain. There is great potential for IoT systems in blockchain technology capabilities that rely on device identity protocols and reputation systems. With a device identity protocol, each device can have its own blockchain public key and send encrypted challenge and response messages to other devices, thereby ensuring a device remains in control of its identity. In addition, a device with an identity can develop a reputation or history that is tracked by a blockchain.

[g], For the invention the nexus of new technology Blockchain is at the nexus of technologies like IoT, AI and Cloud. It has the means of bringing the missing element of trust that is currently lacking from these technologies. Trust is gained through diversity of users.

Unlike a database that has a single administrator, a blockchain enables a set of diverse administrators to “referee” the data, such that no single admin can maliciously or accidentally change or delete data. And once the administrators reach consensus, the data is secured in blocks that are “chained” to one another cryptographically forming a tamper resistant ledger. When AI, IoT and Cloud use blockchain to track provenance, proofs and permissions associated with data used and emanating from these systems, the trust in the data is increased radically.

This trust will allow IoT, AI and Cloud to be adopted without fear of compromise, ushering in a new era of application and adoption of these technologies to change everyday life for the better. In data we trust . . . well, after you add a little blockchain.

II, Smart contracts defined Smart contracts are simply programs stored on a blockchain that run when predetermined conditions are met. They typically are used to automate the execution of an agreement so that all participants can be immediately certain of the outcome, without any intermediary's involvement or time loss. They can also automate a workflow, triggering the next action when conditions are met. How smart contracts work for the invention Smart contracts work by following simple “if/when . . . then . . . ” statements that are written into code on a blockchain. A network of computers executes the actions when predetermined conditions have been met and verified. These actions could include Identity's each user them production their data's, registering new users, sending notifications, or issuing a ticket.

The blockchain is then updated when the transaction is completed. That means the transaction cannot be changed, and only parties who have been granted permission can see the results. Within a smart contract, there can be as many stipulations as needed to satisfy the participants that the task will be completed satisfactorily. To establish the terms, participants must determine how transactions and their data are represented on the blockchain, agree on the “if/when . . . then . . . ” rules that govern those transactions, explore all possible exceptions and define a framework for resolving disputes.

[a], Then the smart contract can be programmed by a developer—although increasingly, organizations that use blockchain for business provide templates, web interfaces, and other online tools to simplify structuring smart contracts. Benefits of smart contracts for the invention; Speed, Efficiency and Accuracy. Once a condition is met, the contract is executed immediately. Because smart contracts are digital and automated, Trust and transparency Because there's no third party involved, and because encrypted records of transactions are shared across participants, there's no need to question whether information has been altered for personal benefit.

Security Blockchain transaction records are encrypted, which makes them very hard to hack. Moreover, because each record is connected to the previous and subsequent records on a distributed ledger, hackers would have to alter the entire chain to change a single record. IoT with blockchain can bring real trust to captured data. The underlying idea is to give devices, at the time of their creation, an identity that can be validated and verified throughout their lifecycle with blockchain.

There is great potential for IoT systems in blockchain technology capabilities that rely on device identity protocols and reputation systems. With a device identity protocol, each device can have its own blockchain public key and send encrypted challenge and response messages to other devices, thereby ensuring a device remains in control of its identity. In addition, a device with an identity can develop a reputation or history that is tracked by a blockchain.

[b], How the Using Smart Contracts to Improve Data Management for the invention Smart contracts are a great way to bridge multiple application data stores to produce a clean version of data without having to repeatedly aggregate and reconcile source systems. Smart contracts bring a few fundamental changes to the way we look at business information and processes.

To give you a proper definition—A smart contract is a digital agreement intended to facilitate, verify, or enforce the negotiation or performance of a contract. It allows multiple parties to do so by directly interacting with each other, without going through a third-party. A smart contract works similarly, except for two game-changing modifications—the rules defined by the contract are machine readable and executable and they are enforced using a distributed computer system without either party to the contract having enough control to override it alone.

III, How smart contracts and AI could work together Smart contracts have emerged as one of the most efficient and effective ways to streamline data management. By converging AI and smart contracts, there is great potential to improve AI and machine learning (ML) driven applications and to streamline data management functions. IT leaders can now remove 60% of typical data management headaches, overcoming a number of data challenges once and for all. AI and Distributed Ledger Technologies Converge Modern AI technology can perform complex tasks previously thought possible only for humans and in much less time. Distributed ledger technology (DLT) provides distributed consensus over a shared ledger in untrustworthy networks, which may contain, for example, unreachable or maliciously behaving nodes.

[a], Although the most well-known applications of DLT today are in the field of cryptocurrencies, other applications have emerged across multiple industries beyond finance, such as insurance and healthcare. There is a growing landscape of use cases where both AI and distributed ledger technology applications overlap. One of the main reasons AI and DLT work well together is because the two significantly improve data management. We've had great success converging DLT-underpinnings to exchange data and computing resources in order to enable AI applications in a manner that is much more efficient and effective than using traditional data management technologies.

Converging DLT with AI gives data providers the opportunity to share their data while keeping it confidential as needed and maintaining the right to manage data access, enabling businesses to safely and efficiently train algorithms on the data to derive insights. With DLT, infrastructure under the hood gives developers a way to build an app across multiple organizations. While you usually build an app running within your organization, the paradigm created for DLTs and blockchains was to span multiple organizations.

[b], Smart contacts are the programming layer of that underlying infrastructure. The Smart Contracts Approach in Practice To augment AI and automation capabilities, organizations can simply pair smart contracts-enabled technologies with AI and M L applications. The general idea is that smart contracts can be used to orchestrate processes and transactions closer to both business rules and core data, thus harmonizing the underlying information to create a golden source of truth.

Robots can more seamlessly connect to core data and orchestration workflows. AI and ML applications can leverage smart contracts and harmonized data to further extend analytics capabilities, we call this full-stack automation. The potential benefits of smart contract applications to create automated and intelligent digital capabilities are becoming clearer and more appealing to organizations.

From a business and process-driven approach, they allow organizations to leverage features such as non-repudiation and atomic transactions, process-driven development, seamless multi-party integration, and higher abstraction from technical constraints. Using smart contracts, companies can easily build contract-driven orchestration layers that are persistence layer agnostic (meaning they can run on either databases or blockchains).

This approach mitigates the data management problem, reduces the complexity of adoption, and accelerates the time-to-market for AI and analytics programs by bridging data silos without requiring constant reconciliation.

IV, the invention chooses to use DAM L smart contract DAM L Smart Contracts it's a functional language (inspired by Haskell) and designed for distributed business workflows. It aims to focus developer time on programming business processes, rather than needing to deal with the innards of blockchain and encryption. DAM L is an open-source smart contract language for building future-proof distributed applications. It enables organizations to run and execute smart contract applications across multiple parties in a safe and secure manner.

DAML is a functional language (inspired by Haskell) and designed for distributed the invention workflows.

[a], It aims to focus developer time on programming business processes, rather than needing to deal with the innards of blockchain and encryption. Dam is an open-source smart contract language used by developers to write and deploy full-stack, distributed applications for DLT, blockchain, or databases in days. It is purpose-built to support multiparty business workflows in any industry.

Dam build ecosystem for the invention full-stack smart contract based distributed applications. Its core smart contract language is a purpose-built functional language specialized in describing composable distributed business workflows.

DAML's unique selling point is simple—focus entirely on the application logic without worrying about the nitty-gritty of the underlying infrastructure, be that distributed ledger, blockchain, or database. DAM L is easy to write and read so a person who understands the business being defined can verify that the code is aligned with their intent.

[b], DAML is fast to build and deploy, you can go from zero to an end-to-end production application extremely quickly. It is a language of contracts, where agreements and parties are native constructs in the language. Developers will be accurately able to describe how contracts are formed and which parties are, directly and indirectly, involved in it.

Developers don't need to worry about low-level constructs and can completely focus on creating business logic. DAM L provides high levels of privacy and abstraction. The DAM L system will automatically track the parties which are allowed to see the details of each contract. This information will also be passed to the underlying ledger to ensure that only the data a particular party is authorized to see is actually sent to it.

Once a DAM L program is executed, it creates a well-structured and human-understandable audit trail that will help explain two things: why each action was performed and the role of each party in that smart contract. In DAML, the upgrades are defined in code and can be executed in a non-disruptive manner with zero downtime. You can easily add new roles and workflows to existing solutions without going through any complications.

V, Smart contracts defined Smart contracts are simply programs stored on a blockchain that run when predetermined conditions are met. They typically are used to automate the execution of an agreement so that all participants can be immediately certain of the outcome, without any intermediary's involvement or time loss.

[a], They can also automate a workflow, triggering the next action when conditions are met. How smart contracts work for the invention; Smart contracts work by following simple “if/when . . . then . . . ” statements that are written into code on a blockchain. A network of computers executes the actions when predetermined conditions have been met and verified. These actions could include Identity's each user them production their data's, registering new users, sending notifications, or issuing a maintenance schedule. The blockchain is then updated when the transaction is completed.

That means the transaction cannot be changed, and only parties who have been granted permission can see the results. Within a smart contract, there can be as many stipulations as needed to satisfy the participants that the task will be completed satisfactorily. To establish the terms, 3 participants must determine how transactions and their data are represented on the blockchain, agree on the “if/when . . . then . . . ” rules that govern those transactions, explore all possible exceptions, and define a framework for resolving disputes.

Then the smart contract can be programmed by a developer—although increasingly, organizations that use blockchain for business provide templates, web interfaces, and other online tools to simplify structuring smart contracts. Benefits of smart contracts for the invention; Speed, Efficiency and Accuracy. Once a condition is met, the contract is executed immediately. Because smart contracts are digital and automated.

Trust and transparency Because there's no third party involved, and because encrypted records of transactions are shared across participants, there's no need to question whether information has been altered for personal benefit.

[b], Security Blockchain transaction records are encrypted, which makes them very hard to hack. Moreover, because each record is connected to the previous and subsequent records on a distributed ledger, hackers would have to alter the entire chain to change a single record. IoT with blockchain can bring real trust to captured data.

The underlying idea is to give devices, at the time of their creation, an identity that can be validated and verified throughout their lifecycle with blockchain. There is great potential for IoT systems in blockchain technology capabilities that rely on device identity protocols and reputation systems. With a device identity protocol, each device can have its own blockchain public key and send encrypted challenge and response messages to other devices, thereby ensuring a device remains in control of its identity. In addition, a device with an identity can develop a reputation or history that is tracked by a blockchain.

How the Using Smart Contracts to Improve Data Management for the invention Smart contracts are a great way to bridge multiple application data stores to produce a clean version of data without having to repeatedly aggregate and reconcile source systems. Smart contracts bring a few fundamental changes to the way we look at business information and processes. To give you a proper definition—A smart contract is a digital agreement intended to facilitate, verify, or enforce the negotiation or performance of a contract.

It allows multiple parties to do so by directly interacting with each other, without going through a third-party. A smart contract works similarly, except for two 4 game-changing modifications—the rules defined by the contract are machine readable and executable and they are enforced using a distributed computer system without either party to the contract having enough control to override it alone.

VI, How smart contracts and AI IoT could work together for the invention Smart contracts have emerged as one of the most efficient and effective ways to streamline data management. By converging AI and smart contracts, there is great potential to improve AI and machine learning (ML) driven applications and to streamline data management functions.

IT leaders can now remove 60% of typical data management headaches, overcoming a number of data challenges once and for all. AI and Distributed Ledger Technologies Converge Modern AI technology can perform complex tasks previously thought possible only for humans and in much less time. Distributed ledger technology (DLT) provides distributed consensus over a shared ledger in untrustworthy networks, which may contain, for example, unreachable or maliciously behaving nodes.

[a], Although the most well-known applications of DLT today are in the field of cryptocurrencies, other applications have emerged across multiple industries beyond finance, such as insurance and healthcare. There is a growing landscape of use cases where both AI and distributed ledger technology applications overlap. One of the main reasons AI and DLT work well together is because the two significantly improve data management.

We've had great success converging DLT-underpinnings to exchange data and computing resources in order to enable AI applications in a manner that is much more efficient and effective than using traditional data management technologies. Converging DLT with AI gives data providers the opportunity to share their data while keeping it confidential as needed and maintaining the right to manage data access, enabling businesses to safely and efficiently train algorithms on the data to derive insights. With DLT, infrastructure under the hood gives developers away to build an app across multiple organizations. While you usually build an app running within your organization, the paradigm created for DLTs and blockchains was to span multiple organizations. Smart contacts are the programming layer of that underlying infrastructure.

[b], The Smart Contracts Approach in Practice To augment AI and automation capabilities, organizations can simply pair smart contracts-enabled technologies with AI and ML applications. The general idea is that smart contracts can be used to orchestrate processes and transactions closer to both business rules and core data, thus harmonizing the underlying information to create a golden source of truth.

Robots can more seamlessly connect to core data and orchestration workflows. AI and ML applications can leverage smart contracts and harmonized data to further extend analytics capabilities, we call this full-stack automation. The potential benefits of smart contract applications to create 5 automated and intelligent digital capabilities are becoming clearer and more appealing to organizations.

From a business and process-driven approach, they allow organizations to leverage features such as non-repudiation and atomic transactions, process-driven development, seamless multi-party integration, and higher abstraction from technical constraints. Using smart contracts, companies can easily build contract-driven orchestration layers that are persistence layer agnostic (meaning they can run on either databases or blockchains). This approach mitigates the data management problem, reduces the complexity of adoption, and accelerates the time-to-market for AI and analytics programs by bridging data silos without requiring constant reconciliation.

Blockchain can help clarify the provenance, transparency, understanding, and explanations of those outcomes and decisions. If decisions and associated data points are recorded via transactions on a blockchain, the inherent attributes of blockchain will make auditing them much simpler. Blockchain is a key technology that brings trust to transactions in a network: therefore, infusing blockchain into AI decision-making processes could be the element needed to achieve the transparency necessary to fully trust the decisions and outcomes derived from AI.

[c], With the advancement in IoT, industries are now enabled to capture data, gain insight from the data, and make decisions based on the data. Therefore, there is a lot of “trust” in the information obtained. But the real truth of the matter is, do we really know where these data came from and should we be making decisions and transacting based on data we cannot validate? IoT with blockchain can bring real trust to captured data.

The underlying idea is to give devices, at the time of their creation, an identity that can be validated and verified throughout them lifecycle with blockchain. There is great potential for IoT systems in blockchain technology capabilities that rely on device identity protocols and reputation systems.

With a device identity protocol, each device can have its own blockchain public key and send encrypted challenge and response messages to other devices, thereby ensuring a device remains in control of its identity. In addition, a device with an identity can develop a reputation or history that is tracked by a blockchain. For the invention the nexus of new technology Blockchain is at the nexus of technologies like IoT, AI and Cloud. It has the means of bringing the missing element of trust that is currently lacking from these technologies.

Trust is gained through diversity of users. Unlike a database that has a single administrator, a blockchain enables a set of diverse administrators to “referee” the data, such that no single admin can maliciously or accidentally change or delete data. And once the administrators reach consensus, the data is secured in blocks that are “chained” to one another cryptographically forming a tamper resistant ledger. When AI, IoT and Cloud use blockchain to track provenance, proofs and permissions associated with data used and emanating from these systems, the trust in the data is increased radically. This trust will allow IoT, AI and Cloud to be adopted without fear of compromise, ushering in a new era of application and adoption of these technologies to change everyday life for the better. In data we trust . . . well, after you add a little blockchain. VII, the invention chooses Private blockchains In most blockchains or distributed ledger technologies (DLT), the data is structured into blocks and each block contains a user dates transaction or bundle that user data of transactions.

Each new block connects to all the blocks before it in a cryptographic chain in such away that it's nearly impossible to tamper with. All transactions within the blocks are validated and agreed upon by a consensus mechanism, ensuring that each transaction is true and correct. Private blockchains use identity to confirm the invention each user of membership and access privileges and typically only permit known organizations to join. Together, the organizations form a private, members-only “business network.” A private blockchain in a permissioned network achieves consensus through a process called “Selective endorsement,” where known the invention users verify the transactions. Only enterprise members with special access and permissions can maintain the transaction ledger. This network type requires more identity and access controls. When building the invention enterprise blockchain application, it's important to consider security at all layers of the technology stack, and how to manage governance and permissions for the network.

A comprehensive security strategy for the invention enterprise blockchain solution includes using traditional security controls and technology-unique controls.

Some of the security controls specific to the invention enterprise blockchain solutions include:

[1], Identity and access management

[2], Key management Data privacy

[3], Secure communication

[4], Smart contract security

[5], Transaction endorsement Employ experts to help you design a compliant and secure solution and help the invention achieve business goals. Look for the invention production-grade platform for building blockchain solutions that can be deployed in the technology environment of the invention choosing, whether that is on-premises and preferred cloud vendor. Using blockchain to store and distribute AI models provides an audit trail, and pairing blockchain and AI can enhance data security.

AI can rapidly and comprehensively read, understand and correlate data at incredible speed, bringing a new level of intelligence to blockchain-based business networks. VIII, the invention chooses to use smart contracts Benefits of smart contracts Speed, efficiency and accuracy for the invention. Once a condition is met, the contract is executed immediately. Because smart contracts are digital and automated, there's no paperwork to process and no time spent reconciling errors that often result from manually filling in documents.

Trust and transparency Because there's no third party involved, and because encrypted records of transactions are shared across participants, there's no need to question whether information has been altered for personal benefit. Security Blockchain transaction records are encrypted, which makes them very hard to hack.

Moreover, because each record is connected to the previous and subsequent records on a distributed ledger, hackers would have to alter the entire chain to change a single record.

[a], Savings Smart contracts remove the need for intermediaries to handle transactions and, by extension, their associated time delays and fees Using smart contracts, applications we've been developing since the dawn of the digital age inside traditional centralized architectures can now be redesigned using a process-driven approach and deployed on a shared, distributed, or decentralized environment, which connects all participants and automates digital processes. How smart contracts and AI could work together Smart contracts have emerged as one of the most efficient and effective ways to streamline data management. By converging AI and smart contracts, there is great potential to improve AI and machine learning (ML) driven applications and to streamline data management functions. Smart contracts are one of the reasons blockchain technology could be so powerful—but as yet, they've only reached a fraction of their potential.

The invention to reach mainstream adoption and transform users' data's transaction faster, secure, scalable, and more affordable. Smart contracts have emerged as one of the most efficient and effective ways to streamline data management for the invention. By converging AI and smart contracts, there is great potential to improve AI and machine learning (ML) driven applications and to streamline data management functions. Using Smart Contracts to Improve Data Management, Smart contracts is a great way to bridge the invention multiple application data stores to produce a clean? version of data without having to repeatedly aggregate and reconcile source systems. Smart contracts bring a few fundamental changes to the way we look at the invention user's information and processes.

Moreover, a smart contract-based application landscape enjoys a single version of the truth in the form of the smart contracts store. This source of data does not need to be reconciled or aggregated retroactively. It is automatically created as the invention business processes execute over time. Data no longer just works as a static record driven by applications. It can itself trigger events and drive processes forward when it is changed. In this way, old complexities associated with aggregation and reconciliation of data are no longer a concern. It's essentially enabling companies to bring algorithms into data, as opposed to bringing data into algorithms.

[b], The focus then shifts to distributing data to those who need it. The Smart Contracts Approach in Practice: To augment AI and automation capabilities, organizations can simply pair smart contracts-enabled technologies with AI and ML applications. The general idea is that smart contracts can be used to orchestrate processes and transactions closer to the invention both business rules and core data, thus harmonizing the underlying information to create a golden source of truth.

Robots can more seamlessly connect to core data and orchestration workflows. AI and ML applications can leverage smart contracts and harmonized data to further extend analytics capabilities, we call this full-stack automation. The potential benefits of smart contract applications to create automated and intelligent digital capabilities are becoming clearer and more appealing to organizations. From a business and process-driven approach, they allow the invention to leverage features such as non-repudiation and atomic transactions, process-driven development, seamless multi-party integration, and higher abstraction from technical constraints. Using smart contracts, the invention can easily build contract-driven orchestration layers that are persistence layer agnostic (meaning they can run on either databases or blockchains).

This approach mitigates the data management problem, reduces the complexity of adoption, and accelerates the time-to-market for AI and analytics programs by bridging data silos without requiring constant reconciliation. Smart Contracts for the invention Multi-party Business Processes; DAML is an open-source smart contract language for building future-proof distributed applications. It enables organizations to run and execute smart contract applications across multiple parties in a safe and secure manner.

The basic configuration of Edge computing powers for Blockchain

Smart contract, AI algorithm/Models;

I, For the invention basic model of operation. The basic model it's four chips Edge computing of the invention, the configuration power set up as chips of Edge computing—A, it's separating Mainly Focused configuration for Two categories for users' data. The chips of Edge computing—B, it's separating Mainly Focused configuration for Robot system programs. The chips of Edge computing—C, it's separating Mainly Focused configuration for IoT system programs. The chips of Edge computing—D, it's separating Mainly Focused configuration for Family Data Center system programs.

The invention Standard model chips Edge computing it's Multi-chips be able add up, when an certain demand arises, there have a new configuration power should add to.

For example. when the IoT system programs need work for Wears electronic devices then the chips of edge computing may update to Five or Six, Seven, Eight, Nine . . . . As so on. Also, the chips of Edge computing—E or F, it's separating Mainly Focused configuration for Wears electronic devices system programs.

If there have another certain demand arises, there have another new configuration powers should add to. For example. when the IoT system programs need work for Mobiles electronic devices then the chips of edge computing may update to Seven or Eight. The chips of Edge computing—G or H, it's separating Mainly Focused configuration for Mobiles electronic devices system programs. e.g., also. Anyways, therefore, there it's NO Limit. Important; for the invention IC design should focus the Vital things of Each chip edge computing it must have a dedicated transmission LINE.

II, the basic configuration of Edge computing powers for the invention running Blockchain, Smart

contract, AI algorithm/Models For the invention basic model of operation. The basic model it's four Ships Edge computing of the invention, the configuration power set up as Ships of Edge computing—A, it's separating Mainly Focused configuration for Two categories for users' data. The Ships of Edge computing—B, it's separating Mainly Focused configuration for Robot system programs.

The Ships of Edge computing—C, it's separating Mainly Focused configuration for IoT system programs. The Ships of Edge computing—D, it's separating Mainly Focused configuration for Family Data Center system programs. The invention Standard model Ships Edge computing it's Multi-ships be able add up, when an certain demand arises, there have a new configuration power should add to. For example, when the IoT system programs need work for Wears electronic devices then the ships of edge computing may update to Five or Six. The Ships of Edge computing—E or F, it's separating Mainly Focused configuration for Wears electronic devices system programs. If there have another certain demand arises, there have another new configuration powers should add to. For example, when the IoT system programs need work for Mobiles electronic devices then the ships of edge computing may update to Seven or Eight; The Ships of Edge computing—G or H, it's separating Mainly Focused configuration for Mobiles electronic devices system programs.

Anyways, therefore, there it's NO Limit. Important; for the invention IC design should focus the Vital things of Each Ship of edge computing it must have a dedicated transmission LINE.

III, The AI Robots of Edge algorithms & Blockchain with smart contract;

[1], Private blockchain it be able has two keys of public and private keys. public keys A key aspect of privacy in blockchains is the use of private and public keys. Blockchain systems use asymmetric cryptography to secure transactions between users. In these systems, each user (data's) has a public and private key.

These keys are random strings of numbers and are cryptographically related. It is mathematically impossible for a user to guess another user's private key from their public key. This provides an increase in security and protects users from hackers. Public keys can be shared with other users in the network because they give away no personal data. Each user has an address that is derived from the public key using a hash function. These addresses are used to send and receive assets on the blockchain, such as cryptocurrency. Because blockchain networks are shared to all participants, users can view past transactions and activity that has occurred on the blockchain.

Senders and receivers of past transactions are represented and signified by their addresses. users' identities are not revealed. Public addresses do not reveal personal information or identification: rather, they act as pseudonymous identities. It is suggested [by whom?] that users do not use a public address more than once; this tactic avoids the possibility of a malicious user tracing a particular address' past transactions in an attempt to reveal information. Private keys are used to protect user(data's) identity and security through digital signatures. Private keys are used to access funds and personal wallets on the blockchain; they add a layer of identity authentication.

[2], Smart Contracts For the invention Multi-parts Business Processes; DAML is an open source smart contract language for building future-proof distributed applications. It enables organizations to run and execute smart contract applications across multiple parties in a safe and secure manner. Using smart contracts, the invention can easily build contract-driven orchestration layers that are persistence layer agnostic (meaning they can run on either databases or blockchains). This approach mitigates the data management problem, reduces the complexity of adoption, and accelerates the time-to-market for AI and analytics programs by bridging data silos without requiring constant reconciliation.

[3], For the invention of Robots AI algorithms has two First of Naïve Bayes Based on the Bayes theorem, this is one of the most efficient machine learning algorithms ever known to mankind and is highly used by the healthcare industry for medical data clarification and disease prediction. When it comes to data mining, classification can be termed as data analysis, which is often used to extract models describing data classes. Since the probability distribution is high, Bayes classifier can achieve an optimal result. Second of Logistic Regression This machine-learning algorithm is used to predict the current scenario of the categorical dependent variable through the use of predictor variables.

It is often used for classifying and predicting the probability of an event, such as disease risk management, which assists doctors in making critical medical decisions. It also helps medical institutions target patients with more risk and curate behavioral health plans to improve their daily health habits. Logistic Regression Logistic regression is another popular AI algorithm, able to provide binary results. This means that the model can both predict the outcome and specify one of the two classes of the y value. The function is also based on changing the weights of the algorithms, but it differs due to the fact that the non-linear logic function is used to transform the outcome. This function can be represented as an S-shaped line separating the true values from false ones. Above two AI algorithms division of labors assists in joint calculation data's analysis then issue right instruction to ensure Robots work properly.

IV, Feature—first service supports of basic configuration of computer powers When a certain arises the system will be adjusted according to the software's guidelines prioritize feature requirement in the shortest possible time, for example, use the basic model it's four Chips Edge computing of the invention, when from the sensors comeback to the data's showing that the intelligent toilet demand had been generated at this moment, as Chips of Edge computing—A, it's should focus own jobs and another thing Emphasize division of labors with collaboration. When this moment it's has two main parts jobs.

[a], Basic classification algorithms.

[b], AI audio frequency algorithms The Chips of Edge computing—B it's specifically running the Naïve Bayes algorithms. Focus Robots run the track, with be sure the robots following chip of edge computing issue instruction each activity precise and properly, here emphasize SAFELY. The chips of Edge computing—C it's at temporary put down own mainly focused jobs, to division of labors with collaboration, work for the intelligent toilet demands.

In this moment it focusses algorithms of toilet own surroundings. For example, Algorithms for temperature sensors sates, included waters with airs, as Algorithms for pressure sensors sates, included waters with airs, dried, as so on It's specifically focus all circumstance of surrounding with precises issue Instructions if have any requirement. The Chips of Edge computing—D it's at temporary put down own mainly focused jobs, to division of labors with collaboration, work for the intelligent toilet demands. In this moment it focusses algorithms of Robots do Injecting the waters into user anus. The chip edge—D must be sensitives to control how many the waters of injecting into the user anus.

V. The invention of edge computing power there is NO fixed mode; it can be multi-chips, it's depending on the marketing & user demands. The chips increase according to functions requirement variations, so, the invention can be Singulars; 5 chips, 7, 9, 11, 13 . . . . As so on. Or even numbers; 6 chips, 8, 10, 12 . . . . As so on. There is no limited of edge computing powers, this is the invention own Characteristics. Beyond, for those expansion It can build up several expansion slots to meet up requirement. Anyway, when the intelligent toilet using request happen the moment any number edge computing power of chips it must be 75% use for “Feature—first service supports of basic configuration of computer powers”. The division of labors synergy almost same of previously write.

On the other hand, when the toilet suing demand vanished, all edge computing power must back up to make good focus to their specifically works.

VI, For the invention of the software designs, Not recommended design by technology team of management enterprise. Should to Outsourcing to a professional company, the invention own excellent software's it's successfully based on. Its decisive role also. there have few things should notes, when the make IC designs the edge computing each of chip must be builds Dedicated channels line, that means those designs for individual chip of specifically, data transmissions in without. That CRUCIAL.

VII, the invention chooses to use SSHD or SSD to memory all data. Advantages of the SSHD SSD represents a solid-state hybrid drive. SSHD is the mixture of both SSD and HDD. it's a traditional spinning hard disk that has a small amount of fast solid-state storage built-in. Advantages SSHD driver has the characteristics of high speed and large space, so it is more reliable to use. It has less rotation and less part movement. User can easily access those files and data's that user often uses. SSHD has a longer life span. SSHD is cheap so can easily control it within budget. SSHD for working method SSHD uses a small amount of high-performance NAND flash to work. With this flash, it can store the most commonly used data, for example: the store installed the invention specifically designed running OS software's (Please view the invention software design section). The invention has multi-SSHD or SSD memories of running those functions. For example: the General SSHD call memory—A, it is mainly focused work for the Intelligent Toilet. Then the SSHD or SSD memory—B, it is mainly focuses work for the Family data's center (A software design requirement). The SSHD memory—C, it is mainly focused work for the Iota OS (Software design request) The SSHD memory—D, it is mainly focused work for the Local data's base, the temporary data's storages and transmissions (Software design should notice this section—when the data's complete done the transmission jobs then all daytime data should all dilates). The SSD or SSHD memory—E, it is mainly focused work for the Remove data's base, also temporary data's storages with transmissions (Software design should notice this section—when the data's complete done the transmission jobs then all daytime data should all dilates). When the invention happens, a new OS admired then, as so on. IC design requirements for the invention of IC design should notice, SSD or SSHD IC need build up parallel link circuits, each SSD or SSHD need respective of dedicated data's transmission Access with output lines Independently. On the other hand, need considers add the additional two Expansion slots, for the future may have new OS should be.

VIII, the IoT Blockchain, Smart Contract with AI Algorithms

[1], private blockchains the invention IoT adoption Private blockchain for it underlying. When the enterprise build up that should consider of below several things: Blockchain security tips and best practices When designing a blockchain solution, consider these key questions:

[a], What is the governance model for participating organizations or members?

[b], What data will be captured in each block?

[c], What are the relevant regulatory requirements, and how can they be met?

[d], How are the details of identity managed? Are block payloads encrypted?

[e], How are the keys managed and revoked?

[f], What is the disaster recovery plan for the blockchain participants?

[g], What is the minimal security posture for blockchain clients for participation?

[h], What is the logic for resolving blockchain block collisions?

When establishing a private blockchain, ensure that it's deployed in a secure, resilient infrastructure. Poor underlying technology choices for business needs and processes can lead to data security risks through their vulnerabilities.

Consider business and governance risks. Business risks include financial implications, reputational factors and compliance risks. Governance risks emanate primarily from blockchain solutions' decentralized nature, and they require strong controls on decision criteria, governing policies, identity and access management. Blockchain security is about understanding blockchain network risks and managing them. The plan to implement security to these controls makes up a blockchain security model. Create a blockchain security model to ensure that all measures are in place to adequately secure your blockchain solutions. To implement a blockchain solution security model, administrators must develop a risk model that can address all business, governance, technology and process risks.

Next, they must evaluate the threats to the blockchain solution and create a threat model. Then, administrators must define the security controls that mitigate the risks and threats based on the following three categories: Enforce security controls that are unique to blockchain Apply conventional security controls Enforce business controls for blockchain.

[2], Smart Contracts For the invention Multi-parts Business Processes. DAML is an open-source smart contract language for building future-proof distributed applications. It enables organizations to run and execute smart contract applications across multiple parties in a safe and secure manner. Using smart contracts, the invention can easily build contract-driven orchestration layers that are persistence layer agnostic (meaning they can run on either databases or blockchains). This approach mitigates the data management problem, reduces the complexity of adoption, and accelerates the time-to-market for AI and analytics programs by bridging data silos without requiring constant reconciliation.

[3], For the invention of IoT AI algorithms had two;

[a], Decision Trees This is one of the oldest, most used, simplest and most efficient M L models around. It is a classic binary tree with Yes or No decision at each split until the model reaches the result node. This model is simple to learn, it doesn't require data normalization and can help to solve multiple types of problems. The decisions generally depend on if and else conditional statements. The deeper the tree, the more complex the rules and the better the model. It is the most demandable method in supervised learning and has a wide range of applications. It has a flowchart like structure that is constructed through algorithmic approaches to identify in which ways splitting will be done based on different conditions? If we talk about the structure of the flowchart, it contains a root node from where a model building is initiated, the internal node to represent a test on any feature, branches to show the outcome of the test, and the leaf node to give a group of the same values which is created after taking decisions on all related attributes. [b] Decision trees are hugely used in regression and classification-based problems. They built automated predictive models that have many applications in machine learning, data science, data mining, and statistics. Tree-based models enable predictive models while delivering high accuracy, more stability, and extremely interpretable that's why it is easy to understand. They map the non-linear relationship quite well, unlike linear models. A decision tree is undoubtedly very fast as compared to other techniques, the only thing that limits it is the condition of overfitting that arises when the trees grow and become complex or dense, in order to overcome the problem of overfitting, we should use the random forest, i.e. nothing but the group of decision trees that performs decision making on a sub-part of the dataset, therefore, it reduces the chance of overfitting, and it still remains fast.

How does a decision tree work? In machine learning terms, under the supervised learning algorithm, decision trees are mostly applied on classification or regression-based problems, it works for both continuous and categorical variables, in this method, we divide the entire population or sample(dataset) into a various number of subpopulations sets on the basis of different attributes. Decision trees use various algorithms to recognize the most significant variables, the split, and the best possible value as a result that produces a further subpopulation set. Similarities and Differences between the Regression and Classification tree 23 Let's discuss the primary differences and similarities in the regression tree and the classification tree. Regression trees are used when the target variable is a continuous variable and the value received in the training dataset to the end of a terminal node is the mean response of all the observation lying under that section. Also, if any other known observation comes in that section, it is then replaced by a mean value, and prediction is done.

[c], In contrast to this, Classification trees work are required when the target variable is categorical variable and the value received in the training dataset to the end of a terminal node is the mode of all the observation lying under that section. Also, if any other known observation comes in that section, it is then replaced by a mode value, and prediction is done. If we discuss similarities; Both the trees split up independent variables into definite and non-overlapping regions and use a recursive binary approach, i.e., splitting initiates from the top of the tree while all the observations lying in one single region and divide the independent variable into two new branches. The splitting process is continued and results in a fully developed tree when the stopping criteria get fulfilled, defined by a user.

[d], Random Decision Forests or Bagging Random decision forests are formed of decision trees, where multiple samples of data are processed by decision trees and the results are aggregated (like collecting many samples in a bag) to find the more accurate output value. Random Forest Instead of finding one optimal route, multiple suboptimal routes are defined, thus making the overall result more precise. If decision trees solve the problem, you are after, random forests are a tweak in the approach that provides an even better result.

[4], The IoT Connectivity Standards Alliance the IoT has Multi-intelligent devices connections on near the future. For example, Refrigerate, AC, all house Lamps, Microware, Oven, Washer, Dryer, TV, Mobile devices, Wear devices, health devices, and any intelligent advice, as so on. Above those devices connectivity needs an standards alliance to ensure themes be able communication each other's. Matter is built around a shared belief that smart home devices should be secure, reliable, and seamless to use. By building upon Internet Protocol (IP), Matter will enable communication across smart home devices, mobile app and cloud services, and to define a specific set of IP-based networking technologies for device certification. Matter is the foundation for connected things. This industry-unifying standard is a promise of reliable, secure connectivity—a seal of approval that devices will work seamlessly together, today and tomorrow. Matter is creating more connections between more objects, simplifying development for manufacturers and increasing compatibility for consumers.

This collaborative breakthrough is built on proven technologies and guided by the Connectivity Standards Alliance (formerly Zigbee Alliance), whose members come together from across industries to transform the future of connectivity. Companies from across the industry are contributing market-proven technologies and best practices. Matter is built around a shared belief that smart home devices should be secure, reliable, and seamless to use. By building upon Internet Protocol (IP), Matter will enable communication across smart home devices, mobile app and cloud services, and to define a specific set of IP-based networking technologies for device certification. IP-Based Matter makes it easier for device manufacturers to build devices that are compatible with smart home and voice services such as Amazon's Alexa, Apple's Siri, Google's Assistant, and others. The first specification release of the Matter protocol will run on Wi-Fi and Thread network layers and will use Bluetooth Low Energy for commissioning. Matter is a unifying, IP-based connectivity protocol built on proven technologies, helping you connect to and build reliable, secure IoT ecosystems, and keeping your focus on developing innovative products and accelerating paths to market.

IX, The Root of the Decision Tree with “Matter” Matter is the foundation for connected things. So, should put it's on the Root of the Tree of the algorithms of “Decision Trees”, There will have some intelligent devices its parameters feature of the tree (internal node), on which decision is taken (to produce branches of the tree—call each line). First splitting is done on the set parameter, now for further splitting, other sets of parameters are required, does those intelligent devices do exercise in the moments or not, and so on, and at last, we got the results (leaves of the tree-everything which is not roots or branches).

[a], Leaves are basically the decisions and don't split, a tree has decided whether a intelligent device is fit or not. Example of the Decision Tree The decision tree has its own representation and solves the problem, as mentioned above it contains roots, branches, internal nodes, and leaves. Following are the steps to make tree representation. Optimize the best attribute and put it at the root of the tree. Divide the dataset into subsets, using the previous attribute make sure subsets must have the same values for an attribute.

Repeat the process step 1 and step 2, until do to find the leaf nodes for all branches of the tree. The classification is basically a two-stepped process, first is the learning step in which an arbitrary model is built on a given set of training data and the second one is the prediction step in which the model is implemented to predict the response for a given data set. Sometimes, situations come in which a decision was made on continuous data, or when the target variable will be a real number, like, to an intelligent device it's made those data's on the basis of the it's work condition, related with, how often that device by the owner use for. etc.

Here, the target variable is either a real value or a part of the dataset is continuous data used for predicting the target variable.

[b], And hence, the criteria of regression as a decision tree comes. The regression tree takes into account the observation about the various features of an object and trains the model to predict data in order to give meaningful continuous output. Decision trees needs more attention on data preprocessing as there are many attributes in a dataset that the invention may not even need and in an algorithm like decision tree, every attribute contributes in decision making of the algorithm to produce results, therefore it is highly important to clean and prepare data in such a way that there exists no way by which the invention would get unwanted result. Similarities and Differences between the Regression and Classification tree the primary differences and similarities in the regression tree and the classification tree.

[c], Regression trees are used when the target variable is a continuous variable and the value received in the training dataset to the end of a terminal node is the mean response of all the observation lying under that section. Also, if any other known observation comes in that section, it is then replaced by a mean value, and prediction is done. In contrast to this, Classification trees work are required when the target variable is a categorical variable and the value received in the training dataset to the end of a terminal node is the mode of all the observation lying under that section. Also, if any other known observation comes in that section, it is then replaced by a mode value, and prediction is done. If them has similarities; Both the trees split up independent variables into definite and non-overlapping regions and use a recursive binary approach, i.e., splitting initiates from the top of the tree while all the observations lying in one single region and divide the independent variable into two new branches.

The splitting process is continued and results in a fully developed tree when the stopping criteria get fulfilled, defined by a user. Decision trees have some advantages and disadvantages Implementing decision trees in machine learning has several advantages; here above it can work with both categorical and continuous data and can generate multiple outputs.

[d], Decision trees are easiest to interact and understand, even anyone from a non-technical background can easily predict his hypothesis using decision tree pictorial representation. The model can interpret accurate results and trees' reliability can be trusted and quantified. Decision trees require less time for data preparation as it doesn't require dummy variables, data normalization, replacement of missing values, etc. Also, it takes very less time for data exploration, to find the most important variables and its relationship with other variables, to create new features that strengthen the target variable. Decision trees are very helpful in data cleaning, it takes much less time in the data cleaning process in comparison to other modeling techniques as it doesn't get affected by outliers and missing values up to a certain mark. Decision trees are often considered as a non-parametric method, they have no opinions about space arrangement and designing of classifiers. Even though non-linear relationships between various features are not able to influence the performance and efficiency of trees. disadvantages in decision trees. While dealing with categorical data having multiple observations, the information gain gets biased in approval of the attributes with the most observations.

As datasets have values with many levels, these are interconnected so calculations become more complex. Decision trees often struck with the problems of overfitting, there might be situations when over-complex trees can't generalize the data well.

[e], By constraining the number of parameters at the leaf node or setting the maximum depth of the tree, this problem can be minimized. Very small changes in data might result in generating a completely different tree, this is termed as variance, so decision trees are treated as unstable. The concept of bagging, boosting, etc. are introduced for the same in comparison with other modeling techniques, it produces low prediction accuracy for any data. Therefore, the invention needs another AI algorithms of Random Decision Forests or Bagging Random decision forests are formed of decision trees. To ensure the AI Algorithms in the futures work properly for IoT systems added that must be.

X, the Local Database AI Algorithms & Blockchain with Smart Contract

[1], Private blockchain. Blockchain technology produces a structure of data with inherent security qualities. It's based on principles of cryptography, decentralization and consensus, which ensure trust in transactions. In most blockchains or distributed ledger technologies (DLT), the data is structured into blocks and each block contains a transaction or bundle of transactions.

Each new block connects to all the blocks before it in a cryptographic chain in such away that it's nearly impossible to tamper with. All transactions within the blocks are validated and agreed upon by a consensus mechanism, ensuring that each transaction is true and correct.

Blockchain technology enables decentralization through the participation of members across a distributed network. There is no single point of failure and a single user cannot change the record of transactions. However, blockchain technologies differ in some critical security aspects.

[2], Smart Contracts For the invention Multi-parts Business Processes; DAML is an open source smart contract language for building future-proof distributed applications. It enables organizations to run and execute smart contract applications across multiple parties in a safe and secure manner. Using smart contracts, the invention can easily build contract-driven orchestration layers that are persistence layer agnostic (meaning they can run on either databases or blockchains). This approach mitigates the data management problem, reduces the complexity of adoption, and accelerates the time-to-market for AI and analytics programs by bridging data silos without requiring constant reconciliation.

[3], the invention chooses adoption Artificial Neural Networks, Deep Learning Algorithms, with Clustering Algorithms for the Local database. It is a group of deep learning algorithms inspired by the neuron organization in animal brains that can receive signals from a previous layer and send it to the next layer.

A network that can learn by analyzing examples or without any human intervention. From pathologists using it for diagnosis to biochemical analysis, an artificial neural network has a bunch of other uses as well. It is further divided into two parts—convolutional neural network (CNN) and a recurrent neural network (RNN). neural networks are neural networks that are mostly used in the invention users image classification, users walk closed to the intelligent toilet detection, users face recognition, robotics, neural style transfer, video recognition, recommendation systems, etc. CNN classification takes any users input image and finds a pattern in the image, processes it, and classifies it in various categories which are like the invention its users' genders, Men, Women, Elders, Child, etc. CNN is also used in unsupervised learning for clustering images by similarity. It is a very interesting and complex algorithm, which is driving the future of technology.

The convolutional layer's main objective is to extract features from the invention users' images and learn all the features of the image which would help in object detection techniques. the input layer will contain some pixel values with some weight and height, our kernels or filters will convolve around the input layer and give results which will retrieve all the features with fewer dimensions.

AI need to do padding in order to make AI kernels fit the input matrices. Sometimes AI do zero paddings, i.e., adding one row or column to each side of zero matrices or AI can cut out the part, which is not fitting in the input image, also known as valid padding. Matrix formation using the parameters reduction method such as max pooling and average pooling to enhance the computational power of the CNN model. Matrix formation using Max-pooling and average pooling Max pooling or average pooling reduces the parameters to increase the computation of our convolutional architecture. Here, 2*2 filters and 2 strides are taken (which usually use). By name, AI can easily assume that max-pooling extracts the maximum value from the filter and average pooling takes out the average from the filter.

[4], AI perform pooling to reduce dimensionality. also have to add padding only if necessary. The more convolutional layer can be added to our model until conditions are satisfied. CNN An activation function is added to AI network anywhere in between two convolutional layers or at the end of the network. So, people must be wondering what exactly an activation function does, here a clear it in simple words. It helps in making the decision about which information should fire forward and which not by making decisions at the end of any network. In broadly, there are both linear as well as non-linear activation functions, both performing linear and non-linear transformations but non-linear activation functions are a lot helpful and therefore widely used in neural networks as well as deep learning networks.

Deep learning algorithms heavily rely on the nervous system of a human and are generally designed on the neural networks that use plentiful computational resources. All these algorithms use different types of neural networks to perform particular tasks. They train computers by learning from examples and industries users' usage habits, during each says use times, any special usage habits, how many time use each day then use deep learning algorithms. Since, the deep learning algorithms signify self-learning representations, they basically ANNs that reflect the way a human brain functions and computes information. While the training process starts, algorithms intakes unknown components as the input data for extracting out features, group objects, and find out useful and hidden data patterns.

These algorithms make use of several algorithms where no one single network is considered perfect and some algorithms are perfect fitted to perform specific tasks. However, in order to choose the correct ones, one should have a strong understanding of all primary algorithms Some popular deep learning algorithms are Convolutional Neural Network (CNN), Recurrent Neural Networks (RNN), Long Short-Term Memory Networks (LSTM), etc. Clustering Algorithms Being an unsupervised learning problem, clustering approach is used as a data analysis technique for identifying informative data patterns, such as groups of the users based on their behavior or locations.

[5], Clustering describes a class of user's usage habits issues or specials usage habits and a class of methods, focus on Clustering Methods and Applications. Clustering Algorithms refer to the group task of clustering, i.e., grouping an assemblage of objects in such away that each object is more identical to each other under the same group (Users usage habits cluster) in comparison to those in separate groups. There are various kinds of clustering algorithms that use similarity or distance measures amid examples in the feature space to find out dense regions of observations. Therefore, it is a good attempt to scale data previously for using clustering algorithms. However, each clustering algorithm is different, some of them are connectivity-based algorithms, dimensionality reduction, neural networks, probabilistic, etc.

[6], The Remove database AI algorithms & Blockchain with smart contract [a], Private blockchain. Blockchain technology produces a structure of data with inherent security qualities. It's based on principles of cryptography, decentralization and consensus, which ensure trust in transactions. In most blockchains or distributed ledger technologies (DLT), the data is structured into blocks and each block contains a transaction or bundle of transactions. Each new block connects to all the blocks before it in a cryptographic chain in such a way that it's nearly impossible to tamper with.

All transactions within the blocks are validated and agreed upon by a consensus mechanism, ensuring that each transaction is true and correct. Blockchain technology enables decentralization through the participation of members across a distributed network. There is no single point of failure, and a single user cannot change the record of transactions. However, blockchain technologies differ in some critical security aspects. [b], Smart Contracts For the invention Multi-parts Business Processes; DAML is an open source smart contract language for building future-proof distributed applications. It enables organizations to run and execute smart contract applications across multiple parties in a safe and secure manner. Using smart contracts, the invention can easily build contract-driven orchestration layers that are persistence layer agnostic (meaning they can run on either databases or blockchains). This approach mitigates the data management problem, reduces the complexity of adoption, and accelerates the time-to-market for AI and analytics programs by bridging data silos without requiring constant reconciliation.

[7], the invention chooses adoptions Multi-algorithms, that because the remote database it has some variety of task requirement.

[I], Artificial Neural Networks It is a group of deep learning algorithms inspired by the neuron organization in animal brains that can receive signals from a previous the invention user usage habits data's layer and send it to the next AI algorithms layer. A network that can learn by analyzing examples or without any human intervention. using it for users' usage habits with some special usage habits diagnosis to analysis, an artificial neural network has a bunch of other uses as well. It is further divided into two parts—convolutional neural network (CNN) and a recurrent neural network (RNN). that two all are important especially those users have special usage habits. The AI need deeps focus and learns.

[II], Logistic Regression This machine-learning algorithm is used to predict the current scenario of the categorical dependent variable through the use of predictor variables. It is often used for classifying and predicting the probability of an event, such as ordinary usage habits, special usage habits, the users as Women, or Men, Elders, Childs, etc . . . . , for those people how will requirement their own some usage habits with use that do to training AI.

[III], Discriminant Analysis Discriminant Analysis is a machine learning algorithm that is used to analyze the adequacy of object classification, and also for assigning one object to single or many groups.

From users the Gender, Men, Women, Elders, Child. Ordinary usage habits, special usage habits. As so on.

[a], Gender classification, Women, or Men.

[b], Agi classification, Elders, or ordinary Women Men, Child.

[c], Elders of Women Men.

[d], Ordinary Women, or Men.

[e], Male or Female of Child.

[f], Usage habits classification, the Elders of Women and Men, Ordinary Women and Men, Male and Female of Child.

[g], Ordinary usage habits with special usage habit.

[h], The special usage habits should classification.

Quantitative.

[1], Weakness

[2], Neutrality

[3], Strength

[4], Extraordinary

Above those classifications with adequacy's it's helpful for Artificial Neural Networks It is a group of deep learning algorithms, do to takes all users the usage habits then, it be able to provide the greatly excellent services for all users.

[5], Naïve Bayes Based on the Bayes theorem, this is one of the most efficient machine learning algorithms ever known to mankind and is highly used by the healthcare industry for medical data clarification and disease prediction.

When it comes to data mining, classification can be termed as data analysis, which is often used to extract models describing data classes. Since the probability distribution is high, Bayes classifier can work for the invention user's usage habits achieve an optimal result. Please notices: Local with Remove databases get any optimal result which can be analyzed to extract valuable insights using AI. do to training the AI Edge Computing then be able to provide greatly excellent services for each user

[6], The automatic AI speech system algorithms & Blockchain with smart contract

[a], Private blockchain. Blockchain technology produces a structure of data with inherent security qualities. It's based on principles of cryptography, decentralization and consensus, which ensure trust in transactions. In most blockchains or distributed ledger technologies (DLT), the data is structured into blocks and each block contains a transaction or bundle of transactions. Each new block connects to all the blocks before it in a cryptographic chain in such away that it's nearly impossible to tamper with. All transactions within the blocks are validated and agreed upon by a consensus mechanism, ensuring that each transaction is true and correct. Blockchain technology enables decentralization through the participation of members across a distributed network. There is no single point of failure and a single user cannot change the record of transactions. However, blockchain technologies differ in some critical security aspects.

[b], Smart Contracts For the invention Multi-parts Business Processes, DAML is an open-source smart contract language for building future-proof distributed applications. It enables organizations to run and execute smart contract applications across multiple parties in a safe and secure manner. Using smart contracts, the invention can easily build contract-driven orchestration layers that are persistence layer agnostic (meaning they can run on either databases or blockchains). This approach mitigates the data management problem, reduces the complexity of adoption, and accelerates the time-to-market for AI and analytics programs by bridging data silos without requiring constant reconciliation.

[c], The AI speech system adoptions Multi-algorithms.

[I], Logistic Regression. This machine-learning algorithm is used to predict the current scenario of the categorical dependent variable through the use of predictor variables. It is often used for classifying and predicting the probability of a speech's event, such as the invention users for thermostatic of water. Air, water pressures of injecting risk management, which assists AI systems in making critical decisions. It also helps the invention AI systems of IoT institutions target users with more or special requirements users make some health plans to improve them daily health habits.

[II], Deep Neural Networks DNNs are among the most widely used AI and ML algorithms. There are significant improvements in deep learning-based the invention users them text and speech apps, deep neural networks for machine perception and OCR, as well as using deep learning to empower reinforced learning difference of user's speech and controls robotic movement, along with other IoT systems miscellaneous applications of DNNs.

[III], Naive Bayes Naive Bayes algorithm is a simple, yet very strong model for solving a wide variety of complex problems. It can calculate 2 types of probabilities:

[a]. A chance of each class the user's speech's words appearing.

[b]. A conditional probability for a standalone class, given there is an additional x modifier. Bayes Theorem The model is called naive as it operates on the assumption that all the input data values are unrelated to each other. While this cannot take place in the real world, this simple algorithm can be applied to a multitude of normalized users speech words data flows to predict results with a great degree of accuracy.

[7], The invention in software design

[a], The following detailed requirements for software design are only for the purpose of making relevant developers clear; the present invention sets out some basic requirements that should be met in various aspects of software writing, and they are not intended to provide any software design and to be applied to the present invention, set restrictions, any type of software design and applied to the present invention should be included in the patent of the present invention. The text editing and design of the software of the present invention system must be entrusted to the specialty of good reputation, reliable quality, and willingness to pursue design details industry companies.

The software design method to describe the system functions of the present invention based on logic: Logic is used to describe requirements, specifications, designs and procedures.

Requirements: Specifications and procedures are required to build “software” to control the accurate operation of the various functions of the system of the present invention, as well as their mutual integration. It requires software engineers to edit and write codes to achieve the construction. The system of the present invention passes Intelligent sensor control “water level control”, “water temperature control”, “water pressure control”, “injection (anal) water volume control”, “washing (butt) water pressure control”, “seat plate temperature control” “,” “Bottom (butt) pressure (air) control”, “Micro machine movement (accurately anal anal) control”, “Barrel lid induction opening and closing control”, and other things that were not shown in the system function of this, etc.

In addition, it is necessary to thoroughly understand and understand the relationship between these functions and AI edge computing, as well as the accuracy of the work produced by mutual integration, implementation and development requirements for some non-conventional functions. These include requirements determination, specific functional analysis and design, implementation, software, file editing, code writing (including selection positive the exact code) then tests repeatedly to meet the design requirements of the invention system.

[b], the writing of software documentation must be delegated to a reliable and reputable professional company. Because the system of the present invention is particularly emphasis on the execution of fine section is written; it is related to the very important user's personal feelings. Each element of the invention has its unique characteristics, which determine the interaction of software and machine. The real world the phenomenon determines the specific requirements of the invention system. That's why it's possible to make demand capture a little difficult because it's in the crossing the invention, system should be used to check the software compilation and software design really understand the invention, The system's functional requirements and the software design is complete with its true commitment.

So, after delivery, it's been returned to the test there are many problems, only in repeated tests to discover, modify, upgrade, etc. For software development, the blogger is a good idea. It is easy to ignore the real demand for the various functions of the invention system, because the direct shift can be made to start the “solve the problem” the general nature of the system's functionality is easier, but the accuracy of the detail will be a bit sleepy difficulty, this invention emphasizes the “pursuit of details” and is also a place to be noted. The gap between requirements and procedures should (probably) exist, and not all phenomena of the system function of the present invention is easy to design Software and machine fusion.

Therefore, the various functional requirements of the present invention system and the software and machine can directly interact between the product there can be gaps, which require special attention, cannot be due to some problems in the software design and change any of the present invention system the ability to perform functions accurately. Traditional software is from text to code writing—the transition from requirements to implementation procedures may be a solution to bridge the gap between the system function phenomenon of the present invention and this phenomenon. In a reasonable development process, each step in it follows the sequence from 1 to 10 and starts with the sequence and steps. For example, when the sensor designed and installed in the system of the present invention (AI smart bucket) finds that the user enters the toilet and then gradually approaches, the first (first) lid of the bucket is automatically opened. When the AI intelligent system determines that the user is facing the system equipment of the present invention and begins to take out the excretory organs, the AI intelligent system will automatically use the system of the present invention designed in the bucket during the excretion process of the user.

[c], the cleaning system progresses slowly and orderly, producing small water flows out, and constantly cleaning the inner diameter of the barrel until the user completes the excretion, and then closes the lid to clean the entire barrel. In this example, the order of the functions can be clearly understood:
[1]. The user is found,
[2]. It is judged that the user has excretion needs (gradually approaching the device),
[3]. The lid is opened,
[4]. It is judged whether the user is on the device,
[5]. The function starts to cooperate with the user's excretion process,
[6], determine that the user has completed the excretion,
[7], close the lid of the bucket,
[8], clean the entire inner diameter of the bucket. The above-mentioned |all are in the most elegant and economical order, is not the complicated thing that exists in the reality of the living.

[d], You can taste it try to follow established procedures as far as possible and, if not departed from established procedures, the final product and the archive would be the desired result. In addition, the editing of software text and code design also need to emphasize the following three steps.

[I], according to the system design of the present invention a variety of functions Document each requirement in detail.

[II], From the various requirements expressed in the system of the present invention, it is found that the phenomena of sharing these functions are tabled the specifications of various functions of the system of the present invention. Therefore, the specification describes the various functions and application domains required in the system of the present invention the interface or boundary of.

[III], from the specification we draw the program. The procedure relates to the sharing phenomenon and inner of various functions of the system of the present invention phenomenon. The writing and code design of the software text is to provide proof that the software program meets all the functional needs of the system of the present invention reasons for seeking. How to produce a specification, assuming—If the system equipment (machine) of the present invention behaves similarly, then the specification requirements can be met.

That is, implementation correctness: (Equation 1) implies that it is a more specific or defined product requirement than a more abstract specification beg. This makes the program more useful and easier to implement than the specification, because the program describes how the specification is implemented, whereas the specification describes the necessity what needs to be achieved without any unnecessary attraction to the internal details. The implementation of the specification is a program that can be used with assertions from logically describe it. Since predicate is a theorem of proposition logic, the system equipment (machine) of the present invention meets its specification. If the rules are met fan requirements, then the requirements are also met, that is, specification correctness (Equation 2), system correctness: (Equation 3) in the above development In the process, software text and code design need to be distinguished between specifications and requirements. The term “norm” is one of three terms that represent requirements, specifications, and procedures.

Demand only with the present invention system equipment (machine) Environment-related, that is, related to the real environment. Programming_will certainly be interested in phenomena on the boundary, but this interest is that the acquisition of the device (machine) must be in the demand for data on its upper shipment is triggered by the demand for data. The norms form a bridge between demand and program, and the norms are only about common phenomena—yeah.

[IV], the specification is therefore a requirement of a ‘species’ (which relate to the various functional phenomena of the invention system), but it is also part of the program which is They are involved in certain equipment (machine) phenomena. Because the specification is the function of the device of the invention system through many reasoning steps in fact, it is necessary to ensure that these functions are not affected by the deviation of implementation, i.e., the “machine” details Interest.

[1], The quality of the final software will be determined to a very degree by the correctness of the description of the system domain and demand of the invention. The logic of software design is often a novel way to save work that has already been done. Deliver products on time and within time and cost overriding requirements often mean that at least logical analysis and calculations cannot always be done carefully in detail. Software development is now just because you can't find an accurate mathematical description doesn't mean you can't find one. Software engineers will seek a balance between sketching and accurate descriptions and calculations weigh. Therefore, useful software development methods will allow software engineers to choose the appropriate level between mathematical and informal descriptions balance. Logic is a useful tool for verifying the correctness and achievability of specifications. Once the software text is written and designed to verify the module specifications, Logic E and theorem proofs can be used. Although the complete development from specification to implementation can be completed mathematically, it is also possible to use logic calculations to derive routines from the specification, and the program meets the conditions for correctness. If you use a programming language that does not support simultaneous assignment, you may need to further optimize the code. Use the same type of calculation as the design calculus for

[2], this derivation, logical connectives and quantitative words, such as combination Taken, implication can be used for program optimization, also known as program correctness (Equation [a]. If (that is, all the actions described by the program) also meet the specification, the program will implement the specification. Connection is a common method for expressing connection and interaction in an assembly composed of two or more components. For example, consider two classes that each satisfy invariants. If both classes are used in a given program, then the behavior of the assembly can basically be guaranteed to be consistent. If a specification is complex, we can decompose it into two sub-standards (or design into). Then, each design can be implemented in a separate program and provide theorems. The final realization is to ensure various functional requirements of the system of the present invention through planned calculations. The above has shown how to use logic to describe requirements, specifications and procedures. In addition, logic can be used as descriptive calculations throughout the software life cycle (including design, implementation, and documentation).

[b], Finally, the logic calculation format can be used in all phases of the software life cycle. How to realize the various functional programs that regulate the system equipment of the present invention, or determine the set of components of the system components of the present invention that meets its specifications combine. Well, the computational format must have the advantages of simplicity, ease of reading, ease of use, and how to make it in all stages of software design using computational logic is an important problem in software text editing and code design.

The system of the invention has various functional needs and fusion stronger theorems will be required to simplify calculations, which can greatly improve the reliability and safety of the present invention system. [4], An informal description of the case study is provided below: As an example of the wall-type Water tank of the system equipment of the present invention, if the value of the water in the Water tank is 10 units when it is fully loaded, then “when the water in the water tank is reduced by 1 unit or more, the water in the water tank is reduced by 1 unit or more. The level sensor should send out low liquid level warning data. Then the software controls the water controller to open the water valve when the liquid level is low, and fill the wall water box until there are 9 units of water in the water box. The maximum capacity of the water tank is 10 units, but the water level should always be between 1 and 9 units. The sensor readings are updated once every cycle, that is, every 20 seconds (a cycle). Every time. One cycle uses a certain unit of water, and then up to 9 units of water can be added back in one cycle. After studying the above problems, the programmer may immediately write reasonable code for the controller module. The main body of the module executes “set alarm; once per cycle. If the tank level is already 0 units, the tank routine will the wall water tank input set point is set to 9 units. If the wall water tank level is 1 unit, the wall water tank input set point is set to 8 units. In this way, at the end of the cycle Fill the wall tank to exactly 9 units. However, there may be errors in the above procedure because the recommended design method described above is not followed. In fact, if there is no specification that satisfies the correctness of the specification (Formula 2), We can't even start debugging the program.

A reasonable software design method requires the designer to first divide the system of interest into the actual domain (the system equipment of the present invention) and determine the relevant phenomena.

[V], In this case Below, the actual area is the wall-type water box, which is out and in. Including the phenomenon shared with the machine. (Water level and alarm). Outflow is not a common phenomenon, because the machine cannot enter it Measurement. There are some requirements that it is not formal and cannot be expressed accurately; mathematical descriptions that can be used can be used to eliminate the ambiguity in the non-formal description. After determining the phenomenon of interest, the next step is to write the water box. It is assumed that the machine will read the level sensor data at the beginning of a cycle, immediately calculate the new value of in and produce Alarm, and then repeat this operation at the beginning of the next cycle after 20 seconds. Therefore, The demand can be described in terms of variables of interest at the beginning and end of any cycle. Water tank requirements is generated by the initial value of the water level, the alarm signal and flow rate are specified by the water level, the alarm and the discharge, and the cycle ends the water level value of the time.

[1], Therefore, the requirement states that the final value of the water level must be within the specified range if the water tank level is low (at the beginning of the cycle), the water tank must be filled (at the end of the cycle) to 9 units, and the alarm must be low at any level warning when level water level (at the beginning of the cycle). Of course, there is another state that must be considered. For example, when the water box is in front of the user, the user has just completed the use, and the other user has a need for use (this is in the life of the user). It is very common). At this time, the water position of the water box may be at a lower water level, and the software controller should be executed separately, that is, the software control water valve is at the water box water position. When the set 9 water levels are not reached, the inlet valve should not be affected by any use status. The inlet of the water valve and the outlet during use by the user will naturally operate at the same time, even, Increase the amount of water input to ensure the normal use of users. The next step in the recommended design approach is to describe the properties that characterize real-world domains. Real-world description:

[2], Domain attributes are guaranteed from what is required the physical law of holding traffic is derived from the fact that the traffic at the end of the loop is the level that the original traffic must maintain, and depending on the volume of the traffic small adjustment. This is a hypothetical assertion that the outflow at the beginning of a cycle is a unit unless there is no remaining water to flow out (the Ministry). is not in the informal description, but must be added if you want to describe it accurately). In the absence of a controller, the water tank's “Self.” By “Run will not be able to meet the requirements.” This is because the inflow setting can be set to any value. Therefore, in order to meet the requirements, we must a value must be specified. Requirements and descriptions in the real world can be referenced. However, without sensors, outflow is not a common and the machine's controller may not reference it. This is the machine specification: If the instant device is assumed to be fast-circulating (quickly) the instant's speed of the invention system much. Therefore, software and design must ensure that the above values are set and reported at the beginning of each cycle. Specification refers only to sharing phenomenon.

[3], The specification of the software controller module described is realized. seems correct at first glance, because if water is zero it would add nine units' water if the water were to be 1+8=9, it would add eight units' water otherwise it would not add anything. Like the counter-case show up that's wrong. Consider the state of the cycle at the beginning of the cycle, in which it. This requirement is therefore based on the above specification the method is to be full, as at the end of the cycle the water box is to be 9 units. The failure specifications do not take into account the fluid the fact that one unit of flow is available (note that there will be zero flow when the liquid level is 0). When performing the logical calculation of logical correctness (Equation 2), a counterexample was detected. The correct specification of the controller is the machine specification. It points out whether the water level at the beginning of the cycle is zero units or one unit water, it must be added to 9 units.

[4], If we can prove the validity, then specify the correctness factor, determine what the level at the beginning of the irrelevant cycle is, and as long as the application domain meets the specifications of the actual machine, the requirements can be met. Therefore, the software design needs to read the data of the water level sensor immediately before the start of each application, not during the process or after the process is completed. The above example leads to a situation that may occur in actual application: the occurrence of an accident. In order to fully guarantee the normal use of users, it is necessary to emphasize during software text editing and code design. Take the previous example as an example: when a wall-mounted water tank executes the output of the water, the water level of the water tank may be “0”. There are many possibilities for this phenomenon, including but not limited to network attacks, or software BIGs, etc. This is a very important event.

[5], Therefore, it is necessary to make pre-settings during software text and code design, such as periodic system physical examination.

The specific requirements are as follows:

[a], in a busy use cycle, every 30 minutes dedicated to set the software medical examination procedure will be the invention system for a comprehensive body the program reads all sensor data and checks and tests all controllers for their operating status, if used during this time period is in use and can wait for its use to complete.

[b], in the non-busy use cycle, every hour to carry out a full-face system physical examination.

[c], if abnormal state is found in testing and inspection, software text writing and code design should be designed with a set of programs capable of pairing abnormal state recovery, or removal of obstacles and removal of BIGs, to ensure that the system equipment of the present invention can rely on the operation.

[VI], if the above software fails, first of all, must pass the software to correctly assess the abnormal state, one problem cannot there are three steps that must be performed to recover from the set software: If the above software fails, first, the software must be used to correctly evaluate the normal state. Once the problem cannot be recovered through the set software, the following three steps must be performed:

[1], Turn off all the functions of the “mini robot” through the software system (that is, the mini robot stops working) to ensure the safety of the user.

[2]. After performing the above A, the set software will perform another physical examination to evaluate whether the remaining functions can be safely used by the user without the involvement of micro-machines demand. After three repeated physical examinations, in order to obtain a correct answer, whether the system of the present invention can be used safely at this time. If the answer is YES, all functions except the micro machine can provide safe services to users.

[3]. If B has been executed, the answer is NO, and the software must close most of the system functions.

[VII], Currently, the system equipment of the present invention is like an ordinary bucket, but it still needs to retain some basic functions, because any time these functions are performed, the user has no security concerns:

[A]. The bucket is used After using the auto impulse function.

[B]. The automatic opening and closing function of the lid.

[C]. The designed drum cover has all the functions of cleaning the inner diameter of the drum and the seat plate. In some cases, software design must follow a hybrid approach to continuous and discrete mathematics. For example, in the flow volume of more in the precise model, you may want to represent the relationship between the water tank flow and the valve setting as: until time, discharge from the tank the total amount is what, while the water tank flow setting is the time function State Time, Step and Hytech tools are software design tools, set examples of these toolsets can use algorithms and theorem proof techniques to analyze and calculate descriptions using real-time time logic or hybrid.

[D], The properties of the system, these tools enable designers to analyze and discover uncertain reactive programs. can be made throughout the process with the logical software development life cycle, can be used as a design calculus, but also can be used to record requirements, regulations, design and sequence. The use of logic provides both accuracy and the ability to predict software behavior, providing developers with something like it tools used in his engineering disciplines.

[VIII], Spice has been used to analyze key analog circuits in almost all ICs designed in the United States. In addition, software text and code design require special consideration. For example, the first argument in the appendix of logic E6.1 inference rules is monotonous and expressed by theorems: one. You can try to use PVS to verify the AI edge computing IC transistors and its microprocessors, and software to check the microcode instructions. Check for errors or lack of functional requirements. It is also necessary to check whether there are coding errors in AI edge computing (whether the stack size is correct). Of course, perhaps more effective methods have been produced on the market in the past to complete the previous tasks, but these software functions are very necessary and must not be lacking. Software text writing and code design also need special consideration: dynamic sequencing (standards) when the software is operating normally, and constantly looking for the first priority that the software should perform.

[1], For example, when a user is found approaching, the first priority of the software is “Automatically open the lid”. After this action is completed, the new first priority will be automatically changed to use the smart camera to distinguish the user. Body shape “is it facing the barrel or back to the barrel? When the AI edge calculation is completed, and the judgment is completed, the AI intelligent system of the barrel will take corresponding cooperation, such as (The first priority of the new product) seat plate heating or cooling, (the first priority of the new product) double butterfly intelligence Protection, (the first priority of new production) Micromachines began to work accurately. This example is to show that the software text and code design must be considered. AI edge computing can constantly search for and determine the new first execution priority during normal operations. In the gap period when the device of the invention is used, AI edge calculation will also be carried out non-stop physical examination to read the intelligence sensing data, to find out what may arise, to find and judge possible first priority.

[2], The same water tank as the front for example, when using idle time, AI edge calculations check the water level in the water tank at any time, and even, test the discharge of a small amount of water to detect the data reaction generated by water level sensors, as well as various other intelligent sensor tests, and so on. The software development should thoroughly understand every detail of the present invention, especially the design of all the details that must be done is based on the user experience as the first priority. Of course, software developers must also be aware; accurate sensor operation depends on the sophisticated design of software and hardware interfaces to meet specific performance requirements. At the same time, developers need to carefully consider the placement of the sensor on the circuit board and the nature of the housing used to protect the sensitive sensor and optimize the accuracy and reliability of the sensor.

[3]. Software development also needs to consider how the multi-sensor combination can be coordinated and accurately work on the system of the present invention at the same time. Developers need to solve the problem of each individual sensor to avoid electrical or physical interaction between the sensors in the final circuit board design. They also need to pay attention to the reliable data conversion and transmission of various types of sensors in the system of the present invention at each stage of software and hardware design. The software development of the system of the present invention requires a specially designed application that can realize the various functions designed by the present invention, and can fully guarantee the accurate execution of the various functions of the present invention. In this operating system, there are some key factors that require special attention in software development.

[IX], These key factors have the following points:

[a], sort and find out the first priority, the second priority, and the third priority category. First, software development needs to classify the raw data obtained from sensors. Including but not limited to personal privacy data of the user of the present invention obtained by the smart camera sensor. For example, the body, face, excretory organs, and some privacy actions of any user during use, and so on. These are the first priority privacy data and need to be specially stored in the designated family data center (SSD or SSHD) and cannot be shared or transmitted. Here, the inventor cannot prejudge the complete definition of privacy for all users. Software development should design user options in the privacy definition function so that the user can determine in addition to the above. In addition to this privacy, the user is willing to add any other data to the privacy that needs to be protected. Of course, too much data generated by the user during the excretion process is limited to the scope that needs to be protected.

The complete operation of the AI system has a greater impact on the production. Therefore, the software needs to design a suggestion program that can tell the user that its choice has limited the service performance of the AI intelligent system. Perhaps the user can only choose the special purpose of this invention. The “manual operation” program is designed to ensure that the privacy of users can be completely, and thoroughly protected, and normal use will not be affected. The second priority category.

The user's performance requirements during the excretion process, such as water temperature, water pressure, the amount of water injected (out of the limit), the short cleaning time, the specific needs of the user, and the production of these requirements What time of the day, and others, etc. After obtaining these raw data from the sensor, it is necessary to store the data on a designated storage card, and transmit the data to the distributed (local) cloud and remote cloud computing center during the designated time period when the network usage is low.

The cloud computing AI intelligent system needs to perform calculations and analysis on these raw data, and then generate service instructions, and further train the AI edge computing designed in the system equipment of the present invention. The third priority category.

[b], The IoT system controls the raw data generated by various devices, which also need to be stored in the storage card. During the network low peak period set by the system of the present invention, the data is transmitted to the distribution (local) cloud and the remote transport computing center, which is AI The intelligent system analyzes and processes, and then generates instructions for the dual AI intelligent edge calculation designed for the present invention system and the IoT control system Train. The invention system and IoT can also carry out more classification, above just some tips, specific needs in the software open hair design process to perfect. sorting the acquired sensor raw data may help the AI edge calculation to decide which order of services should be generated. Below are examples of sorting that are intended to help software development and design clear examples, not specific designations and limitations any possibility is worth noting:

[1]. The privacy-level data specified in the first priority category above should be sorted in place.

[2]. The above-mentioned first priority category clearly specifies that user-defined privacy data should be sorted behind.

[3]. The original data of user requirements should be sorted in three.

[4]. The raw data produced by the equipment controlled by the IoT system should be sorted in four.

[5], IoT system control equipment inside, refrigerator, home automatic lighting system, air conditioning system, smart wear system, smartphone, The raw data of the home hot water system, and others, should be reordered and reclassified. The above indicates that there are many systems in the system of the present invention and IoT that can be sorted in detail, and the inventor of the present invention is not able to do so because of the length problem the law is arranged one by one, just to do a demonstration.

[c], multi-essence AI edge computation software design in other all condition same situation, more essence usual table show up bigger energy strength. (The correct compilation software may use many essences to come one time to process the duty a part.) In this invention system-wide, the polynuclear usual performance is better. Therefore, the software development and design required by the system of the present invention should be multi-threaded (this is especially suitable for content creation and editing of graphics and video packages), and more cores will help.

AI edge computing cores should support multi-threading. In short, multithreading allows software to run two discrete processing tasks or threads on each core of the PC. Assuming software and operating systems can take advantage of it, the potential of simultaneous processing will be doubled. Intel calls this feature Hyper-Threading (HT), but in the AM D world, the generic term SMT calls it symmetric multi-threading. In fact, this is the same thing. For CPU-intensive tasks such as video rendering, supporting HT/SMT is the same thing. As with core counts, these numbers are only stated within a given processor family.

For example: 3.5 GHz Intel Core X-series cores and 4 GHz AMD sharp mainstream cores are only based on clocks and cannot be directly compared. These are just the judgments due to formal benchmark tests and laboratory-based reviews. The above-mentioned suggestions are the places that require special attention in the development and design of the system software of the present invention. A full understanding of the AI edge calculation IC index used by the system of the present invention is very important for software development and design, and is also the key to its success.

[d], the system design of the present invention has a home data center, its function and function is to protect the privacy of users; it is designed as the original Inventing the system dual AI edge computing manipulation, its physical properties should be a SSD or SSHD. Software must be designed with its none in mind limited scalability, no specification limits, can be extended to N GB. The data center needs to be designed by software: by 256 digits full coverage of protected home data centers must be password protected, and password systems must be able to accept and certify the specialty of computers characters, e.g.: smh.com.au, etc. Software design must support password non-transferability, that is, in the user set after you have determined your own password, it can only be stored in the home data center, cannot be submitted or transferred, the password is also 256 bits digital encryption, because there is 256-bit data encryption, the user's privacy including password cannot be stolen by anyone. In family data center software design:

[1]. Classification. The software design family data center is divided into two categories (partitions):

[A], the private data storage area produced by the user when using the system of the present invention. These data include, but are not limited to, the graphics acquired by the user by the smart camera, the state actions during excretion, the graphics of excretory organs, and others, and so on. These data cannot be downloaded and moved outside.

[B], any electronic data uploaded by users and family members. These data include the storage of any smart data of the user's family. The software must be designed to be able to upload and download. The storage functions must include graphic data storage, file data storage, image data storage, text data storage, App storage, Bookmarks storage, History storage, Theme Wallpapers storage, Password storage, Address storage, Phone number storage, Notepad storage, Date storage, and others, etc.

[2], sort. To sort the above privacy data, the first priority should be the use of the privacy data generated during the present invention, which data cannot be downloaded and moved out. The second priority is the privacy data that users' homes can upload and download. Of course, the first and the second priority class can also be sorted because the user has such a need. Therefore, software design must create a “The Settings feature allows users to sort and sort “Customize” themselves, as well as several other options. Software development and design should also consider the ability to support two design ideas:

[a], can be from local to global. From the local to the whole, it means that researchers think and design the local knot from the functional fragment first in this way, the characteristics of the local structure can be precisely designed, and the precise control thereof can be maintained.

[b], from the whole to the local, is a major advance in helping to complex design. From the whole to the local means software development designer determines the overall shape of the device of the invention system and then consider how to combine the functional sections as required get up full of the whole requirement.

The two design ideas combine & design, which can design a more complex set of equipment functionality and maintain the fine of individual parts quasi control. In addition, the development and design of software requires repeated simulation and testing of actual usage, and designers can model inside the software, The system equipment of the present invention will produce various complex uses in the real world.

As structural complexity increases, it needs to be evaluated the accuracy of the last appearance, and behavior of various functions of the present invention system. So, it is important to be able to simulate the operation of the system of the present invention, no A lot of design and development time is wasted. Below are some essential factors which the software development needs to pay attention.

[c], Consider the final use and implement the use test. In the whole process, it is very important to fully understand the needs of the users of the system equipment of the present invention. When creating a value-driven statement, software development and design must fully understand the product's target and the problem the product will use to solve the target. Consider the various stages of the project to be tested. Different methods can be used, depending on what kind of value feedback the software developer and designer want to get. Performing the user test of the system of the present invention before designing can determine whether the software design has sufficient user boundaries, while constructing it and ensuring that participants and test areas are prepared to obtain accurate test results.

[I], have clear targets and specifications. Create a road map for software development and design and develop a strategic plan to highlight the target. Detailed apparatus indicates what the team needs to help achieve the final design of the target. Before the Software Development & Life Cycle, create—value-driven statements to help set a precedent for the items, targets, and targets and the problems that the item will solve.

[II], hire experienced developers. Hiring skilled developers allows the development process to proceed smoothly. For senior developers investments are sure to cost more, but view from a long period, this can effectively reduce software development and design difficulties and save time and money.

[III], pay attention to the plan. The right planning will ensure that everyone knows what they are responsible for throughout the project. Before you start working, you should first determine the project strategy and approach that will guide you to your ultimate goal. Take the time to find out which opens you will use throughout the process tools and determine the technical architecture that supports your software. Sprint plans with clear milestones, application frameworks, generations code review, automated testing, error and task tracking.

[IV], implements the effective project management. The project all benefit counterparts must agree a set may pay the achievement and the approval standard, avoids scope slow change and following extra cost. Between the service and the software development team's official agreement is the hypothesis is clear about the expectation and the elimination no matter what a what confusion very good method.

[V], there's a clear communication. Clear and coherent agreement is the pillar of successful software item's helping to avoid confusion, delay and mistakes. The stage in which communication is essential. Whether you understand your focus or achievement is still in progress the update should have specific communication channels (i.e., Slack, Skype, electro-mail, etc.) to coordinate the whole Team function effectively.

[VI], focus on your design. At the design stage, the designer shall create a detailed design & file, specifying the technology for the product & target and the tools. Software development workers should then view the gear to correct the technological changes. Design is a blueprint to be built. It may take many times Test the luck to find the right design. That's why testing and improvement stages are important in the whole development process cause. You should form a team of excellent designers, who should give priority to the experience. They need some technical & technical & technical & technical such as the wire frame and prototype design of a flow model.

[VII]. Implementing risks management. Software development and design always go wrong before testing is complete, so failure should be as elegant as possible. for this purpose, create risks Log and include action plans to mitigate and handle insurance early in the process. The software development team should develop a plan for the risk.

[VIII]. Follow the best practices of software development. Development teams should follow the best practices of software development. The development team should follow the code standard guidelines. Source management is another important component because it allows you to manage changes to code and provide a set of code medium source code. The software development team should be reviewed by the code before the program start. Code review is one weight of the software item to have components, you can help you identify any errors and defects.

Code review ensures that software development & staff follow best practices while make sure the entire team reviews the code. 10, for final and post-release review. At the beginning of the project, you should measure it using settings and data that are as close to production as possible Test the system. Once all of this is done and the final acceptance test is complete, the next step, deployment, is to be completed. The deployment process is project-based specific requirements for customization. The operations team should review, confirm, and approve the deployment documentation. No two projects are the same because each company has different requirements and expectations.

As the project progresses, there will be others in the process some variables work, which can lead to additional time and cost, keeping software development and design out of order.

The Family Data's Center

Basic configuration of Edge computing powers for the invention running Blockchain, Smart contract, AI algorithm/Models.

I, Private blockchains use identity to confirm the invention each user of membership and access privileges and typically only permit known organizations to join. Together, the organizations form a private, members-only “business network.” When building a private family data's center blockchain application, it's important to consider security at all layers of the technology stack, and how to manage governance and permissions for the network.

A comprehensive security strategy for a family data's center blockchain solution includes using traditional security controls and technology-unique controls. Some of the security controls specific to family data's center blockchain solutions include: Identity and access management (Who the family member they're able to join's) Key management (Who the family members be able upload & download) Data privacy Secure communication Smart contract security Transaction endorsement Employ experts to help you design a compliant and secure solution and help you achieve your business goals.

Look for a production-grade platform for building blockchain solutions that can be deployed in the technology environment of your choosing, whether that is on-premises or your preferred cloud vendor.

II, Smart Contracts. For the invention Multi-party Business Processes, DAML is an open-source smart contract language for building future-proof distributed applications. It enables organizations to run and execute smart contract applications across multiple parties in a safe and secure manner.

Using smart contracts, the invention can easily build contract-driven orchestration layers that are persistence layer agnostic (meaning they can run on either databases or blockchains). This approach mitigates the data management problem, reduces the complexity of adoption, and accelerates the time-to-market for AI and analytics programs by bridging data silos without requiring constant reconciliation.

III, Linear Discriminant Analysis (LDA) This is a branch of the logistic regression model that can be used when more than 2 classes can exist in the output. Statistical properties of the data, like the mean value for every class separately and the total variance summed up for all classes, are calculated in this model. The predictions allow to calculate the values for each class and determine the class with the most value. To be correct, this model requires the data to be distributed according to the Gaussian bell curve, so all the major outliers should be removed beforehand. This is a great and quite simple model for data classification and building the predictive models for it.

Discriminant Analysis is a machine learning algorithm that is used to analyze the adequacy of object classification, and also for assigning one object to single or many groups. From the early diagnosis of diabetic Peripheral Neuropathy to refining the diagnostic features of blood vessel distributed according to the Gaussian bell curve, so all the major outliers should be removed beforehand. This is a great and quite simple model for data classification and building the predictive models for it. Discriminant Analysis is a machine learning algorithm that is used to analyze the adequacy of object classification, and also for assigning one object to single or many groups.

From the early diagnosis of diabetic Peripheral Neuropil images, discriminant analysis is applied in the healthcare industry. It is also used for electronic health record management systems and to detect signs of mental health disorientation. Family data's center mainly focused works for the received those data's specifically Category's. When the center received a data's then; it's should followings the software design to Classification each type of data's saves into correct SSD or SSHD.

IV, the IC and Software Design should Pay Attention to the Following Important Key Points (Exegesis)

1, user—friendly version that makes it very easy for user to innovate the classification of various privacy information, easily edit their information, or delete any unwanted information on a user-friendly dashboard.

2, use SSD and SSHD OF Dual back up information storage its must be able to be upload and download their own private information at anytime from anywhere.

3, SSD and SSHD design to be one in and one out single line.

[a], SSD it is wireless network supports. When after the data has been infected by a virus all data easy to make to deleted and cannot be recovered.

[b], SSHD its not support wireless network, if the owner has adman some requests want to download information, then must be uses the data cable reads out the storage data.

[c], SSD and SSHD both cannot be linked to each other, and has an independence line for entering and exiting, used to prevent virus from infecting each other.

[d], On the other hand, should build up USB sockets for the SSD and SSHD, for data storage extensions and data reading out.

[e], for security reasons, build up user password with three security questions, that with all data storage adopt data encryption software. Used to secure data reading at the remove end.

[f], password and three security questions data cannot be transferred or move out, its can only saved in SSD and SSHD of the family data center.

[g], all family data center of its computational requirement is borne by the invention Edge computation. 4, SSD size: 64G, 128G, 256G, so on. SSHD size: 80G, 160G, 300G, 500G, etc.,

The below listing those items creates by; Jesse O Sung
Family data center
Internet of Thing (IoT)
Sensors network data transmission
The infrared Camera on the water's injector is the modification
Data transmission
Wireless sensors network
AI edge calculous take precedence
Under the control of the AI edge computing system
Sensors and computer . . .
IoT device layer
Open-source smart software for data's flow programming
Database Basis Software
Large data analysis
Data processing security
The invention uses Private blockchains It's use identity to confirm membership and access privileges and typically only permit known organizations to join
The health excretion reference score indicator
Error-correcting Introduction All error-detection and correction schemes add some redundancy
Arduino and computing
Build up an AI data and private cloud
Train itself to create a neural network model and Algorithm
Smart contracts defined
How smart contracts and AI could work together
The invention chooses to use DAM L smart contract
Smart contracts defined Smart contracts are simply programs stored on a blockchain that run when predetermined conditions are met
How smart contracts and AI The invention chooses
Private blockchains
The invention chooses to use smart contracts Benefits of smart contracts
Speed The invention made chooses adoption
Private blockchains
The invention chooses Private blockchains for security of Basic layer all users data's
The basic configuration of Edge computing powers for the invention running Blockchain
The AI Robots of Edge algorithms & Blockchain with smart contract
The invention chooses to use SSHD or SSD to memory all data's
The IoT Blockchain, smart contract with AI algorithms
The local database AI algorithms & Blockchain with smart contract
The Remove database AI algorithms & Blockchain with smart contract
The automatic AI speech system algorithms & Blockchain with smart contract

The Invention in Software Design's
The below listing those items creates by; Bright R Sung
The Main Structure of The Toilet
The intelligent toilet wall water tank
Mini robots & Double butterfly robots
3D Camera system used on the intelligent toilet with wall water tank

Independent of Claims:
The main structure of the toilet the machine is mainly composed of three large parts
The Internet of Things (IoT)
The software design and development of the priority's
AI edge calculations take precedence
The invention uses private blockchains
The family data's center

Dependent of Claims:
Although the following detail . . .
Therefore the following examples . . .
In the disclosure, “containing”, “including” . . .
“The terms “first”, “second”, “third” . . .
The terms “left”, “right”, “front”, “back” . . .
As used in this Aircel, when used . . .
As used herein, the term “basically”, refers to . . .
As used in this Aircel, the term “approximate” . . .
As used in this Aircel, for convenience . . .
Concentrators, quants, and other . . .
The same principle applies to . . .
A reference to the “example” throughout . . .
A initial overview of the technical embodiments is . . .
The main structure of the toile the machine is mainly composed of three large parts
The internet thing
Sensor's network data transmission
Mini robots at the present invention
Data transmission
The infrared camera on the water injector (Mini robots) is then modified
Butt clearing system
Wireless sensor network
Sensor's network & sensors data transmission
The invention requires cloud-based
Database management software
Quality factors of the software design
The software design and development of the priority's
AI edge computing calculations take precedence
Double butterfly robots
How can we achieve the goal pursued by the present invention
AI edge computing can constantly search
Combining data analysis and the internet of things
AI machine learning at the same time
Open-source artificial intelligent software for data
AI intelligent making & work in the invention
Sensor and computer
Database basis software
Build up an AI data and private cloud
The invention uses private blockchain
The basic configuration of Edge computing power for blockchain smart contract, AI algorithm/models
The family data's center

THE END

1. The Independent claims

2. The main structure of thte toilet the machine is mainly composed of three large parts

3. The siftware design and development of the priority's

4. AI edge calculations take precedence

5. The invention uses private blockchains

6. The family data's center

8. Denpendent of claims

9. Although the following detailed description contains many details for the purpose of explanation.

10. Therefore, the following examples are elaborated without losing their generality and . . .

11. In the disclosure, “containing”, “including”, and “containing” and having “having” should have meaning under U.S. patent law . . .

12. The terms “first”, “second”, “third”, “fourth” . . .

13. The terms “le”, “right”, “front”, “back”, ”top”, “boom”, “top”, “below” etc . . .

14. As used in this arcle, when used in conjunction with the decription of the device or process

15. As used herein, the term “basically” refers to acons, characteriscs,
